SEQUENCE LISTING (114 sequences)

SEQ ID NO: 1 - DNA, 22 bp, Artificial Sequence
  A synthetic oligonucleotide
ttgggcatctaggcttgaacac

SEQ ID NO: 2 - DNA, 22 bp, Artificial Sequence
  A synthetic oligonucleotide
gtgttcaagcctagatgcccaa

SEQ ID NO: 3 - DNA, 23 bp, Artificial Sequence
  A synthetic oligonucleotide
ttttcacgaatgtcacgtccatc

SEQ ID NO: 4 - DNA, 23 bp, Artificial Sequence
  A synthetic oligonucleotide
gatggacgtgacattcgtgaaaa

SEQ ID NO: 5 - DNA, 22 bp, Artificial Sequence
  A synthetic oligonucleotide
agggactctgggattgaacact

SEQ ID NO: 6 - DNA, 22 bp, Artificial Sequence
  A synthetic oligonucleotide
agtgttcaatcccagagtccct

SEQ ID NO: 7 - DNA, 22 bp, Artificial Sequence
  A synthetic oligonucleotide
agcatggcactcattattacgc

SEQ ID NO: 8 - DNA, 22 bp, Artificial Sequence
  A synthetic oligonucleotide
gcgtaataatgagtgccatgct

SEQ ID NO: 9 - DNA, 21 bp, Artificial Sequence
  A synthetic oligonucleotide
actctacttcgtgacatcgag

SEQ ID NO: 10 - DNA, 21 bp, Artificial Sequence
  A synthetic oligonucleotide
ctcgatgtcacgaagtagagt

SEQ ID NO: 11 - DNA, 23 bp, Artificial Sequence
  A synthetic oligonucleotide
caggtcaaaagggtccttaggga

SEQ ID NO: 12 - DNA, 23 bp, Artificial Sequence
  A synthetic oligonucleotide
tccctaaggacccttttgacctg

SEQ ID NO: 13 - DNA, 22 bp, Artificial Sequence
  A synthetic oligonucleotide
actcttgacttaaggtacccaa

SEQ ID NO: 14 - DNA, 22 bp, Artificial Sequence
  A synthetic oligonucleotide
ttgggtaccttaagtcaagagt

SEQ ID NO: 15 - DNA, 23 bp, Artificial Sequence
  A synthetic oligonucleotide
aattacgattagcactatcccca

SEQ ID NO: 16 - DNA, 23 bp, Artificial Sequence
  A synthetic oligonucleotide
tggggatagtgctaatcgtaatt

SEQ ID NO: 17 - DNA, 23 bp, Artificial Sequence
  A synthetic oligonucleotide
gtttcacgaatgtcacgtccatc

SEQ ID NO: 18 - DNA, 23 bp, Artificial Sequence
  A synthetic oligonucleotide
gatggacgtgacattcgtgaaac

SEQ ID NO: 19 - DNA, 22 bp, Artificial Sequence
  A synthetic oligonucleotide
atcgaatagtctgactacaact

SEQ ID NO: 20 - DNA, 22 bp, Artificial Sequence
  A synthetic oligonucleotide
agttgtagtcagactattcgat

SEQ ID NO: 21 - DNA, 22 bp, Artificial Sequence
  A synthetic oligonucleotide
gacacgcacactgtcgccgact

SEQ ID NO: 22 - DNA, 22 bp, Artificial Sequence
  A synthetic oligonucleotide
agtcggcgacagtgtgcgtgtc

SEQ ID NO: 23 - DNA, 23 bp, Artificial Sequence
  A synthetic oligonucleotide
tcgatgtaacagacgacccaaag

SEQ ID NO: 24 - DNA, 23 bp, Artificial Sequence
  A synthetic oligonucleotide
ctttgggtcgtctgttacatcga

SEQ ID NO: 25 - DNA, 21 bp, Artificial Sequence
  A synthetic oligonucleotide
tcgatgtagaccgatgaccca

SEQ ID NO: 26 - DNA, 21 bp, Artificial Sequence
  A synthetic oligonucleotide
tgggtcatcggtctacatcga

SEQ ID NO: 27 - DNA, 22 bp, Artificial Sequence
  A synthetic oligonucleotide
acagtcaaacagtttatggggt

SEQ ID NO: 28 - DNA, 22 bp, Artificial Sequence
  A synthetic oligonucleotide
accccataaactgtttgactgt

SEQ ID NO: 29 - DNA, 23 bp, Artificial Sequence
  A synthetic oligonucleotide
atcgtggtaaactttagtcacaa

SEQ ID NO: 30 - DNA, 23 bp, Artificial Sequence
  A synthetic oligonucleotide
ttgtgactaaagtttaccacgat

SEQ ID NO: 31 - DNA, 19 bp, Artificial Sequence
  A synthetic oligonucleotide
caggcgattgctaaccgtt

SEQ ID NO: 32 - DNA, 18 bp, Artificial Sequence
  A synthetic oligonucleotide
cagactgggagttggtgc

SEQ ID NO: 33 - DNA, 19 bp, Artificial Sequence
  A synthetic oligonucleotide
actgcctgagtctatggtt

SEQ ID NO: 34 - DNA, 21 bp, Artificial Sequence
  A synthetic oligonucleotide
gccgtttactttgaaaggaat

SEQ ID NO: 35 - DNA, 18 bp, Artificial Sequence
  A synthetic oligonucleotide
cacaaggcattgaccctg

SEQ ID NO: 36 - DNA, 23 bp, Artificial Sequence
  A synthetic oligonucleotide
gcacctttttaaatttttgagtg

SEQ ID NO: 37 - DNA, 41 bp, Artificial Sequence
  A synthetic oligonucleotide
gcgcaatggagataccgtcgttccgcgaacatcaaaggtct

SEQ ID NO: 38 - DNA, 39 bp, Artificial Sequence
  A synthetic oligonucleotide
ccactgaaggcgcgctgaactgttagcagactgaaccgc

SEQ ID NO: 39 - DNA, 46 bp, Artificial Sequence
  A synthetic oligonucleotide
acaccgtcaaggaaatgagaagaatcaacttttctctaccgatacg

SEQ ID NO: 40 - DNA, 40 bp, Artificial Sequence
  A synthetic oligonucleotide
ttaacgcaaggtgtgagaaaggttgactcttggcctgaac

SEQ ID NO: 41 - DNA, 45 bp, Artificial Sequence
  A synthetic oligonucleotide
agctctttagcgatattaacagctttttatgacccacatacctcc

SEQ ID NO: 42 - DNA, 44 bp, Artificial Sequence
  A synthetic oligonucleotide
aggacgtttggatcctaaacacaatcttcagttagttgctctgc

SEQ ID NO: 43 - DNA, 19 bp, Artificial Sequence
  A synthetic oligonucleotide
acaactccatctgttgtgg

SEQ ID NO: 44 - DNA, 18 bp, Artificial Sequence
  A synthetic oligonucleotide
gcatccccattatcagcc

SEQ ID NO: 45 - DNA, 44 bp, Artificial Sequence
  A synthetic oligonucleotide
cagtgttttctgggtttgtgattgctttttctgaagatgggcag

SEQ ID NO: 46 - DNA, 43 bp, Artificial Sequence
  A synthetic oligonucleotide
ttacgcaacaaagaggctaattggttatatggtaaaattccct

SEQ ID NO: 47 - DNA, 22 bp, Artificial Sequence
  A synthetic oligonucleotide
ttgcaacttcaccaaccaatct

SEQ ID NO: 48 - DNA, 24 bp, Artificial Sequence
  A synthetic oligonucleotide
agaaggtacgaagaagaagcaatc

SEQ ID NO: 49 - DNA, 19 bp, Artificial Sequence
  A synthetic oligonucleotide
acgcagaaggcagtcaaga

SEQ ID NO: 50 - DNA, 20 bp, Artificial Sequence
  A synthetic oligonucleotide
accacacttcaatgtcgcag

SEQ ID NO: 51 - DNA, 42 bp, Artificial Sequence
  A synthetic oligonucleotide
ggaagcagcactagtttggccaactgaagcttctggtagcca

SEQ ID NO: 52 - DNA, 40 bp, Artificial Sequence
  A synthetic oligonucleotide
tccagctcaaagtgaaggcgcggggtaccttctccgaacc

SEQ ID NO: 53 - DNA, 23 bp, Artificial Sequence
  A synthetic oligonucleotide
tcactaccttcctcttcagaacc

SEQ ID NO: 54 - DNA, 22 bp, Artificial Sequence
  A synthetic oligonucleotide
tgcggcacttcatttgtaatgt

SEQ ID NO: 55 - DNA, 20 bp, Artificial Sequence
  A synthetic oligonucleotide
gaagcgtactggaaagggaa

SEQ ID NO: 56 - DNA, 19 bp, Artificial Sequence
  A synthetic oligonucleotide
tcaacaatgcggggatctg

SEQ ID NO: 57 - DNA, 41 bp, Artificial Sequence
  A synthetic oligonucleotide
atgatgccggcaatagcgtcacagccagctttacggttcct

SEQ ID NO: 58 - DNA, 41 bp, Artificial Sequence
  A synthetic oligonucleotide
gatgacccgccatggtatggataccatcaccaatggtcagc

SEQ ID NO: 59 - DNA, 22 bp, Artificial Sequence
  A synthetic oligonucleotide
tgataaacttcatcgcaccgtc

SEQ ID NO: 60 - DNA, 20 bp, Artificial Sequence
  A synthetic oligonucleotide
ttrtcctccgctctgtctac

SEQ ID NO: 61 - DNA, 21 bp, Artificial Sequence
  A synthetic oligonucleotide
gccattccacatcgaagaggt

SEQ ID NO: 62 - DNA, 22 bp, Artificial Sequence
  A synthetic oligonucleotide
atgagaacatcaatggtatggc

SEQ ID NO: 63 - DNA, 40 bp, Artificial Sequence
  A synthetic oligonucleotide
ggcgtgagagatccacctggaatgcgccgtaatagcggtc

SEQ ID NO: 64 - DNA, 44 bp, Artificial Sequence
  A synthetic oligonucleotide
caccattatggaaacgcttatccgccggatacagctgaagcatc

SEQ ID NO: 65 - DNA, 20 bp, Artificial Sequence
  A synthetic oligonucleotide
caggtgatcaacatcccgcc

SEQ ID NO: 66 - DNA, 22 bp, Artificial Sequence
  A synthetic oligonucleotide
cggtaaagtggtcagcaaagat

SEQ ID NO: 67 - DNA, 21 bp, Artificial Sequence
  A synthetic oligonucleotide
ccccacctttaactagaacaa

SEQ ID NO: 68 - DNA, 20 bp, Artificial Sequence
  A synthetic oligonucleotide
gccaaatcctttgctatcga

SEQ ID NO: 69 - DNA, 46 bp, Artificial Sequence
  A synthetic oligonucleotide
cgcagggcgattttcaaaaattaaacaataatgcagyaaatgggat

SEQ ID NO: 70 - DNA, 44 bp, Artificial Sequence
  A synthetic oligonucleotide
ttaaccattttaggccctagcggcaaatccaatttccttgtgct

SEQ ID NO: 71 - DNA, 24 bp, Artificial Sequence
  A synthetic oligonucleotide
gcttcgtctttaaagygaggattg

SEQ ID NO: 72 - DNA, 20 bp, Artificial Sequence
  A synthetic oligonucleotide
agcagctttaacggtttggg

SEQ ID NO: 73 - DNA, 22 bp, Artificial Sequence
  A synthetic oligonucleotide
gcaagacaatattattgatcgc

SEQ ID NO: 74 - DNA, 18 bp, Artificial Sequence
  A synthetic oligonucleotide
ctttcacaggctgcactt

SEQ ID NO: 75 - DNA, 42 bp, Artificial Sequence
  A synthetic oligonucleotide
acagcaccgccacctatagtagaagcttttttaaactagggc

SEQ ID NO: 76 - DNA, 46 bp, Artificial Sequence
  A synthetic oligonucleotide
aggcagcagaacttacgcattgagtttgaaaaaacattctacctct

SEQ ID NO: 77 - DNA, 22 bp, Artificial Sequence
  A synthetic oligonucleotide
ctagctgctactacagaaccac

SEQ ID NO: 78 - DNA, 20 bp, Artificial Sequence
  A synthetic oligonucleotide
catcaagcttcacaaggaaa

SEQ ID NO: 79 - DNA, 20 bp, Artificial Sequence
  A synthetic oligonucleotide
agctctaacaatgtacagct

SEQ ID NO: 80 - DNA, 19 bp, Artificial Sequence
  A synthetic oligonucleotide
agttgcagttcctgaaaca

SEQ ID NO: 81 - DNA, 40 bp, Artificial Sequence
  A synthetic oligonucleotide
gtcttatccgccgtaaagtccgccgttctgtcgaatggtc

SEQ ID NO: 82 - DNA, 41 bp, Artificial Sequence
  A synthetic oligonucleotide
ctaaagcggataacgccgatacccagggacattagcctgag

SEQ ID NO: 83 - DNA, 20 bp, Artificial Sequence
  A synthetic oligonucleotide
cccaacctggtcgacaactt

SEQ ID NO: 84 - DNA, 23 bp, Artificial Sequence
  A synthetic oligonucleotide
attacttataccgcgacggtgaa

SEQ ID NO: 85 - DNA, 19 bp, Artificial Sequence
  A synthetic oligonucleotide
gagatatcgacccctcttg

SEQ ID NO: 86 - DNA, 22 bp, Artificial Sequence
  A synthetic oligonucleotide
aatctgaaaaacggtagaaagt

SEQ ID NO: 87 - DNA, 42 bp, Artificial Sequence
  A synthetic oligonucleotide
tccacagcaaaataactgcccaacatatatctcaggggacca

SEQ ID NO: 88 - DNA, 40 bp, Artificial Sequence
  A synthetic oligonucleotide
gatgtctatcaggcgcgttttgccgtattaacgaacccgg

SEQ ID NO: 89 - DNA, 24 bp, Artificial Sequence
  A synthetic oligonucleotide
tgtggttaataacagacaccgatg

SEQ ID NO: 90 - DNA, 24 bp, Artificial Sequence
  A synthetic oligonucleotide
accatcttcgtctgattattgagc

SEQ ID NO: 91 - DNA, 18 bp, Artificial Sequence
  A synthetic oligonucleotide
tcgggcagattctagacc

SEQ ID NO: 92 - DNA, 18 bp, Artificial Sequence
  A synthetic oligonucleotide
gtgggcacttctcaaact

SEQ ID NO: 93 - DNA, 45 bp, Artificial Sequence
  A synthetic oligonucleotide
ttgagtacctcggtcaaagtacttcctgatgaaataaagcagtca

SEQ ID NO: 94 - DNA, 46 bp, Artificial Sequence
  A synthetic oligonucleotide
tcaacctttatgatcatgcaagaggggaaacatatccatcatcgtg

SEQ ID NO: 95 - DNA, 20 bp, Artificial Sequence
  A synthetic oligonucleotide
cctcttggcataagaccacc

SEQ ID NO: 96 - DNA, 22 bp, Artificial Sequence
  A synthetic oligonucleotide
aactcagacgggatttgttagg

SEQ ID NO: 97 - DNA, 20 bp, Artificial Sequence
  A synthetic oligonucleotide
cgagtggaaacggttgaaga

SEQ ID NO: 98 - DNA, 20 bp, Artificial Sequence
  A synthetic oligonucleotide
aggggaagtaagaccgctat

SEQ ID NO: 99 - DNA, 41 bp, Artificial Sequence
  A synthetic oligonucleotide
gcacactgcttgaytctgcgtacgaaagcgaagctgctcat

SEQ ID NO: 100 - DNA, 42 bp, Artificial Sequence
  A synthetic oligonucleotide
agccactgtagtgaacacaccgtcgattccccaagtttggag

SEQ ID NO: 101 - DNA, 23 bp, Artificial Sequence
  A synthetic oligonucleotide
acagattctggctgagagatgtc

SEQ ID NO: 102 - DNA, 20 bp, Artificial Sequence
  A synthetic oligonucleotide
cagccagccaatgttgtgac

SEQ ID NO: 103 - DNA, 17 bp, Artificial Sequence
  A synthetic oligonucleotide
gtcaagcaacctgatct

SEQ ID NO: 104 - DNA, 18 bp, Artificial Sequence
  A synthetic oligonucleotide
tgccgcaatcaaaatcct

SEQ ID NO: 105 - DNA, 45 bp, Artificial Sequence
  A synthetic oligonucleotide
ccatcatggaattgttgacaaatcctaatcctcaacgacagtctg

SEQ ID NO: 106 - DNA, 45 bp, Artificial Sequence
  A synthetic oligonucleotide
gccaggtcaaccaggaataaaacgcttcatataataaagcgacgt

SEQ ID NO: 107 - DNA, 19 bp, Artificial Sequence
  A synthetic oligonucleotide
gaggacaatggcccactca

SEQ ID NO: 108 - DNA, 21 bp, Artificial Sequence
  A synthetic oligonucleotide
cgttgacctttgccaatctga

SEQ ID NO: 109 - DNA, 21 bp, Artificial Sequence
  A synthetic oligonucleotide
tctttacgttgatgaactagc

SEQ ID NO: 110 - DNA, 23 bp, Artificial Sequence
  A synthetic oligonucleotide
aagttgaaagtattagggtctac

SEQ ID NO: 111 - DNA, 40 bp, Artificial Sequence
  A synthetic oligonucleotide
agagcaaacagattaggggtgccatcacgtgtgaagccaa

SEQ ID NO: 112 - DNA, 38 bp, Artificial Sequence
  A synthetic oligonucleotide
atagcggtggtgaagcgattgtaaataggcggcgcaat

SEQ ID NO: 113 - DNA, 25 bp, Artificial Sequence
  A synthetic oligonucleotide
tgtctattctttcttttgcccagac

SEQ ID NO: 114 - DNA, 20 bp, Artificial Sequence
  A synthetic oligonucleotide
cacggacatgcctttgttcc

(19) United States
(12) Patent Application Publication
(10) Pub. No.: US 2014/0211204 A1
(43) Pub. Date: Jul. 31, 2014

(54) HAND-HELD WIRELESS PLATFORM AND OPTICS FOR MEASUREMENT OF DNA, RNA, MICRORNAS, AND OTHER MARKERS OF PATHOGENS, GENETIC DISEASES, AND CANCER

(71) Applicant: BOARD OF TRUSTEES OF MICHIGAN STATE UNIVERSITY, EAST LANSING, MI (US)

(72) Inventors: ROBERT STEDTFELD, LANSING, MI (US); SYED HASHSHAM, OKEMOS, MI (US); JAMES TIEDJE, LANSING, MI (US); ERDOGAN GULARI, ANN ARBOR, MI (US); FARHAN AHMAD, SEATTLE, WA (US); GREGOIRE SEYRIG, PASADENA, CA (US); DIETER TOURLOUSSE, TOKYO (JP); MAGGIE KRONLEIN, LANSING, MI (US); YEN-CHENG TERRY LIU, EAST LANSING, MI (US)

(73) Assignee: BOARD OF TRUSTEES OF MICHIGAN STATE UNIVERSITY, EAST LANSING, MI (US)

(21) Appl. No.: 14/015,787

(22) Filed: Aug. 30, 2013

Related U.S. Application Data
(60) Provisional application No. 61/696,048, filed on Aug. 31, 2012.

(51) Int. Cl. G01N 21/01; G01N 21/64

(52) U.S. Cl. CPC G01N 21/01; G01N 21/6486
USPC 356/244; 250/458.1; 250/206

(57) ABSTRACT

The present invention provides compositions for making and methods of using a hand-held nucleic acid amplification device, comprising a disposable biochip with a series of sample wells, each sample well having a novel optical arrangement that includes a light-emitting diode (LED) and a single light capturing element (e.g. a photodiode) for quickly measuring light emissions from biological samples such as nucleic acid amplification reactions. Such a device can utilize isothermal amplification for obtaining detectable yields of amplified nucleic acid product in short time periods, for example, within seconds.

This patent application claims the benefit of priority, under 35 U.S.C. §119(e), to U.S. Provisional Patent Application Ser. No. 61/696,048, filed on Aug. 31, 2012, the contents of which application is specifically incorporated by reference herein in its entirety.

This invention was made with government support from the National Institutes of Health, grant numbers 5R01RR018625-03 and R01447RR018625-01, and the Environmental Protection Agency grants RD83162801-0 and RD83301001. The United States Government has certain rights in the invention.

### FIELD OF THE INVENTION

The present invention provides devices, compositions for making devices, and methods of using a hand-held fluorescence nucleic acid amplification device. The devices include a novel optical arrangement of light-emitting diode (LED) for use with a light energy collector, such as a single photodiode (PD), for quickly detecting and/or measuring fluorescence in biological samples. Specifically, methods of use include disposable chips and customized primers for multiple applications requiring nucleic acid amplification. Some embodiments include: (i) a disposable microfluidic chip with pre-dispensed and dehydrated primers, (ii) a compact and inexpensive fluorescence detector, and (iii) a wirelessly-connected smart device (iPod Touch or iPhone) for control, data collection, display, and analysis. In particular, a device of the present invention uses isothermal amplification for obtaining detectable yields of amplified nucleic acid product including an analysis in short time periods, i.e. within seconds or minutes.

### BACKGROUND OF THE INVENTION

It was estimated that in 2012 point of care (POC) testing would constitute roughly one third of the $59 billion in vitro diagnostics market. However, existing POC devices are focused on sample chemistry based diagnostics due to market size and ease of measurement (e.g., cholesterol, lipids, cardiac markers, drugs of abuse, and cancer markers). In general, chemistry based diagnostic results are obtained in hours, days or weeks. Furthermore, POC devices are typically large and difficult to transport from person to person.

Moreover, POC devices provide few test options for detecting pathogens, either as environmental pathogens, such in the hospital room, or as infectious agents within a patient, or in genetic testing of a patient.

Thus, there is a need for faster results from POC testing devices, in particular for pathogen detection and genetic testing.

### SUMMARY OF THE INVENTION

The present invention provides devices, compositions for inclusion in such devices, and methods of using a hand-held fluorescence nucleic acid amplification device, comprising a novel optical arrangement of light-emitting diode (LED) for use with a single light energy collector, such as a photodiode, for each reaction chamber that allow fast fluorescence detection of nucleic acids in biological samples. Disposable chips, each containing customized primers, are provided in the devices for multiple applications requiring nucleic acid amplification. Some embodiments include: (i) a disposable microfluidic chip with pre-dispensed and dehydrated primers, (ii) a compact, and inexpensive fluorescence detector, and (iii) a wirelessly-connected smart device (iPod Touch or iPhone) for control, data collection, display, and analysis. In particular, a device of the present invention is configured for isothermal amplification of nucleic acids and can provide detectable yields of amplified nucleic acid product in short time periods, i.e. within seconds.

In some embodiments, the invention provides a device, comprising: a) a plurality of sample wells, at least one of the wells containing a fluorescent molecule; b) a plurality of Light Emitting Diodes (LEDs) for emitting optical energy capable of activating the fluorescent molecule, wherein each of the LEDs has a vertical plane; c) a plurality of optical fibers wherein each optical fiber has first and second ends, the first end positioned for capturing emitted optical energy from the fluorescence molecule, the second end configured for emitting the captured optical energy, wherein the first end is at an angle of greater than 1° and less than 90° from the vertical plane of the LED; wherein each LED source is associated with one sample well and one the optical fiber in optical communication such that optical energy emitted by the LED illuminates the one sample well in a manner capable of causing the fluorescent molecules to emit optical energy captured by the first end of the optical fiber. In some embodiments, the angle is 30° to 60°; in some embodiments the angle is 45°. In some embodiments, the device further comprises one emission filter positioned for filtering optical energy emitted from the second end of the plurality of fiber optics. In some embodiments, the sample wells are contained within a biochip. In some embodiments, the device further comprises a biochip holder in contact with the sample wells wherein the holder has indented openings for guiding placement of the sample wells into the biochip holder. In some embodiments, the holder further comprises a heater capable of heating the sample wells in contact with the heater. In some embodiments, the sample wells comprise acrylic. In some embodiments, the biochip further comprises a channel having a sealable cap for enclosing the sample well and the channel. In some embodiments, the sealable cap is an airlock system for keeping reagents inside of the biochip during sample loading. In some embodiments, at least one of the sample wells contains an amplification nucleic acid molecule selected from the group consisting of a primer for nucleic acid amplification, a primer for microRNA nucleic acid amplification, an oligonucleotide probe, a DNA extension sequence, a template strand for hybridization and base stacking. In some embodiments, at least one of the sample wells further comprises a sample selected from the group consisting of a single cell, whole cells, genomic DNA, a cell that has undergone chemical lyses, a purified sample, an unpurified sample and any combination thereof.

In some embodiments, the invention provides a device, comprising a) a plurality of sample wells in a biochip, at least one of the wells containing a fluorescent molecule; b) a plurality of Light Emitting Diodes (LEDs) for emitting optical energy capable of activating the fluorescent molecule, wherein each of the LEDs has a vertical plane; c) a plurality of optical fibers wherein each optical fiber has first and second ends, the first end positioned for capturing emitted optical energy from the fluorescence molecule, the second end configured for emitting the captured optical energy, wherein the first end is at an angle of greater than 1° and less than 90° from the vertical plane of the LED; wherein each LED source is associated with one sample well and one of the optical fibers is in optical communication such that optical energy emitted by the LED illuminates one sample well in a manner capable of causing the fluorescent molecules to emit optical energy to be captured by the first end of the optical fiber, and b) a biochip holder in contact with the sample wells, wherein the holder comprises indented openings for guiding placement of the sample wells into the biochip holder. In some embodiments, the holder further comprises a heater capable of heating the sample wells in contact with the heater. In some embodiments, the device further comprises a user interface for operating the device and/or receiving captured optical energy. In some embodiments, the user interface is a wireless user interface module. In some embodiments, the device further comprises a microcontroller in electrical communication with the heater and the wireless user interface module. In some embodiments, the wireless user interface is selected from the group consisting of a touch screen computational phone, tablet, PDA, and a music player with wireless capabilities. In some embodiments, the device further comprises one light energy collector, such as a photodiode, for capturing and measuring optical energy emitted from each second end of the plurality of optical fibers. In some embodiments, the device further comprises an emission filter positioned for filtering optical energy emitted from each second end of the plurality of fiber optics before capture by the light energy collector.

In some embodiments, the invention provides a method for detecting fluorescence, comprising, a) providing, a device, comprising: i) a plurality of sample wells, at least one of the wells containing a fluorescent molecule; ii) a plurality of Light Emitting Diodes (LEDs) for emitting optical energy capable of activating the fluorescent molecule, wherein each of the LEDs has a vertical plane; iii) a plurality of optical fibers wherein each optical fiber has first and second ends, the first end positioned for capturing emitted optical energy from the fluorescence molecule, the second end configured for emitting the captured optical energy, wherein the first end is at a 45 degree angle in relation to the vertical plane of the LED; wherein each LED source is associated with one sample well and one the optical fiber, and b) illuminating one or more of the sample wells with the LEDs; c) capturing the optical fluorescence energy emitted by the fluorescent molecules with the optical fibers and thereby detecting fluorescence. In some embodiments, the device further comprises a user interface for operating the device and/or receiving captured optical fluorescence energy emitted by the fluorescent molecules. In some embodiments, at least one of the sample wells further comprises a sample selected from the group consisting of a single cell, whole cells, genomic DNA, a cell that has undergone chemical lyses, a purified sample and an unpurified sample. In some embodiments, at least one of the sample wells further comprises a sample selected from the group consisting of water, a bodily fluid, and a blood sample. In some embodiments, at least one sample well has a concentration of cells between one and 10⁶ L⁻¹ cells. In some embodiments, at least one of the sample wells further comprises an amplification nucleic acid selected from the group consisting of a primer for nucleic acid sequence amplification, a primer for microRNA nucleic acid sequence amplification, an oligonucleotide probe, a DNA extension sequence, a template DNA strand for hybridization, a base stacking sequence, and any combination thereof. In some embodiments, at least one of the sample wells further comprises a polymerase, including but not limited to a Bst polymerase enzyme. In some embodiments, at least one of the sample wells further comprises amplification reagents. In some embodiments, at least one of the sample wells further comprises free nucleic acids. In some embodiments, the method further comprises nucleic sequence amplification, wherein the amplification comprises the steps of starting an amplification reaction by hybridizing the amplification nucleic acid to a complementary target nucleic acid sequence within a target nucleic acid molecule such that the target nucleic acid molecule is duplicated and the fluorescence molecule associates with the duplicated target nucleic acid molecule. In some embodiments, the fluorescence is detected within 1 minute up to 20 minutes after the start of the amplification. In some embodiments, the target nucleic acid molecule with the complementary nucleic acid sequence is from a microorganism. In some embodiments, the detection of the duplicated target nucleic acid molecule identifies the presence of a target selected from the group consisting of a microorganism, a pathogen, a disease marker, and a cancer marker. In some embodiments, the duplicated target nucleic acid molecule is a microRNA sequence. In some embodiments, the method further comprises analyzing the detection of the fluorescence.

### DEFINITIONS

To facilitate an understanding of the present invention, a number of terms and phrases are defined below:

The use of the article “a” or “an” is intended to include one or more. As used in this application, the singular form “a,” “an,” and “the” include plural references unless the context clearly dictates otherwise. For example, the term “an agent” includes a plurality of agents, including mixtures thereof.

As used herein, “amplify” in reference to a nucleic acid sequence refers to increasing the number of copies of a nucleic acid sequence.

As used herein, “nucleic acid sequence” refers to a string of nucleotide bases attached by phosphodiester bonds, for example DNA has deoxynucleotides, i.e. combinations of adenine (A), guanine (G), cytosine (C), and thymine (T) molecules attached by covalent phosphodiester bonds, RNA, mRNA, and microRNA has ribonucleotide, i.e. combinations of adenine (A), guanine (G), cytosine (C), and uracil (U) nucleotide molecules attached by covalent phosphodiester bonds.

As used herein, “hand held” or “handheld” in reference to an electronic device refers to having the capability to be operated while being held in human hands, such that a hand held device is lightweight and/or small in size. Examples of “hand held” or “handheld” devices include a video camera, a laptop computer, a net-book, a tablet, a smart device, cell phone, a personal digital assistant (PDA), and the like.

As used herein, “optical system” or “optical set up” refers to components that when used together provide an optical pathway for movement of optical energy, for example, beginning with an LED that emits optical energy, an optical fiber for capturing and transmitting optical energy, and a light energy collector for detecting optical energy for further analysis.

As used herein, “optical pathway” refers to the movement of optical energy (or light energy) through an optical system, for example, a continuous light pathway where optical energy moves from one end of the pathway to another end. One example of an optical pathway includes optical energy emitted by an LED that activates a fluorescent molecule that in turn emits optical energy that is captured by one end of an optical fiber for transmission to the other end of the optical fiber where the optical energy optionally passes through an emission filter for detection by a photodiode. As another example, light energy emitted from an LED light source travels through a sample well area into a sample well and is absorbed by a fluorescent molecule, and the fluorescent molecule emits light energy which is captured by an optical fiber which in turns allows transmission of the light energy to a light energy collector, such as a photodiode (PD).

As used herein, “optical communication” refers to components with the capability of receiving or transmitting optical energy, or both.

As used herein, “battery power” in reference to a power supply for an electronic device refers to obtaining electrical energy from a battery in the form of DC.

As used herein, a “smart device” refers to an electronic device that can be cordless (unless while being charged), mobile (easily transportable) and capable of connecting to wireless receivers such as Wi-Fi, 3G, 4G, Bluetooth etc., including but not limited to devices such as a Blackberry, iPad, iPod Touch, iPod, iPhone, Droid, Android-based devices, etc. In some embodiments, a smart device functions as a processor.

As used herein, the term “wireless user interface module” refers to a device for wireless transmission of data from a genetic diagnostics device (i.e. hand held nucleic amplification device) to the wireless user interface module. In some embodiments, this module has a further capability for performing at least one of the following processes, real time data (results) reporting, or storage of data.

As used herein, the term “processor” refers to a device that performs a set of steps according to a program (e.g., a digital computer). Processors, for example, include Central Processing Units (“CPUs”), small CPUs such as microcontrollers, electronic devices, and systems for receiving, transmitting, storing and/or manipulating digital data under programmed control.

As used herein, the term “microfluidic biochip” or “chip” or “microfluidic chip” in reference to a component comprising a “sample well” or “reagent well” or “biological sample well” refers to a detecting analysis tool having a compact area and high distribution density. According to the type, structure, and a use of a biochip, it can provide various detecting analysis modes based on a molecular biological principles. Thus, there is a considerable potential and value for using the biochip in technological fields of medical therapy or pathogen detection. Furthermore, different biochips may provide different related biological molecules (such as gene fragments, nucleic acids, proteins, organic compounds, or cell tissues) as detection probes which can be precisely placed within, or flowed into the biochips by micro-fluidic, micro-array, or micro-electromechanical processes. Biochips can include a substrate selected from various materials such as glass, silicon, polycarbonate (PC), or poly(methyl methacrylate) (i.e. PMMA), paper, and combinations thereof. The biochip can be used in various applications, and has a compact structure which only needs only small sample volumes and which uses small amounts of reagent for simultaneously and speedily executing a large number of processes. Generally, the sample carries a detected object or a target molecule such as a nucleic acid or protein. After the sample is reacted with reagents and any target molecules are linked to the detection label within the biochip, the detection probes can associate (e.g., bind) to a suitable tag reagent, such as a fluorescent tag, a chemiluminescent tag, or a colorimetric tag. The complex formed by association of a target molecule and a detection label provide a (light) signal indicating that the target molecule is present in the sample. The strength or amount of signal also indicates the quantity of target molecule present in the sample.

As used herein, the term “target” in reference to an amplified nucleic acid sequence refers to the source or original nucleic acid in a sample, such that when an amplified nucleic acid sequence is detected by the devices and methods described herein the target is found in the sample. For example, a particular microorganism can have a target nucleic acid, which when detected by the devices and methods described herein signifies that the microorganism is present in the sample. As another example, the target can be a cancer marker, amplification of a nucleic acid encoding the cancer marker, identifies that the cancer marker is present in the sample.

As used herein, a “polymeric disposable chip” or “polymeric disposable biochip” refers to a biochip made of a polymer and intended for use one time in a device of the present inventions.

As used herein, “airlock” or “air-lock” or “airlock system” refers to a biochip comprising microfluidic channels having a means for holding selected materials (i.e. reagents, primers, fluorescent molecules, etc.) within a reaction well and of permitting sample to be loaded into the reaction well without movement of the selected materials (e.g., primers etc.) into other channels or other reaction wells of the biochip.

As used herein, “chip holder” or “biochip holder” refers to a component of a device of the present inventions capable of holding an inversely matching biochip for use in the present inventions, for example, see FIG. 1. In one embodiment, a biochip holder has at least one sample well area capable of holding a sample well of the biochip for use in the present inventions. In one embodiment, the biochip holder and biochip bottom are both substantially flat as both have a planar surface with indentations that inversely match each other.

As used herein, “digital amplification” or “digital isothermal amplification” refers to the use of dozens to hundreds of reaction wells for a given target, which allows for precise quantification of the target gene based on the number of wells that display presence/absence amplification.

As used herein, “electrical communication” in reference to electrical components refers to a wire attaching two or more components.

As used herein, “wireless communication” or “wireless network” in reference to a device refers to the capability of a device to transmit information, such as the results obtaining from using a device of the present inventions, without the use of a physical wire.

As used herein, “chamber” or “well” in reference to a sample, such as a biological sample chamber or sample well, refers to an area capable of holding a biological sample (and reagents such as primers) in a distinct area of a biochip. The chamber or well fits into a portion of the holder.

As used herein, “light source” in reference to an illuminating (illumination) light source refers to an excitation light source for exciting electrons in a fluorescent molecule.

As used herein, “detecting” in reference to light emitted by a fluorescent compound refers to sensing an optical signal emitted from the fluorescent compound.

As used herein, “light-emitting diode” or “LED” refers to a semiconductor device that when electrically stimulated emits a form of electroluminescence as optical energy. In other words emits an incoherent narrow-spectrum light. For the purposes of the present inventions, a center line or vertical plane of an LED light is shown in FIG. 6C for use in reference for attaching the fiber optic to the bottom of the sample well holder of a device of the present inventions.

As used herein, “turned on sequentially” in reference to an LED refers to electrically stimulating, i.e. turning on a plurality of LEDs in a device of the presence inventions one after the other throughout the device, in other words, the LEDs are not turned on at the same time.

As used herein, “organic light-emitting diode” or “OLED” refers to a light-emitting diode (LED) in which the emissive layer comprises a thin-film of organic compounds for emitting optical energy or “light”.

As used herein, a “microRNA” or “miRNA” refers to a ribonucleic acid (RNA) molecule, for one example, approximately 22 nucleotides in length. In one embodiment, miRNA sequences bind to complementary sequences in the 3′ UTR of target mRNAs, usually resulting in silencing of the target mRNA, so that the target mRNA is not translated.

As used herein, a “fluorescent molecule” or “fluorophore” or “fluorophores molecule” or “fluorescent dye” in general refers to a molecule capable of excitation, i.e. activation, under conditions for emitting an optical energy emission, i.e. signal, for example, synthetic dyes, orange fluorescent dyes (stain) having exemplary optimal excitation wavelengths (i.e. spectra) in the 530 nm to 570 nm range and exemplary emission wavelengths in the 545-583 nm range, such as orange SYTO® 81, SYTO®-82, and cyanine dyes, asymmetrical cyanine dyes, green fluorescent dyes (stain), such as SYBR® dyes, i.e., SYBR Green I and II, and green SYTO® dyes, etc. For the purposes of the present inventions, a fluorescent molecule is capable of binding to a nucleic acid sequence. In some embodiments, the biological sample comprises a fluorescent compound, wherein the fluorescent compound is selected from the group consisting of SYBR™ Brilliant Green, SYBR™ Green I, SYBR™ Green II, SYBR™ gold, SYBR™ safe, EvaGreen™, a green fluorescent protein (GFP), fluorescein, ethidium bromide (EtBr), thiazole orange (TO), oxazole yellow (YO), thiarole orange (TOTO), oxazole yellow homodimer (YOYO), oxazole yellow homodimer (YOYO-1), SYPRO® Ruby, SYPRO® Orange, Coomassie Fluor™ Orange stains, and derivatives thereof. These dyes are generally available commercially, and many of them can be made as described by Deligeorgiev et al., Recent Pat. Mat. Sci. 2: 1-26 (2006).

As used herein, an “optically activated fluorescent molecule” “optically activated fluorescent molecule” refers to a fluorescent molecule illuminated (i.e. excitation) under conditions for releasing energy as emitted light (i.e. emission) measured spectrally as wavelengths i.e. spectral profiles. In other words, light comprising wavelengths capable of exciting a fluorescent molecule, i.e. excitation light, causing the molecule to release emission energy capable of detection, i.e. captured, using a device of the present inventions.

As used herein, “optical signal” refers to any energy (e.g., photo-detectable energy) emitted from a sample (e.g., produced from a microarray that has one or more optically excited [i.e., by electromagnetic radiation] molecules bound to its surface).

As used herein, “vertical plane” in reference to a LED refers to a vertical line parallel to the direction of the LED see, FIG. 6C.

As used herein, “horizontal plane” in reference to a microfluidic chip refers to the longitudinal plane of a chip parallel to the long opening of a sample well, see, FIG. 6C for example.

As used herein, “optical fiber” or “fiber optic” refers to both the medium, i.e. glass tube or plastic wire, and the technology associated with the transmission of light as optical energy as information along the fiber. A fiber optic has two ends, one end used for capturing optical energy for transmission to the other end upon which the optical energy leaves the fiber.

As used herein, “filter” refers to a device or coating, such as an emission filter, that preferentially allows light of characteristic spectra to pass through it (e.g., the selective transmission of light beams). “Polychromatic” and “broadband” as used herein, refer to a plurality of electromagnetic wavelengths (i.e. optical energy) emitted from a light source or sample whereas monochromatic refers to a single wavelength or a narrow range of wavelengths.

As used herein, “microarray” refers to a substrate with a plurality of molecules (e.g., nucleotides) bound to its surface. Microarrays, for example, are described generally in Schena (2000) Microarray Biochip Technology, Eaton Publishing, and Natick, Mass.; which is incorporated herein by reference in its entirety. Additionally, the term “patterned microarrays” refers to microarray substrates with a plurality of molecules non-randomly bound to its surface.

As used herein, the term “probe” refers to a molecule (e.g., an oligonucleotide, whether occurring naturally as in a purified restriction digest or produced synthetically, recombinantly or by PCR amplification), that is capable of hybridizing to another molecule of interest (e.g., another oligonucleotide). When probes are oligonucleotides they may be single-stranded or double-stranded. Probes are useful in the detection, identification and isolation of particular targets (e.g., gene sequences). In some embodiments, it is contemplated that probes used in the present invention are labeled with any “reporter molecule,” so that is detectable in any detection system, including, but not limited to enzyme (e.g., ELISA, as well as enzyme-based histochemical assays), fluorescent, radioactive, and luminescent systems. It is not intended that the present invention be limited to any particular label. With respect to microarrays, the term probe is used to refer to any hybridizable material that is affixed to the microarray or provided with a chip for the purpose of detecting a “target” sequences in the analyte.

As used herein “probe element” and “probe site” refer to a plurality of probe molecules (e.g., identical probe molecules) affixed to a microarray substrate. Probe elements containing different characteristic molecules are typically arranged in a two-dimensional array, for example, by microfluidic spotting techniques or by patterned photolithographic synthesis, et cetera.

As used herein, “DNA signature” refers to a nucleotide sequence that can be used as a specific signature for a target pathogen, disease, or marker.

As used herein, “conventional QPCR” and “QPCR” refer to “quantitative PCR,” that for the purposes of the present invention is a real-time PCR analysis, such as real-time PCR reactions that are performed by a Taqman® thermal cycling device and reaction assays by Applied Biosystems.

As used herein, “conventional PCR” and “PCR” refer to a nonquantitative PCR reaction, such as those reactions that take place in a stand-alone PCR machine without a real-time fluorescent readout.

As used herein, “isothermal amplification” refers to an amplification step that proceeds at one temperature and does not require a thermocycling apparatus.

As used herein, “Transcription-mediated amplification” and “TMA” refer to an isothermal nucleic acid amplification system for isothermal amplification of RNA using RNA polymerase.

As used herein, “Strand Displacement Assay” and “SDA” refer to an isothermal nucleic acid amplification system where cDNA product is synthesized from an RNA target.

As used herein, “Q-beta replicase” refers to an isothermal nucleic acid amplification system that uses the enzyme Q-beta replicase to replicate an RNA probe.

As used herein, “NASBA” refers to an isothermal nucleic acid amplification procedure comprising target-specific primers and probes, and the coordinated activity of THREE enzymes: AMV reverse transcriptase, RNase H and T7 RNA polymerase, for example, NASBA allows direct detection of viral RNA by nucleic acid amplification.

As used herein, the term “primer” refers to an oligonucleotide, whether occurring naturally as in a purified restriction digest or produced synthetically, which is capable of acting as a point of initiation of synthesis when placed under conditions in which synthesis of a primer extension product which is complementary to a nucleic acid strand is induced, (i.e., in the presence of nucleotides and an inducing agent such as DNA polymerase and at a suitable temperature and pH). The primer is preferably single stranded for maximum efficiency in amplification, but may alternatively be double stranded. If double stranded, the primer is first treated to separate its strands before being used to prepare extension products. Preferably, the primer is an oligodeoxyribonucleotide. The primer must be sufficiently long to prime the synthesis of extension products in the presence of the inducing agent. The exact lengths of the primers will depend on many factors, including temperature, source of primer and the use of the method.

As used herein, “integrated heater” refers to a small electronic heater comprising semiconductor material.

As used herein, “Charge-Coupled Device” and “CCD” refers to an electronic memory that records the intensity of light as a variable charge.

As used herein, “storage CCDs” refers to either a separate array (frame transfer) or individual photosites (interline transfer) coupled to each imaging photosite.

As used herein, the term “photodiode” or “PD” refers to a solid-state light detector type including, but not limited to PN, PIN, APD and CCD.

As used herein, the terms “memory device,” and “computer memory” refer to any data storage device that is readable by a computer, including, but not limited to, random access memory, hard disks, magnetic (e.g., floppy) disks, zip disks, compact discs, DVDs, magnetic tape, and the like.

As used herein, “peripheral” refers to a device, such as a computer device, for example, a CD-ROM drive or wireless communication chip that is not part of the essential computer, i.e., the memory and microprocessor. Peripheral devices can be external, such as a mouse, keyboard, printer, monitor, external Zip drive or scanner or internal, such as a CD-ROM drive, CD-R drive or internal modem. Internal peripheral devices may be referred to as “integrated peripherals.”

As used herein, the terms “optical detector” and “photo-detector” refers to a device that generates an output signal when exposed to optical energy. Thus, in its broadest sense, the term “optical detector system” refers devices for converting energy from one form to another for the purpose of measurement of a physical quantity and/or for information transfer. Optical detectors include but are not limited to photomultipliers and photodiodes, as well as fluorescence detectors.

As used herein, “semiconductor” refers to a material that is neither a good conductor of electricity (such as copper) nor a good insulator (such as rubber) used in providing miniaturized components for taking up less space, faster and requiring less energy than larger components. Examples of common semiconductor materials are silicon and germanium and the like.

As used herein, the term “TTL” stands for Transistor-Transistor Logic, a family of digital logic chips that comprise gates, flip/flops, counters etc. The family uses zero Volt and five Volt signals to represent logical “0” and “1” respectively.

As used herein, “battery” refers to a device that stores chemical energy and makes it available in an electrical form. Batteries comprise electrochemical devices such as one or more galvanic cells, fuel cells or flow cell, examples include, lead acid, nickel cadmium, nickel metal hydride, lithium ion, lithium polymer, CMOS battery and the like.

As used herein, “CMOS battery” refers to a battery that maintains the time, date, hard disk and other configuration settings in the CMOS memory.

As used herein, “electronic power supply” refers to an electronic device that produces a particular DC voltage or current from a source of electricity such as a battery or wall outlet whereas using a wall outlet requires a “power supply” for converting AC into DC.

As used herein, “power supply” or “power adaptor” refers to an electrical system that converts AC current from the wall outlet into the DC currents required by computer and electronic device circuitry.

As used herein, “AC current” and “Alternating Current” and “AC” refers to a type of electrical current, the direction of which is reversed at regular intervals or cycles. In the United States, the standard is 120 reversals or 60 cycles per second.

As used herein, “DC current” and “Direct Current” and “DC” refers to a type of electricity transmission and distribution by which electricity flows in one direction through the conductor, usually relatively low voltage and high current. For typical 120 volt or 220-volt devices, DC must be converted to alternating current.

As used herein, “power adapter,” “transformer,” or “power supply” refer to an external power supply for laptop computers or portable or semi-portable electronic device.

As used herein, “AC adapter” refers to a rectifier to convert AC current to DC and a transformer to convert voltage from 120V down, for example, 15V or 12V or 9V.

As used herein, “external AC adaptor power brick” refers to an electronic device that produces AC current.

As used herein, “AC powered linear power supply” refers to a transformer to convert the voltage from the wall outlet to a lower voltage. An array of diodes called a diode bridge then rectifies the AC voltage to DC voltage. A low-pass filter reduces (smoothens) the voltage ripple that is left after the rectification. Finally a linear regulator converts the voltage to the desired output voltage, along with other possible features such as current limiting.

As used herein, the term “dynamic range” refers to the range of input energy over which a detector and data acquisition system is useful. This range encompasses the lowest level signal that is distinguishable from noise to the highest level that can be detected without distortion or saturation.

As used herein, the term “noise” in its broadest sense refers to any undesired disturbances (i.e., any signal not directly resulting from the intended detected event) within the frequency band of interest. One example of noise is the summation of unwanted or disturbing energy introduced into a system from man-made and natural sources. In another example, noise may distort a signal such that the information carried by the signal becomes degraded or less reliable.

As used herein, the term “signal-to-noise ratio” (SNR) refers the ability to resolve true signal from the noise of a system. One example of computing a signal-to-noise ratio is by taking the ratio of levels of the desired signal to the level of noise present with the signal. In preferred embodiments of the present invention, phenomena affecting signal-to-noise ratio include, but are not limited to, detector noise, system noise, and background artifacts.

As used herein, the term “detector noise” refers to undesired disturbances (i.e., signal not directly resulting from the intended detected energy) that originate within the detector. Detector noise includes dark current noise and shot noise (caused by the random arrival of photons). Dark current noise in an optical detector system results from the various thermal emissions from the photodetector. Shot noise in an optical system is the product of the fundamental particle nature (i.e., Poisson-distributed energy fluctuations) of incident photons as they pass through the photodetector.

As used herein, the term “system noise” refers to undesired disturbances that originate within the system. System noise includes, but is not limited to noise contributions from signal amplifiers, electromagnetic noise that is inadvertently coupled into the signal path, and fluctuations in the power applied to certain components (e.g., a light source).

As used herein, the term “background” or “background artifacts” include signal components caused by undesired optical emissions from the microarray. These artifacts arise from a number of sources, including: non-specific hybridization, intrinsic fluorescence of the substrate and/or reagents, incompletely attenuated fluorescent excitation light, and stray ambient light. In some embodiments, the noise of an optical detector system is determined by measuring the noise of the background region and noise of the signal from the microarray feature.

As used herein, “inverter” or “rectifier” refers to a device that converts direct current electricity to alternating current either for stand-alone systems or to supply power to an electricity grid.

As used herein, “volt” and “V” refer to a unit of electrical force equal to that amount of electromotive force that will cause a steady current of one ampere to flow through a resistance of one ohm.

As used herein, “voltage” refers to an amount of electromotive force, measured in volts, that exists between two points.

As used herein, “Ohm” refers to a measure of the electrical resistance of a material equal to the resistance of a circuit in which the potential difference of 1 volt produces a current of 1 ampere.

As used herein, “ampere” and “amp” refers to a unit of electrical current or rate of flow of electrons, such that one volt across one ohm of resistance causes a current flow of one ampere.

As used herein, “watt” or “W” refer to a measure of power, i.e., Volts multiplied by Amps=Watts. Watt may also refer to a rate of energy transfer equivalent to one ampere under an electrical pressure of one volt, for examples, one watt equals 1/746 horsepower, or one joule per second, i.e., voltage×current=amperage.

As used herein, the term “reference DNA” refers to DNA that is obtained from a known organism (i.e., a reference strain). In some embodiments of the invention, the reference DNA comprises random genome fragments. In particularly preferred embodiments, the genome fragments are of approximately 1 to 2 kb in size. Thus, in preferred embodiments, the reference DNA of the present invention comprises mixtures of genomes from multiple reference strains.

As used herein, the terms “test DNA” and “sample DNA” refer to the DNA to be analyzed using the method of the present invention. In preferred embodiments, this test DNA is tested in the competitive hybridization methods of the present invention, in which reference DNA(s) from multiple reference strains is/are used.

As used herein, the term “target,” when used in reference to hybridization assays, refers to the molecules (e.g., nucleic acid) to be detected. Thus, the “target” is sought to be sorted out from other molecules (e.g., nucleic acid sequences) or is to be identified as being present in a sample through its specific interaction (e.g., hybridization) with another agent (e.g., a probe oligonucleotide). A “segment” is defined as a region of nucleic acid within the target sequence.

The terms “sample” and “specimen” in the present specification and claims are used in their broadest sense. On the one hand, they are meant to include a specimen or culture. On the other hand, they are meant to include both a biological sample and an environmental sample. These terms encompasses all types of samples obtained from humans and other animals, including but not limited to, body fluids such as urine, blood, fecal matter, cerebrospinal fluid (CSF), semen, and saliva, as well as solid tissue. These terms also refers to swabs and other sampling devices that are commonly used to obtain samples for culture of microorganisms. Biological samples may be animal, including human, fluid or tissue, food products and ingredients such as dairy items, vegetables, meat and meat by-products, and waste. Environmental samples include environmental material such as water, (for example, fresh water, salt water, tap water, and the like), surface matter, soil, and industrial samples, as well as samples obtained from food and dairy processing instruments, apparatus, equipment, disposable, and non-disposable items. These examples are not to be construed as limiting the sample types applicable to the present invention.

As used herein, the term “oligonucleotides” or “oligos” refers to short sequences of nucleotides.

As used herein, the term “polymerase chain reaction” or “PCR” refers to the methods described in U.S. Pat. Nos. 4,683,195, 4,683,202, and 4,965,188, hereby incorporated by reference, that describe a method for increasing the concentration of a segment of a target sequence in a mixture of genomic DNA without cloning or purification. This process for amplifying the target sequence consists of introducing a large excess of two oligonucleotide primers to the DNA mixture containing the desired target sequence, followed by a precise sequence of thermal cycling in the presence of a DNA polymerase. The two primers are complementary to their respective strands of the double stranded target sequence. To effect amplification, the mixture is denatured and the primers then annealed to their complementary sequences within the target molecule. Following annealing, the primers are extended with a polymerase so as to form a new pair of complementary strands. The steps of denaturation, primer annealing, and polymerase extension can be repeated many times (i.e., denaturation, annealing and extension constitute one “cycle”; there can be numerous “cycles”) to obtain a high concentration of an amplified segment of the desired target sequence. The length of the amplified segment of the desired target sequence is determined by the relative positions of the primers with respect to each other, and therefore, this length is a controllable parameter. By virtue of the repeating aspect of the process, the method is referred to as the “polymerase chain reaction” (hereinafter “PCR”). Because the desired amplified segments of the target sequence become the predominant sequences (in terms of concentration) in the mixture, they are said to be “PCR amplified.” In addition to genomic DNA, any oligonucleotide or polynucleotide sequence can be amplified with the appropriate set of primer molecules. In particular, the amplified segments created by the PCR process itself are, themselves, efficient templates for subsequent PCR amplifications. With PCR, it is possible to amplify a single copy of a specific target sequence in genomic DNA to a level detectable by the device and systems of the present invention.

As used herein, the terms “PCR product,” “PCR fragment,” and “amplification product” refer to the resultant mixture of compounds from at least two or more cycles of the PCR steps of denaturation, annealing and extension are complete. These terms encompass the case where there has been amplification of one or more segments of one or more target sequences.

As used herein, the terms “thermal cycler” or “thermal cycler” refer to a programmable thermal cycling machine, such as a device for performing PCR.

As used herein, the term “amplification reagents” refers to those reagents (such as, DNA polymerase, deoxyribonucleotide triphosphates, buffer, etc.), necessary for nucleic acid sequence amplification.

As used herein, the terms “reverse-transcriptase” and “RT-PCR” refer to a type of PCR where the starting material is mRNA. The starting mRNA is enzymatically converted to complementary DNA or “cDNA” using a reverse transcriptase enzyme. The cDNA is then used as a “template” for a “PCR” reaction.

As used herein, the terms qI-Mir assay” refers to quantitative isothermal microRNA assay. More specifically it refers to the isothermal approach presented in this application. See for example, FIGS. 12, 15.

As used herein, the terms “restriction endonucleases” and “restriction enzymes” refer to bacterial enzymes, each of which cut double-stranded DNA at or near a specific nucleotide sequence.

As used herein, the term “recombinant DNA molecule” as used herein refers to a DNA molecule that is comprised of segments of DNA joined together by means of molecular biological techniques.

The term “isolated” when used in relation to a nucleic acid, as in “an isolated oligonucleotide” or “isolated polynucleotide” refers to a nucleic acid sequence that is identified and separated from at least one contaminant nucleic acid with which it is ordinarily associated in its natural state or source. An isolated nucleic acid is present in a form or setting that is different from that in which it is found in nature. In contrast, non-isolated nucleic acids are nucleic acids such as DNA and RNA found in the state they exist in nature. For example, a given DNA sequence (e.g., a gene) is found on the host cell genome in proximity to neighboring genes; RNA sequences, such as a specific mRNA sequence encoding a specific protein, are found in the cell as a mixture with numerous other mRNAs that encode a multitude of proteins. The isolated nucleic acid, oligonucleotide, or polynucleotide may be present in single-stranded or double-stranded form. When an isolated nucleic acid, oligonucleotide or polynucleotide is to be utilized to express a protein, the oligonucleotide or polynucleotide will contain at a minimum the sense or coding strand (i.e., the oligonucleotide or polynucleotide may single-stranded), but may contain both the sense and anti-sense strands (i.e., the oligonucleotide or polynucleotide may be double-stranded).

As used herein the term “coding region” when used in reference to a structural gene refers to the nucleotide sequences that encode the amino acids found in the nascent polypeptide as a result of translation of a mRNA molecule. The coding region is bounded, in eukaryotes, on the 5′ side by the nucleotide triplet “ATG” that encodes the initiator methionine and on the 3′ side by one of the three triplets that specify stop codons (i.e., TAA, TAG, and TGA).

As used herein, the terms “purified” and “to purify” refer to the removal of contaminants from a sample, for example, a sample is purified after removal of at least 50% of contaminants, at least 75% of contaminants, at least 95% of contaminants. In some embodiments a purified sample is a concentrated sample, such that the number or concentration of cells or organisms is increased per unit volume (e.g. per ml) after purification.

As used herein the term “portion” when in reference to a nucleotide sequence or nucleic acid (as in “a portion of a given nucleotide sequence” or a “portion of a nucleic acid”) refers to fragments of that sequence or that nucleic acid. The fragments may range in size from four nucleotides to the entire nucleotide sequence or nucleic acid minus one nucleotide.

The terms “recombinant protein” and “recombinant polypeptide” as used herein refer to a protein molecule that are expressed from a recombinant DNA molecule.

As used herein the term “biologically active polypeptide” refers to any polypeptide that maintains a desired biological activity.

As used herein the term “portion” when in reference to a protein (as in “a portion of a given protein”) refers to fragments of that protein. The fragments may range in size from four amino acid residues to the entire protein minus one amino acid.

As used herein, the terms “microbe” and “microbial” refer to microorganisms. In particularly preferred embodiments, the microbes identified using the present invention include bacteria (i.e., eubacteria and archaea), fungi, and the like. However, it is not intended that the present invention be limited to bacteria, as other microorganisms are also encompassed within this definition, including fungi, viruses, and parasites (e.g., protozoans and helminthes).

The term “gene” refers to a nucleic acid (e.g., DNA) sequence that comprises coding sequences necessary for the production of a polypeptide or precursor. It is intended that the term encompass polypeptides encoded by a full length coding sequence, as well as any portion of the coding sequence, so long as the desired activity and/or functional properties (e.g., enzymatic activity, ligand binding, etc.) of the full-length or fragmented polypeptide are retained. The term also encompasses the coding region of a structural gene and the sequences located adjacent to the coding region on both the 5′ and 3′ ends for a distance of about 1 kb on either end such that the gene corresponds to the length of the full-length mRNA. The sequences that are located 5′ of the coding region and which are present on the mRNA are referred to as “5′ untranslated sequences.” The sequences that are located 3′ (i.e., “downstream”) of the coding region and that are present on the mRNA are referred to as “3′ untranslated sequences.” The term “gene” encompasses both cDNA and genomic forms of a gene. A genomic form of a genetic clone contains the coding region interrupted with non-coding sequences termed “introns” or “intervening regions” or “intervening sequences.” A subset of gene is “virulence and marker” genes or VMGs that refers to genes associated with virulence or used as markers for any specific reason. Introns are segments of a gene that are transcribed into nuclear RNA (hnRNA); introns may contain regulatory elements such as enhancers. Introns are removed or “spliced out” from the nuclear or primary transcript; introns therefore are absent in the messenger RNA (mRNA) transcript. The mRNA functions during translation to specify the sequence or order of amino acids in a nascent polypeptide.

Where “amino acid sequence” is recited herein to refer to an amino acid sequence of a naturally occurring protein molecule, “amino acid sequence” and like terms, such as “polypeptide” and “protein” is not meant to limit the amino acid sequence to the complete, native amino acid sequence associated with the recited protein molecule.

In addition to containing introns, genomic forms of a gene may also include sequences located on both the 5′ and 3′ end of the sequences that are present on the RNA transcript. These sequences are referred to as “flanking” sequences or regions (these flanking sequences are located 5′ or 3′ to the non-translated sequences present on the mRNA transcript). The 5′ flanking region may contain regulatory sequences such as promoters and enhancers that control or influence the transcription of the gene. The 3′ flanking region may contain sequences that direct the termination of transcription, post-transcriptional cleavage and polyadenylation.

As used herein, the terms “nucleic acid molecule encoding,” “DNA sequence encoding,” and “DNA encoding” refer to the order or sequence of deoxyribonucleotides along a strand of deoxyribonucleic acid. The order of these deoxyribonucleotides determines the order of amino acids along the polypeptide (protein) chain. The DNA sequence thus codes for the amino acid sequence.

DNA molecules are said to have “5′ ends” and “3′ ends” because mononucleotides are reacted to make oligonucleotides or polynucleotides in a manner such that the 5′ phosphate of one mononucleotide pentose ring is attached to the 3′ oxygen of its neighbor in one direction via a phosphodiester linkage. Therefore, an end of an oligonucleotide or polynucleotide, referred to as the “5′ end” if its 5′ phosphate is not linked to the 3′ oxygen of a mononucleotide pentose ring and as the “3′ end” if its 3′ oxygen is not linked to a 5′ phosphate of a subsequent mononucleotide pentose ring. As used herein, a nucleic acid sequence, even if internal to a larger oligonucleotide or polynucleotide, also may be said to have 5′ and 3′ ends. In either a linear or circular DNA molecule, discrete elements are referred to as being “upstream” or 5′ of the “downstream” or 3′ elements. This terminology reflects the fact that transcription proceeds in a 5′ to 3′ fashion along the DNA strand. The promoter and enhancer elements that direct transcription of a linked gene are generally located 5′ or upstream of the coding region. However, enhancer elements can exert their effect even when located 3′ of the promoter element and the coding region. Transcription termination and polyadenylation signals are located 3′ or downstream of the coding region.

As used herein, the terms “an oligonucleotide having a nucleotide sequence encoding a gene” and “polynucleotide having a nucleotide sequence encoding a gene,” means a nucleic acid sequence comprising the coding region of a gene or, in other words, the nucleic acid sequence that encodes a gene product. The coding region may be present in a cDNA, genomic DNA, or RNA form. When present in a DNA form, the oligonucleotide or polynucleotide may be single-stranded (i.e., the sense strand) or double-stranded. Suitable control elements such as enhancers/promoters, splice junctions, polyadenylation signals, and combinations thereof can be placed in close proximity to the coding region of the gene if needed to permit proper initiation of transcription and/or correct processing of the primary RNA transcript.

As used herein, the term “regulatory element” refers to a genetic element that controls some aspect of the expression of nucleic acid sequences. For example, a promoter is a regulatory element that facilitates the initiation of transcription of an operably linked coding region. Other regulatory elements include splicing signals, polyadenylation signals, termination signals, etc.

As used herein, the terms “complementary” and “complementarity” are used in reference to polynucleotides (i.e., a sequence of nucleotides) related by the base-pairing rules. For example, for the sequence “A-G-T,” is complementary to the sequence “T-C-A.” Complementarity may be “partial,” in which some of the nucleic acids' bases are matched according to the base pairing rules. Or, there may be “complete” or “total” complementarity between the nucleic acids. The degree of complementarity between nucleic acid strands has significant effects on the efficiency and strength of hybridization between nucleic acid strands. This is of particular importance in amplification and hybridization reactions, as well as detection methods that depend upon binding between nucleic acids.

Equivalent conditions may be employed to comprise low stringency conditions; factors such as the length and nature (DNA, RNA, base composition) of the probe and nature of the target (DNA, RNA, base composition, present in solution or immobilized, etc.) and the concentration of the salts and other components (e.g., the presence or absence of formamide, dextran sulfate, polyethylene glycol) are considered and the hybridization solution may be varied to generate conditions of low stringency hybridization different from, but equivalent to, the above listed conditions. In addition, the art knows conditions that promote hybridization under conditions of high stringency (e.g., increasing the temperature of the hybridization and/or wash steps, the use of formamide in the hybridization solution, etc.).

When used in reference to a double-stranded nucleic acid sequence such as a cDNA or genomic clone, the term “substantially homologous” refers to any probe that can hybridize to either or both strands of the double-stranded nucleic acid sequence under conditions of low stringency as described above.

A gene may produce multiple RNA species that are generated by differential splicing of the primary RNA transcript. cDNAs that are splice variants of the same gene will contain regions of sequence identity or complete homology (representing the presence of the same exon or portion of the same exon on both cDNAs) and regions of complete non-identity (for example, representing the presence of exon “A” on cDNA 1 wherein cDNA 2 contains exon “B” instead). Because the two cDNAs contain regions of sequence identity they will both hybridize to a probe derived from the entire gene or portions of the gene containing sequences found on both cDNAs; the two splice variants are therefore substantially homologous to such a probe and to each other.

When used in reference to a single-stranded nucleic acid sequence, the term “substantially homologous” refers to any probe that can hybridize (i.e., it is the complement of) the single-stranded nucleic acid sequence under conditions of low stringency as described above.

As used herein, the term “hybridization” is used in reference to the pairing of complementary nucleic acids. Hybridization and the strength of hybridization (i.e., the strength of the association between the nucleic acids) is impacted by such factors as the degree of complementary between the nucleic acids, stringency of the conditions involved, the Tₘ of the formed hybrid, and the G:C ratio within the nucleic acids.

As used herein, the term “Tₘ” is used in reference to the “melting temperature.” The melting temperature is the temperature at which a population of double-stranded nucleic acid molecules becomes half dissociated into single strands. The equation for calculating the Tₘ of nucleic acids is well known in the art. As indicated by standard references, a simple estimate of the Tₘ value may be calculated by the equation: Tₘ=81.5+0.41(% G+C), when a nucleic acid is in aqueous solution at 1M NaCl (See e.g., Anderson and Young, Quantitative Filter Hybridization, in Nucleic Acid Hybridization [1985]). Other references include more sophisticated computations that take structural as well as sequence characteristics into account for the calculation of Tₘ.

As used herein the term “stringency” is used in reference to the conditions of temperature, ionic strength, and the presence of other compounds such as organic solvents, under which nucleic acid hybridizations are conducted. Those skilled in the art will recognize that “stringency” conditions may be altered by varying the parameters just described either individually or in concert. With “high stringency” conditions, nucleic acid base pairing will occur restricted between nucleic acid fragments that have a high frequency of complementary base sequences (e.g., hybridization under “high stringency” conditions may occur between homologs with about 85-100% identity, preferably about 70-100% identity). With medium stringency conditions, nucleic acid base pairing will occur between nucleic acids with an intermediate frequency of complementary base sequences (e.g., hybridization under “medium stringency” conditions may occur between homologs with about 50-70% identity). Thus, conditions of “weak” or “low” stringency are often required with nucleic acids that are derived from organisms that are genetically diverse, as the frequency of complementary sequences is usually less.

As used herein, “amplification” in reference to a method of use of a device of the present inventions refers to amplifying a template or target nucleic acid sequence comprising the steps of hybridizing an amplification nucleic acid, such as a primer, to its complementary target sequence or sample nucleic acid sequence, also termed template nucleic acid sequence, in the presence of amplification reagents, free nucleic acids, and a polymerase, for example a BST polymerase for loop-mediated isothermal amplification, which results in the duplication of said complementary nucleic acid sequence then repeating these steps until amplification is detected or stopped. Amplification may be detected by a device of the present inventions as fluorescent molecules become incorporated into the amplifying sequence or amplified sequence. Amplification may have a start time or point and an end time or point. Examples of amplification are shown in FIG. 12 or 15.

“Amplification” is a special case of nucleic acid replication involving template specificity. It is to be contrasted with non-specific template replication (i.e., replication that is template-dependent but not dependent on a specific template). Template specificity is here distinguished from fidelity of replication (i.e., synthesis of the proper polynucleotide sequence) and nucleotide (ribonucleotide or deoxyribonucleotide) specificity. Template specificity is frequently described in terms of “target” specificity. Target sequences are “targets” in the sense that they are sought to be sorted out from other nucleic acid. Amplification techniques have been designed primarily for this sorting out.

Template specificity is achieved in most amplification techniques by the choice of enzyme. Amplification enzymes are enzymes that, under conditions they are used, will process specific sequences of nucleic acid in a heterogeneous mixture of nucleic acid. Finally, Taq and Pfu polymerases, by virtue of their ability to function at high temperature, are found to display high specificity for the sequences bounded and thus defined by the primers; the high temperature results in thermodynamic conditions that favor primer hybridization with the target sequences and not hybridization with non-target sequences.

As used herein, the term “amplifiable nucleic acid” is used in reference to nucleic acids that may be amplified by any amplification method. It is contemplated that “amplifiable nucleic acid” will usually comprise “sample template.”

As used herein, the term “sample template” refers to nucleic acid originating from a sample that is analyzed for the presence of “target.” In contrast, “background template” is used in reference to nucleic acid other than sample template that may or may not be present in a sample. Background template is most often inadvertent. It may be the result of carryover, or it may be due to the presence of nucleic acid contaminants sought to be purified away from the sample. For example, nucleic acids from organisms other than those to be detected may be present as background in a test sample.

As used herein, “thin layer” refers to a very thin deposition of a colloidal substance (such as a layer of phosphor, dielectric, silver, etc.) onto an ITO coated glass plate.

As used herein, “electroluminescence” or “EL” refers to a direct conversion of electrical energy into light by a luminescent material such as a light emitting phosphor.

As used herein, “capacitor” refers to an electrical device that can store energy in the electric field between a pair of conductors or ‘plates,’ such as electrodes.

As used herein, “layer” in reference to a compound, refers to a deposition of the compound by methods such as sputter deposition, an electron beam evaporation deposition, and a physical vapor deposition.

As used herein, “dielectric” refers to a substance, such as a solid, liquid, or gas, that is highly resistant to electric current n electric field polarizes the molecules of the dielectric, producing concentrations of charge on its surfaces that create an electric field opposed (for example, antiparallel) to that of the capacitor. Thus, a given amount of charge produces a weaker field between the plates than it would without the dielectric, which reduces the electric potential.

As used herein, “dielectric layer” refers to an insulating layer, for example, a layer that serves to even out the electric field across the phosphor layer and prevent a short circuit.

As used herein, “filter” refers to a device or coating that preferentially allows light of characteristic spectra to pass through it (e.g., the selective transmission of light beams).

As used herein, “light” refers to electromagnetic radiation with a wavelength that is visible to the human eye (such as, visible light) or, in a technical or scientific context, electromagnetic radiation of any wavelength. As used herein, light comprises three basic dimensions of intensity, frequency and polarization.

As used herein, “pound” or “lb” or “avoirdupois pound” refers to a unit of mass (or weight) equal to 16 ounces or 16 avoirdupois ounces that is equal to approximately 453.59 grams.

As used herein, the term “transducer device” refers to a device that is capable of converting a non-electrical phenomenon into electrical information, and transmitting the information to a device that interprets the electrical signal. Such devices can include, but are not limited to, devices that use photometry, fluorimetry, and chemiluminescence; fiber optics and direct optical sensing (e.g., grating coupler); surface plasmon resonance; potentiometric and amperometric electrodes; field effect transistors; piezoelectric sensing; and surface acoustic wave.

As used herein, the term “optical transparency” refers to the property of matter whereby the matter is capable of transmitting light such that the light can be observed by visual light detectors (e.g., eyes and detection equipment).

As used herein, the term “film” refers to any substance capable of coating at least a portion of a substrate surface and immobilizing capture particles. Examples of materials used to make such films include, but are not limited to, agarose, acrylamide, SEPHADEX, proteins (e.g., bovine serum albumin (BSA), polylysine, collagen, etc.), hydrogels (e.g., polyethylene oxide, polyvinyl alcohol, polyhydroxyl butylate, etc.), film forming latexes (e.g., methyl and ethyl aerylates, vinylidine chloride, and copolymers thereof), or mixtures thereof. In certain embodiments, films include additional material such as plasticizers (e.g., polyethylene glycol [PEG], detergents, etc.) to improve stability and/or performance of the film. In preferred embodiments, a film is a material that will react with the capture particles and present them in the same focal plane. In other preferred embodiments, a film is pre-activated with cross-linking groups such as aldehydes, or groups added after the film has been formed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A and 1B show exemplary embodiments of a combined heating unit and chip holder. FIG. 1A-1 shows exemplary CAD views of a close up of a reaction well. FIG. 1A-2 shows exemplary CAD views illustrating examples of dimensions for the heater base. FIG. 1A-3 shows channels and wells in the heater base at a diagonal view illustrating channels and well openings indented into the heater base for guiding exact placement of a chip into the heater. FIG. 1A-4 shows a transparent side view of a reaction well with an exemplary guide for insertion and attachment of an optical fiber into the heater base. FIG. 1A-5 and 1A-6 show side views and dimensions of an exemplary heater base. FIG. 1B shows exemplary CAD views of sample well holders. FIG. 1B-1 shows an example of a top side of a holder. FIG. 1B-2 shows an example of a bottom side of a holder. FIG. 1B-3 shows a close up view from the top of an indentation for sample well with hole in the bottom for receiving light from an LED, and a guide at an angle for an optical fiber. FIG. 1B-4 shows a close up side view of the angle of a guide for an optical fiber and a fitting for a LED relative to the sample well of the microchip holder. The line for determining the angle of the optical fiber guide and/or for attachment of the optical fiber is also shown.

FIG. 2A-2G shows an exemplary chip holder with an embedded strip heater, LEDs and optical fibers. The inset shows an exemplary positioning of LEDs and optical fibers in relation to wells. FIG. 2A shows a cross-sectional view of the chip holder with integrated LEDs and optical fibers. FIG. 2B shows a block diagram of a Gene-Z™. FIG. 2C shows an exemplary positioning of LEDs and optical fibers in relation to wells. FIG. 2D is a photograph showing an actual exemplary assembly of a circuit board comprising LEDs, chip holder with an embedded strip heater, optical fibers, photodiode fixture, heater leads, thermocouple and the wires attaching these components. FIG. 2E shows an on-off switch for a device described herein. FIG. 2F shows a GeneZ™ kit, illustrating that GeneZ™ can be wirelessly connected to a control computer system, such as an iPad or Droid tablet. FIG. 2G shows a carousel of biochips.

FIG. 3 shows exemplary embodiments of a LED power circuit board.

FIG. 4 shows exemplary embodiments of a component circuit board.

FIG. 5 shows exemplary embodiments of a push-button power circuit board.

FIG. 6A-6C show exemplary embodiments of microfluidic biochips. FIG. 6A is a photograph of an empty chip with four parallel arrays of sample well units. The inset at the lower left is a close-up of the shell-structured microchannels and reaction wells. FIG. 6B is an exemplary schematic of the structure and working principle of a microfluidic chip (three reaction channels are shown as examples for clarity). FIG. 6C-1 to 6C-3 show exemplary locations of the vertical plane of LED and horizontal plane of microfluidic chip for an exemplary 30°-60° (e.g., 45°) angle of attachment (placement) of an optical fiber guide or an optical energy capturing end of optical fiber.

FIG. 7A-7B show exemplary assembly of a device described herein. FIG. 7A illustrates components that can be present in the device in the orientation that they can be positioned within the device. FIG. 7B shows exemplary embodiments of substantially assembled devices.

FIG. 8A-F show exemplary screen shots of iTouch views. FIG. 8G shows an embodiment of a screen shot of an onboard view in relation to the types of pathogens detected using a device described herein.

FIG. 9A-9C illustrates features of an exemplary Gene-Z™ device. FIG. 9A shows a photograph of a Gene-Z™ device with the iPod docked on the recharge port and a disposable biochip sitting on the chip insertion door. FIG. 9B shows a fluorescence image of a single 15-well array after amplification to demonstrate lack of fluidic cross-talk between reaction wells. For this experiment, primers for the eaeA gene of E. coli were dehydrated within 12 wells, 1.7×10⁵ copies of E. coli were added to alternating wells (wells marked with ‘+’ contain primers and target DNA; the symbol ‘*’ indicates wells without dehydrated DNA and primers). FIG. 9C shows ten ΔRn values for the wells shown in FIG. 9B as measured at the end of a 60 minute reaction using the Gene-Z™ device, revealing effective optical isolation of the reaction wells, where the ΔRn is the magnitude of the signal generated by the given set of nucleic acid amplification conditions.

FIG. 10A-10D show exemplary results obtained with a Gene-Z™ device, including an evaluation of inter- and intra-chip reproducibility. Three separate chips were prepared with primers for the stx2 gene of E. coli and dehydrated for use in each reaction. For the experiment, samples contained Loop mediated isothermal amplification (LAMP) reagents supplemented with 1.7×10⁵ genome copies per well, and the assays were monitored in real-time in a Gene-Z™. FIG. 10A shows amplification plots for reaction wells in a single representative chip. FIG. 10B graphically illustrates the mean (bar height), standard deviation, and coefficient of variation (in parenthesis) of the Tt for reaction wells in each of the four arrays in three separate chips. Data obtained as controls using tube-based LAMP reactions with a commercial real-time PCR instrument, and the same amount of DNA in 25 microliter reactions, are also shown (white, non-filled bars). FIG. 10C graphically illustrates amplification plots obtained using a Gene-Z™ for a 10-fold serially diluted E. coli DNA sample using an eaeA gene primer set. FIG. 10D illustrates standard curves obtained using a Gene-Z™ (filled symbols) and a commercial real-time PCR instrument using tubes (empty symbols). Data represent the mean and standard deviation of three determinations for the commercial real-time PCR instrument and 3 to 15 determinations for a Gene-Z™.

FIG. 11A-11D show exemplary results for parallel detection of multiple pathogens and virulence marker genes (VMGs) using a device described herein. FIG. 11A shows a fluorescent image of the two arrays of the Gene-Z™ device chip after 60 min of amplification. The layout of primers dehydrated in the chip during assembly, and composition of the samples added in each array is indicated. Samples consisted of 3.1×10⁴ and 2.0×10⁴ copies per reaction well of S. aureus and E. coli, respectively. FIG. 11B shows real-time amplification plots for wells in the two arrays loaded with S. aureus samples and either mecA primers (heavy dashed lines) or vicK primers (lighter dotted lines). FIG. 11C shows real-time amplification plots for wells in the two arrays loaded with E. coli samples and either sstx2 primers (dark lines) or eaeA primers (light lines). FIG. 11D shows real-time amplification plots for wells in the two arrays loaded with both S. aureus and E. coli DNA, and mecA primers (heavy dashed lines), vicK primers (lighter dotted lines), sstx2 primers (dark lines) or eaeA primers (light lines). Amplification was not detected in the control well without template.

FIG. 12 shows an exemplary schematic illustrating qI-miR assay process for microRNAs that can be performed in any of the devices described herein. The developed protocol includes ligation of DNA extension sequence to the microRNA to achieve the assays requirement for longer sequence length.

FIG. 13A-13D illustrates use of an exemplary chip and process. FIG. 13A shows a picture of the chip after 60 min reaction time to demonstrate primer specificity and typical signals obtained (within dotted rectangles). FIG. 13B graphically illustrates the signal to noise ratio (SNR) measured with a device described herein after assays using targeted and non-targeted primers for various microRNAs with a 60 min reaction time. FIG. 13C graphically illustrates the time to threshold (Tt) detection for a dilution series of different microRNAs. FIG. 13D illustrates that a dynamic range of 10⁹-100 copies per reaction was observed with the miR-141 target. The starting number of copies per reaction (x-axis) versus the number of estimated copies (y-axis) is shown. The average slope and intercept from FIG. 13C was used to calculate estimated copies. A threshold of more than 3,000 to 4,000 copies (indicating prostate cancer) is highlighted.

FIG. 14A-14B shows exemplary time to threshold (Tt) plots. FIG. 14A shows an exemplary time to threshold (Tt) plot for different microRNAs that were mixed in 10 fold ratios prior to a ligation step, and then a qI-Mir assay was run on a Gene-Z™. FIG. 14B shows dilution series of miR-100 with qI-Mir assay run both on Gene-Z™ and real time amplification instrument. Results from the use of a Gene-Z™ device exhibited a dynamic range of 10²-10⁹ copies amplified in 15-50 min. Dynamic range on the BioRad was observed to be 10³-10⁹ copies.

FIG. 15 shows an exemplary method of amplifying microRNAs in one step. In this procedure, two template strands that have a short complementary sequence at their ends (approximately 10-15 bp) are added to the reaction. The short sequence is not long enough to allow hybridization at high Loop mediated isothermal amplification (LAMP) temperatures, however, in the presence of the microRNAs (which is complementary to a portion of template strand 1), the microRNAs stabilizes the strands to thus create a double stranded template. The LAMP primers are specific to the new template as a whole and do not amplify the strands if the microRNAs does not create it. Because each template is specific to the microRNAs of interest, the entire procedure is one-step from either total RNA or plasma/serum samples and results can be obtained in approximately one hour.

FIG. 16A-16F shows exemplary RT_{f}-LAMP curves of 10⁵ DNA copies of 6 waterborne pathogens (2 virulent genes for each) on the microchips with 5 seconds of CCD exposure time (filled circles and squares) and commercial real-time PCR instrument (Chromo4™) (open circles and squares). Error bars represent the standard deviation of the mean from triplicates. FIG. 16A shows exemplary RT_{f}-LAMP curves of 10⁵ DNA copies S. enterica. FIG. 16B shows exemplary RT-LAMP curves of 10⁵ DNA copies C. parvum. FIG. 16C shows exemplary RT-LAMP curves of 10⁵ DNA copies C. jejuni. FIG. 16D shows exemplary RT_{f}-LAMP curves of 10⁵ DNA copies L. pneumophila. FIG. 16E shows exemplary RT_{f}-LAMP curves of 10⁵ DNA copies E. coli. FIG. 16F shows exemplary RT_{f}-LAMP curves of 10⁵ DNA copies V. cholerae.

FIG. 17A-17D shows exemplary amplification curves for a 10-fold serially diluted DNA sample of Shigella (ipaH gene assay, FIG. 17A) and C. jejuni (cdtA gene assay, FIG. 17C). The standard curves (FIG. 17B and FIG. 17D) were calculated based on the average Tₜ (black circles) from at least two replicates (empty circles represent data included for calculation of the average Tₜ while data shown as empty diamonds were omitted from analysis).

FIG. 18 shows an exemplary schematic of the experimental setup consisting of a LED/CCD-based imaging system and temperature-controlled chip holder with transparent closing lid. The angle of light emitted by the LED relative to the light received by the imaging lens can be about 30° to 60° (here about 45°).

FIG. 19A-19D show exemplary chip embodiments. FIG. 19A shows two photographs of a 64 well chip with a screw cap having low melt temperature wax for easy sealing. The chip has an air-lock design for equal distribution of sample into each reaction chamber (sample well), where the air-lock design allows the reaction chambers (sample wells) to be filled with sample but prevents movement of primers into the channels of into other wells (see FIG. 45). The material used in the fabrication of microfluidic chips was PMMA sheets (Poly(methyl methacrylate)) (McMaster, Chicago, Ill., USA) with the thickness of 1.6 mm. A commercially available desktop CO₂ laser system (Full Spectrum Laser LLC, Las Vegas, Nev., USA) was used in the micromachining of the channels and reaction wells. Screw caps (filled with low melting temperature wax) were used to seal the chip during the reaction. FIG. 19B shows fluorescent amplification signals in alternate wells of a biochip in which primer was dispensed but not in wells without primer, demonstrating the utility of the air locks for loading sample without primer carryover between reaction wells. FIG. 19C shows another embodiment where low temperature wax is placed in reaction wells with primer to eliminate primer carryover in a chip. FIG. 19D illustrates fluorescent amplification signals in alternate wells in which primer was dispensed but not in wells without primer, demonstrating the utility of the low temperature wax for preventing primer carryover during sample introduction.

FIG. 20A-20C shows exemplary airlock systems that can be present in the biochips described herein. FIG. 20A shows close-up picture of a 64 well laser cut biochip with the air-lock design where reaction wells have been filled with sample (lighter parts of the channels and the reaction wells) illustrating equal distribution of sample into each well. The arrow identifies one of the air locks. The material used in the fabrication of microfluidic chips were PMMA sheets (Poly(methyl methacrylate)) (McMaster, Chicago, Ill., USA) with the thickness of 1.6 mm. A commercially available desktop CO₂ laser system (Full Spectrum Laser LLC, Las Vegas, Nev., USA) was used in the micromachining FIG. 20B shows a close-up of several units in a biochip being filled with a dark liquid, illustrating that the sample wells fill with dark liquid but the airlocks do not. The airlock prevents materials within a sample well (e.g., primers) from migrating out of the sample well. FIG. 20C shows an image of a biochip partially filled with dark liquid.

FIG. 21A-21C show an exemplary process for detection and evaluation of vcrA and 16S rRNA expression in different numbers of cells. FIG. 21A shows exemplary processes with different numbers of cells are processed slightly differently (e.g., no filtering if numerous cells are available, filtering if about 10⁶ to 10⁷ cells are available or filtering with additional enrichment if fewer than 10⁶ cells are available) in a schematic diagram for sample preparation that is dependent on the desired detection limit. Also shown is a picture of battery powered Gene-Z™ device of the present invention with an iPod Touch user interface, microfluidic chip. The iPod is sitting on the recharge dock. FIG. 21B illustrates the relationship between original cell concentration (cells L⁻¹) versus time to threshold (Tt) for varying dilutions of DHC cells tested for direct amplification with primers targeting the vcrA gene on a Gene-Z™ device. Tested samples included Range 1: not filtered (squares), Range 2: 100 mL concentrated with Sterivex filters (triangles), and Range 3: 4 L concentrated with Sterivex filters (circles). The inset shows Tt between a Gene-Z™ and Chromo4™ device for Range 2 concentrations. FIG. 21C illustrates the relationship between original cell concentration (cells L⁻¹) versus time to threshold (Tt) for varying dilutions of DHC cells tested for amplification with primers targeting 16S rRNA gene with the Chromo4™ real time PCR detection system from BioRad. Concentrations lower than 10⁷ cells L⁻¹ did not reliably show amplification on either device, and a concentration higher than 10⁹ cells L⁻¹ was not tested for 16S rRNA gene on Gene-Z™ device. Data represents average time to threshold for 3 or more wells and error bars represent standard deviation.

FIG. 22A-22B show exemplary time to threshold (Tt) plots for amplification of DNA from Pseudoperonospora cubensis fungal spores, with loop-mediated isothermal amplification. Pseudoperonospora cubensis is responsible for down mildew in cucumber plants and its detection in the field would expedite appropriate treatment and handling of a crop. FIG. 22A shows exemplary time to threshold (Tt) plots for amplification of a series of genomic DNA (diamonds) and spores (circles) dilution samples, illustrating that the results for spores are similar to those for isolated genomic DNA. FIG. 22B illustrates direct amplification of spores from infected cucumber leafs.

FIG. 23 shows exemplary amplification of DNA from Desulfovibrio vulgaris at various cell dilutions. The primer set targeted the Hildenborough strain of Desulfovibrio vulgaris. Three reactions were performed per dilution. The dilutions tested included 2,500,000, 250,000, 25,000, 2,500, 250, 25, 2.5 copies per reaction, (and a negative control). These results demonstrate use of a device described herein with isothermal amplification for genetic detection of organisms related to corrosion and souring in oil filed applications.

FIG. 24A-24C shows testing of components to optimize an optical setup system. FIG. 24A illustrates the time required for accurate measurement of each reaction in a 64 reaction microfluidic chip is >0.1 seconds. FIG. 24B graphically illustrates that positive amplification is identified when using either a $0.60 (50 mA) LED for excitation (Black) or a $20 (1000 mA) LED (gray). FIG. 24C shows that use of extremely bright dyes in the sample wells allows use of lower power LEDs and PDs for measurement of amplified DNA.

FIG. 25A-25C illustrate the effects of SYTO-81 concentration on loop mediated isothermal amplification monitoring in a Gene-Z™ device. FIG. 25A shows amplification plots (ARN versus time) at four SYTO-81 concentrations. FIG. 25B shows the resulting velocity plots (ASlope versus time) at four SYTO-81 concentrations. FIG. 25C shows the resulting plot of threshold (Tt) values as a function of dye concentration. Tt was calculated as the first point of the velocity curve that goes above an arbitrary threshold value of 0.001. A polyester microfluidic chip with 0.5 microliter 64 wells was used for this experiment and the target was 10 ng of M. tuberculosis genomic DNA.

FIG. 26A-26D shows exemplary amplification plots of M. tuberculosis with a device described herein where different fluorescent dyes are employed for detection of amplified products. M. tuberculosis genomic DNA (0.1 ng) was amplified in a Gene-Z™ device using SYBR green I (FIG. 26A) and SYTO-81 (FIG. 26B). Resulting velocity plots (slope of 6 points) for SYBR green I (FIG. 26C) and SYTO-81 (FIG. 26D). A polyester microfluidic chip with 64 wells, each having a 2 microliter reaction volume was used for this experiment.

FIG. 27A-27B shows exemplary LAMP amplification profiles illustrating discrimination of mutated and wild type primers for the katG gene by Taq mutS. In the presence of Taq mutS (FIG. 27B) the wild type DNA triggers amplification. In the absence of Taq mutS (FIG. 27A), both targets result in amplifications, but the mutant amplification time is about 10 min longer than for the wild type.

FIG. 28 shows exemplary real-time amplification results illustrating the effect of storage time on freeze-dried (filled shapes) and non-freeze-dried (empty shapes) reagents after storage at room temperature. Real-time amplification mixes for various spiked target (C. jejuni) copy numbers contained the following: 10 copies (circles), 100 copies (triangles) and 1,000 copies (squares). ECN: estimated copy number. The data shown are mean values for six replicate reactions (experiment was conducted twice with triplicates).

FIG. 29A-29G illustrates the effect of orange fluorescent dyes on the Tt of real-time LAMP. Reactions were performed with 0.1 to 20 μM of SYTO-80 (FIG. 29A), SYTO-81 (FIG. 29B), SYTO-82 (FIG. 29C), SYTO-83 (FIG. 29D), SYTO-84 (FIG. 29E) or SYTO-85 (FIG. 29F) or SYTOX orange (FIG. 29G). When amplification was not observed, the 0 point was not included. Target: 0.1 ng of M. tuberculosis genomic DNA. The error bars represent the standard error from triplicate reactions.

FIG. 30A-30D shows exemplary effect of green fluorescent dyes on the Tt of real-time LAMP. Reactions were performed with 0.01 to 5.0× of SYBR Green I (FIG. 30A), PicoGreen (FIG. 30B), EvaGreen (FIG. 30C), or Calcein (FIG. 30D). When amplification was not observed, the 0 point was not included. Target: 0.1 ng of M. tuberculosis genomic DNA. The error bars represent the standard error from triplicate reactions.

FIG. 31A-31B provide an exemplary comparison of fluorescence intensity (FIG. 31A) and SNR amplification profile (FIG. 31B) of calcein, PicoGreen, SYBR Green I, SYTO-81 and SYTO-82. Target: 0.1 ng of M. tuberculosis genomic DNA.

FIG. 32A-32D illustrate the effects of pre-hybridization of the primers with the target DNA on the sensitivity and Tt of real-time LAMP. FIG. 32A shows a threshold time (Tt) plot for increasing concentrations of M. tuberculosis. FIG. 32B shows a threshold time (Tt) plot for increasing concentrations of G. intestinalis.

FIG. 32C shows a threshold time (Tt) plot for increasing concentrations of S. aureus. FIG. 32D shows a threshold time (Tt) plot for increasing concentrations of S. thyphimurium. Close circles: pre-hybridization; open circles: no pre-hybridization.

FIG. 33 shows log copy number versus threshold time (Tt) plots quantitatively comparing detection of real-time lamp amplification using SYTO-82 and other fluorescent dyes (from literature). Numbers in bracket correspond to different publication reference numbers. Lines (A) to (D) are real-time LAMP assay results using SYTO-82 (2 μM), and targeting G. intestinalis, M. tuberculosis, S. aureus, and S. enterica respectively (current study).

FIG. 34A-34E shows an exemplary comparison of fluorescence intensity (ΔF; FIGS. 34A and 34C) and signal to noise (SNR; FIGS. 34B and 34D) amplification profiles of SYTO-80, SYTO-81, SYTO-82, SYTO-83, SYTO-84, SYTO-85 and SYTOX Orange (FIGS. 34A and 34B), and calcein, EvaGreen, SYBR Green I, and PicoGreen (FIGS. 34C and 34B). Dyes were used at their optimum concentration. Target: 0.1 ng of M. tuberculosis genomic DNA. FIG. 34E illustrates the absorbance versus time for development of color for a non-DNA species (in this case soluble phosphate species in water). This illustrates that the versatility of the device Gene-Z as a spectrophotometer.

FIG. 35A-35B shows exemplary assay results for detection of the E. coli (gadA gene) and the E. faecalis (gel E gene). FIG. 35A shows an end point microLAMP assay of the E. coli (gadA gene) in a most probable number (MPN)-based dilution series. Cell number per well is shown to the left and number of positive reactions is shown to the right of the image. FIG. 35B shows an endpoint microLAMP assay for E. faecalis (gel E gene) in a most probable number-based dilution series. Cell number per well (left) and number of positive reaction (right) were shown in the image. When such amplification of DNA for a specific primer is carried out by polymerase chain reaction in large number of wells, it is referred to as digital PCR. Hence, the above could be considered as digital LAMP.

FIG. 36 illustrates one embodiment of a device described herein (e.g., a Gene-Z™ device), which has a custom solar panel of approximately 180 mm×158 mm solar panels.

FIG. 37 is a photograph of an iDx device for isothermal amplification with either eight 1-μL wells within self-digitizing microfluidic chips or with eight separate 200-μl PCR vials. The iDX device is a smaller version of the Gene-Z™ device.

FIG. 38 is a photograph of an iDx illustrating the cellphone attachment.

FIG. 39 illustrates a heater component of an iDX device that can accommodate an 8-well chip or 8 PCR tubes.

FIG. 40 illustrates an ARM microcontroller and drivers of an iDx device.

FIG. 41 illustrates an iDX printed circuit boards (PCB). The difference between the printed circuit boards of the iDx-photodiode and the iDx-charge-coupled device is the addition of a circuit for detecting with the photodiode (PD) on the LED board and use of surface mount LEDS of the same brightness.

FIG. 42 is a photograph of an iDx-CCD prototype that uses the camera of a tablet or cellphone to detect signals from the reaction wells during nucleic acid amplification instead of a photodiode.

FIG. 43 illustrates use of the iDx with the camera of the cellphone for time lapse imaging of an amplification reaction, instead of a photodiode.

FIG. 44A-44D illustrates features of an optical setup integrated with a rotating carousal that serves to allow multiple chips to be loaded/unloaded/run/imaged as desired. FIG. 44A shows a Gene-Z HT device that uses the same principles described for Gene-Z but that allows up to 100 samples to be run in parallel. FIG. 44B shows a rotating carousal that allows multiple chips to be loaded/unloaded/run/imaged as needed. The carousal is integrated with an optic holder (L2-OH-S35, LED Supply), collimating lens (L2-OP-025, LED Supply), and a glass diffuser (e.g., ED1-050, Thorlabs, Newton, N.J.) to achieve widely distributed homogenous light, a bandpass filter for excitation and emission, and a 16 bit, 0.25 megapixel monochrome CCD camera (MEADE DSI Pro, Irvine, Calif.) equipped with a 16 mm relay lens (15774, Deal Extreme). FIG. 44C illustrates control features of the device. FIG. 44D illustrates device parameters can be selected.

FIG. 45A-45F illustrates features of an airlock microfluidic chip. FIG. 45A shows liquid (darker areas) beginning to flow into the microfluidic chip. FIG. 45B shows liquid beginning to flow into reaction well (wider area of the channel surrounded by dots) of the microfluidic chip. FIG. 45C shows that liquid has filled the reaction well (wider area of the channel surrounded by dots) of the microfluidic chip. FIG. 45D shows that when by the time the reaction well is full, the liquid flow from the other side reaches the junction at the top and stops the flow of liquid from the well from reaching the same junction. FIG. 45E illustrates some of the structural parts of the airlock chip, focusing on one well and its associated channels. The air segment slows or stops flow from the left side of the reaction well so that the blocked flow proceeds to the right and out of the sample outflow channel. FIG. 45F shows a picture of an airlock microfluidic chip, illustrating that the reaction wells fill with a dark liquid but the air segments (clear areas) do not and the phenomenon is also stable at higher well number and densities.

FIG. 46A-46B shows two different configurations of an eight well airlock chip, which can have a cap to seal in inlet port.

FIG. 47A-47B illustrates LAMP reactions in an airlock chip. LAMP reactions were performed with amplicons from the toxR gene of V. cholerea in all samples plus templates of genomic DNA from C. jejuni (column 2), Salmonella (column 3), and V. cholera (column 4) added to each of the four sample columns. FIG. 47A illustrates where the primers were located within the airlock chip reaction wells. FIG. 47B shows a CCD image of the chip after the 60 min LAMP reaction. The signal to noise ratio (SNR) results for columns i, iii, and iv versus reaction time as monitored with the Gene-Z device are shown in the plots below.

FIG. 48A-48C illustrates the simpler processes that can be used with the devices described herein. FIG. 48A is a schematic diagram of a typical traditional procedure for nucleic acid amplification, which can take from 1-5 days. FIG. 48B is a schematic diagram of a process that can be used with the devices described herein, where DNA extraction is not needed, and the process can be performed in 30 minutes to 1 hour. FIG. 48C illustrates some of the steps that can be performed for direct quantitative amplification of sample nucleic acids.

FIG. 49A-49C illustrates that a variety of the sample types, including veligers, eggs, and juveniles, can be tested in the devices described herein. FIG. 49A shows that nucleic acids from Cyanobacterial cells (Lyngbya wollei) in lake water can amplified. FIG. 49B shows that zebra mussel (Dreissena polymorphs) and quagga mussel can be detected in concentrated lake samples. FIG. 49C shows that plant pathogen fungal spores (Pseudoperonospora cubensis), Ascaris eggs present in 50-fold diluted sludge, as well as gut microbiota in 5-fold diluted fecal matter, and bacterial cells in 4000-fold concentrated groundwater can be detected using the devices and methods described herein.

FIG. 50 is a schematic diagram illustrating an integrated system or network for lake water monitoring using iDx devices, where the results of such monitoring can form a database that can be periodically updated for early detection of problematic organisms, contaminating species, and infectious microbes.

### GENERAL DESCRIPTION OF THE INVENTION

The present invention provides devices, compositions for making such devices, and methods of using such devices. The devices are hand-held nucleic acid amplification devices, that include a novel optical arrangement of one or more light-emitting diodes (LEDs), each coupled to a light capturing element (e.g., a single photodiode) for quickly measuring light signals from amplification assays of nucleic acids in biological samples. Specifically, the devices include disposable chips and customized primers for multiple applications requiring nucleic acid amplification. Some embodiments include: (i) a disposable microfluidic chip with pre-dispensed and dehydrated primers, (ii) a compact, and inexpensive light (e.g., fluorescence) detector, and (iii) a wirelessly-connected smart device (e.g., iPod Touch or smart phone) for control, data collection, display, and analysis. A device of the present invention can use isothermal amplification for obtaining detectable yields of amplified nucleic acid product including an analysis in short time periods, i.e. within seconds.

The hand-held fluorescence gene amplification device can include multiple light-emitting diodes (LEDs), optical fibers, photodiodes, a CCD camera (or CCD) and combinations thereof for measuring light signals from nucleic acid amplification assays of biological samples; and microfluidic chips as assay containers. In some embodiments, the nucleic acid amplification device includes one or more light-emitting diodes (LEDs) as illumination sources, each operably coupled to a single photodiode capable multiply detecting light signals from an amplification assay to track the progress of an amplification reaction. The amplification reactions each occur within a reaction well of a molded, carved, or laser-cut thin plastic microfluidic chip, that can have multiple reaction wells and multiple microchannels. The device software is controlled by tablet or smart devices, such as iPod Touch, iPhone and Google Android Tablets, or other wireless interface modules such as a touch screen computational phone, PDA, and a music player with wireless capabilities. The overall system provides an economical, battery powered and hand-held device for detecting light emitted from reporter molecules incorporated into amplified DNA, RNA, microRNA and other nucleic acid molecules. In some embodiments, this detection and analysis occurs faster than bench top PCR machines. Thus, the devices and methods described herein operate in real time. Nucleic acids amplification may be accomplished using one of many isothermal nucleic acid amplification processes (methods), including loop mediated isothermal amplification (LAMP). The real-time hand-held nucleic acid amplification device of the present invention can be used for detecting amplification light signals from microRNAs, DNA of pathogenic and beneficial microorganisms, bacterial cells, fungal spores, in as little as 10 minutes. In some embodiments, nucleic acids were detected from a single cell. In some embodiments, nucleic acids were directly detect from disrupted cell samples. In some embodiments, nucleic acids were directly detected from cell samples that had not been pretreated or lysed prior to sample introduction into the device. In some embodiments, optical energy (e.g., fluorescence of chemiluminescence) can be directly measured in wells by a CCD camera without the use of fiber optics or a photodiode. In further embodiments, wherein the measurements are made with CCD cameras, fluorescence is measured without the use of an emissions filter.

Advantages of using a POC genetic testing device of the present inventions include at least the following:
i) a more rapid turnaround time leading to improved speed of diagnosis and thus improved clinical outcomes over conventional genetic testing;
ii) one simple step for dispensing sample and reagents into a multichannel chip; and
iii) quantification of markers present in sample instead of the qualitative results provided by conventional POC tests that are only positive or negative results;
iv) full calibration and quality control materials within the chips of the present invention;
v) built-in wireless connectivity for clinical and hospital databases and potential insurance reimbursement;
vi) low replacement costs of the device and disposable chips (e.g., under $5 and as low as $0.50 per disposable chip) especially when numerous assays ranging from 100,000 to 1 million per year are performed; vii) battery operable;
viii) portable;
ix) automated data processing and results reporting;
x) easy-to-use, easy to maintain, and easy to replace permitting even remote patient sites and small clinical laboratories to utilize the devices and methods described herein; and
xi) requiring only smaller volumes of environmental samples or of blood or bodily fluid, for example, urine, spittle, pleural fluid, lung fluid, etc., such that reaction volume per well in the assays is smaller than for other assays.

Currently available devices are generally of one of two types: 1) those with equipment suitable for centralized laboratories; and 2) qualitative (not quantitative) hand-held or portable genetic analyzers for POC and point of use (POU). Devices and equipment available in centralized large laboratories for quantitative genetic amplification have varying levels of multiplexing and may be available with or without integrated sample processing include SmartCycler: $45,000, Third Wave Technology System: $50,000, LightCycler: $55,000, Cobas Amplicor PCR: $65,000, Cobas TaqMan PCR: $75,000, GeneXpert: $90,000, and Tecan: $95,000. Assay cost ranges from $20 to $90 or higher depending upon the target of interest. GeneXpert® System (Cepheid) employs real-time polymerase chain reaction (PCR) to amplify and detect target DNA from target samples. This system includes a processing unit that is 11.5½ wide×14½ high×12.25½ deep as described in “GeneXpert: The world's fully integrated real-time PCR system” (Cepheid Technical publication 0112-02, herein incorporated by reference). This system comprises a SmartCycler® type device that provides real-time PCR reactions for identifying DNA/RNA from prepared biological samples. A SmartCycler® (Cepheid) is 12″W×12″L×10″H and weighs at least 22 lbs. These larger devices have played an important role in clinical settings (e.g. GeneXpert by Cepheid, Sunnyvale, Calif. and GeneOhm by BD, Franklin Lakes, N.J.) but they are expensive ($31,000-$80,000 equipment cost, about $50 per test), and are also limited by the number of genetic markers that can be targeted simultaneously, without substantial cost increases. Additionally, devices used in pathogen detection often use a single marker. Tracking a pathogen by a single marker has led to improper diagnosis in some instances Blanc, et al., (2011), J. Clin. Microbiol. 49:722-724; Ciardo, et al., (2010), J. Clin. Microbiol. 48:3030-3032; Stamper, et al., (2011), J. Clin. Microbial. 49:1240-1244. Examples of device limitations are described, for example, in Lewandrowski, (2008), Point of Care. 7:86-88; Nichols, (2008), Point of Care. 7:91-93.

Options currently available in the hand-held and/or portable diagnostic devices mainly include at least five commercially available PCR machines that utilize fluorescent detection of amplification products: Bio-Seeq™'s HANAA (Smiths Detection), RAPID® and RAZOR™ (Idaho Technology Inc.) and Smartcycler™ and GeneExpert™ System (Cepheid Inc.). Of these, three are advertised as hand-held and/or portable devices; Bio-Seeg™ HANAA (Smiths Detection), RAPID® and RAZOR™ (Idaho Technology Inc.). The conventional PCR analyzer, Bio-Seeg™ (Smiths Detection Handheld PCR Instrument) Handheld Advanced Nucleic Acid Analyzer (HANAA) uses two light emitting diodes (LED) to provide greater than 1 mW of electrical power at wavelengths of 490 nm (blue) and 525 nm (green). HANAA is a portable real time thermal cycler unit that weighs less than 1 kg (about 6-1/2 pounds and the approximate size of a book) is 28×9×18 cm (11×3.5×7 inches) that uses silicon and platinum-based thermocycler units to conduct rapid heating and cooling of plastic reaction tubes. Results are displayed in real time as bar graphs, and up to three, 4-sample assays can be run on the charge of the 12 V portable battery pack. HANAA is powered by batteries, vehicle adapter, or AC plug and can test up to six different samples simultaneously Higgins, et al., (2003), Biosensors and Bioelectronics. 18:1115-1123.

Another example of an LED illuminated real-time PCR Analyzer is a Ruggedized Advanced Pathogen Identification Device (RAPID®) PCR machine (Idaho Technology). RAPID® is a portable device of 50 pounds and requiring a 110-volt power source to identify biological agents in less than 30 minutes. Another related device is a stand-alone, battery-operated real-time PCR thermal cycler with built in analysis and detection software RAZOR™, comprising a fan cooled thermal cycler (see website at www.idahotech.com/RAZOR™/features.html), that is 8 pounds in weight, 6.6×4.4×9.1 inch/17×11×23 cm (h×d×w) and is reported to analyze 12 samples in 22 minutes running on battery power.

Many of these machines are heavy (at least 6.5 pounds in weight), large (at least 17×11×23 cm::h×d×w), and with a restricted range of sample numbers and limited target identification. In particular, available devices developed for POC deployment cost over $7,000, offer tube-based assays that require 10 μl or more of reaction volume, are limited in the number of assays that can be performed in parallel, and in some cases still require a laptop for data analysis and reporting (e.g. ESEQuant, Genie II).

Significant advantages of making and using the POC devices described herein (i.e. hand held nucleic acid amplification device) include but are not limited to capability of economical multiplexing, reduced equipment weight, optimal fluorescent excitation and imaging technology, lowered cost, reduced size, reduced power consumption, increased safety (e.g., by eliminating the use of UV light), increased sensitivity (e.g., by lowering the number of cells or number of target nucleic acids needed for obtaining a detectable amplification signal, i.e. florescence), increased range of use (e.g., by being portable and by increasing the number of different types of detectable microorganisms in one assay), and increased genetic and functional testing of numerous microorganisms with more detailed results, i.e. amounts of microorganism, pathogenicity potential of microorganism, etc.

One solution to the problems of the prior art that is solved by the devices described herein is provided by a small, lightweight and economical light source in the form of a LED-based illumination device.

Several companies have provided LED-based devices as light sources for illuminating samples comprising fluorescent dyes. For one example, a portable microprocessor-based LED water analyze is CHEMetrics V-2000 Multi-analyte Photometer or SAM-Single Analyte Photometer Kit using CHEMetrics Vacu-vials® self-filling ampoules. However these devices and kits test are adapted for identifying analytes related to bacterial contamination, and are not useful for actual identification of genetic markers from microorganisms.

A device of the present invention is a powerful and simple platform for multiplexed quantification of genetic markers and diagnostics. The device can be adapted to include various components, and in various embodiments can readily be adapted quantification of DNAs, RNAs, mRNAs, and microRNAs. One of the device embodiments is Gene-Z™—a Smart device driven device with a novel optical setup that allows 1/10th to 1/100th of the cost of currently available quantitative gene monitoring devices. The Gene-Z™—a Smart device driven device can be operably linked to a smart phone or other smart device. One embodiment of a Gene-Z™ device is a nucleic acid quantification machine using a credit card size microfluidic chip, i.e. card. Another of the device embodiments is an iDx device that has many of the same features as the Gene-Z™ device but is somewhat smaller.

In one embodiment, the device is contemplated to simultaneously analyze up to 64 or more assays in 500 nanoliter reaction well chambers. Advantages of using a device described herein include:
i) a sample cell range as low as 1-5 cells,
ii) analytical sensitivity—at least 1-10 copy per sample,
iii) analytical specificity greater than 99%,
iv) total time from sample-to-result of about 10 min to 1 hr, and
v) cost—about $500-$2,500 for device and less than $1-10 per assay.

Gene-Z™ has a novel optical setup for increased sensitivity of light (e.g., fluorescent) detection of nucleic acid amplification reactions. Components were optimized to allow ruggedness, portability, and low cost. A small, lightweight, economical and safe light source can be used such as a Light Emitting Diode, where one LED is used for each microfluidic well, and each LED is excited to provide excitation light to one sample well so the resulting emitted fluorescence can be detected or read using a single photodiode. The excitation by the LEDs can be done in a time staggered manner (sequentially). The use of this optical system eliminated the use of moving parts. Effectively, this arrangement combined with other modifications form the basis for providing the power of a real time genetic diagnostics machine in the hand-held device of the present inventions. Use of Smartphone for control, detection, and data analysis shows broad distribution of the technology. The assays can use novel SYTO-82 or SYTO-81 dye to track isothermal amplification in miniaturized wells with simple photodiodes. An example of a dye that is useful in the devices and methods described herein includes either of the following structures:

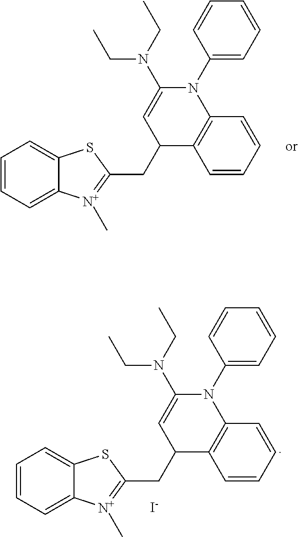 [SMILES: CCN(CC)C1=CC(Cc2sc3ccccc3[n+]2C)c2ccccc2N1c1ccccc1 ; CCN(CC)C1=CC(Cc2sc3ccccc3[n+]2C)c2ccccc2N1c1ccccc1 ; [I-]]

Furthermore, the use of portable computational and communication devices has the potential for data transmission in remote regions and/or in limited resource settings where the infrastructure for cellular networks is common yet laboratory diagnostic support is minimal. The global positioning system available in smart devices, including Smartphones, is contemplated for use to carry out epidemiological studies tied to geographical location providing complex genetic testing under field conditions. The barcode scanning capabilities of the autofocus camera combined with wireless printing and database-querying capabilities of smart devices can correlate sample identification with sample results, providing a genetic testing device as a powerful laboratory information management tool for proper database management of samples, sample results and/or assay conditions and reagents.

Genetic assays that can be conducted using these POC devices are numerous based on bacterial, protozoan, and viral pathogens. Because outbreaks of infectious diseases due to contaminated food and water continue to pose a serious threat to human health worldwide, in developing nations but also in industrialized countries such as the United States, see, Craun, et al., (2010), Clin Microbiol Rev. 23:507-28; Scallan, Clin Infect Dis. 2007:718-25. While treatment, disinfection, and stringent hygienic standards generally provide effective safeguards for the consumer, rapid screening of food and water for the many pathogens of concern is paramount to preventing sporadic disease outbreaks due to delayed detection of contamination. Traditionally, microbial agents in food and water are analyzed through culturing and biochemical/serological testing; however, this is notoriously time-consuming and also not easily adopted for specific detection of a panel of pathogens. Genetic testing using multiplex PCR and microarrays is much faster and can also screen for multiple pathogens and/or virulence and marker genes (VMGs) simultaneously with high specificity and sensitivity, Miller, et al., (2008), Appl Environ Microbial. 74:2200-9, but typically requires expensive and bulky equipment that is not well suited for testing on-site or even in small-scale laboratories. For genetic testing based on nucleic acid amplification, polymerase chain reaction (PCR) was the first used in POC devices since it was well established in clinical laboratories. However, PCR requires thermal cycling and relatively sensitive optics for real-time detection, both of which are not well suited for compact and inexpensive battery-operated devices. In contrast, isothermal assays would be capable of being monitored in real-time for quantification, with a sensitivity level to differentiate single nucleotide polymorphisms. Examples of human health related applications that are contemplated to benefit from quantitative and multiplexed POC genetic testing include measuring viral load with HIV, differentiation of point mutations for multiple drug resistance tuberculosis, and measurement of microRNAs panels for diagnosing cancer. In general, genetic testing is aimed at detecting the presence or absence of genetic markers such as pathogen-specific virulence genes, antibiotic resistance genes, or disease-specific mutations.

Therefore, the inventors developed several embodiments of a hand held nucleic acid amplification device for use with isothermal amplification techniques. Thus, a low-cost, compact, and battery-operated POC genetic testing device (e.g., Gene-Z™ and/or iDx) that satisfied many of the desired attributes listed above was developed and tested with multiple virulence and marker genes of major human pathogens in addition to microRNAs detection. In particular, the inventors contemplate several uses of devices described herein, such as a genetic testing POC device and a pathogen detection device for overcoming limitations of current amplification devices, such as providing faster results, having the capability to amplify and analyze in real time numerous genes in parallel, along with having a lower cost than conventional devices, a lower cost per test, in addition to having a compact size, i.e., hand held, and battery-operation. One exemplary embodiment of such a device was developed and tested with primers for detecting microRNA. Another embodiment was used for testing multiple virulence and marker genes (VMGs) of major human pathogens.

Numerous examples are available to illustrate the use of DNA, RNA, mRNA, and microRNAs as markers of microorganisms and disease including water and food borne pathogens, DNA and RNA viruses, and microRNAs marker based assays. The commercial products and the devices related to the present inventions are designed to provide conventional or real-time isothermal assays, such as qLAMP (quantitative LAMP), for detecting biological pathogens that are designed to be performed outside of BSL 2 (Biosafety Level 2) containment (as described in Biosafety in Microbiological and Biomedical Laboratories (BMBL) 4th Edition Ed., Richmond and McKinney published by the U.S. Department of Health and Human Services Centers for Disease Control and Prevention and National Institutes of Health Fourth Edition, May 1999 US Government Printing Office Washington: 1999) either in a laboratory or on portable devices taken to the site of the problem. For example, substantial progress has been made in certain areas e.g., Xpert MTB/RIF assay can measure the mutation causing rifampicin resistance in 2 hours compared to months taken by the susceptibility assay. Such devices are the method of choice at centralized screening facilities with abundant resources and will most likely remain so. Present invention is focused on carrying out some of these assays under field conditions.

An example application in the environmental biotechnology area is the measurement of microbial species carrying out trichloroethene (TCE) degradation. TCE is a contaminant at more than 3,000 US Department of Energy and Defense sites Committee on Source Removal of Contaminants in the Subsurface, (2004). Bioremediation relies on the use of halorespiring or dechlorinating microbial populations (e.g. Dehalococcoides spp., Dehalobacter spp.) He, et al., (2005), Environ. Microbial. 7:1442-1450; He, et al., (2003), Appl. and Environ. Microb. 69:996-1003; Scheutz, et al., (2011), Water Res. 45:2701-2723; Sung, et al., (2006), Appl. Environ. Microb. 72:1980-1987. For decision making and optimization of remedial performance, simple and quantitative tools for monitoring these organisms are needed Lendvay, et al., (2003), Environ. Sci. Technol. 37:1422-1431; Rahm, et al., (2006), Biodegradation. 17:523-534; Scheutz, et al., (2008), Environ. Sci. Technol. 42:9302-9309. Nucleic acid amplification is a rapid, sensitive, and specific means of quantitative detection; however, sample concentration and DNA extraction are major obstacles for routine implementation. Loop-mediated isothermal amplification (LAMP) offers a significant advantage because it is less inhibited by extraneous materials present in the sample matrix allowing amplification without DNA extraction Hill, et al., (2008), J. Clin. Microbial. 46:2800-2804; Kaneko, et al., (2007), J. Biochem. Bioph. Methods. 70:499-501; Masaomi, et al., (2003), Genome Letters. 2:119-126; Poon, et al., (2006), Clin. Chem. 52:303-306; Sotiriadou and Karanis, (2008), Diagn. Microbial. and Infect. Disease. 62:357-365, incorporated herein by reference in their entireties.

Lower assay cost and portability of the analytical platform are also critical for on-site measurement. The devices and methods described herein provide novel field-deployable approaches for cell concentration and rapid direct cell amplification for quantitative detection of target nucleic acids, for example of nucleic acids from Dehalococcoides spp. (DHC), using LAMP and a hand-held, battery-operated, wireless and automated device provided herein for monitoring nucleic acid amplification in a multi-well (e.g., 64-wells each with a 500 nanoliter reaction volume) microfluidic chip.

Examples of RNA detection using isothermal amplification include detection of RNA viruses (e.g., Dengue, Noroviruses, and HIV). Quantification of copy number of viruses during treatment is specialized assay currently possible by a handful of devices ranging from approximately $50,000 (LightCycler, Third Wave Technology, Cobas Amplicor) to approximately $100,000 (TaqMan PCR, GeneXpert). With the number of HIV cases crossing 40 million globally, the need to bring down the cost and take these capabilities to the masses is urgent. Viral load determination based on nucleic acid amplification is expensive with $100-$160 per sample using equipment that range from $30,000 to $60,000. It is more commonly used for prognosis and for managing therapy. Viral load monitoring must be done every 2-8 weeks until it is less than 200 particles per ml. Thus, a “digital” amplification technique can be performed with hundreds of wells targeting the same genetic HIV marker.

Another example is the measurement of microRNAs as markers of cancer and other diseases. Measurement of microRNAs has been difficult due to its small size. Initially, hybridization-based screening was used but now real-time PCR based measurement techniques are also available which are based on extension of the molecule followed by amplification. Cancer markers exist in circulating DNAs, mRNAs, or microRNAs in various body fluids. Currently, there are more than 1,000 microRNAs known in humans. They were heavily studied for their role in cell proliferation, differentiation, and apoptosis, but more importantly as markers of certain types of cancer. Numerous studies correlate the changes in microRNAs expression in various tissue samples to specific types of cancer including breast, thyroid, lung, hepatocellular carcinoma, prostate, ovarian, and colorectal cancer. MicroRNAs are small (approximately 22 nucleotides in length) single stranded molecules and their quantitative measurement was limited to centralized analytical facilities using complex techniques including bench top real time PCR, microarrays, and deep sequencing devices.

There are multiple embodiments of the device. In particularly preferred embodiments, the present invention provides a nucleic acid amplification device named Gene-Z™. The optical unit has an array of individually addressable light emitting diodes (LEDs, one per reaction well) and a single photodiode, with the different wells being read by triggering the 64 LEDs one at a time in a sequential manner. To prevent the problem of optical cross talk between reaction wells, the chips were fabricated as thin film shell microstructures using rubber-assisted hot embossing.

In one embodiment, a Gene-Z™ has a size of 22.5 cm (L)×17.3 cm (H)×3.5 cm (H), and weighs 930 g. Overall, a Gene-Z™ is a low-cost POC device capable of analysis of multiple genetic markers in an easy-to-use and compact format. In one embodiment, Gene-Z™ was used with a chip that consisted of four arrays of 16 reaction wells molded, carved, or laser-cut thin plastic microfluidic channels with sample chambers. In one embodiment, a Gene-Z™ device simultaneous analyses four samples for multiple genetic targets in parallel. Gene-Z™ uses operating software installed on a tablet device, such as iPod Touch, iPad, and Google Android Tablets. Overall it is an economical, battery powered hand-held genetic analysis device. It can detect fluorescent light emitted from reporter molecules incorporated into DNA, RNA and microRNA, or associated with other biological samples such as proteins, or react with chemical species present in the sample. Thus in principle, the optical arrangement does not limit its use for other molecules such as antibodies and chemical reagent-based assays using fluorescence. Gene amplification may be accomplished using any isothermal amplification technique, e.g., LAMP.

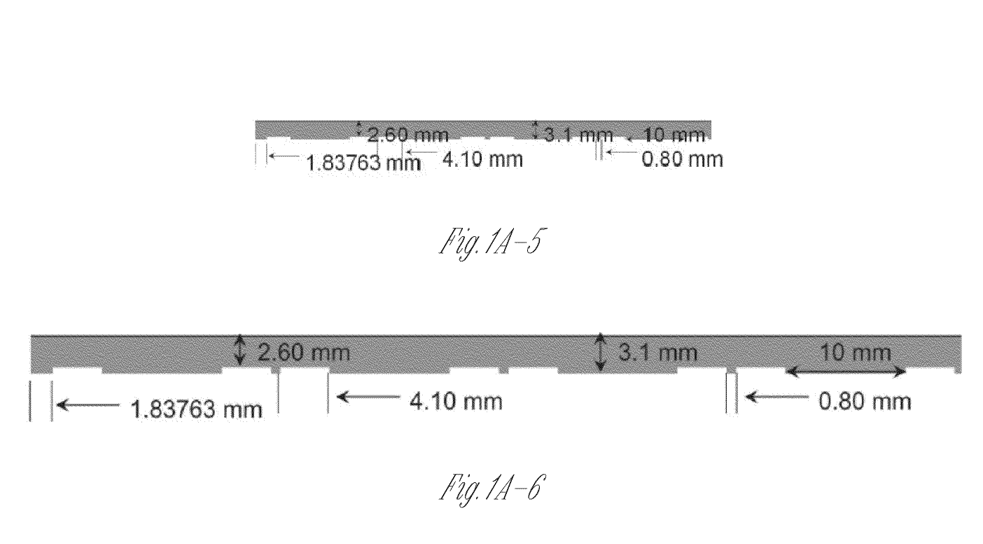

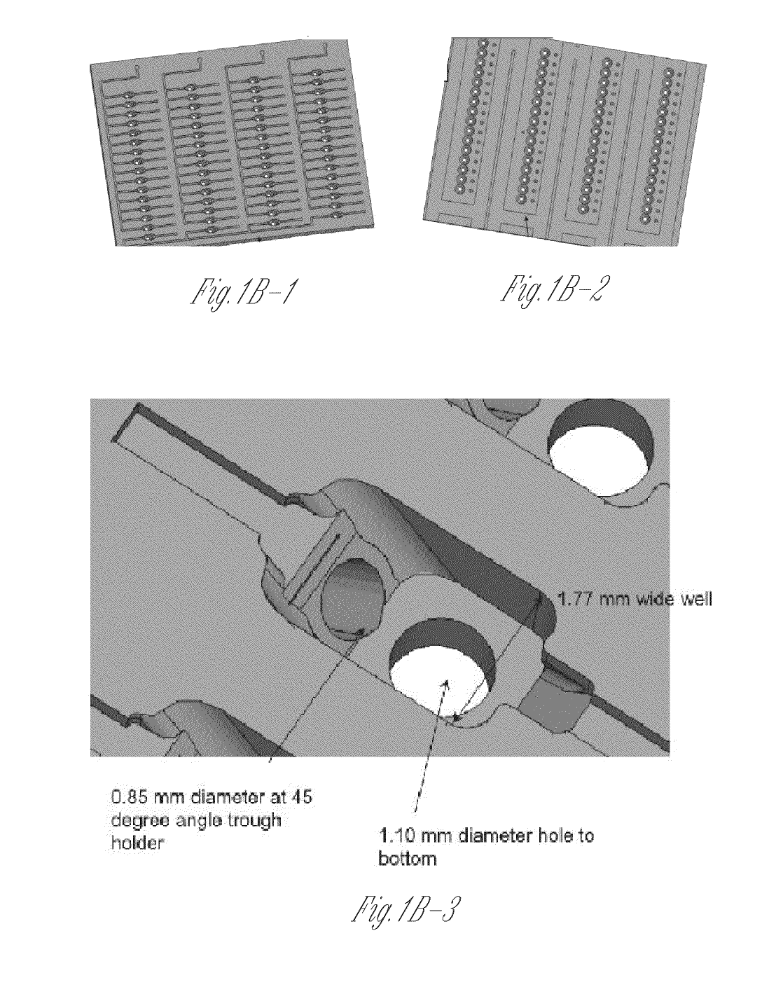

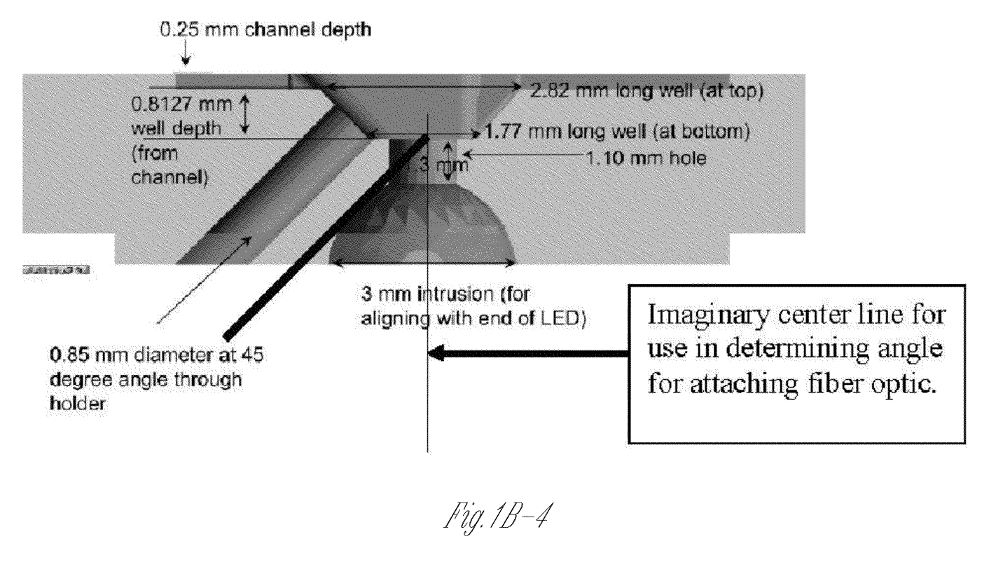

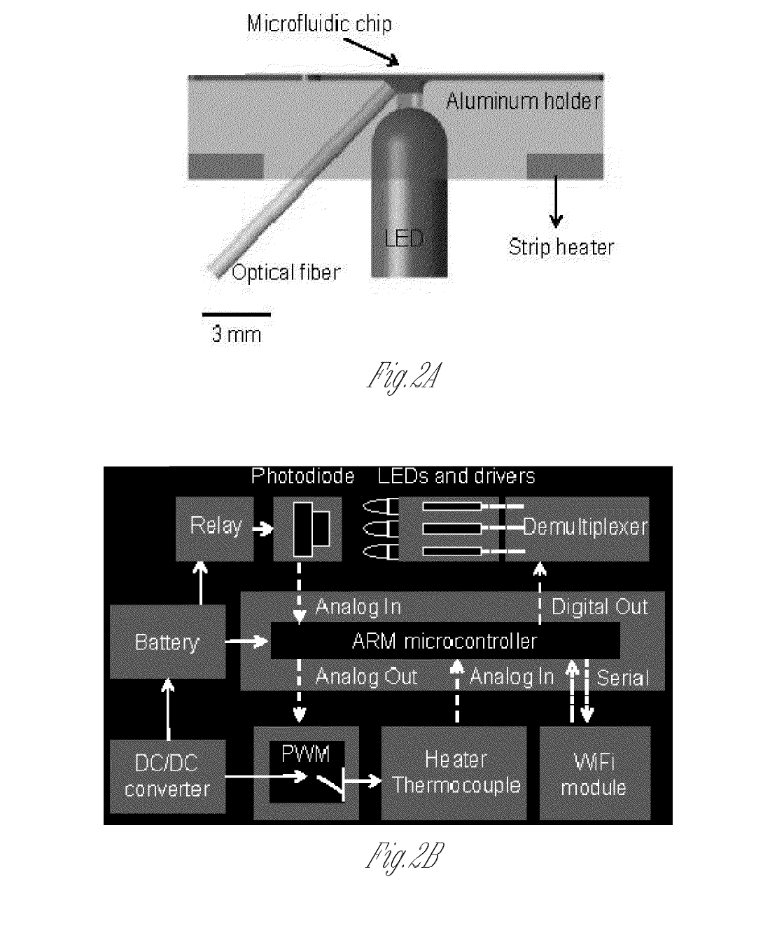

Several embodiments were tested in terms of components used for the optics, as well as the arrangement of components around the amplification chip. In one embodiment, electroluminescent film was tested, however, this did not provide enough excitation light, and thus, emission light was not observed during amplification when measuring with the photodiode. In another test, optical fibers were placed directly above the chip (in-line with the LEDs); however, the excitation light was too bright and saturated the photodiode. In another test, an optical fiber was placed directly above the chip (in-line with the LEDs) with an arrangement of excitation filters, however, this reduced excitation light below a readable level using the photodiode. In another test, optical fibers were placed at a 45 degree angle; this allowed the photodiode to read an increase in emission light during amplification, however, there was no existing physical arrangement that would allow an optical fiber to be butted against reaction wells in the 64 reaction well chip. As such, the arrangement of LEDs, optical fibers, and the single photodiode (as shown in FIG. 2) was the best arrangement for reading each of the 64 wells simultaneously.

Multiple innovations were made to make the microRNAs measurable using isothermal approach and use simple PDs for copy number quantification in real time. Therefore a standard LAMP assay was modified into two separate new techniques. In one embodiment, the assay was modified by ligating an easily amplifiable DNA piece or “amplifier” and then designing LAMP primers to amplify the overall product with one of the primers sitting on the microRNAs and the rest 3-5 primers sitting on the DNA amplifier. In another embodiment, we have developed a method of amplifying microRNAs in one step. In this procedure, two template strands that have a short complementary sequence at their ends (approximately 10-15 bp) were added to the reaction. The short sequence was not long enough to allow hybridization at high LAMP temperatures, however, in the presence of the microRNAs (which is complementary to a portion of template strand 1), the microRNAs stabilized the strands to thus create a double stranded template. The LAMP primers are specific to the new template as a whole and do not amplify the strands if the microRNAs does not create the double strand. Primers used include FIP, BIP and F3, B3, and no loops. A different strand was used for each targeted microRNA. Because each template is specific to the microRNAs of interest, the entire procedure is one-step from either total RNA or plasma/serum samples and results were obtained in approximately one hour.

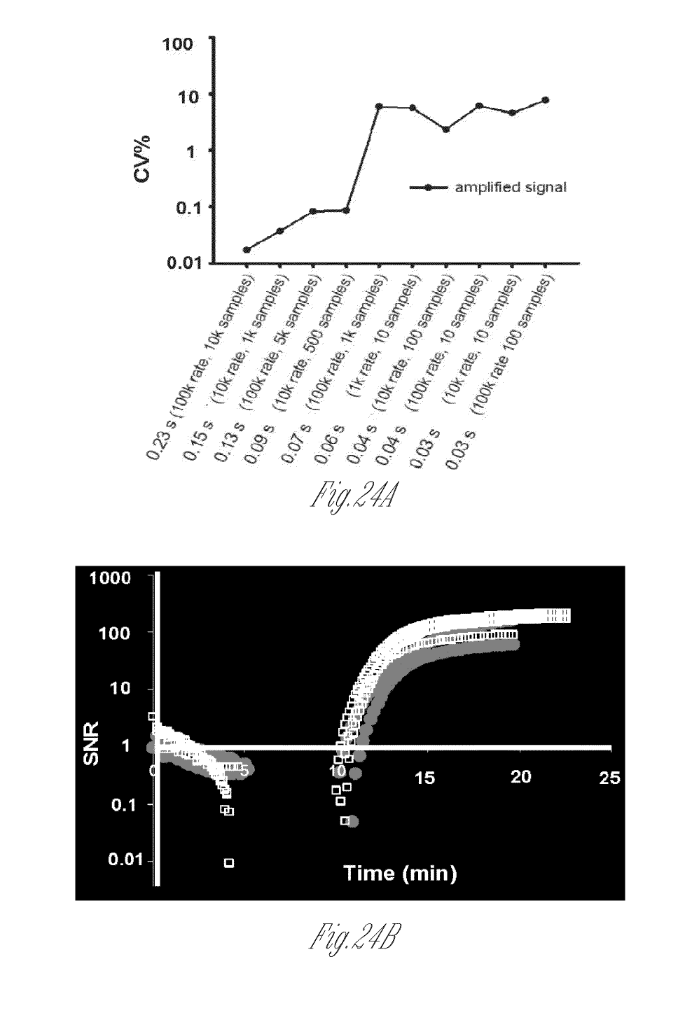

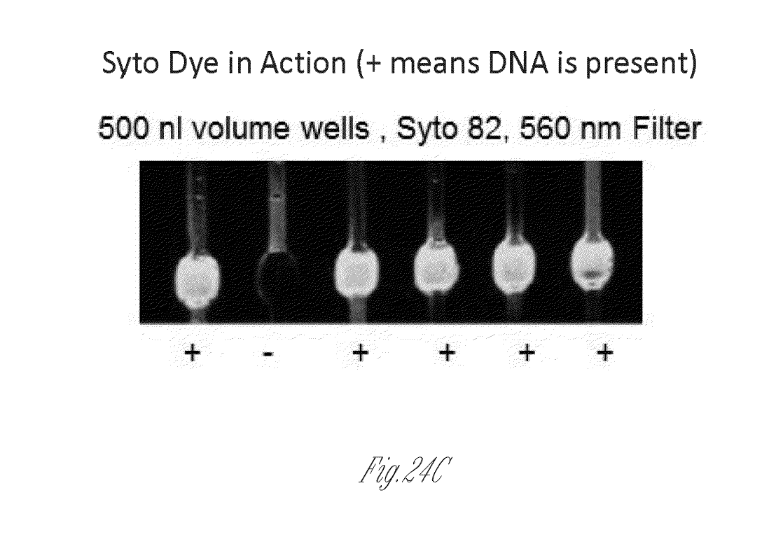

Another innovation was the optimization and systematic testing of fluorescent dyes to find a dye combination with the optical system of the present inventions that would allow the use of the low cost, and off the-shelf optical components (i.e. LEDs, optical fibers, and a single photodiode), without sacrificing the sensitivity, robustness, and limit of detection obtained with commercially available real-time bench top platforms. In addition, the sensitivity of the isothermal amplification reaction was optimized using non-conventional intercalating dyes, in order to increase confidence in making presence/absence calls using the novel optical setup of the present inventions. As such, a device of the present inventions is contemplated for use as a point of care device for detecting genetic markers selected from medically relevant microRNAs, RNAs, and DNA signatures (i.e. individual sequences including SNPs, and patterns of sequences. Therefore the combined use of an isothermal amplification method with strand displacement for generating high yields of amplicon, and a high-concentration of non-inhibiting intercalating dye permitted detection of an amplification profile with such components, as described herein. Thus, tests were performed with both SYBR®Green I and a varying concentration of SYTO-81 to demonstrate the utility of this dye over more conventional dyes for detection with this simple optical setup. Results showed amplification curves when using SYTO-81 at 20 μM. In contrast amplification was not observed using SYBR®Green I (FIG. 26). These results demonstrated that SYTO-81 was a better dye than SYBR®Green I for use in a Gene-Z™ device. This is likely due to the possibility to use this dye at a high concentration, allowing readings even when using a device with low-cost optical settings. This was further confirmed by using SYTO-81 at various concentrations (2, 5, 10, and 20 μM) in a Gene-Z™). It was possible to detect amplification for every dye concentrations tested. However, when using SYTO-81 at 20 μM, the Tt was about 1 min shorter and less variable than when using any of the other concentration.

Multiple embodiments of the microfluidic chips were developed. The microfluidic chips served to allow simple placement of sample with 1 to 4 loading reservoirs into 8, 64, 384, 1536 or more reaction wells without the use of centrifugation or a valve technique. Instead, an “air lock” system or wax was used to reduce primer and reagent carryover as samples were loaded into the chip. The air lock system was a network of channels that served to allow sample to be equally loaded into reaction wells without primer carryover. In one embodiment, chips were fabricated by hot embossing thermal plastics with a mold and press. In another embodiment, chips were fabricated by scouring channels with a laser. In preferred embodiments, primers are dispensed and dried into the reaction wells, and the channels and wells were enclosed using a piece of non-inhibiting tape. Bubble formation and displacement of sample in wells due to expansion/de-expansion was minimized by using temperatures less than 65 degrees C. for isothermal amplification.

The present invention provides devices, compositions for such devices, and methods for using such devices, where the devices comprise a set of LEDs and photodiodes for measuring fluorescence in biological samples. In particularly preferred embodiments, the present invention provides an economical, battery powered and hand-held device for detecting fluorescent light emitted from reporter molecules (e.g., fluorescent dyes) incorporated into DNA, RNA, microRNAs, proteins or other biological molecules in various samples, such as a fluorescence emitting amplicon of a target microRNAs or a diagnostic DNA/RNA in a microfluidic chip. Further, a real-time hand-held nucleic acid analysis device comprising an LED/PD system for measuring fluorescence emissions from amplified nucleic acid signatures and other molecules is provided.

For example, the present invention provides fluorescence detection devices comprising a set of LEDs that provide static and/or real-time fluorescent read-outs in a number of formats including visual and digital. In further examples, the present invention provides fluorescence detection devices comprising PDs that provides real time quantification assay capabilities, such as isothermal amplification assays, antibody-based reagent assays, and chemical assays resulting in fluorescence, computational capabilities for data read-outs, and read-out capabilities in a number of formats including visual and digital.

It is not intended that the present invention be limited by the nature of the reactions carried out in the fluorescence detection device. Reactions include, but are not limited to, biological reactions. Biological reactions include, but are not limited to microRNAs abundance measurement, mRNA transcription quantification, RNA amplification, DNA amplification, cDNA amplification, mutation detection, nucleic acids sequencing, and the like. It is also not intended that the invention be limited by the particular purpose for carrying out the biological reactions. In one diagnostic application, it may be desirable to simply detect the presence or absence of a particular pathogen. In another diagnostic application, it may be desirable to simply detect the presence or absence of specific allelic variants of pathogens based on mutations in a gene of the target pathogen such as those causing drug resistance in Mycobacterium tuberculosis in a clinical sputum or blood or body fluid sample. In one embodiment, it may be used to detect a large number of antibiotic resistance genes emanating from pathogens present in patient samples in an emergency room. For example, different species or subspecies of bacteria may have different susceptibilities to antibiotics; rapid identification of the specific species or subspecies present aids diagnosis and allows initiation of appropriate treatment. A quick and simple measurement on antibiotic resistance at the bedside or POC setting may help in prescribing the correct antibiotic at the outset instead of using a broad set of antibiotics and waiting for culture-based results taking a few days or molecular assays taking at least a day.

In one embodiment, the excitation filter was not used when a narrow range LED was used for illumination. The present invention is not limited to a particular light source. Indeed, a variety of light sources may be incorporated, including, but not limited to a blue, blue-green and green LEDS, organic LEDS, and the like. Indeed, a variety of emission filters and excitation filters may be incorporated, including, but not limited to colored glass filters and Super Gel filters. In any case, the emission filter and when used an excitation filter should be optically compatible with the light source and a target fluorescent molecule.

In one embodiment, the device further comprises an optical signal detector positioned to detect optical signals from a biological sample contained in said biological sample holder. Indeed, a variety of optical signal detector types may be incorporated, including, but not limited to an optical signal detector is selected from the group consisting of a single PD used for the LEDs in a time staggered arrangement, an array of PDs with varying filters ranges, or a charge-coupled device (CCD) and complimentary metal-oxide semiconductor (CMOS) device with exposure control for imaging fluorescent signals at once. In one embodiment, the device comprises an external case enclosing said electroluminescent light source, excitation filter, biological sample holder, and emission filter.

The present invention is not limited to a particular external case. A variety of cases are contemplated, including but not limited to a hard case or a soft case. The present invention is not limited to a particular size. In one embodiment, the device weighs 2 pounds or less. In one embodiment, the device weighs 1 pound or less. In one embodiment, the dimension of the device is less than 11×3.5×7 inches. In one embodiment, the device further comprises an electrical power source.

The present invention is not limited to a particular electrical power source. A variety of electrical power sources are contemplated, including but not limited to an AC power source and/or a DC power source electrically connected to said light source and other components requiring power. In one embodiment, the device further comprises a battery power source electrically connected to said light source and other components requiring power. The present invention is not limited to a particular battery power source. Indeed, a variety of battery power sources are contemplated, including but not limited to an internal battery power source or an external battery power source. In one embodiment, the battery is chargeable by solar cells integrated on the device or placed separately. In one embodiment, the device further comprises a peripheral. The present invention is not limited to any particular peripheral. Indeed, a variety of peripherals are contemplated including but not limited to an external USB hard drive and/or an electrically connected wireless communication chip. In a further embodiment, the biological sample holder comprises an optically compatible assay.

The present invention is not limited to a particular assay. Indeed, a variety of biological assays are contemplated, including but not limited to isothermal assays for microRNAs, RNA, DNA, and genetic mutations, hybridization-based microarray chip or a PCR chip. In a further embodiment, the assay comprises a biological sample. In one embodiment, the microfluidic chip comprises a biological sample for nucleic acid-based assays. In one embodiment, the microfluidic chip comprises a biological sample for antibody-based assays. In another embodiment, the microfluidic chip comprises biological samples for chemical assays.

In some embodiments, the device further comprises at least one component selected from the group consisting of excitation filter, emission filter, optical signal detector, thin-film heater, software, a liquid crystal display, a Universal Serial Bus port, and an external case. In one embodiment, the device is capable of connecting to the internet via Wi-Fi or Bluetooth. In another embodiment, it is capable of sending the results to a cell-phone which can then communicate with the internet via short messaging system (SMS).

The present invention is not limited to a particular biological sample. In some embodiments, the target molecule is quantified by following the signal generation due to amplification or physical, chemical association of molecules in real time.

### DETAILED DESCRIPTION OF THE INVENTION

The present invention provides compositions for making and methods of using a hand-held fluorescence nucleic acid amplification device, comprising a novel optical arrangement of light-emitting diode (LED) for use with a single photodiode for quickly measuring fluorescence in biological samples. Specifically, methods of use includes disposable chips and customized primers for multiple applications requiring nucleic acid amplification. Some embodiments include: (i) a disposable microfluidic chip with pre-dispensed and dehydrated primers, (ii) a compact, and inexpensive fluorescence detector, and (iii) a wirelessly-connected smart device (iPod Touch or iPhone) for control, data collection, display, and analysis. In particular, a device of the present invention uses isothermal amplification for obtaining detectable yields of amplified nucleic acid product including an analysis in short time periods, i.e. within seconds.

The present invention provides compositions, methods, and applications for making and exemplary methods of using a hand-held fluorescence nucleic sequence amplification device, comprising an electroluminescent source e.g., light-emitting diode (LED) as illumination source for measuring fluorescence in tagged biological samples. In particularly preferred embodiments, the present invention provides a nucleic sequence amplification device comprising, a temperature-controlled non-transparent chip holder, a set of LEDs as excitation sources, a multichannel fluorescence sensor, custom printed circuit boards (PCBs), and a smart device, such as an iPod Touch or Android Tablet, with custom applications. A device of the present inventions was used with chips having molded thin plastic micro fluidic channels with sample chambers matching the chip holder, for providing an economical, battery powered and hand-held device for detecting fluorescent light emitted from reporter molecules incorporated into nucleic acids or proteins, i.e. DNA, RNA, mRNA, microRNAs and other biological molecules. In particular, nucleic acid sequence amplification may be accomplished using isothermal amplification enzymes, e.g., LAMP for identifying microRNAs related to disease states. Further, an operational real-time hand-held nucleic sequence amplification device for detecting fluorescence from amplified microRNAs is provided for identifying these markers in less than 10-40 minutes.

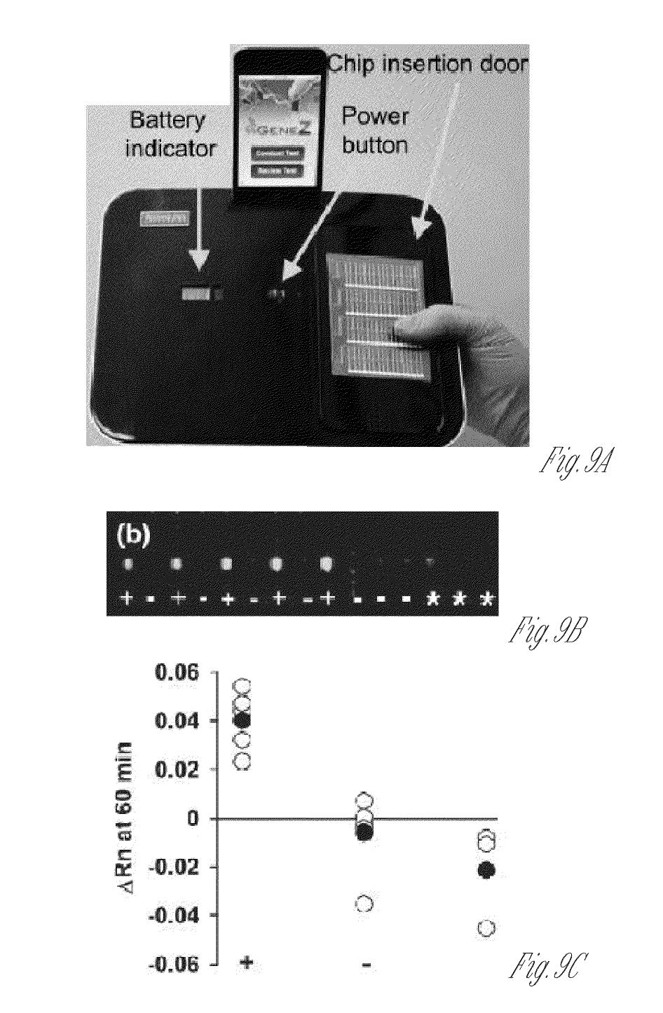

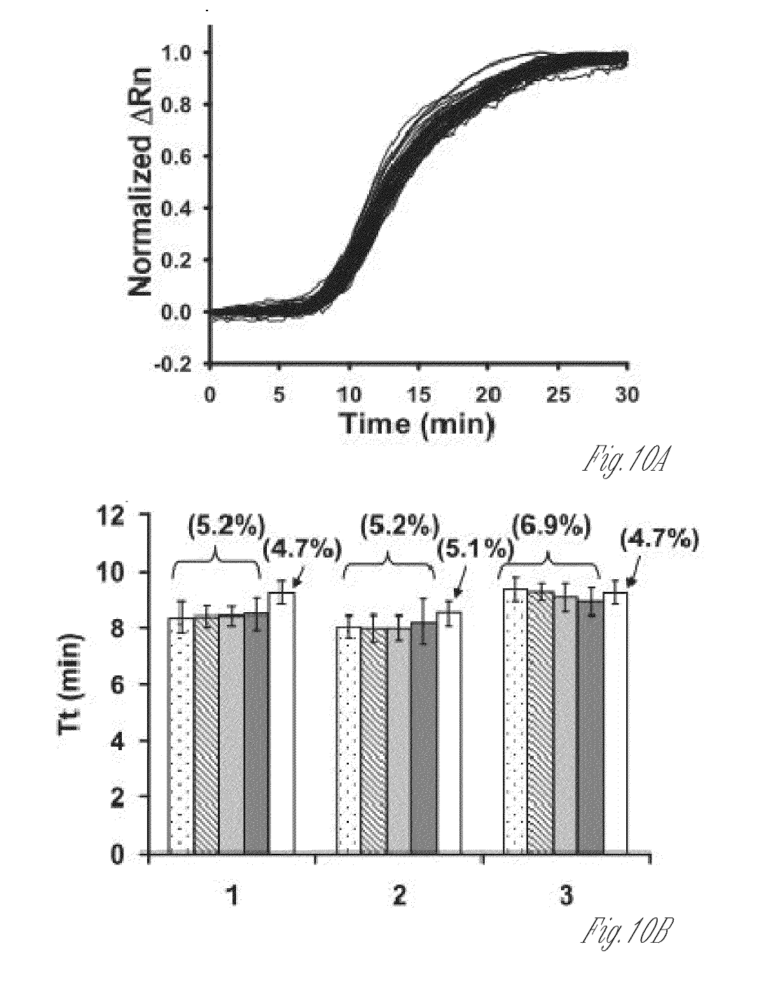

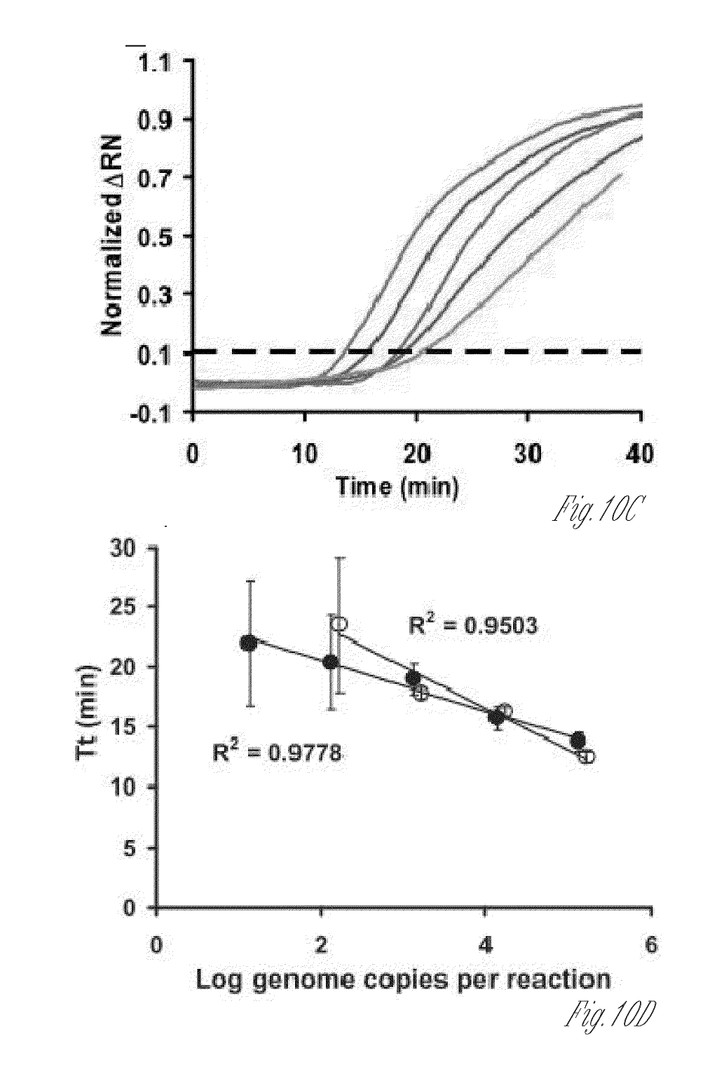

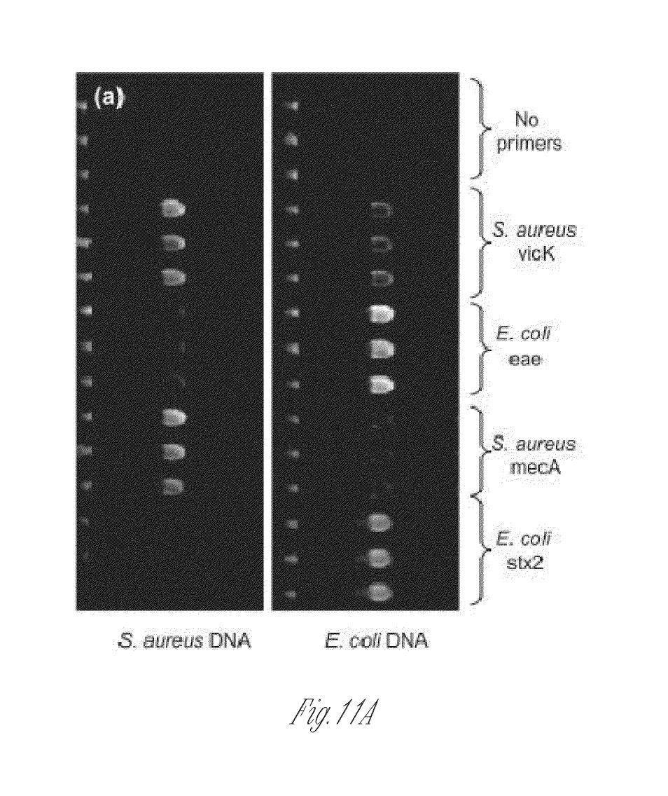

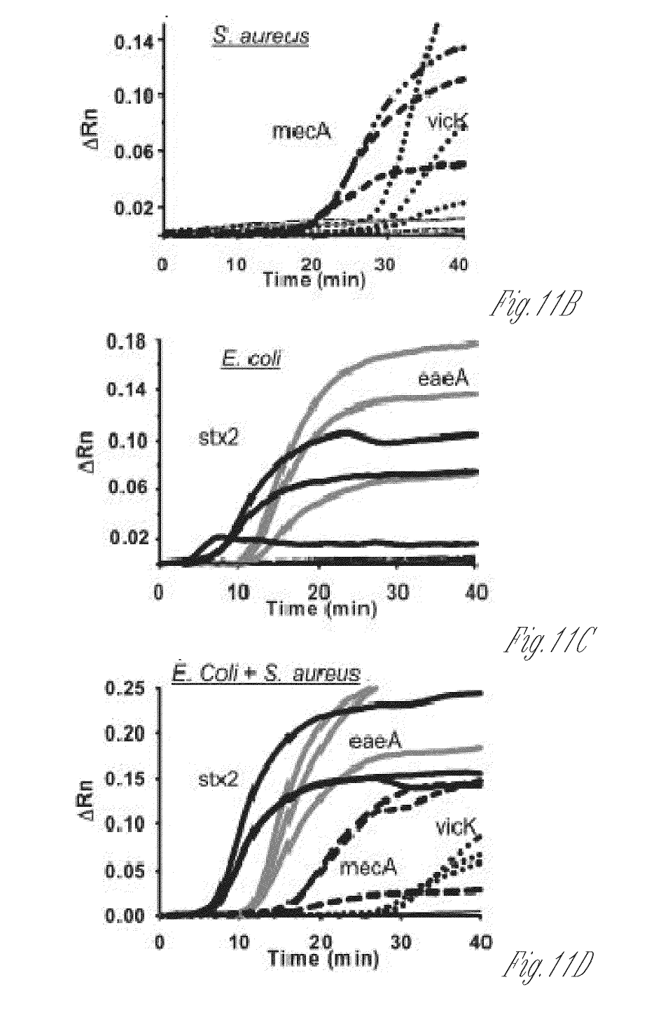

In particular, the inventors discovered through side by side comparison, that the use of their device shows more sensitive detection with isothermal amplification methods when using microfluidic chips and SYTO-81 or SYTO-82 fluorescent molecules for detection, i.e. orange fluorescent molecules; in contrast to earlier studies using microfluidic chips and other dyes (FIG. 26). Specifically, in an exemplary embodiment, a device of the present inventions was capable of isothermal amplification of microRNAs of pathogens in less than 30 minutes with 30-100 copies of the target DNA, and in some experiments, detection of a target was in less than 10 minutes (FIGS. 13, 14). Additional novel embodiments include:

1. making the disposable microfluidic chip from polyester, rather than the more traditional silicon or polydimethylsiloxane (FIG. 6),

2. integration of small and low cost optical components for detection of multiple genetic assays without moving parts (FIG. 2),

3. use of isothermal amplification of microRNAs that can include a base stacking technique (requiring no sample preparation prior to amplification), for example, and/or the use of oligonucleotide capture probes complementary to ribosomal RNA bound to the sample well which causes the ring structure of the adjacent nucleic acids to lie on top of each other,

4. air-lock and/or low temperature wax, and/or use of a hydrophobic membrane for sample distribution into wells of the microfluidic chip without primer carryover during sample loading or diffusion of amplicons during the reaction,

5. the use of exposure control CCD to decrease the time required for detection.

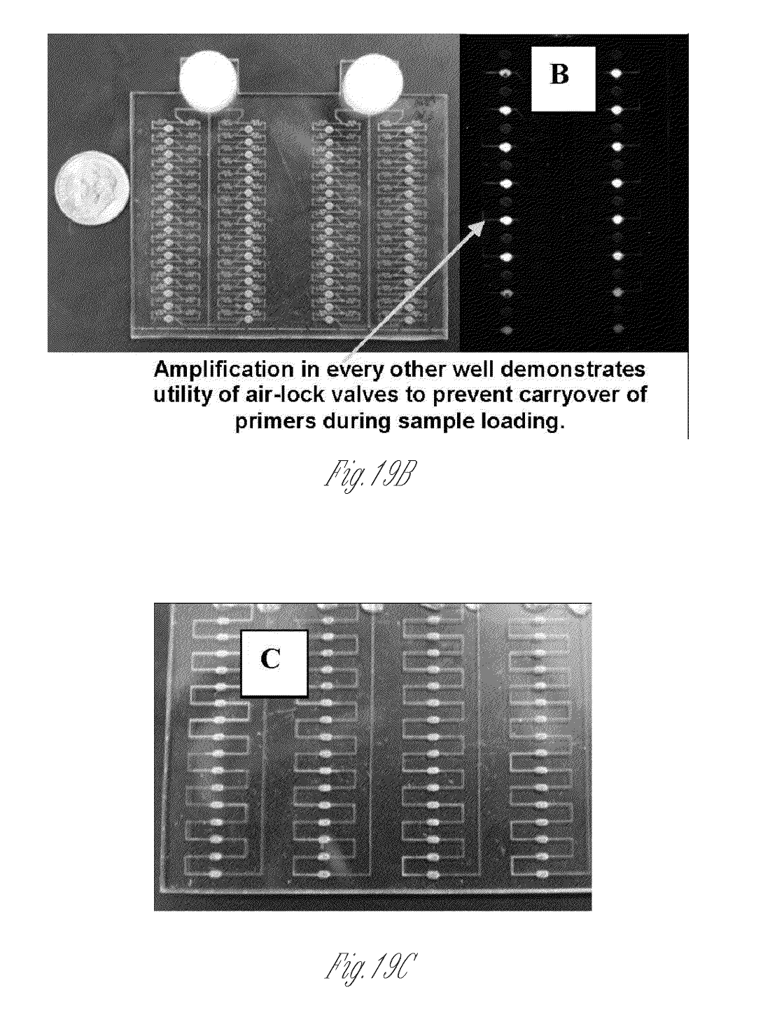

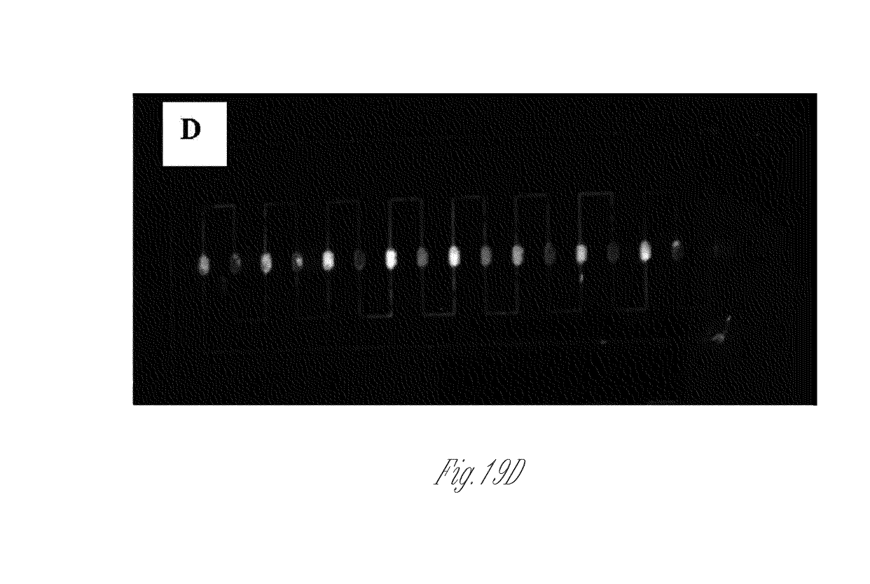

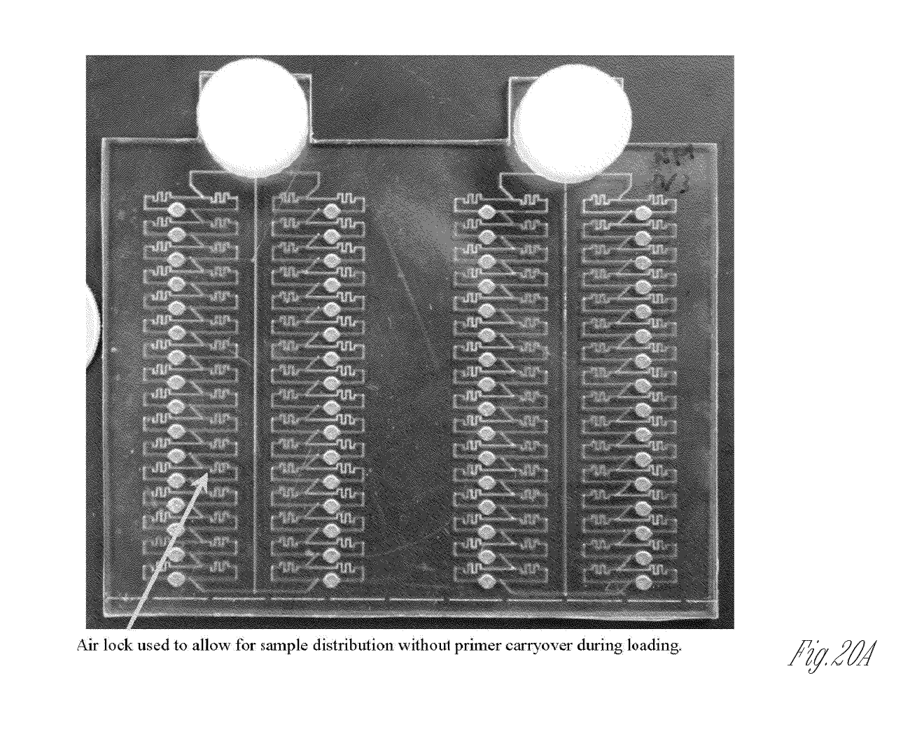

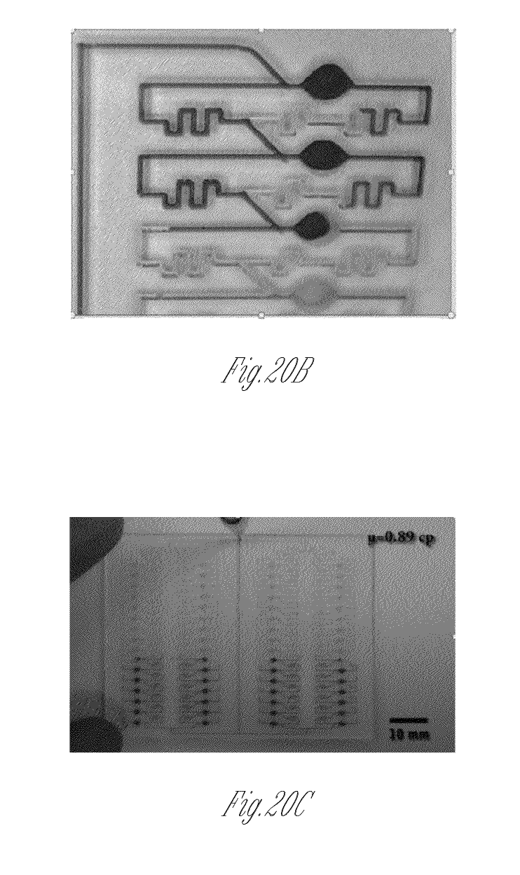

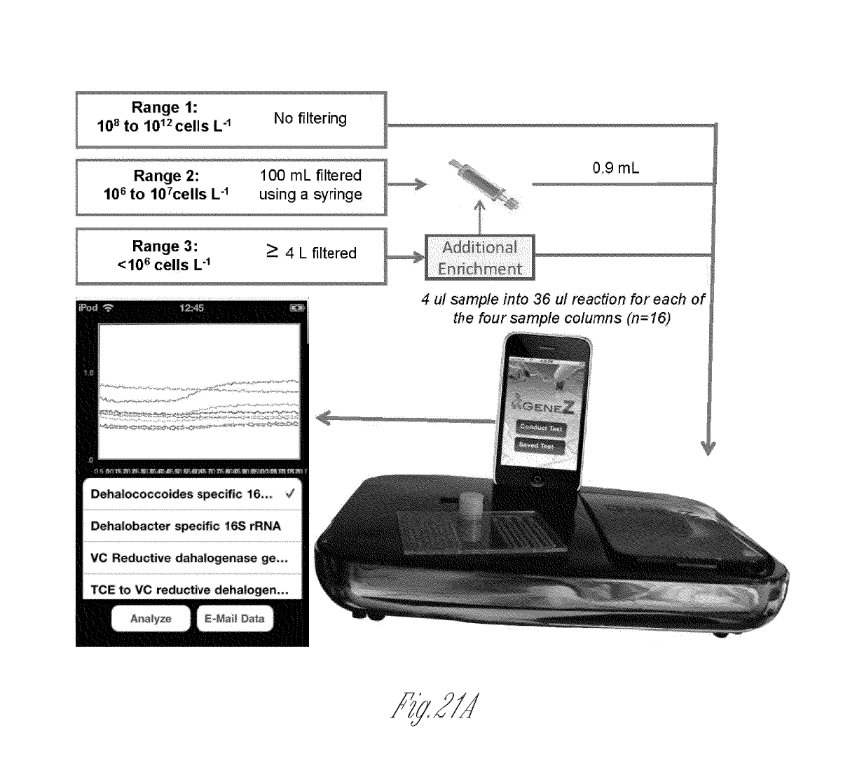

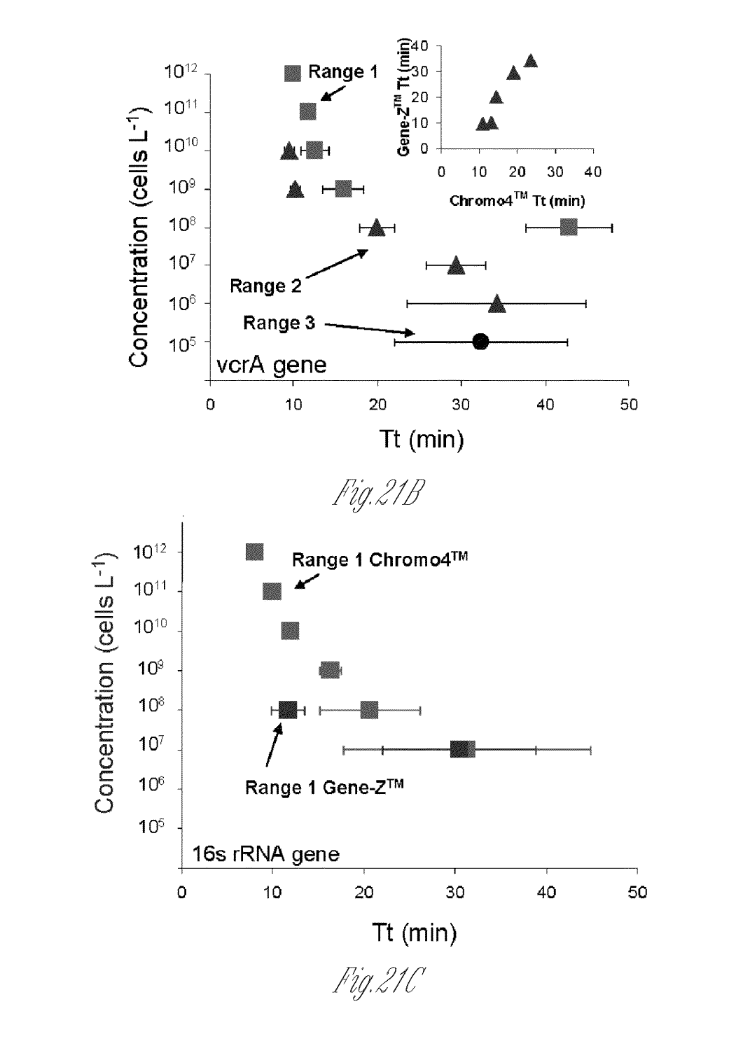

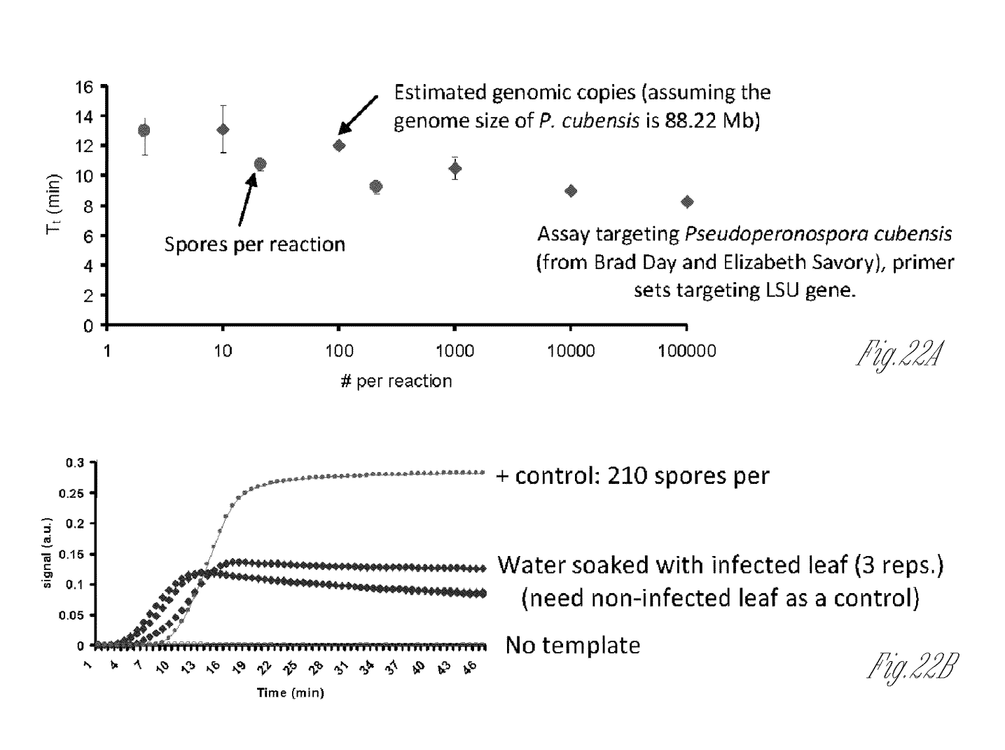

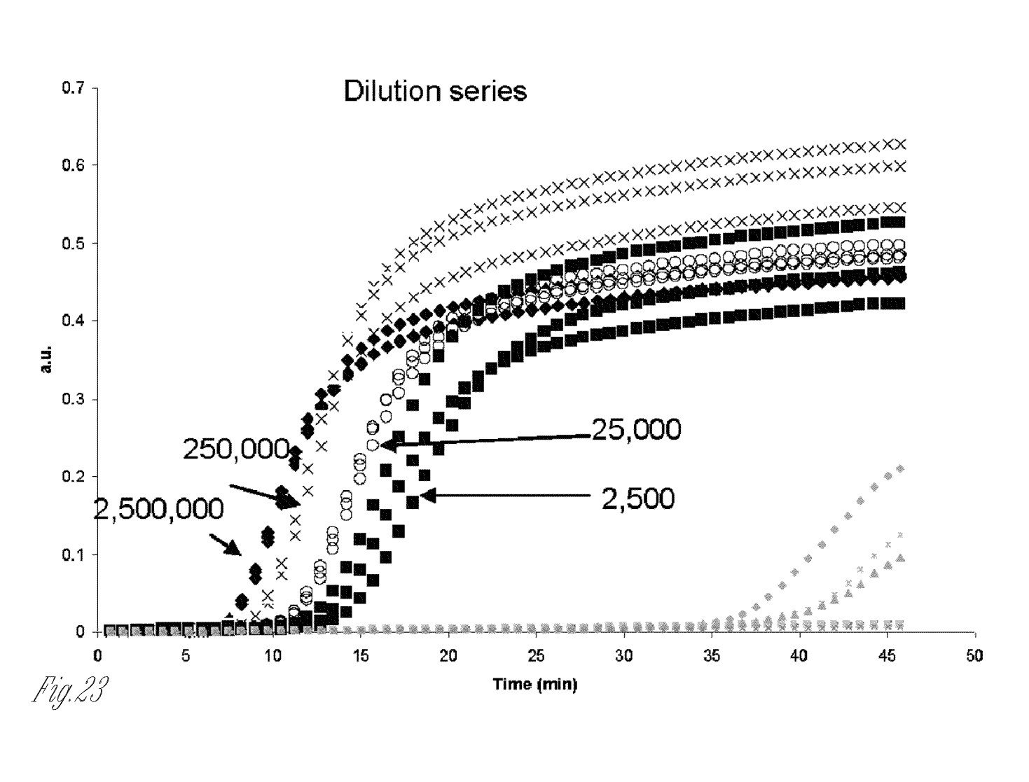

Isothermal assays including LAMP are capable of dealing with contaminants and inhibitors much more efficiently than PCR, making the device extremely powerful for samples where less sample processing will save time and cost, and provide “sample in-result out” capabilities. The LAMP assay does not use thermal cycling, and less expensive optics can be used for detection. Further, a LAMP assay was less influenced by inhibitory substances that would cause detection of false negatives, which is a problem with PCR techniques. Finally, Wi-Fi and a Smartphone with a custom-built app as the interface to manage data from the device was used (FIGS. 8, 9A, 21). Use of isothermal amplification for obtaining high yields of amplified product, the optical components and the arrangement described herein resulted in a smaller device than the conventional bench top PCR devices. Moreover, the devices described herein permit real-time measurements, use less power than bench top PCR devices, have no moving parts, and are significantly less expensive than existing PCR devices. During development of the present inventions, nucleic acids amplification was successful without extraction of DNA from the bacterial cells and spores thus eliminating the need for sample processing (FIGS. 21, 22, 35). Additional results and components of the device are described in further detail herein.

A. Development of a Hand Held Nucleic Acid Amplification Device for Point of Care Genetic Testing.

A hand held nucleic acid amplification device is described herein for producing multiplexed genetic results (for example, microRNA detection and/or quantification) that is inexpensive, user-friendly, compact, and can be called a Gene-Z™ or iDx™ device. Such devices can be used for rapid quantitative detection of multiple genetic markers while providing high sensitivity and specificity. Using one embodiment of a valve-less polymer microfluidic chip containing four arrays of 15 reaction wells each with dehydrated primers for isothermal amplification, a Gene-Z™ device enabled simultaneous analysis of four samples, each for multiple genetic markers in parallel, requiring one pipetting step per sample for dispensing sample into reaction wells. To drastically reduce the cost and size of the real-time detector necessary for quantification, loop mediated amplification (LAMP) can be performed with a high concentration of Syto81, a non-inhibiting fluorescent DNA binding dye. Another benefit of the use of a LAMP reaction in this device was the amount of amplified product that can be generated, in one exemplary embodiment the amount of DNA amplified was up to ten-fold (10×) greater than an equivalent reaction using conventional PCR amplification. The devices can be operated using a smart device such as an iPod Touch or a cell phone, which can also receive data and carry out automated analyses and reporting via a Wi-Fi interface. Data pertaining to performance of this device including sensitivity and reproducibility was produced using genomic DNA from Escherichia coli and Staphylococcus aureus. Overall, a Gene-Z™ device represented an inexpensive and compact tool contemplated for POC genetic testing and for providing diagnostic results.

One exemplary embodiment of a Gene-Z™ device, was made using the following components: i) a temperature-controlled non-transparent aluminum heater, ii) a multichannel fluorescence sensor, iii) a multilayer custom printed circuit board (PCB) for main components, LEDs, push button control, and iv) a smart device with custom applications, for control, data collection, display, and analysis. The optical unit consists of an array of individually-addressable light emitting diodes (LEDs, one per reaction well) and a light capturing element (e.g., a single photodiode), where nucleic acid amplification in the different reaction wells can be read by triggering the 64 LEDs one at a time (e.g., sequentially or simultaneously). In one embodiment, a device of the present invention can be designed using computer-assisted design (CAD), fabricated via stereo-lithography out of Accura material (Midwest Prototyping), and aestheticized with a chrome and black glossy finish. In one embodiment, a Gene-Z™ device has a size of 22.5 cm (Length)×17.3 cm (Height)×3.5 cm (Width), and weighed 930 g, including the iPod Touch and battery. In one embodiment shown herein, the device can be operably linked to a smart device such as a smart phone (e.g., an iPhone or droid phone). In another embodiment shown here in a smart device can be an iPod Touch. In one embodiment, the battery is a rechargeable Lithium polymer (XP8000 Energizer), which allowed eight 30 min tests to be run before recharging, and has an indicator for remaining battery life. Included in the contemplated Gene-Z™ package is a dock to recharge the iPod, a plug-in port for recharging the internal battery, a power button that illuminates green when turned on, and a blue LED that is illuminated when a test is in progress.

In another embodiment, a Gene-Z™ device had the following components: (i) a disposable microfluidic chip with pre-dispensed and dehydrated primers, (ii) a compact and inexpensive fluorescence detector, and (iii) a wirelessly-connected smart device (iPod Touch or iPhone) for control, data collection, display, and analysis. The chip had four arrays of 15 reaction wells, permitting simultaneous analysis of four samples for multiple pathogens and/or virulence marker genes in parallel. The optical unit (system) has an array of individually-addressable light emitting diodes (LEDs, one per reaction well) and a single photodiode, with the different wells being read by triggering the 64 LEDs (e.g., one at a time).

In one embodiment for overcoming a problem of optical cross-talk between reaction wells, the inventors fabricated chips as thin film shell microstructures using rubber-assisted hot embossing. In one demonstrated application, Gene-Z™ was used for parallel detection of multiple pathogens using real-time fluorogenic LAMP in disposable microfluidic chips. One exemplary chip consisted of four arrays of 15 reaction wells, permitting simultaneous analysis of four samples for multiple pathogens and/or virulence marker genes in parallel. Additionally, the device was used with one embodiment of a disposable microfluidic chip with pre-dispensed and dehydrated primers. With the use of disposable chips and customized primers, the device is contemplated for other types of nucleic acid amplification assays.

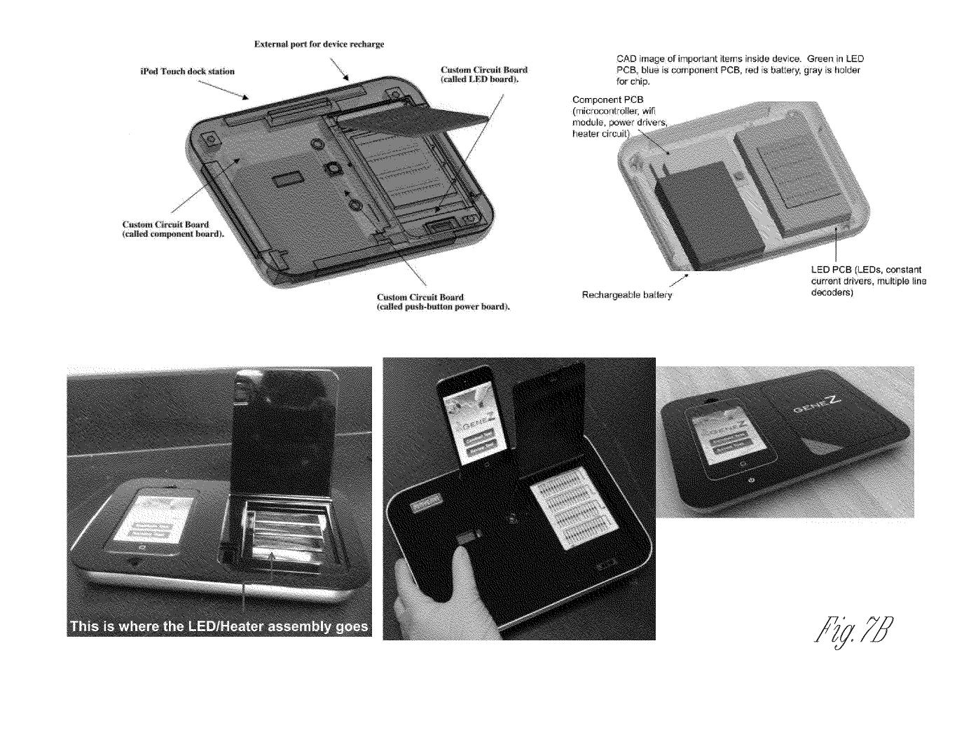

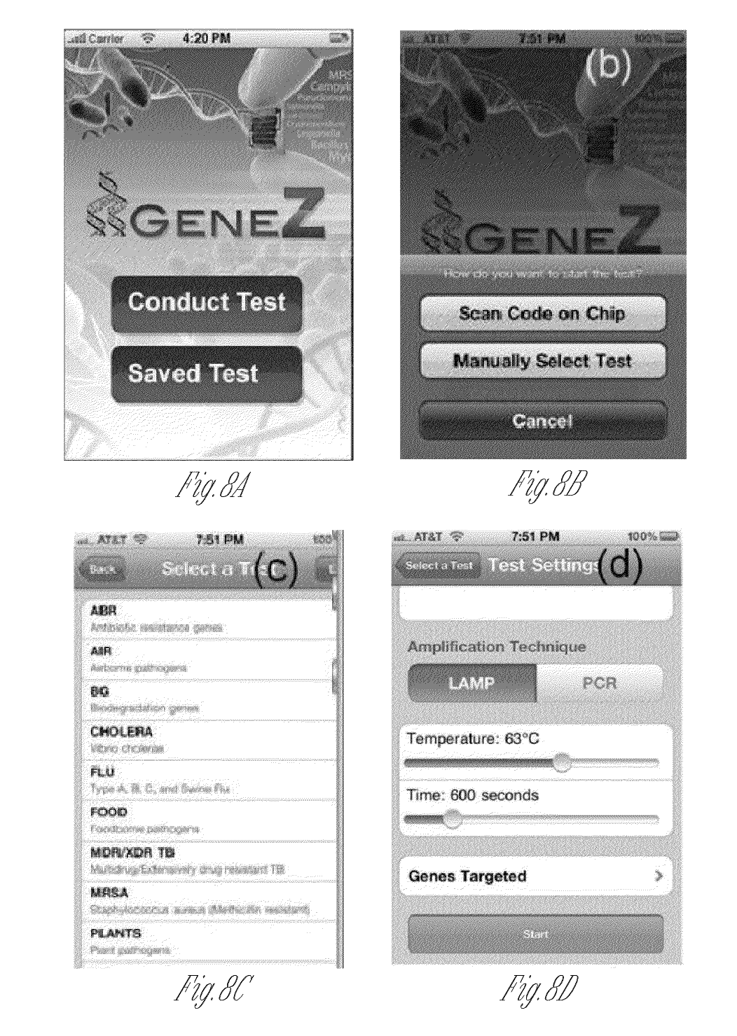

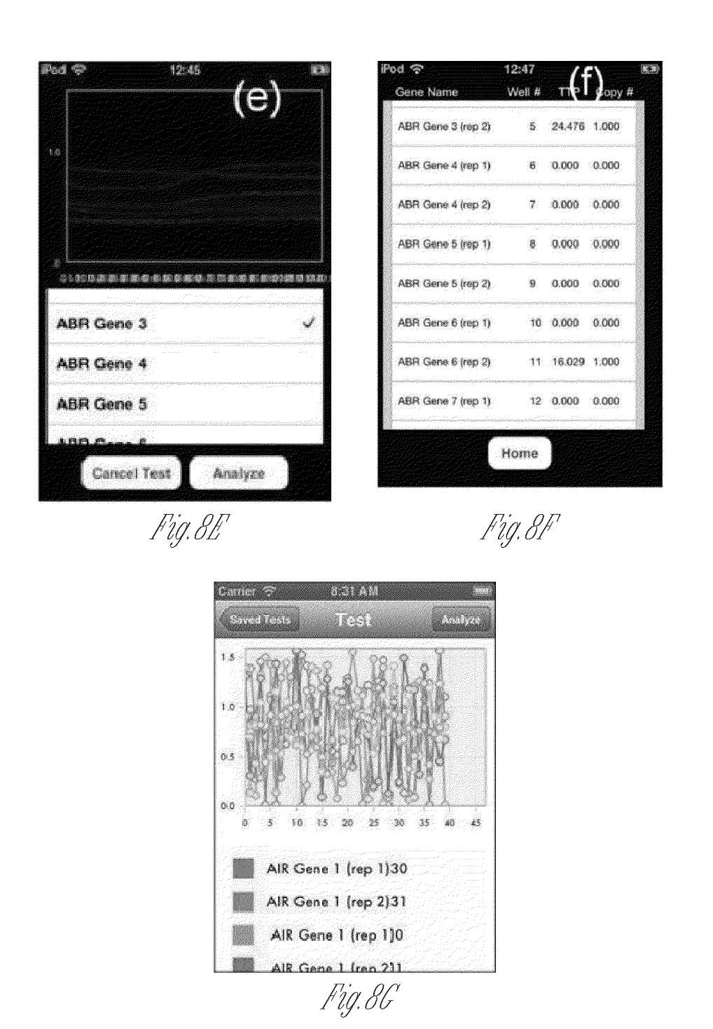

Thus, a compact, user-friendly and inexpensive point of contact device was made during the development of the present inventions that is contemplated for use to rapidly screen for dozens of genetic markers with high sensitivity and specificity (for example, see FIGS. 11, 13). Key enabling technologies included: LAMP for highly specific amplification at a single temperature and with high yield, a low-cost fluorescence sensor, disposable polymer microfluidic chips for multiplexed detection, and a wireless user interface module having a Smartphone application for automated data analysis and reporting.

For real-time monitoring of isothermal assays, the devices can have fluorescence detection capabilities that do not rely on turbidity measurements because fluorescence detection provides faster detection of nucleic acid amplification in the device. The devices also do not require expensive interference filters and lenses, which were typically used in fluorescence detectors for real-time PCR. However the inventors' found that many of the fluorescent molecules inhibited LAMP amplification. Therefore the inventors also tested several fluorescent molecules and discovered a few, such as SYTO-81, that showed little or marginal inhibitory effects on LAMP in the inventors' assays when used up to concentrations of 20 μM.

To monitor the 64 reaction wells, a scanning LED light source and single spot detector were implemented. More specifically, an LED and optical fiber was assigned to each reaction well. To read the different reaction wells, LEDs are lit one at a time and emitted fluorescence from each well transferred to the photodiode through the optical fibers. This sensor is highly robust since the LEDs and optical fibers are integrated in the chip holder, which eliminates alignment issues. Furthermore, due to the use of optical fibers, the components could be readily packaged in a small device owing to flexibility in terms of positioning the photodiode with respect to the chip. Overall, the optical unit in the devices for sensing of multiple reaction wells is simple, inexpensive and compact, compared to systems that typically use multiple lenses, filters, and individual detectors assigned to each reaction well.

In summary, fully functional and externally packaged point of contact devices for genetic testing have successfully been developed as described herein. Compared to commercially available devices for isothermal amplification, the devices provide higher multiplexing (i.e. a larger number of different types of nucleic acid can be detected) at lower cost in a compact and lightweight package, i.e. hand held device. The devices can be operably linked or integrated with a variety of smart devices (such as smart phone), include a simple user interface, and have an internal rechargeable battery for applications outside of a laboratory.

To the inventor's knowledge, there are no wireless devices for genetic testing that provide the level of sensitivity, fast amplification reaction time, accurate result analysis, ease of use, and simplicity in a format as compact and inexpensive as an embodiment of the devices described herein.

Several exemplary embodiments are described herein for making a device of the present inventions. Exemplary parts for use in a hand held nucleic acid sequence amplification device of the present inventions are described herein although are not meant to be limiting. Any part or material that would provide the results reported herein is included. Specifically, embodiments for an exemplary heating unit and chip holder, a multichannel fluorescence sensor, custom circuit boards and components are described herein.

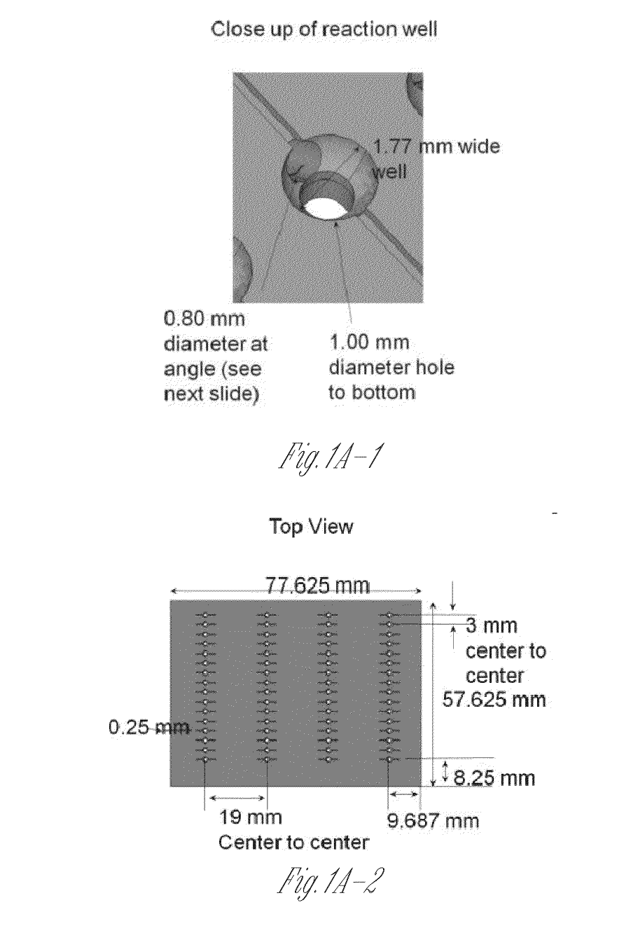

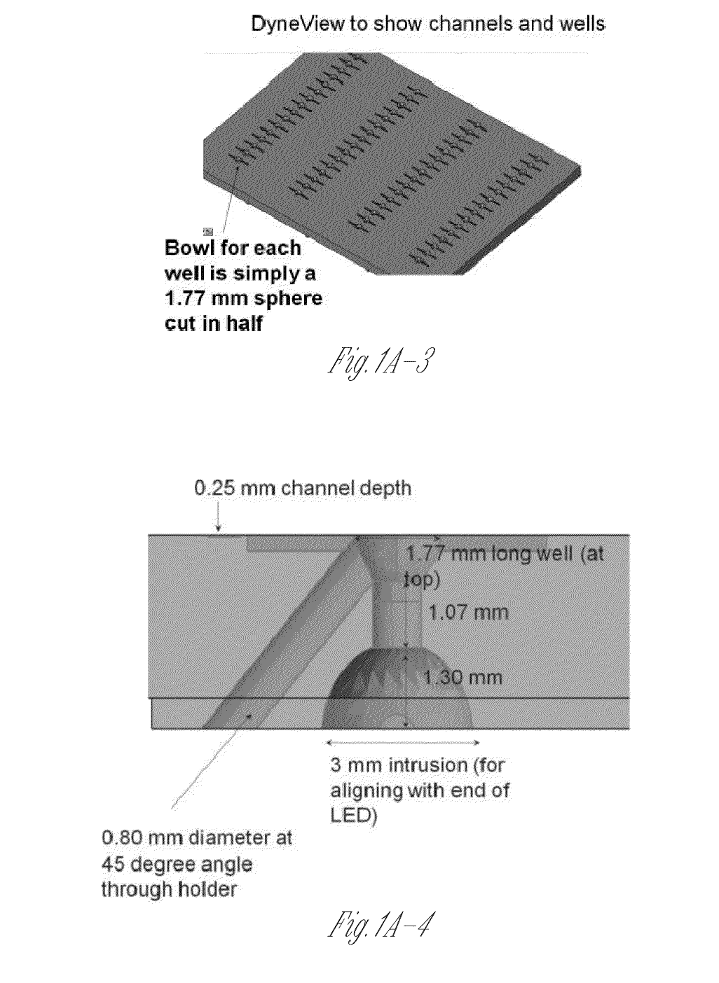

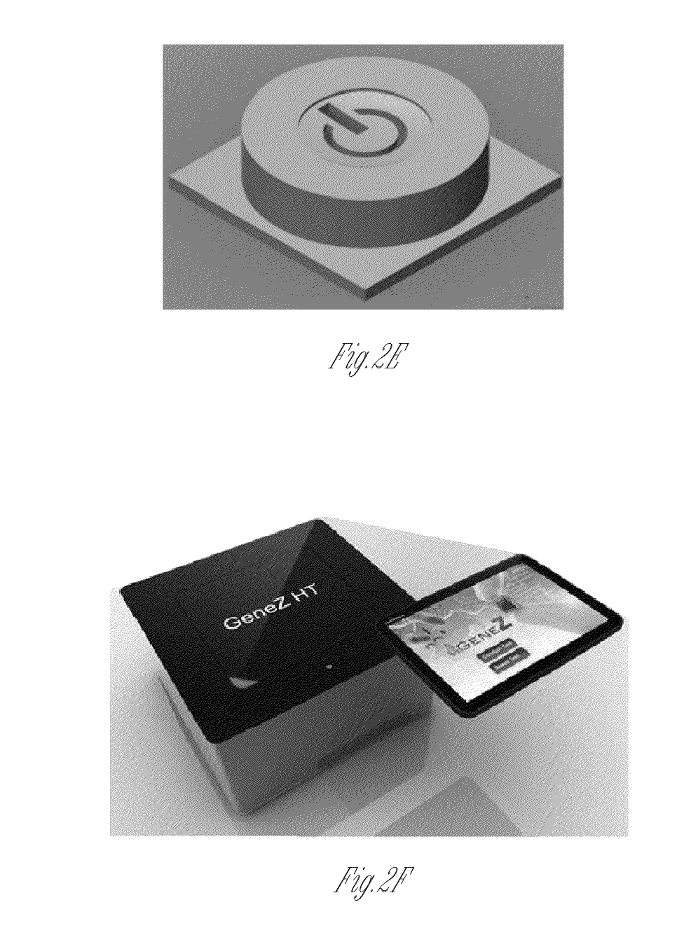

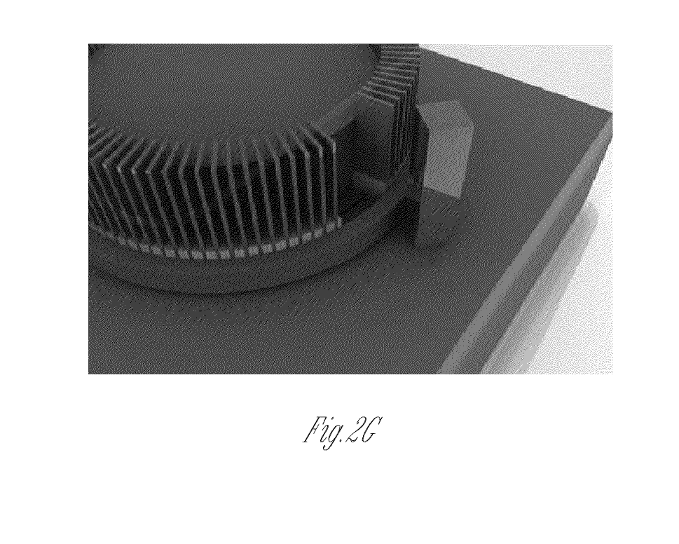

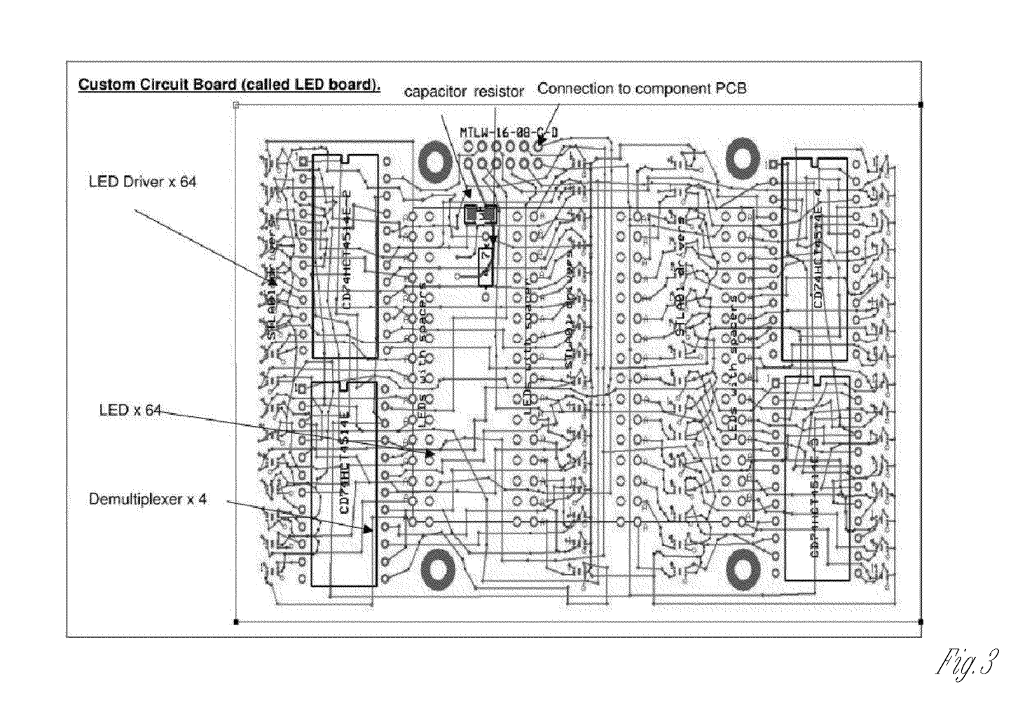

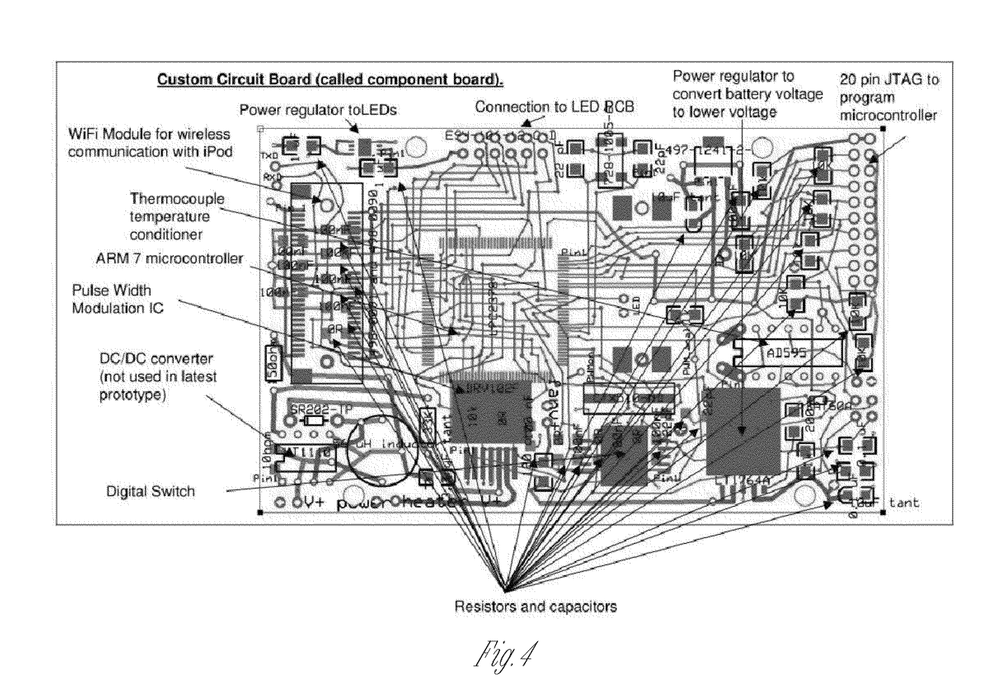

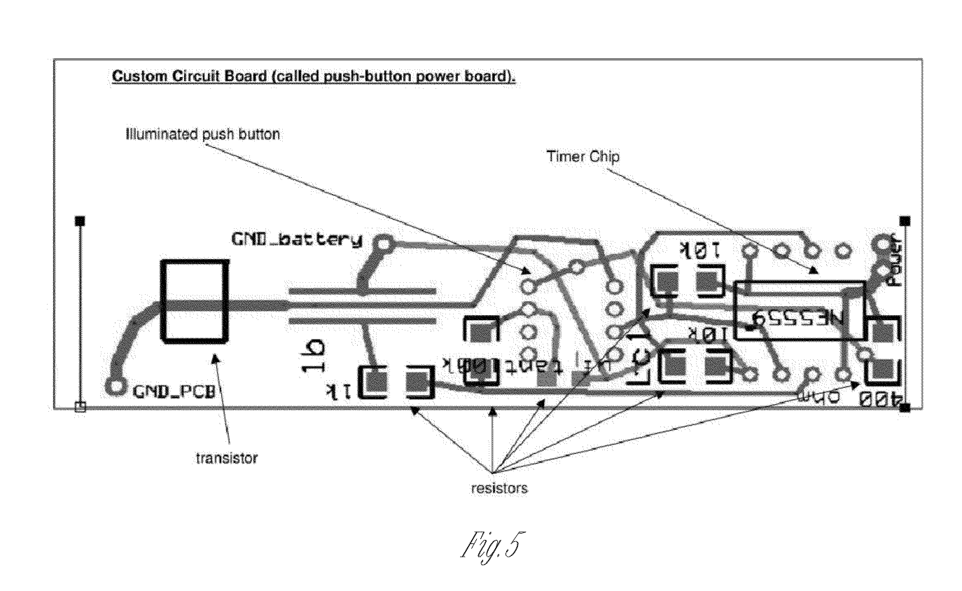

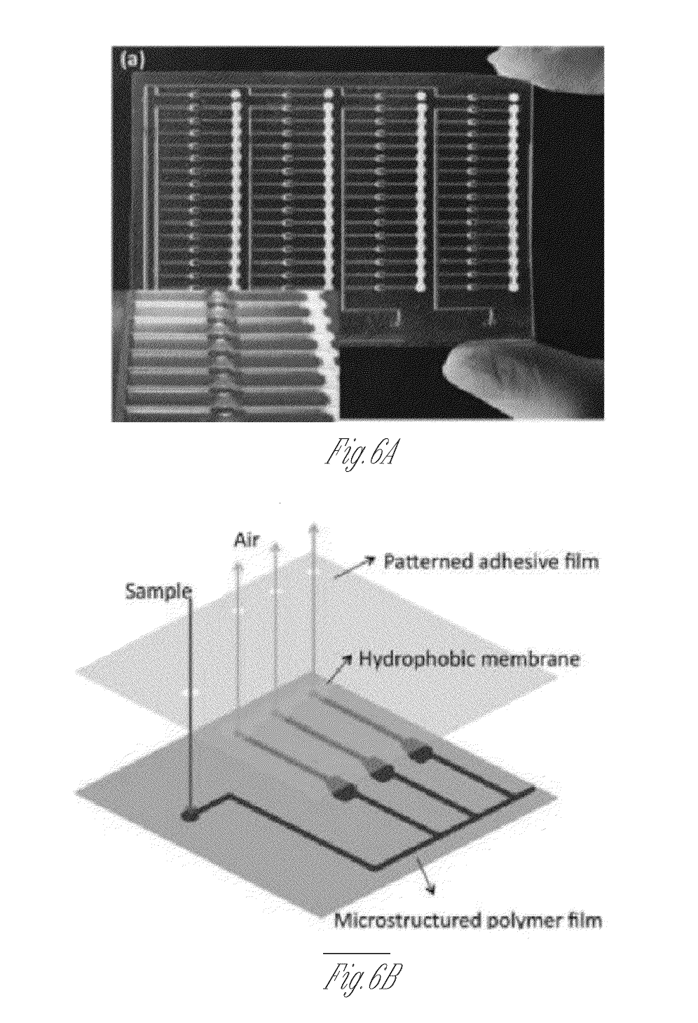

Additionally, the inventors contemplated several types of cases and configurations for use in making devices of the present inventions. For example, diagrams of exemplary cases for a variety of devices, see, FIGS. 1-9, 21, 36-38.

Smart devices are contemplated for use with devices of the present inventions. Further, such a device that comprises wireless connectivity for communicating results of genetic testing would be desired under certain conditions, such as hospitals with centralized databases containing patient records. In one Embodiment, a Gene-Z™ Device was made comprising an Apple device, i.e. iPod Touch, for use in point of care genetic testing. In one exemplary embodiment, an iPod Touch with custom applications was used with a device of the present inventions (FIGS. 8, 21A). In other embodiments, the device can be operably linked to an iPhone, Droid, Droid clone, Tablet device, or other Apple device or a smart device. In other words, the devices described herein can be operably linked to any device capable of providing contemplated desired capabilities, such as receipt and transmission of positive or negative results. Transmission of positive and/or negative results can be through wireless data communication, such as texting, numerical transmissions, using a telephone function for oral transmission of results, and other types of data gathering and transmission application such as GPS positioning, etc.

B. Use of Highly Fluorescent Dyes to Obtain High SNR in Gene-Z™.

Numerous dyes were tested for their level of sensitivity for use in devices and methods of the present inventions. Thus, an exemplary method was used for the detection of Mycobacterium tuberculosis and other pathogens by fluorescence-based real-time loop-mediated isothermal amplification. This method used a conventional real time PCR machine along with 20 μl reaction volumes in contrast to using a device of the present inventions in methods of the present inventions using and reaction volumes in the range of 2 μl.

Loop-mediated isothermal amplification (LAMP) is monitored in real-time by measuring the increase in fluorescence of DNA binding dyes. However, there is little information about the effect of various fluorescent dyes on signal to noise ratio (SNR) or time threshold (Tₜ) which are parameters needed for use in increasing the sensitivity of LOOP assays. This information can significantly reduce the time it takes to identify the presence of a target DNA or microRNAs sequence. In particular, reduced detection times are of use for field-deployable diagnostic tools. Additionally, developing methods resulting in increased signal strength of results may be of use to decrease the time of assays providing identification of pathogens or disease related gene expression, in addition to lowering the cost of making detection devices, for example, reducing the cost of optics used in these detection devices.

As described herein, at least eleven fluorescent dyes were evaluated for their effect on the Signal-to-noise ratio (SNR) and threshold time (Tₜ) during real-time microRT_{f}-LAMP assays. Of dyes tested, SYTO-81 and SYTO-82 resulted in the desired shortest Tₜ. This exemplary optimized LAMP protocol was then successfully used to detect 10 genome copies of Mycobacterium tuberculosis in less than 10 min, 10 copies of Giardia intestinalis in about 20 min, and 10 copies of Staphylococcus aureus or Salmonella enterica in less than 15 min. Results demonstrated that reaction efficiency depended on both dye type and concentration. During the development of methods of the present inventions, a preliminary step provided increased detection sensitivity and increased quantitative accuracy where primers and the target DNA were pre-hybridized prior to the addition of Bst polymerase. For some of the targets, this additional step resulted in better sensitivity and quantification ability, and shorter Tₜ values. Because the LAMP reaction is isothermal, this reaction is less affected by environmental conditions and inhibitors, and is more cost effective compared to the use of traditional polymerase chain reaction (PCR) enzymes such as the TAQ polymerase. LAMP-based assays are already the method of choice for the detection of pathogens in low resource settings. Real-time monitoring of LAMP can be performed by measuring the increase in turbidity or the increase in fluorescence of double-stranded DNA (dsDNA) binding dyes in the reaction mixture Gill and Ghaemi, (2008), Nucleosides Nucleotides Nucleic Acids. 27:224-243. The time threshold (Tₜ, defined as the time at which the fluorescence or turbidity crosses a predetermined cut-off signal) is directly related to the amount of target sequence copies, which permits accurate quantification through the use of standard curves. Fluorescent dye-based real-time LAMP has sensitivity similar to turbidity-based LAMP but is generally faster (shorter Tₜ). This is illustrated by several studies showing that LAMP detection time can be reduced by up to 35% when monitoring fluorescence rather than turbidity Chen and Ge, BMC Microbial. 10:41 (2010); Han and Ge, Int. J. Food Microbial. 142:60-66 (2010). Fluorescence-based real-time LAMP can be performed in any conventional microbiology laboratory equipped with a real-time PCR thermocycler. Additionally, high amplification yields and the isothermal nature of LAMP make it well suited for integration with simple diagnostics devices in limited-resource settings Ahmad, et al., (2011), Biomed. Microdevices 13:929-37; Seyrig, et al., (2011), Environmental Microbiology: Current Technology and Water Applications.

While the optimal conditions required for endpoint LAMP are well described using other devices, such optimal conditions were previously not available for microfluidic devices such as those described herein. The following provide a systematic examination of conditions specific to real-time fluorescence detection for increasing the sensitivity of nucleic acid sequence detection. Seyrig, et al., (2011), Environmental Microbiology: Current Technology and Water Applications; Mori and Notomi, (2009), J. of Infection and Chemotherapy. 15:62-69; Notomi, et al., (2000), Nucleic Acids Res. 28:e63; Tomita, et al., (2008), Nat. Protoc. 3:877-882.

Several dsDNA-intercalating dyes were used for LAMP but the reaction conditions and their performance varied significantly among studies. For examples, SYBR Green I, SYTO-9 and YO-PRO-I were used in various LAMP studies for pathogen detection (e.g., S. enterica, Leptospira, hepatitis B virus) with a detection limit of about 10 copies of target DNA but with reaction times ranging from ten minutes to more than one hour. Reaction conditions such as dye concentration, use of a pre-hybridization step, sample type, primer number (four to six), or incubation temperature varied significantly among these published studies. This variability reduced the ability to establish a valuable dye comparison for real-time LAMP assays. For quantitative PCR, it was known that certain dyes allow shorter detection time and higher sensitivity. For example, SYTO-82 was shown to not inhibit qPCR and allowed a 50-fold better detection limit compared to SYBR Green I when used with thermal cycling methods.

Eleven dsDNA binding dyes, including several SYTO dyes and SYBR Green I, were compared using LAMP. The effect of the concentration of each dye was evaluated with a LAMP assay for M. tuberculosis and a constant concentration of target DNA. The sensitivity of LAMP was then examined using the dye and concentration that resulted in the shortest detection time. Assay sensitivity was evaluated with four pathogens including M. tuberculosis and S. enterica. Results showed that the choice of dye and particularly its concentration has a significant effect on the LAMP detection time. See, Example V, embodiments for development of methods for enhancing the sensitivity of nucleic amplification detection through the use of certain fluorescent molecules (dyes).

During the development of the present inventions the inventors also discovered and demonstrated that a one minute pre-incubation of the primers with the target DNA at 95° C. prior to the addition of the polymerase (which would be denatured at this temperature) improved assay sensitivity for certain targets. This additional step resulted in a pre-hybridization of the primers with the target sequence that decreased the time of reaction at which an amplification signal was detected.

C. Use of Multiple Virulence and Marker Genes (VMGs) to Enhance Detection Specificity and Carry out Multiplexed Detection.

An exemplary method was used for the detection of Mycobacterium tuberculosis and other pathogens by fluorescence-based real-time loop-mediated isothermal amplification. The inventors developed the following exemplary methods that were shown to reduce the time required for identification of positive reactions using real-time LAMP (RT-LAMP), comprising a highly fluorescent dye DNA binding (SYTO 82), compared to that of real-time PCR instruments. Starting from genomic DNA mixtures, the chip designed during the development of the present inventions was successfully evaluated for rapid analysis of multiple virulence and marker genes of Salmonella, Campylobacter jejuni, Shigella, and Vibrio cholerae, enabling detection and quantification of 10-100 genomes per microliter in less than 20 minutes. The inventors contemplate the use of a microfluidic chip of the present inventions in combination with the imaging system of the present inventions would find use as an inexpensive and portable system for on-site screening of pathogens relevant to food and water safety as described in part, below.

Microfluidic chips with a multitude of separate reaction wells, each containing primers for amplification of a specific pathogen and/or VMG, provide a promising platform for multiplexed detection in inexpensive, user-friendly and compact devices (see, e.g., McCalla and Tripathi, Annu Rev Biomed Eng. 13: 321-43 (2011)). While a myriad of such chips have been developed over the years, based on PCR and, more recently, isothermal techniques for DNA/RNA amplification (for a review, see Asiello and Baeumner, Lab Chip. 21:1420-3(2011)), robustness and simplicity-of-use have often not been given due consideration. To be suitable for deployment outside traditional laboratory settings and operation by minimally-trained personnel, dispensing of sample should require a single, or at most a few, manual steps, without using bulky off-chip equipment. In many cases, however, either manual loading of sample in a limited number of individual wells was necessary Fang, et al., (2010), Anal. Chem. 83:690-695, or peripheral equipment needed for loading of high throughput multi-well chips Matsubara, et al., (2004), Anal. Chem. 76:6434-6439 and propagation of sample through an interconnecting microfluidic network Lutz, et al., (2010), Lab Chip. 10:887-893. Furthermore, fabrication of the chips often involved surface treatment of the hydrophobic polymers used as substrate for bonding, robust filling, to prevent formation of air bubbles and/or improve biocompatibility Fang, et al., (2010), Anal. Chem. 82:3002-3006; Steingart, et al., (2006), Lancet Infect. Dis. 6:570-581. However, this adds to the complexity of fabrication and cost of the chips, but also has the drawback that surfaces modified by techniques such as oxygen plasma and UV/ozone treatment remain hydrophilic within several hours after exposure to air.

Hence, a polymer microfluidic chip for nucleic acid amplification was developed that enabled parallel detection of multiple pathogens and/or VMGs. Since the chip contained pre-dispensed and dehydrated primers it required a single pipetting step for dispensing of the sample. Thus the chip is contemplated for deployment outside the laboratory and by minimally skilled technicians. In other embodiments, additional reagents are freeze-dried in the chip, such as isothermal amplification buffer, primers or other oligos for use in detection and/or amplification,. To demonstrate the utility of the chips, LAMP was selected as the amplification enzyme because of its robustness, and high sensitivity and specificity. In addition for using with LAMP assays, a chip of the present inventions is capable of accommodating other isothermal amplification techniques, such as helicase-dependent amplification or recombinase polymerase amplification, see for example, helicase assays in Gill and Ghaemi, (2008), Nucleosides Nucleotides Nucleic Acids. 27:224-243; Piepenburg, (2006), PLoS Biol. 4:e204; Vincent, et al., (2004), EMBO reports. 5:795-800. Since each reaction well was effectively sealed using a pair of micro-valves, the chip is contemplated for use with PCR methods, which are typically more prone to cross-contamination between wells and evaporation of liquid from wells due to the need for a high temperature denaturation step and thermal cycling.

For rapid detection and quantification, LAMP was performed with a highly fluorescent DNA binding dye and monitored in real-time using a low-cost CCD imager. The microfluidic chip and imaging system could be integrated in a stand-alone device and combined with off-chip sample processing to provide a complete system for detection for water- and food borne pathogens. Due to the robustness of LAMP, sample purity was less critical than it was for PCR, which should enable less complex sample preparation that could be more easily performed on-site. Another option was to integrate cell lysis and nucleic acid purification on-chip using a variety of microfluidic methods developed over the years Kim, et al., (2009), Lab Chip. 9:606-612, some of which have recently been coupled with LAMP for detection of infectious agents in clinical samples Wu, et al., (2011), Biotech. J. 6:150-155. Many of these techniques can also be readily integrated in inexpensive polymer chips that can be fabricated using inexpensive prototyping techniques, such as the one described here. Initial processing and concentration of the sample may be most challenging to translate into micro-scale systems due to the large amount of sample (10-1000 liters of water or 10-100 grams of food) that was needed for reliable analysis. Due to its ability to analyze multiple pathogens and VMGs in parallel, the microfluidic chip was especially attractive when combined with sample concentration methods that can effectively concentrate different classes of microbes, using either filtration techniques for water or enrichment of food borne pathogens using short-term culturing. With further development and validation, the microfluidic chip could find application in many areas where rapid and reliable detection of multiple microbial pathogens is required, at low-cost and without using cumbersome equipment.

The inventors developed the following exemplary methods that were shown to reduce the time required for identification of positive reactions using real-time LAMP (RT-LAMP), comprising a highly fluorescent dye DNA binding (SYTO 82), compared to that of real-time PCR instruments. In one embodiment, the chip was used for real-time fluorogenic loop-mediated isothermal amplification. In another embodiment, the chip was used for quantitative detection of water borne pathogens. In another embodiment, the chip was used for quantitative detection of food borne pathogens. In yet another embodiment, the chip was used for detection of multiple pathogens. In yet another embodiment, the chip was used for detection of microRNA. In yet another embodiment, the chip was contemplated for use with medical diagnostic tests. In yet another embodiment, the chip was contemplated for use with point-of-care diagnostic tests.

### Making and Using Microfluidic Chips.

During the development of the devices of the present inventions, the following microfluidic chip was developed. In a preferred embodiment, the chip was used in methods of the present inventions comprising an amplification device as described herein. The inventors developed an easy-to-use and rugged (could be performed with good replication by multiple users) polymer microfluidic chip for multiplexed pathogen detection that unlike other chips i) entailed a single step for dispensing of sample into the chip using a common pipettor and ii) required no surface treatment for fabrication and functionality of the chips. The chip was contemplated as being capable of rapid and inexpensive prototyping at or near the bench top. A chip considered to have the primary characteristics for use with the present inventions was fabricated out of multiple layers of biocompatible polymer film and contained 15 interconnected reaction wells containing dehydrated primers. The utility of the chip was evaluated for parallel detection of multiple food- and waterborne pathogens using loop-mediated isothermal amplification (LAMP) as described in detail in the section below on the use of the chip. LAMP was a technique in which four to six specific primers were employed for amplifying DNA with high yield at a constant temperature of 60-65° C. Notomi, et al., (2000), Nucleic Acids Res. 28:e63. Owing to its simplicity, robustness and low equipment cost, LAMP method techniques used for diagnosis of infectious diseases in low-resource settings was the preferred method Mori and Notomi, (2009), J. of Infection and Chemotherapy. 15:62-69. LAMP based amplification was contemplated to serve as a powerful method for detection of food- and waterborne pathogens Lucchi, et al., (2010), PLoS One. 5:e13733; Yamazaki, et al., (2008), J. Med. Microbial. 57:444-51. For quantification of target DNA, LAMP was monitored in real-time using an inexpensive charge coupled device (CCD) based imaging system, briefly described in the Examples, such as Example XVIII.

D. Quantifying MicroRNAs using Isothermal Amplification on Gene-Z™.

Rapid point of care (POC) genetic testing for cancer markers offers minimally invasive alternatives to biopsies and routine examinations. Methods for earlier detection of certain types of cancer would provide information allowing faster initiation of treatment. Additionally, rapid, simple, and low cost measurement of cancer markers is contemplated for use in collection of data necessary for establishing new markers. For example, certain circulating, tumor-derived microRNAs in serum and plasma were studied as biomarkers for cancer Kanemaru et al., J Dermatol Sci. 61:187-93 (2011); Liang et al., BMC Genomics 8:166 (2007); Mitchell et al., Proc Natl Acad Sci USA. 105:10513-8 (2008); Ruepp, et al., Genome Biology 11(1): R6 (2010); Tricoli and Jacobson, Cancer Res. 67:4553-5 (2007).

Methods currently available for quantification of microRNAs include quantitative reverse transcriptase PCR, microRNA arrays, northern blots, stem loop RT-PCR, comparative genomic hybridization, in situ hybridization, and deep sequencing. These methods in general require expensive instruments and/or skilled analytical expertise. For example, measuring a panel of microRNAs by quantitative PCR (which was superior to existing methods in terms of quantitative abilities and time to result) was estimated to cost $100-$500 per sample. Similarly, a microRNA array analysis was estimated to cost $1,000 per sample, provide relative expression and require hours for sample preparation and hybridization, not including additional time for analysis of results. Isothermal amplification based quantification of microRNAs was contemplated to facilitate rapid and cost effective measurement of microRNAs. For example, quantitative detection of one or a few dozen microRNAs specific to a given type of cancer (e.g., miR-141 for prostate cancer) using a device of the present inventions, such as a Gene-Z™, is contemplated as a powerful tool for cancer screening.

One novel approach for quantification of microRNAs by isothermal amplification was demonstrated using the POC nucleic acid amplification device named Gene-Z™. Using this method, it was possible to detect 10⁹ copies of microRNA per well within 10 min and 10² copies per well in less than 50 min. This simple and specific POC-based technique represents a major step forward for rapid non-invasive screening of microRNAs as cancer markers.

However challenges remained such as: i) how to eliminate or minimize sample preparation, and ii) how to specifically amplify a 22 bp microRNAs using an isothermal amplification approach. In order to overcome these challenges, methods were developed during the development of the devices of the present inventions showing a novel method based on ligation of a 180 bp DNA extension to allow specific detection of microRNAs using loop-mediated isothermal amplification. See Examples, such as Example VII for exemplary embodiments of methods including the novel ligation of a 180 bp DNA extension for specific detection of microRNAs.

E. “Sample Digitization” Using a Novel Airlock System to Allow Multiplexing.

The inventors contemplate a variety of microfluidic chips for use with the devices of the present inventions. For example, the chips can contain an “airlock” system to facilitate retention of primers and other desirable materials within chip reaction wells during sample loading and other manipulations.

Overall the airlock mechanism works as illustrated in FIG. 45. As shown in FIG. 45A liquid flows in the slanting channels and bifurcates into left and right channels. FIG. 45B shows that the liquid starts to fill in the reaction well and continues to move into the channel on the right. FIG. 45C shows that as the well fills with sample, the liquid on the right side channel nearly reaches the junction of confluence. FIG. 45D shows that the liquid completely fills the well and part of the channel subsequent to the well but cannot proceed further because the liquid stream from the right reaches the junction ahead of the liquid coming from the well. An air pocket on the left is locked (airlock) between the stream from the well and the junction. FIG. 45E illustrates the result, which is a valve-less equal distribution of sample into multiple wells without primer carryover to subsequent wells.

Thus, the reaction wells contain the components needed to generate an amplification signal, and those components do not migrate out of the reaction wells so that the signal remains localized within the reaction wells. The sample chambers allow the passage of light emissions for providing a fluorescent signal corresponding in intensity to the concentration of fluorophore incorporated into the biological sample (e.g. the within the amplification product).

In one embodiment, the material used in the fabrication of microfluidic chips were PMMA sheets (Poly(methyl methacrylate)) (McMaster, Chicago, Ill., USA) with the thickness of 1.6 mm. A commercially available desktop CO₂ laser system (Full Spectrum Laser LLC, Las Vegas, Nev., USA) was used in the micromachining The maximum output power of the laser is 40 W, and the cutting power and speed can be varied from 0% to 100% by RetinaEngrave USB, a controlling software developed by the laser supplier. The laser supports two machining modes: vector cutting and raster engraving. In vector mode, the laser traces vector drawing data such as lines, polylines, and curves which allows cutting or carving thin channels on PMMA. In raster engraving mode, the laser sweep left to right like a jet printer which allows the engraving of an area in a bitmap image. In this work, the reaction wells are fabricated by engrave mode with 45% power and 20% speed; and the micro-channels are cut by vector mode with 30% current, 20% speed and a various power (5%-65%) for different channel depth.

In another embodiment, polymeric chips are fabricated by hot embossing as described in Example XVI.

In one embodiment, such chips would compromise lyophilized primers for isothermal amplification. Methods for providing on-chip primers would be compatible with the chips used by a genetic analyzer devices, and would include dispensed primers. Dispensed fluids are in the micro to nanoliter range. Methods for providing dispensed primers are contemplated to be based upon robotics mechanisms and would comprise dispensing pre-synthesized primers, such as provided in a “whole chip” sleeve for dispensing into a chip. For example, primer dispensing into low-density chips would be manual or by hand-held pipetter or small machine for dispensing primer sets. In one embodiment, the primers are dispensed into each sample chamber, then lyophilize for adhering primers to chamber, wherein the primers would be released upon contact with fluid. In one embodiment, a dispensing mechanism is used for dispensing primers into sample chambers. In a further embodiment, said dispensing mechanism is used for dispensing buffer, DNA polymerase plus reaction components with or without primer and with or without sample. Examples of such a dispenser mechanism are described in U.S. Patent Appln. No. 2003175163 and U.S. Pat. No. 6,079,283; all of which are herein incorporated by reference.

F. Use of Exposure Control on CCD to Enhance SNR.

Rapid RT-LAMP assays were performed on COP microchips in comparison to a commercial real-time PCR instrument. Increasing the CCD exposure time up to 5s, increased the SNR by 8-fold and reduced the Tt values from 2.7 min to 9.8 min for 10⁵ starting DNA copies of microRT_{f}-LAMP assays. Additionally, microRT_{f}-LAMP assay allowed the analysis of low sample volume of 2 microliter in less than 20 min with a detection limit of single DNA copy. Due to requirements of single temperature incubation, microRT_{f}-LAMP assays have the potential to be translated into rapid and low cost battery operated molecular diagnostic devices, suited to applications in resource-limited settings. In some embodiments, methods were developed of optimizing the detection of pathogens.

### EXPERIMENTAL

The following examples are provided in order to demonstrate and further illustrate certain preferred embodiments and aspects of the present invention and are not to be construed as limiting the scope thereof.

In the experimental disclosure which follows, the following abbreviations apply: ° C. (degrees Centigrade); mm (millimeters); nm (nanometers); t (micrometer); U (units); V (volts); sec (seconds); min(s) (minute/minutes); hr(s) (hour/hours); PCR (polymerase chain reaction); RT (reverse transcription); RT-PCR (reverse transcription PCR); LAMP (loop mediated isothermal amplification).

### Example I

The following describes exemplary parts for use in making and using a hand held nucleic acid sequence amplification device of the present inventions. Specifically, exemplary parts that are combined include custom designed heating units and chip holders are described.

A temperature-controlled non-transparent chip holder was developed for use in a device of the present inventions (FIG. 1-2). The aluminum heater served to provide the desired chip temperature and to encompass a shell-structured chip reaction wells (described herein) to prevent optical cross-talk between reaction wells. The LAMP reaction works isothermally at a constant temperature between 60 and 65 degrees C. This five-degree window allowed some variation to control the assay. Since the reaction proceeded at a single temperature, amplification was much faster than PCR, where a large amount of time was lost waiting for the heater to reach required cycling the temperature from 95 to approximately 60 degrees C. For repetitive correct alignment of the optical components with removable and disposable chips, an aluminum holder was machined with negative chip features. The aluminum holder served to obtain the desired chip (sample) temperature and to encompass (i.e. embed) the shell-structured reaction wells to prevent optical cross-talk (as described in more detail below). The aluminum heater was fabricated by Zero Hour Parts (Ann Arbor, Mich.) and electrical resistance tape (FTP00081, Tempco Electric Heater Corporation, Wood Dale, Ill., 60191, USA) was attached to the bottom for heating.

The thermocouple used in the current device of the present inventions was a type K thermocouple with a 0.004″ sheath diameter with a specified response time of approximately 100 ms (5SRTC-TT-K-40-36, Omega).

LEDs and optical fibers were then embedded and attached (i.e. by epoxy) into the bottom of the aluminum heater (FIG. 2).

The following describes a multichannel fluorescence sensor for use in a device of the present inventions.

In one embodiment, the fluorescence sensor consisted of 64 individually addressable green LEDs (RL3-G4518; Super Bright LEDs, St. Louis, Mo., USA) for excitation, 64 polymer optical fibers with a core diameter of 0.75 mm (IF C U750; Industrial Fiber Optics, Tempe, Ariz. razor cut and diamond polished) for collection of emitted fluorescence, and a single blue/green enhanced photodiode with a built-in 500M photovoltaic amplifier (ODA-6WB-500M; OptoDiode, Newbury Park, Calif., USA) for fluorescence measurements.

In other nucleic acid amplification devices lenses are used for amplifying low levels of signal in reaction wells before detection measurements are made, for example, when detecting low levels of fluorescence in reaction wells. However, due to artifacts from amplification, the inventors contemplated direct measurements of signal. Therefore, the inventors placed LEDs directly below the reaction wells for direct illumination of samples in wells in optical alignment with the end of the optical fibers butted against the reaction wells (FIG. 2). Further, in order to overcome the problem of excessive amounts of LED light from reaching the photodiode, the optical fibers and LEDs were oriented at a 135° angle (or 45° angle depending upon the measured angle). When this configuration was used, a simple 590 nm colored glass filter (NT54-658; Edmund Optics, Barrington, N.J.) was sufficient to reduce signal reaching the photodiode due to emitted LED light that was well below the baseline signal (background) of a LAMP reaction.

Low intensity LEDs (0.3 lumen) were preferred over ultra-bright LEDs (700 mA, green 145 lumen 530 nm Lambertian Luxeon V Star LED (LXHL-LM5C, LED Supply). While both yielded an identical detection time (FIG. 24B), the 0.3 lumen LEDs were more compact, less expensive and consumed less power. To determine the minimum amount of time required for accurate readings of each reaction well, signal acquisition settings, i.e. number of samples to read per measurement and the sampling rate, were adjusted, and signal was measured from a chip filled with amplified LAMP product. It was observed that a sensing time of roughly 100 ms was sufficient to achieve highly reproducible detection (FIG. 24A). Thus, a 200 ms sensing time was used to acquire signal from each well using one embodiment of a device of the present inventions, i.e. a Gene-Z™ device of the present inventions. Overall, this measurement was important in that it allowed us to determine how quickly we could read each of the 64 reaction wells, and then read them again. For example, when it takes 5 seconds to reliably read a reaction, then it would take 5×64 seconds before another measurement could be taken for the same well. In this case, there was more time between each reaction, and fewer points available to plot the amplification curve. PCR machines do not have a similar scheme for detection. In general they either use a CCD for detection (instead of a single photodiode as in a device of the present inventions), or other devices use a photodiode they use several photodiodes unlike the one of the present inventions. In other devices that have photodiodes then it is not stationary as in a device of the present inventions but moves one photodiode over several reaction wells instead of using optical fibers as in the present inventions. In one embodiment, instead of placing an optical fiber below and in the same plane as the LED, the optical fibers were placed directly above the reaction well, in which case, a high band bass emissions filter (610 to 630 nm) was used to capture emitted fluorescence representing amplification in the reaction wells. In one embodiment, optical fibers were replaced with a single piece of PMMA that acted as a waveguide between the various reaction wells and the single photodiode.

### Example II

This example describes some embodiments of custom circuit boards and components used or contemplated for use in making a nucleic acid amplification device.

Custom printed circuit boards (PCBs) were drawn using Express PCB free software and fabricated by Express PCB. Three separate custom PCBs are used inside of a Gene-Z™ device, specifically a push-button power circuit board, a LED circuit board and a component circuit board.

The push-button power circuit board (PCB) was designed to allow the user push button power control of the device. When the external button (located within or on the external casing) is pressed once, the ground connection between the battery (9 to 12 volt output) and component PCB is connected. This PCB also powered the Wi-Fi module and the microcontroller, located on the component board described below. Once the heater reached a desired temperature, the microcontroller communicated with components for obtaining fluorescent measurements.

In one embodiment, after the microcontroller is powered on, the microcontroller then waits for a signal from the iPod. Once the signal from the iPod is received, the microcontroller tells the digital switch to turn on the PWM module (which is connected to the 16 to 20 volt output from the battery), which subsequently drives the heater to a set point temperature. If the button is pressed again, the device will be turned off.

The LED PCB has 64 LEDs to match each of the 64 drivers to equally power each LED, and 4 different multiplexors to allow communication of 64 LEDs using 8 digital output lines from the microcontroller for each row of 8 LEDs. A 12 pin connection between the LED board and the component board, described below, was used to both power the LEDs and for automated communication between each LED and the microcontroller.

The component circuit board had a microcontroller, a Wi-Fi module for wireless communication, a JTAG plug-in port for programming the microcontroller, three separate power regulators to provide correct voltage to different components, a pulse width modulation (PWM) integrated circuit for precise control of the heater, a digital switch for powering photodiode and the PWM, and a signal conditioner for reading temperature from the rapid response thermocouple. After the heater reached the desired temperature, fluorescent measurements were streamed wirelessly to an iPod touch, where the measurements were automatically sorted and analyzed using the computational ability of the iPod in a custom application.

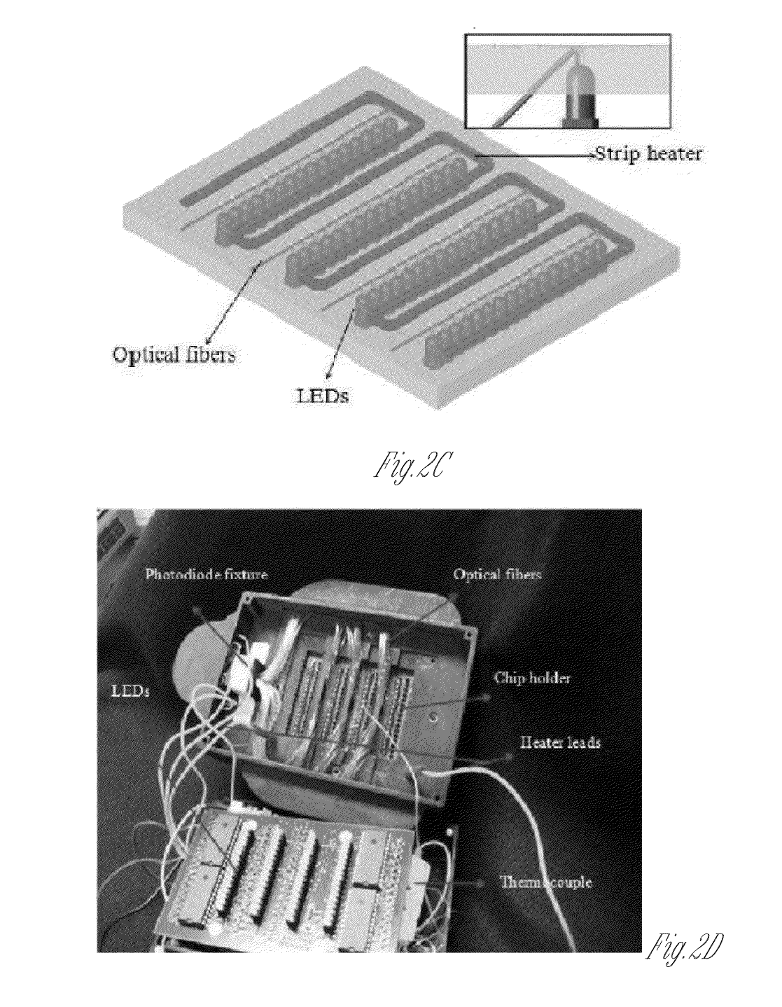

Each circuit board made consisted of four separate layers including a top and bottom layer for traces (electrical and signal lines), a ground layer, and a power layer. Table 1 shows an exemplary list of components and sources. A number of resistors and capacitors were also used for the various component circuits and can be found in the sketches in FIGS. 3-5, 7. The green lines represented copper placement on the bottom of the board. The red lines represented copper placement on the top of the board. The black lines are for reference to the person soldering the components.

“Custom printed circuit boards (PCBs) were drawn using Express PCB free software and fabricated by Express PCB. Three separate custom PCBs are used inside a Gene-Z™ device. One PCB has 64 LEDs, 64 drivers to equally power each LED, and 4 different multiplexors to allow communication of 64 LEDs using 8 digital output lines from the microcontroller. The microcontroller (ARM 7 architecture) is on the custom printed circuit board referred to as component PCB. This PCB also has a Wi-Fi module for wireless communication, a JTAG plug-in port for programming the microcontroller, three separate power regulators to provide correct voltage to different components, a pulse width modulation (PWM) integrated circuit for precise control of the heater, a digital switch for powering photodiode and the PWM, and a signal conditioner for reading temperature from the rapid response thermocouple. A 12 pin connection between the LED board and the component board is used to both power the LEDs and for automated communication between each LED and the microcontroller. The power board PCB was designed to allow push button power control. When the button is pressed once, the ground connection between the battery (9 to 12 volt output) and component PCB is connected. This powers the Wi-Fi module and the microcontroller, and the microcontroller then waits for a signal from the iPod. Once the signal from the iPod is received, the microcontroller tells the digital switch to turn on the PWM module (which is connected to the 16 to 20 volt output from the battery), which subsequently drives the heater to a set point temperature. Once at the desired temperature, the microcontroller will tell communicate with components for obtaining fluorescent measurements. Fluorescent measurements are streamed wirelessly to the iPod touch, where it is automatically sorted and analyzed using computational power of the iPod. If the button is pressed again, the device will be turned off. Boards consist of four separate layers including a top and bottom layer for traces (electrical and signal lines), a ground layer, and a power layer. A number of resistors and capacitors are also used for the various component circuits and can be found in the sketch to the right. The green lines represent copper placement on the bottom of the board. The red lines represent copper placement on the top of the board. The black lines are for reference to the person soldering the components.”

TABLE 1
Components used for making a hand-held
nucleic acid amplification device.

| Supplier | Part number | Brief description |
|---|---|---|
| Digi-Key Corp.* | 20-101-1265 | mini rabbit module |
| (Rabbit) | | RCM5600 W |
| Digi-Key Corp. | 498-0090 | Connector mini PCI |
| | | Express |
| Digi-Key Corp. | 498-0091 | Latch |
| | | connector mini PCI |
| | | Express |
| Super Bright | RL3-G4518 | GreenLEDs |
| LEDs Inc.*** | | |
| Bisco | ERM-1-6MM | LED spacer |
| Industries, Inc.* | | |
| Bisco | E4-10-102-10 | push latch |
| Industries, Inc.* | | |
| Digi-Key Corp. | 568-3998-ND | ARM microcontroller |
| | | NXP Semiconductors |
| Digi-Key Corp. | P0.0ECT-ND | 0 ohm resistor |
| Digi-Key Corp. | P10KECT-ND | 10k resistor |
| Digi-Key Corp. | AD595CQ-ND | thermocouple |
| Digi-Key Corp. | 728-1005-6-ND | 332.768 khz clock |
| Digi-Key Corp. | LT3010EMS8E-5 | IC REG LDO LIN 5 V |
| | | 50MA 8-MSOP |
| Digi-Key Corp. | 399-1249-1-ND | 0.1 uF capacitor |
| Digi-Key Corp. | 399-1197-1-ND | 22 pF capacitor |
| Digi-Key Corp. | BAT60AE6327INCT-ND | diode |
| Digi-Key Corp. | 718-1126-1-ND | 10 uF tant capacitor |
| Digi-Key Corp. | SR202-TPCT-ND | diode |
| Digi-Key Corp. | 718-1520-1-ND | 3.3 uF tant capacitor |
| Digi-Key Corp. | 497-6437-1-ND | LED driver |
| Digi-Key Corp. | 399-1296-1-ND | CAP 1.0UF 25 V |
| | | CERAMIC Y5 V 1206 |

*Digi-Key Corporation, 701 Brooks Avenue South, Thief River Falls, MN 56701.
**Bisco Industries, Inc. 14700 Farmington Rd #103, Livonia, MI 48154 USA.
***Super Bright LEDs Inc. St. Louis Missouri, USA, www.superbrightleds.com

The inventors contemplated several types of cases and configurations for use in making devices of the present inventions. For examples, CAD diagrams of exemplary cases for a variety of devices, see, examples, FIG. 7.

### Example III

This example describes some exemplary embodiments of smart devices used and contemplated for use with devices of the present inventions. In one exemplary embodiment, an iPod Touch with custom applications was used with a device of the present inventions.

The iPod Touch serves as a wireless user interface, an automated means for real time (quantitative) detection, and data management. While an iPod Touch was used for this study, it can be replaced by any computational phone or device with wireless capabilities. As such, the user interface serves as a universal piece of advanced technology that is readily available anywhere in the world, decreasing the overall cost of the device. The software application (currently designed for use with iPod Touch or iPhone, FIG. 8a) has the option for the user to either use the internal autofocus camera for scanning barcodes on the chip for automated assay selection (FIG. 8b), or manually selecting the assay to be run (FIG. 8c). Once the assay is chosen, and the user presses start on the iPod Touch, a pre-programmed temperature and reaction time is wirelessly transmitted to a Gene-Z™ device. The user also has the option to change the reaction temperature and time using the application software (FIG. 8d).

During the reaction, fluorescence readings obtained from the photodiode are streamed wirelessly to the iPod Touch where it is sorted, processed, and amplification profiles are plotted in real-time (FIGS. 8e, 21A). Automated sorting of raw data as it is received by the iPod Touch is crucial for proper differentiation of signals from each of the 60 reaction wells. Once the reaction has completed, the iPod performs automated analysis which includes reporting time to positive amplification (Tt or TTP as shown in the screen shot) and predicted starting copies (FIG. 8f). The estimated number of starting copies is based on the calculated threshold time and assay dependent calibration profiles (which can be modified by the user for the given assay). In addition to storing data, the application provides the user with options to email raw or analyzed data or uploading results via iTunes to a PC.

The docking station serves as follows: 1) a place to set the iPod in an upright position, and 2) a place to recharge the iPod. In one embodiment, communication between a Gene-Z™ device and an iPod were done wirelessly (via the Rabbit Wi-Fi Module). In a further embodiment, the iPod served to provide a means to send instructions to the device to start the reaction, and provided a means for the user to adjust reaction temperature, adjust reaction time, and to obtain fluorescent data as it is read by the photodiode, sort fluorescent data, analyze fluorescent data, report data in real time, store data, and for wireless data transfer to other types of devices, such as a laptop, desktop or main frame computer. These embodiments are described in more detail herein.

Thus in one embodiment, the device has an Apple Dock connection, which is specific for Apple iPhone and iPods. In another embodiment, the USB port of the Apple Dock is connected to the battery of a device of the present inventions. Therefore, the docking station was powered and recharged the iPod. In one embodiment, the external case would be enlarged enough to accommodate a smart device. In this configuration, the screen of the iPod, and the home button would be visible as a user interface. The rest would be embedded into the package. Such that, for example, an iPod would be embedded within an external well or located inside of the external case (in part in order to prevent the smart device from being stolen separately from the device). In another embodiment, a docking station would be large enough to accommodate a tablet merely be connected by wireless communication with a tablet. In another embodiment, a docking station would have a small USB port for a connection from the amplification device to the smart device.

### Example IV

This example describes some embodiments for assembly and function of a nucleic acid amplification device using custom circuit boards described herein.

An embodiment of a nucleic acid amplification device which was functional and externally packaged was named ‘Gene-Z’ and assembled with the following components: i) a temperature-controlled non-transparent chip holder, ii) a multichannel fluorescence sensor, iii) custom printed circuit boards (PCB), and iv) an iPod Touch with custom application. In one embodiment an external package of a device of the present inventions was designed using computer-assisted design (CAD), fabricated via stereolithography out of Accura 25 material (Midwest Prototyping), and aestheticized with a chrome and black glossy finish. Included in the package is a dock to recharge the iPod, a plug-in port for recharging the internal battery, a power button that illuminates green when turned on, and a blue LED that is illuminated when a test is in progress. Including the iPod Touch and battery, the instrument weighs 930 g. The battery is a rechargeable Lithium polymer (XP8000 Energizer), which powered eight 30-minute tests before needing recharging, and has an indicator for remaining battery life.

A 32-bit ARM 7 microcontroller (LPC2378, NXP Semiconductors) was used for controlling the temperature of the chip, triggering the LEDs, acquiring voltage readings from the photodiode, and sending data to a Wi-Fi module (MiniCore™ RCM5600W) (FIG. 2b)). The microcontroller was programmed using the LabView ARM Module (National Instruments). The PCBs, fabricated by Express PCB (Santa Barbara, Calif.), contained the LEDs and constant-current drivers (STLA01, STmicroelectronics), an integrated circuit (IC) for conditioning of thermocouple readings (AD595C, Analog Devices), de-multiplexers for individual control of the LEDs (CD74HCT4514, Texas Instruments), a power regulator (LT3010-5, Linear Technology) with an output of 5 V to power the LED drivers, and other power regulators for driving the microcontroller and Wi-Fi module. The analog output from the ARM was connected to the duty cycle pin of the pulse width modulation driver (DRV102T, Texas Instruments), adjusting the duty cycle between the power supply and the heater. The temperature of the chip holder was measured using a type K thermocouple with a 0.004″ sheath diameter with a specified response time of approximately 100 ms (5SRTC-TT-K-40-36, Omega).

The iPod Touch application (which can also be used with an iPhone or other smart device) allows the user to either manually select the assay to be run or use the internal autofocus camera for scanning barcodes on the chip for automated assay selection. Once the assay is chosen, and the user presses start on the iPod Touch, a pre-programmed temperature and reaction time is wirelessly transmitted to a Gene-Z™ device. During the reaction, fluorescence readings obtained from the photodiode are streamed wirelessly to the iPod Touch where it is processed and plotted in real-time.

### Example V

This Example describes some embodiments for development of methods for enhancing the sensitivity of nucleic amplification detection through the use of certain fluorescent molecules (dyes).

An exemplary method was used for the detection of Mycobacterium tuberculosis and other pathogens by fluorescence-based real-time loop-mediated isothermal amplification. This method used a conventional real time PCR machine along with 20 μl reaction volumes in contrast to the methods of the present inventions using a device of the present inventions and reaction volumes in the range of 2 μl.

DNA Targets.

Genomic DNA from M. tuberculosis (ATCC 25177), methicillin-resistant Staphylococcus aureus (MRSA, ATCC 700699D-5), Giardia intestinalis (ATCC 30888D) and S. enterica subsp. enterica serovar thyphimurium (ATCC 700720D) was obtained from the American Type Culture Collection (ATCC, Manassas, Va.) and resuspended in diethylpyrocarbonate-treated, nuclease-free sterile water (Fischer Scientific, Pittsburgh, Pa.).

LAMP Primers.

A set of six specific LAMP primers for amplifying nucleic acid molecules (i.e. FIP, BIP, F3, B3, LF and LB) (Table 10) were used for each target. Primer sets for G. intestinalis, S. aureus, and S. enterica were designed using Primer Explorer version 4 (Eiken Chemicals Co., LTD, Tokyo, Japan, see website at primerexplorer.jp/e). Primers for S. aureus were designed to target the mecA gene from a consensus of 15 sequences that were aligned with Bioedit Sequence Alignment Editor (Ibis Biosciences, Carlsbad, Calif.). Primers for S. enterica were designed from a consensus of three sequences of the fljB gene. For G. intestinalis one sequence was used to design a primer set targeting the a-giardin gene. The specificity of G. intestinalis, S. enterica and S. aureus primer sets was checked against the GenBank database using a NCBI BLAST program Stedtfeld, et al., (2008), Appl. Environ. Microbial. 74:3831-3838. For M. tuberculosis, primers described in the literature were used to target the 16S rRNA gene Pandey, et al., (2008), J Med. Microbial. 57:439-43. Primers were obtained from Integrated DNA Technologies (IDT, Coralville, Iowa).

Fluorescence-Based LAMP.

LAMP reactions were performed in a volume of 20 μL consisting of 1.6 μM each of FIP and BIP primers, 0.2 μM each of F3 and B3 primers, 0.8 μM each of LF and LB primers, 0.8 M betaine (Sigma, St Louis, Mo.), 1.4 mM of each dNTP (Invitrogen Corporation, Carlsbad, Calif.), 20 mM Tris-HCl (pH 8.8), 10 mM (NH₄)₂SO₄, 10 mM KCl, 8 mM MgSO₄, 8 mM Triton X-100, 0.2 to 2.4 units/4 of Bst DNA polymerase, large fragment (New England Biolabs Inc., Ipswich, Mass.) and various concentrations of a dye: SYTO-80, SYTO-81, SYTO-82, SYTO-83, SYTO-84, SYTO-85 or SYTOX Orange, SYBR Green I, and PicoGreen (Invitrogen Corporation), EvaGreen (Biotium Inc., Hayward, Calif.) or calcein (“Fluorescent detection reagent”, EIKEN Chemical Co., Ltd.). Depending on the color range of their emission maxima, the dyes are referred to here as either green (for SYBR Green I, PicoGreen, EvaGreen and calcein) or orange (for SYTOX-orange and SYTO dyes). Samples were loaded in 200-4 PCR tubes (VWR International, West Chester, Pa.) and incubated at 64° C. for 36 min in a Chromo4™ Real-time PCR detector (Bio-Rad Laboratories, Hercules, Calif.). Fluorescence intensity was measured every minute with the channel 1 (for green dyes) or with Channel 2 (for orange dyes) of the thermal cycler. For pre-hybridization of the target DNA with the primers, samples were incubated for 1 min at 95° C. with a polymerase-free LAMP reaction mixture, and cooled at 4° C. prior to adding the polymerase. Fluorescence data and Tₜ values were collected with Opticon™ software (Bio-Rad) and transferred to Microsoft Excel where they were converted into SNRs as follow: SNR=(X−μ)/σ, where, X is the fluorescence signal (arbitrary units, a.u.), μ the baseline signal and σ, the standard deviation of the baseline signal.

Results of Effect of Dye Type and Concentration on Threshold Time.

The Tₜ of fluorescence-based LAMP was compared for various concentrations of orange and green dyes, using the BioRad Chromo4™ real-time thermocycler and a constant amount of M. tuberculosis genomic DNA (0.1 ng or approximately 2×10⁴ genomes). An optimal dye concentration, defined as the concentration that resulted in the shortest Tₜ, was determined for each dye although several of the dyes were worked efficiently over a broad range of concentrations.

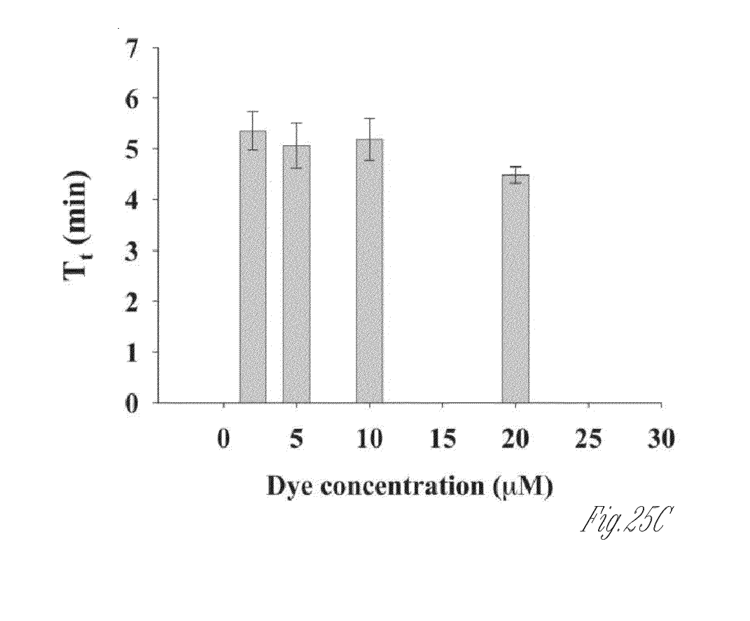

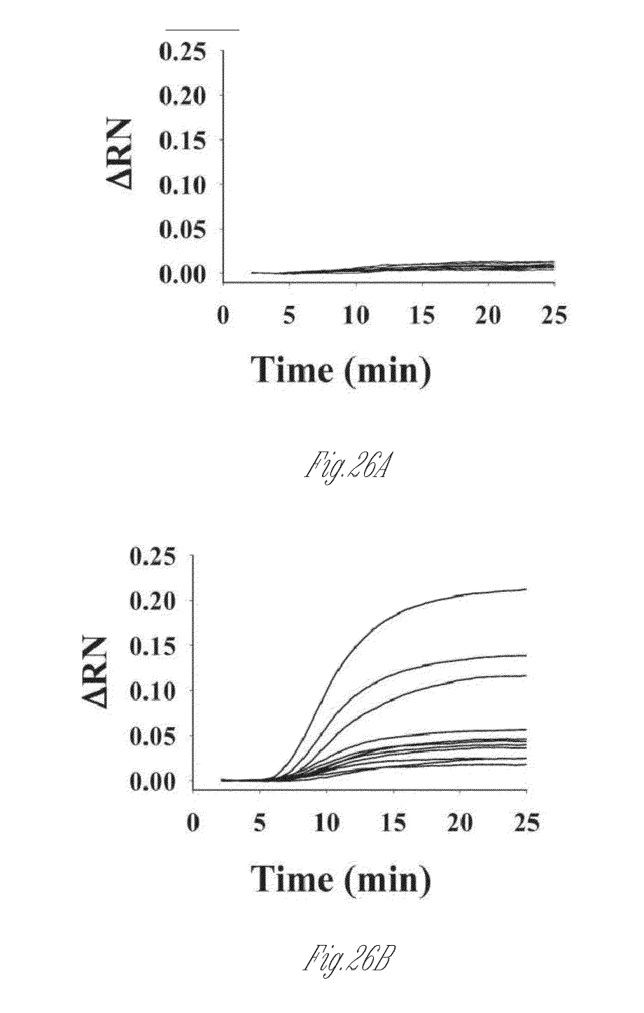

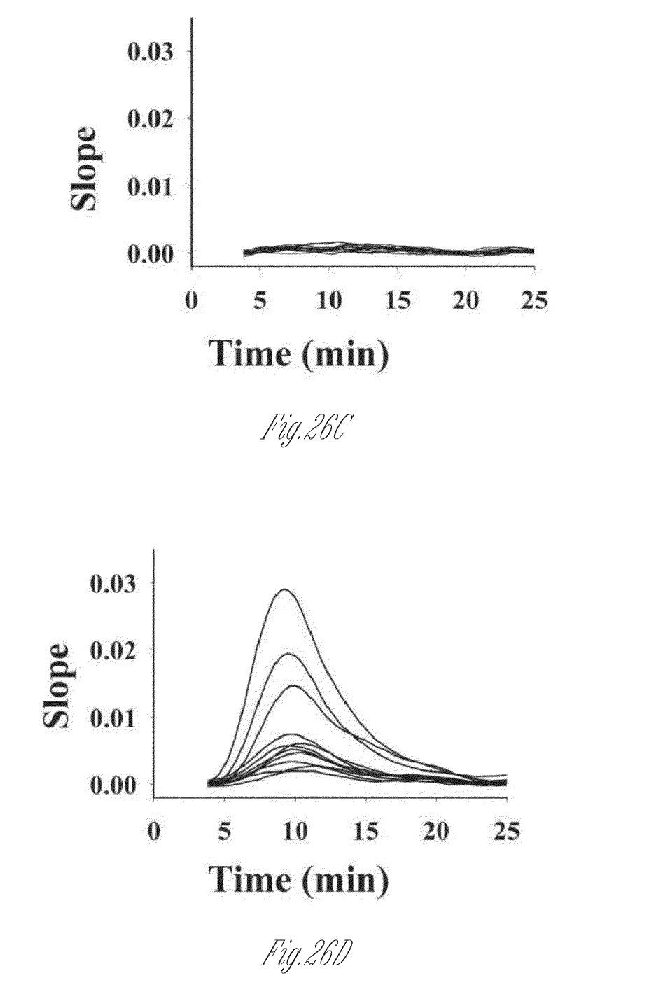

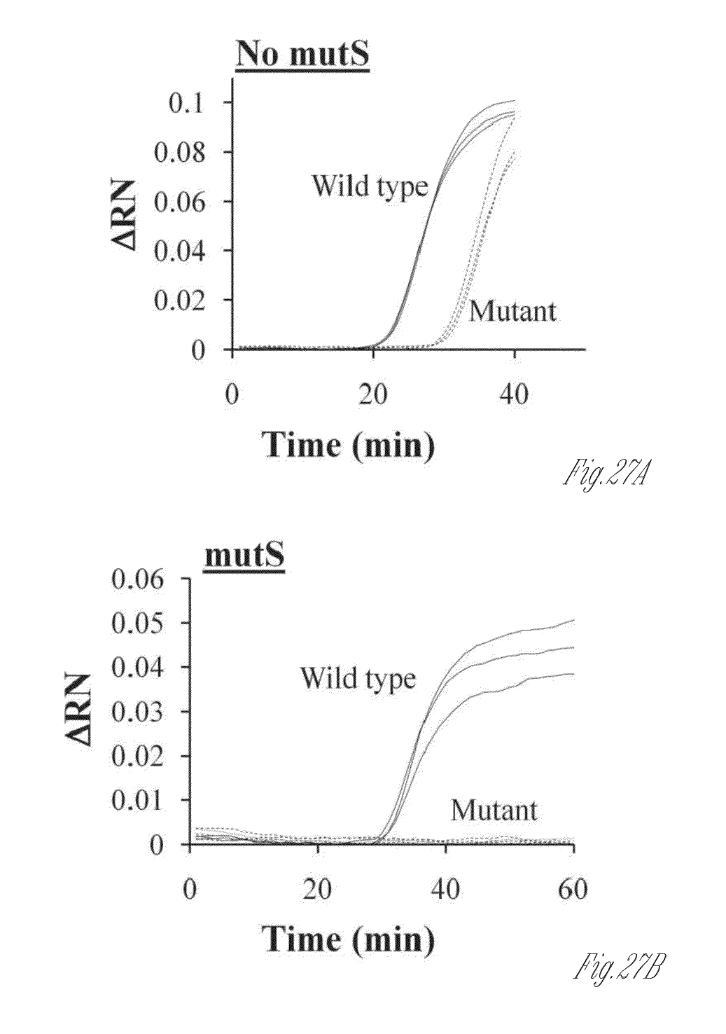

Amplification curves were observed for orange dyes (FIG. 29). SYTO-81 and 84 resulted in the shortest Tₜ and SYTO-81 had the widest working range of concentrations. SYTO-82 at 2 μM and SYTO-84 at 1 μM resulted in the shortest Tₜ (<7 min) of orange dyes tested. Besides SYTO-80, which resulted in a Tₜ of 11.8 min at its optimal concentration, the orange dyes gave a positive result in 7 to 9 min, with an optimal concentration range of 1 to 2 μM for the SYTO dyes and 0.1 μM for SYTOX orange. Higher concentrations of SYTOX orange resulted in inhibition of amplification. SYTO dyes had a working concentration range of 0.1 to 10 μM. Within this range, Tₜ was moderately affected by the concentration. Above 10 μM, amplification was observed for SYTO-80, 81 and 84, but not for the other SYTO dyes. In fact, the Tₜ of SYTO-80 and 84 were doubled when the concentration was increased from 10 to 20 μM. In contrast, there was almost no difference in Tₜ over the concentrations tested for SYTO-81. At its optimum concentration (2 μM), the Tₜ of SYTO-81 was 7 min compared to 9 min when used at 20 μM revealing a wider working concentration range for this dye than the others.

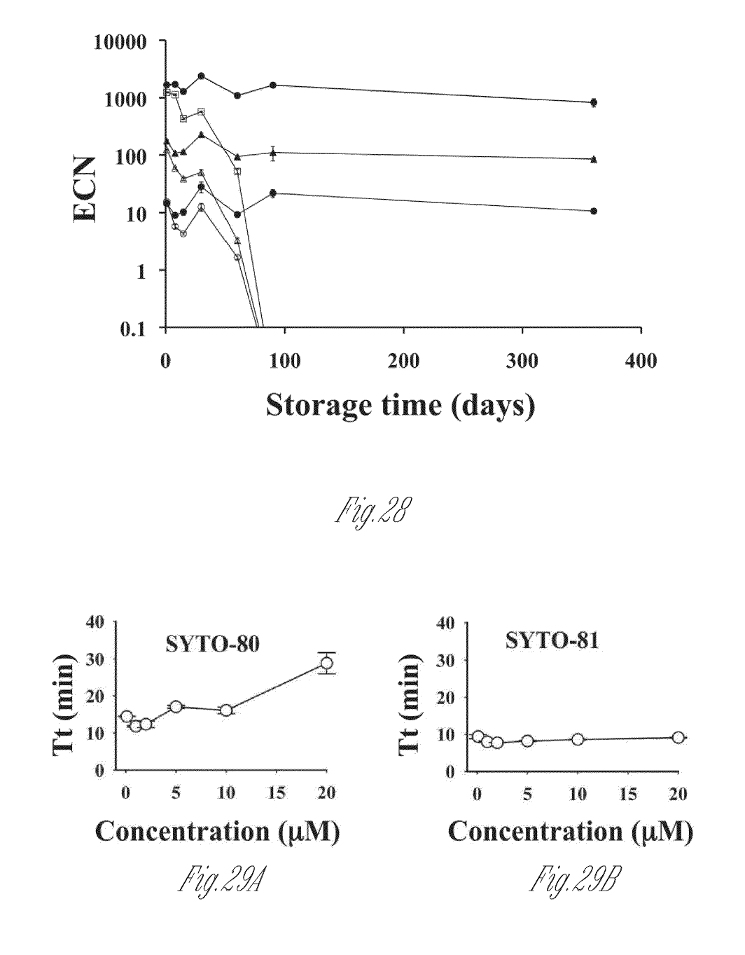

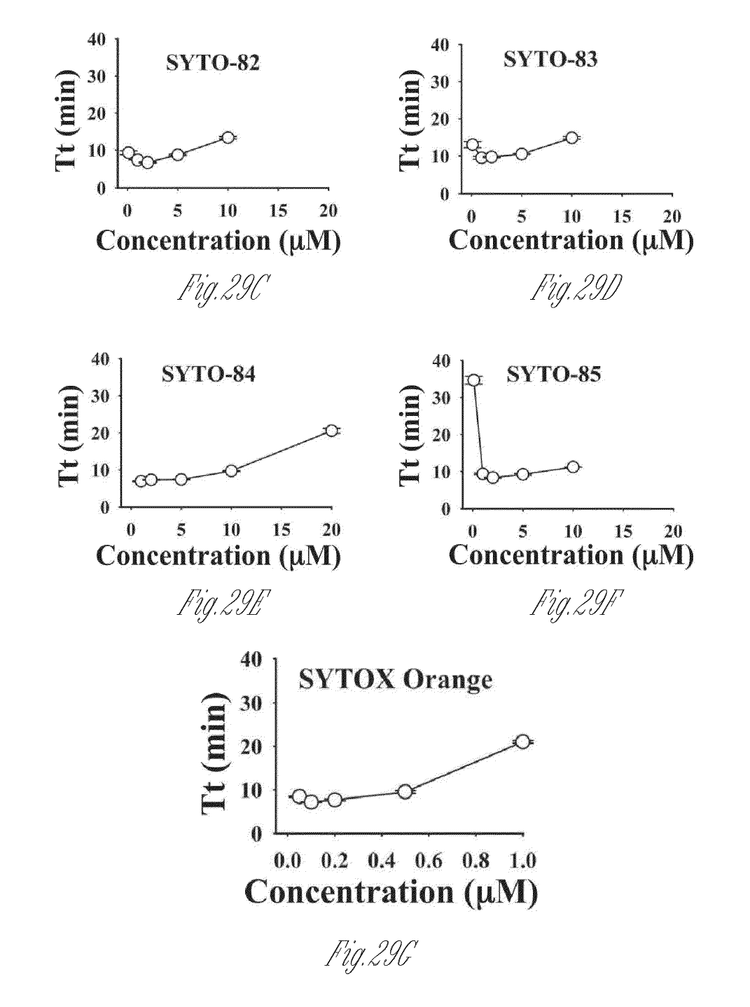

Amplification curves were also observed for green dyes, with SYBR Green I resulting in the shortest Tₜ. The molar concentrations of several dyes were not provided by the manufacturers. Hence they were expressed here as dilution factors of the standard working concentration of 1× rather than μM (FIG. 30). SYBR Green I at 0.25× resulted in the shortest Tₜ (7.4 min) among the green dyes tested. However, this dye had a very narrow working range. No amplification occurred for SYBR Green I concentration outside the 0.1-0.5× range, confirming a report Gudnason, et al., (2007), Nucleic Acids Res. 35:e127. The same optimum SYBR Green I concentration as in the present study was described for the real time machine. An inhibitory effect of SYBR Green I on LAMP (i.e. nucleic acid amplification) was reported Lam, et al., (2008), Biomed Microdevices. 10:539-46, although there is a lack of information on optimal concentration. EvaGreen had a similar response with an optimal concentration of 0.1× corresponding to a Tₜ of about 8 min and a working range of 0.05 to 0.5×. EvaGreen was successfully used in LAMP with PCR at a concentration of 0.5×. It was also shown to inhibit LAMP, although the dye concentration of the assay was not given Chen and Ge, (2010), BMC Microbial. 10:; Tricoli and Jacobson, (2007), Cancer Res. 67:4553-5. In another study, the Tₜ of EvaGreen-based LAMP doubled when the concentration was increased from 0.1 to 0.25×. Real-time monitoring of LAMP using PicoGreen had a Tₜ similar to SYBR Green I and EvaGreen-based LAMP (approximately 8 min) at an optimal PicoGreen concentration of 1.0×, but it had a wider working range of 0.05 to 5.0× with positive amplification curves at certain concentrations. PicoGreen (1×) was used in a LAMP assay to detect foot-and-mouth disease virus (10 detectable copies) in about 22 min Dukes, et al., (2006), Arch Virol. 151:1093-106 with conventional PCR. Calcein, a common dye for visual endpoint detection of LAMP Tomita, et al., (2008), Nat. Protoc. 3:877-882, also allowed the detection of LAMP in real-time. However, the Tₜ was almost twice as long as that of LAMP using SYBR Green I. In contrast to other dyes, calcein does not bind to DNA. It fluoresces when deprived of calcium ions in solution. Free calcium ions decreased in solution because of their association with pyrophosphate ions released from dNTPs during DNA amplification. For the target tested, other green dyes (SYBR Green I, PicoGreen, or EvaGreen) were superior to calcein on the basis of Tₜ measured by a commercial real-time PCR thermocycler.

Results indicated that fluorescence-based real-time LAMP yield shorter Tₜ than turbidity-based real-time LAMP. Except for calcein and SYTO-80, tested dyes resulted in detectable amplification of 0.1 ng of M. tuberculosis after 7 to 9 min. This was almost twice as fast as the results of Pandey et al., who used the same primer set in a turbidity-based real-time LAMP assay (using a thermocycler), and detected 0.1 ng of M. tuberculosis in about 15 min Pandey, et al., (2008), J Med Microbial. 57:439-43. Similarly, Chen et al., (2010) showed that SYTO-9-based real-time LAMP was twice as fast compared to turbidity-based real-time LAMP in detecting Vibrio parahaemolyticus Lucchi, et al., (2010), PLoS One. 5:e13733. Likewise, Aoi et al. obtained a Tₜ for YO-PRO1-based real-time LAMP that was 20 min shorter than a turbidity-based real-time LAMP.

Fluorescence intensity and enhancement during LAMP. The fluorescence intensity of the dyes during LAMP was analyzed by plotting raw fluorescence data and SNR as a function of amplification time (FIG. 31). Absolute fluorescent intensity and noise play an important role in the choice of detector. After completion of the LAMP reaction (indicated by a plateau of the signal intensity), SYTO-82 at its optimum concentration had the highest fluorescent signal among the dyes tested. The fluorescence intensity of SYTO-82 increased about 1000-fold over the noise as a result of the amplification process. The fluorescence intensity of SYTO-81 at optimum concentration had a similar profile but the increase in SNR was 100-fold at the end of the reaction. Furthermore, SYTO-81 has a slight concentration-dependent inhibitory effect on LAMP. Higher concentrations of SYTO-81 (up to 20 μM) were evaluated and resulted in a fluorescent intensity and enhancement that were even higher than that of SYTO-82 but at the cost of a slight increase in Tₜ (FIG. 34). Other SYTO dyes had fluorescence intensities 5 to 20 times lower than SYTO-82, and fluorescence enhancement ranging from 10- to 100-fold (FIG. 34). With a fluorescence of about 0.01a.u. after amplification, SYTOX Orange, was 100-fold less bright than SYTO-82. The fluorescence of SYTOX Orange increased to approximately 70-fold after amplification. Among the green dyes, calcein was the brightest with a fluorescence ranging between 0.4 and 0.6 a.u., when amplification occurred. However, calcein also had the highest baseline signal (0.1a.u.), hence the low SNR of 25, the lowest among dyes tested. EvaGreen and SYBR Green I showed low fluorescence enhancement, similar to calcein, and were almost 100-fold less bright. PicoGreen was twice as bright as SYBR Green I and had 2-fold higher enhancement in fluorescence.

Overall, SYTO-81 and SYTO-82 resulted in the highest fluorescence signal and enhancement. However, based on their fluorescence responses, dyes tested were suitable for fluorescence-based real-time LAMP using the Chromo4™ thermocycler. Similar results are expected if other conventional real-time thermocyclers (e.g., ABI Prism, Rotor-Gene) are used as long as they have comparable sensitivities and dynamic range as the Chromo4™.

These parameters should be taken into consideration when choosing an appropriate fluorescent dye for real-time LAMP because as shown herein, fluorescent DNA dyes have varying brightness, resulting Tₜ, and final SNR after amplification. Thus, dyes with high brightness and high fluorescent enhancement such as SYTO-81 and SYTO-82 or calcein are contemplated for use with simple optical setups such as used in devices of the present inventions.

Effect of Bst polymerase concentration on threshold time. The following methods were used in order to determine ways to reduce Tₜ over a range of Bst polymerase concentrations using 0.1 ng of M. tuberculosis and SYTO-82 dye. An optimal concentration was defined as the concentration that allowed the shortest Tₜ, and was determined to be 0.64-1.28 units/μL. Below this Bst polymerase concentration, Tₜ increased, indicating a lack of sufficient polymerase in the reaction mixture. Above this concentration range, Tₜ increased again, most likely due to inhibitory effect similar to what had previously been observed for polymerases used in PCR Saiki, et al., (1988), Science. 239:487-91. Because no significant difference (p=0.6604) was observed between 0.64 and 1.28 units/μL, 0.64 units/μL was chosen as a suitable Bst polymerase concentration for these assays.

A Bst polymerase concentration of 0.64 units/μL caused a Tₜ reduction of approximately 14% (approximately 1 min) when compared to the conventionally used concentration of 0.32 units/μL Chen and Ge, (2010), BMC Microbial. 10:; Aoi, et al., (2006), J Biotechnol. 125:484-91. However, these results were obtained using purified genomic DNA, not with higher concentrations of Bst are present in some clinical samples. Use of higher concentrations of polymerase was described for PCR and generally allowed faster amplification, but also resulted in loss of target specificity Chen and Ge, (2010), BMC Microbial. 10:; Saiki, et al., (1988), Science. 239:487-91; Aoi, et al., (2006), J Biotechnol. 125:484-91.

Advantage of preheating DNA templates. The use of preheated templates in SYTO-82-based real-time LAMP was evaluated with several primer sets targeting four human pathogens (M. tuberculosis, S. aureus, S. enterica, and G. intestinalis) with serial dilutions of the genomic DNA (10-10,000 copies) for each target individually (FIG. 32). This additional step was used with the goal of reducing detection time and improving sensitivity. In contrast to the limit of detection, the limit of quantification is the minimum numbers of copies of target than can be significantly quantified using a standard curve. For organisms, linear correlations confirmed the potential of real-time LAMP for quantification of target DNA. However, assays made with preheated templates occasionally had shorter Tₜ and were generally more sensitive than assays with non-preheated templates. When G. intestinalis DNA (10 copies) was present in the preheated samples, the Tₜ was 4.5 min (45%) shorter compared to non-preheated samples. In contrast, the Tₜ was improved by 1 min when using a preheating step for M. tuberculosis, S. aureus or S. enterica. Nonetheless, an increased LAMP sensitivity was observed for assays with preheated templates. For M. tuberculosis, pre-heating the templates allowed detection of 10 copies of DNA, which was 20-fold higher than the sensitivity obtained for non-preheated samples. Similarly, for S. aureus, denaturation of the target resulted in an assay 10-fold more sensitive (10 copies). In addition, the limit of detection was the same as the limit of quantification for assays with preheated templates.

Preheating the template prior to Bst addition may considerably improve the limits of detection and quantification of real-time LAMP. In some cases, it may also accelerate the reaction by up to 45%. This phenomenon was described when using a LightCycler 1.0 (Roche Diagnostics, Meylan, France) Seyrig, et al., (2011), Environmental Microbiology Current Technology and Water Applications; Peyrefitte, et al., (2008), J Clin Microbial. 46:3653-9. However, a heat denaturation of the template requires an additional step and therefore adds time, as the polymerase needs to be added after the preheating step to avoid its denaturation. Whether this preheating step is beneficial for each specific assay depends on the requirement and conditions, including desired sensitivity and rapidity.

Comparison of Results with Published Data.

Amplification reactions performed in this study typically show faster Tₜ compared to previously published results with real-time LAMP (FIG. 33). This highlights the ability to detect specifically and quantitatively minute amounts of target nucleic acids in a short period of time. Ten copies of G. intestinalis and S. aureus were detected in less than 21 min of incubation. Similar results were achieved by Peyreffite et al. (2008) who were able to detect 10 copies of Rift Valley fever virus by real-time reverse transcript LAMP in about 18 min, using ethidium bromide Peyrefitte, et al., (2008), J Clin Microbial. 46:3653-9. However, this dye is a known mutagen and hence not suitable for use in field deployable devices. The dye YO-PRO1 was also used in real-time LAMP to detect up to 10 copies of P. jirovecii in less than 20 min Uemura, et al., (2008), J Med. Microbial. 57:50-7. However, the target sequence was incorporated in a plasmid and it is possible that the reaction time would have been different if genomic DNA had been used. Rapid (<12 min) detection of 10 copies of the fungus B. cinerea DNA by fluorescence-based real-time LAMP was described but no information was provided about the fluorescent dye and the concentration that was used Tomlinson, et al., Lett Appl Microbial. 51:650-7 (2010).

A number of strategies were used to increase the performance of real-time LAMP for use with devices of the present inventions. The evaluation of several fluorescent dyes revealed that SYTo-82 resulted in the fastest amplification time, and the highest fluorescence signal and enhancement. In some cases, preheating the template at 95° C. for 1 min prior to amplification allowed a reduction in amplification time and improvement in the limit of detection and the limit of quantification. When the Bst polymerase concentration was doubled, the amplification time was slightly reduced (by approximately 1 min) in comparison to the concentration generally used for LAMP (0.16 units/μL. Using an optimized protocol (SYTO-82, 1-min heat denaturation of template, and 0.32 units/μL of Bst), it was possible to amplify up to 10 copies of M. tuberculosis in less than 10 min and 10 copies of S. enterica in less than 13 min. Results obtained during the development of the present inventions showed how optimization of the LAMP protocol has a significant impact on the result in terms of time and sensitivity when using thermal cyclers. Thus current findings are contemplated for use with hand-held devices of the present inventions in addition to use in methods using hand-held devices of the present inventions for real-time LAMP assays and hand-held isothermal genetic analysis systems for low resource settings, see, FIGS. 25, 26, and 29-34.

### Example VI

This example describes some embodiments of experiments performed to: 1) lower optical and fluidic cross-talk within the chips, 2) increase reproducibility and optical sensitivity, and 3) demonstrate an exemplary Gene-Z™ device used with a disposable microfluidic chip developed for use in the present inventions for simultaneously targeting multiple VMGs.

Valve-Less, Shell-Structured Microfluidic Chip:

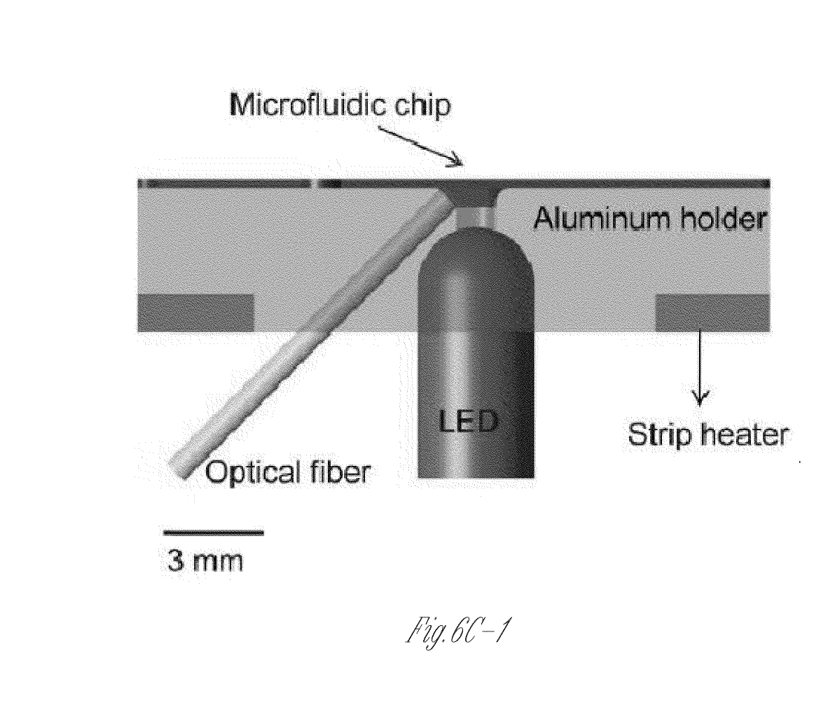

Positive amplification in a reaction well has the potential to influence signal in neighboring wells via optical cross-talk or cross-contamination between connected channels. Optical cross-talk may occur in transparent chips due to the wave-guiding properties of polymers, especially when using unfocused light sources and spot detectors without spatial resolution. Cross-contamination may occur when amplified product migrates between reaction wells. Here, the chip was designed with long channels between reaction wells and with a shell structure (placed in a non-transparent holder) to prevent cross-contamination and optical cross-talk, respectively. In order to confirm the effectiveness of these approaches, a chip was prepared in which (i) DNA of E. coli and eaeA primers and (ii) solely primers were dispensed in alternating wells, and filled with LAMP reagents. As illustrated in FIG. 9c, no detectable increase in signal was measured in the wells lacking E. coli DNA. As such, optical cross-talk between adjacent reaction wells was not detected with the use of this chip. End-point imaging of the chip after 60 min of amplification also revealed that no carry-over of amplicons had occurred between the reaction wells (FIG. 9b). Two previous studies also observed lack of cross-contamination in chips with connected channels during amplification. This demonstrates a simple approach of using channel length and isothermal amplification to circumvent use of micro-valves with the microfluidic chip, and embedding shelled chips to reduce optical cross talk.

Reproducibility:

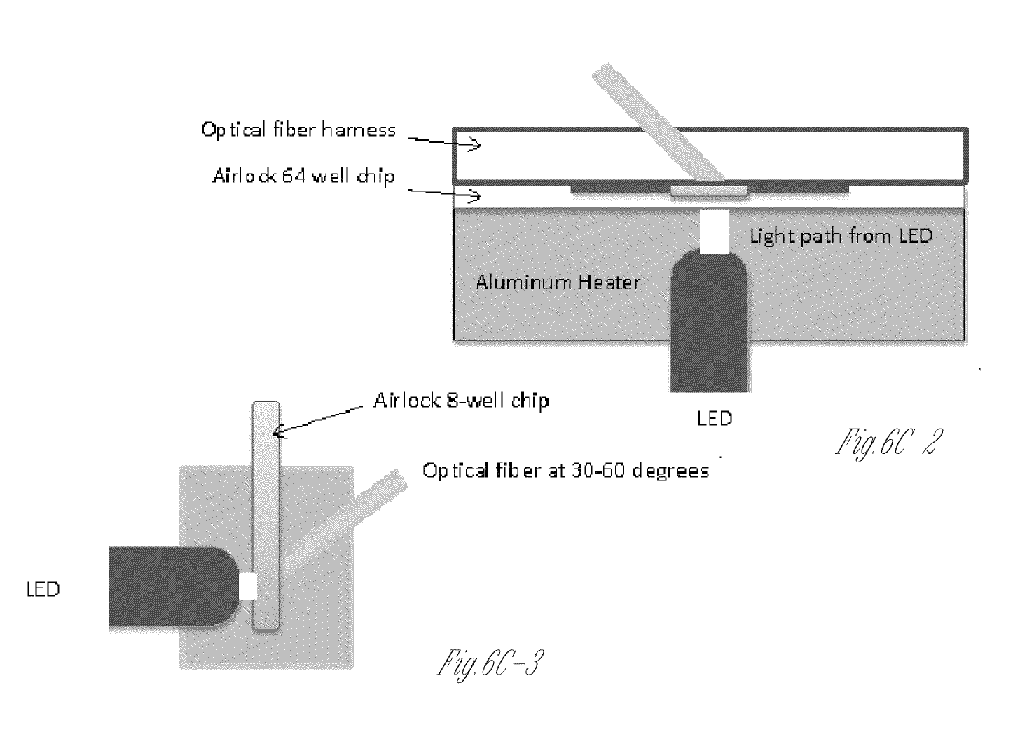

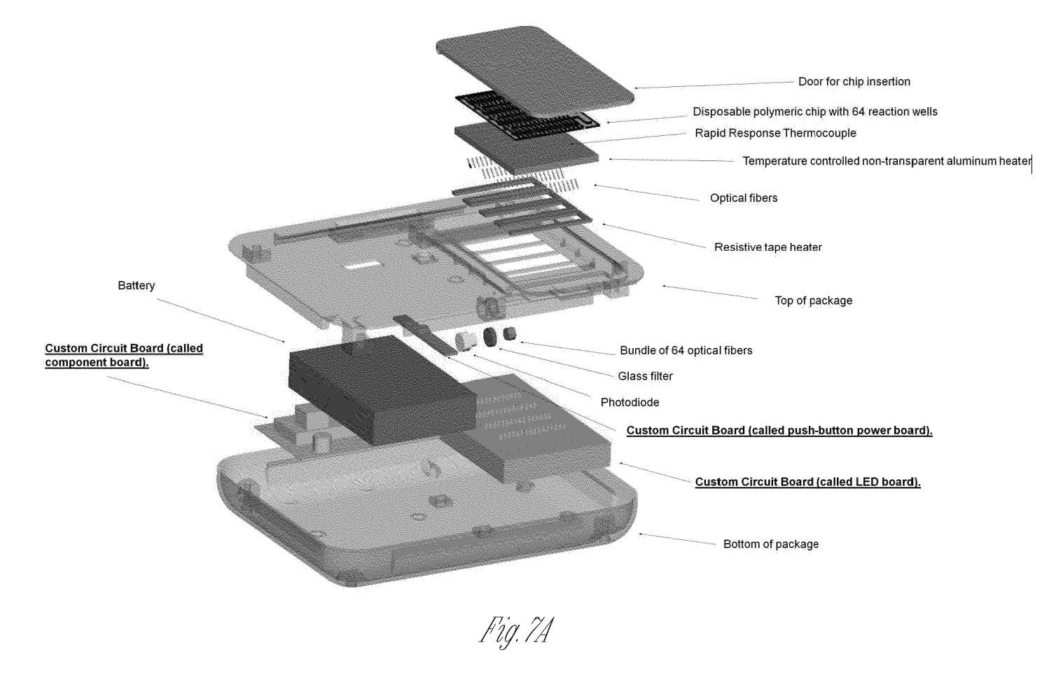

Low intra- and inter-chip variability are critical for reliable quantification and were determined using three chips, each run with primers for the stx2 gene of E. coli dispensed in 60 reaction wells (i.e., 60 replicate assays per chip). After chip assembly, arrays were filled with LAMP reaction mixture containing 1.7×10⁵ genome copies of E. coli per well, and amplification was monitored in real-time using a Gene-Z™ device of the present inventions. Amplification curves for wells in a given chip were highly reproducible (FIG. 10a), with a coefficient of variation (CV) for the Tₜ of 5.2%, 5.2%, and 6.9% for three different chips.

Importantly, this variability was slightly higher than what was observed using a commercial real-time PCR instrument with the same amount of DNA in 25 μl reactions (4.7% for three different reactions, FIG. 10b. The average Tₜ between three chips was 8.6±0.7 min for chips run on a Gene-Z™, which is comparable to the average Tₜ of 9.0±0.5 min on the real-time PCR instrument using conventional reaction tubes. Considering three separate runs, the CV was 7.8% for three separate chips on Gene-Z, and 5.9% for three separate runs on the real-time PCR instrument.

Sensitivity:

To evaluate performance of a Gene-Z™ for detection of pathogens with low abundance and quantification, a serially-diluted DNA sample of E. coli was loaded into two separate chips. Prior to assembly wells of the chip were loaded with primers targeting the eaeA gene of E. coli. One array on each chip was loaded with a no-template control; amplification was not observed for this sample. The lowest copy number that could be detected was 13 copies per reaction well, which amplified in 3 out of 15 reaction wells in the microfluidic chip and did not amplify in any of three replicates tested in 25 microliter reactions on the real-time PCR instrument (FIG. 10D). The dilution of 135 copies per well showed amplification in these sample wells on the chip using a real-time PCR instrument. Although the use of LAMP was reported as capable of amplifying a single target nucleotide for detection, this capability was affected by the device used in combination with the specific primer set used. Therefore, primer sets were tested as described herein on a device of the present inventions for detection limits, including amplification efficiency.

Amplification efficiency was compared between a Gene-Z™ device of the present inventions and a real-time bench-top PCR instrument. Here, both surfactant and surface passivation agent (Pluronic F-68 and BSA) were added to the LAMP reaction mixture at the same concentrations to what has been used for qPCR in 33 nl reactors to reduce inhibitory effects due to the high surface-to-volume ratio in the chips. Experiments with different primer sets on the device have demonstrated that the efficiency was highly dependent on the primer assay, with some assays having greater efficiency on a Gene-Z, and some assays having greater efficiency on the real-time bench top PCR instrument. Because temperature affects time kinetics of LAMP assays, was described previously, temperature differences between the two instruments during the amplification steps are contemplated to be responsible for this variation.

However, in contrast to the bench top PCR instrument, the use of a device of the present inventions for detection of pathogens at an abundance of 10-100 copies per well (300-3,000 copies per microliter of sample), the detection time was less than 30 minute. The time savings associated with using the optimized LAMP protocol and user-friendliness of the microfluidic chip including: i) loading of each array of 15 reaction wells with a single pipetting step, ii) presence of pre-dispensed and dehydrated primers in the wells, and iii) the use of premixed lyophilized reagents, as observed in corresponding studies, significantly reduces time to complete the assay.

Parallel detection of multiple pathogens: To demonstrate parallel detection of multiple pathogens using a Gene-Z™, a chip was prepared in which primers for the mecA and vicK of S. aureus and the stx2 and eaeA gene of E. coli were dispensed in triplicate in the chips (the remaining three wells were left empty). If the primers are material to this invention the sequences must be included. Samples containing solely E. coli DNA, solely S. aureus DNA, both E. coli and S. aureus DNA (target DNA), and a no-template control were loaded in each of the four different arrays of a single chip. As shown in FIG. 11, amplification was observed in the reaction wells, which contained target DNA, primers and solutions of the present inventions.

### Example VII

This example describes Quantifying MicroRNAs for cancer screening using a Point of Contact (POC) device

One of the assay embodiments is a novel technique for isothermal amplification of microRNA as cancer markers. Such an assay can include use of any of the devices described herein. Overall, the method involved: i) extraction of microRNA from blood, plasma, serum or other tissue, ii) reverse-transcription, iii) phosphorylation of 5′ end (30 min incubation), iv) ligation of microRNA to both ends of a DNA extension sequence (5 min incubation), and v) qI-Mir assay (FIG. 12). Because extraction and reverse transcription steps are well established, the challenge was to demonstrate the feasibility of the remaining steps (iii) to (v). and its performance using a POC nucleic acid amplification device. Thus for step (iii), a synthesized strand of DNA was used as an alternative to reverse-transcribed microRNA. For step (iv), a rapidly amplifiable DNA extension obtained from Salmonella enterica was used. Ligation of the cDNA (reverse transcribed microRNAs) to both ends of the DNA extension sequence served as a region for both the F3 and B3 primers during the qI-Mir assay. When a non-targeted microRNA has ligated to the DNA extension sequence, both displacement primers do not anneal, providing the required specificity. Since the majority of the ligated sequence was similar to the majority of microRNAs, the amplification times and standard curves were similar for the microRNAs amplification reactions thus minimizing the need for running separate standard curves for each microRNA. The following specific steps were demonstrated herein: (iii) to (v) of the above approach for a panel of microRNAs in a disposable microfluidic chip using a compact and low-cost nucleic acid amplification device (Gene-Z™). Features of the real time Gene-Z™ nucleic acid amplification device include: i) simple microfluidic chips consisting of 64 wells of 1 μl each, ii) real time isothermal amplification with less than 1 h assay time, iii) potential for wireless communication, automated data processing and reporting using a Smartphone user interface, and iv) a hand-held format with internal rechargeable battery. Overall the amplification method that resulted during the development of the present inventions was as follows. Reagents to perform qI-Mir assay (excluding primers) were dispensed into the disposable microfluidic chip using a pipette. The chip contained a network of 64 amplification wells were loaded from one to four sample inlet ports (depending on the number of samples to be tested). Once samples were loaded, a layer of adhesive tape was used to seal the exit holes on the membranes and prevent egress of assay reagents during heating. Chips were then loaded on a Gene-Z™ nucleic acid amplification device and real time monitoring of amplification started after specifying the reaction temperature and assay time using a Wi-Fi signal sent from an iPod Touch (or an iPhone) that also served as the data analysis and visualization tool.

Once the set point temperature was reached, the nucleic acid amplification device started receiving the emitted fluorescence signal captured from each of the 64 wells by a single photodiode and then sent the signal back to the iPod Gene-Z™ software for storage and analysis. For each well, fluorescence signal was collected every 12.8 seconds (0.2 seconds per reaction) and plotted in real time. Once the assay was completed, an analysis feature of a Gene-Z™ software reported both the time to positive amplification and the starting copies of microRNA, which was dependent on a quantitative control and the predetermined calibration profile. These types of results are contemplated for transmission by email or downloaded to a PC using an iTunes application and a USB port.

Experiments were performed to evaluate the specificity, sensitivity, limit of detection and range for a panel of 15 microRNAs including miR-141 (Table 2). The initial set of 15 microRNAs was tested with qI-Mir assay to ensure the method worked for multiple targets (Table 6). Selection of the initial 15 microRNAs was based on their importance as potential biomarkers. Three separate DNA extension sequences were tested with miR-let-7a where the results showed a similar Tₜ (Table 6).

Specificity of qI-Mir assay was evaluated for three separate microRNAs, mixed prior to ligation. Each of the four lanes was loaded with a different target mixture (10⁷ copies per reaction). Results showed a signal to noise ratio (SNR) less than 10 for non-targeted primers after a 60 min reaction time in a Gene-Z™ nucleic acid amplification device (FIG. 13B). A picture taken of the chip after the reaction also shows higher signal in targeted wells (FIG. 13B). Overall, these results demonstrated specificity of primers for designated microRNAs without cross contamination between reaction wells.

Experiments with varying concentrations of microRNAs were conducted to ensure that a mixture of microRNAs present at different concentrations would not influence specificity or quantification. Seven different microRNAs were mixed in the following amounts (copies per reaction): miR-21 (10⁸), miR-222 (10⁷), miR-223(10⁶), miR-296 (10⁵), mir-17 (10⁴), miR-221(10³), and miR-210 (10²) prior to ligation. Two chips were used for this test, each with 15 wells pre-dispensed with one of the seven microRNAs. A linear correlation with R²=0.9903, even when different targets were used for each point (FIG. 14A), demonstrated the expectation that calibration curves for microRNAs will have approximately similar slope and intercept.

Dynamic range and sensitivity of the assay were tested with miR-141 which was reported to be 100% specific to prostate cancer above 4000 copies per μl of serum Mitchell, et al., (2008), Proc Natl Acad Sci USA. 105:10513-8. Up to 100,000 copies per μl of serum may be found in prostate positive patients. Considering sample processing e.g., concentration and RNA extraction, the dynamic range must be between 10² to 10⁶ copies per reaction well. Gene-Z™ demonstrated a dynamic range of 10² to 10⁹ copies for miR-141 (FIG. 13C). A similar range was observed for miR-100 (FIG. 14b).

The lower limit of detection for miR-100 and miR-141 was the same (10⁴ copies per reaction well), most likely because of the similarity of a large portion of the DNA extension sequence. The reaction did not show positive amplification in replicates (n=15) when using 10² to 10³ copies per reaction. Amplification occurred in reaction wells at levels of 10⁴ copies per reaction well using a 200 bp amplicon. However, from the results obtained with other targets, a detection limit of single copy per well was estimated. Analytical sensitivity of a single copy was reported using loop mediated isothermal assay (LAMP) in conventional tubes. The inventors show single copy detection with the use of thermal plastic microfluidic chips, see, Ahmad, et al., (2011), Biomed. Microdevices. 13:929-37.

High amplification efficiency was confirmed by a dilution series of 5 microRNAs (miR-223, miR-21, miR-155, miR-221, and miR-141) (Table 7). The narrow range of slope and intercept for the 5 microRNAs indicated that a single standard curve is contemplated for use (with some margin of error) to quantify various microRNAs for general results as long as the same DNA extension was used. However for diagnostic use it was contemplated that a standard curve would be generated for each type of DNA extension and type of sample.

The assay time of 10-50 min for qI-Mir is shorter than times currently known for quantifying microRNAs. Combined with a simple, inexpensive, and quantitative platform (Gene-Z™), diagnostics for microRNAs based cancer markers can be accomplished with ease. The total time will be somewhat longer depending upon the sample processing steps. At least one benefit of using LAMP methods with an amplification device of the present inventions are short assay times. For example, at present, more than 40 million tests are conducted using PSA using procedures that are invasive. Therefore the inventors contemplate a quantitative determination of this marker using a device and methods of the present inventions for a rapid non-invasive screening for prostate cancer.

TABLE 2
MicroRNA sequences used to form both the
reverse transcribed product and the F3 and
B3 primers for qi-MIR reactions

| cDNA used | | |
|---|---|---|
| for | | |
| MicroRNAs | Sense (5′-3′) | Antisense (5′-3′) |
| miR-100 | TTGGGCATCTAGGCTTGAA | GTGTTCAAGCCTAGATGC |
| | CAC | CCAA |
| | (SEQ ID NO: 1) | (SEQ ID NO: 2) |
| miR-106a | TTTTCACGAATGTCACGTC | GATGGACGTGACATTCG |
| | CATC | TGAAAA |
| | (SEQ ID NO: 3) | (SEQ ID NO: 4) |
| miR-125b | AGGGACTCTGGGATTGAA | AGTGTTCAATCCCAGAGT |
| | CACT | CCCT |
| | (SEQ ID NO: 5) | (SEQ ID NO: 6) |
| miR-126 | AGCATGGCACTCATTATTA | GCGTAATAATGAGTGCC |
| | CGC | ATGCT |
| | (SEQ ID NO: 7) | (SEQ ID NO: 8) |
| miR-143 | ACTCTACTTCGTGACATCG | CTCGATGTCACGAAGTA |
| | AG | GAGT |
| | (SEQ ID NO: 9) | (SEQ ID NO: 10) |
| miR-145 | CAGGTCAAAAGGGTCCTT | TCCCTAAGGACCCTTTTGA |
| | AGGGA | CCTG |
| | (SEQ ID NO: 11) | (SEQ ID NO: 12) |
| miR-146 | ACTCTTGACTTAAGGTACC | TTGGGTACCTTAAGTCAA |
| | CAA | GAGT |
| | (SEQ ID NO: 13) | (SEQ ID NO: 14) |
| miR-155 | AATTACGATTAGCACTATC | TGGGGATAGTGCTAATCG |
| | CCCA | TAATT |
| | (SEQ ID NO: 15) | (SEQ ID NO: 16) |
| miR-17 | GTTTCACGAATGTCACGTC | GATGGACGTGACATTCGT |
| | CATC | GAAAC |
| | (SEQ ID NO: 17) | (SEQ ID NO: 18) |
| miR-21 | ATCGAATAGTCTGACTACA | AGTTGTAGTCAGACTATTC |
| | ACT | GAT |
| | (SEQ ID NO: 19) | (SEQ ID NO: 20) |
| miR-210 | GACACGCACACTGTCGCC | AGTCGGCGACAGTGTGCG |
| | GACT | TGTC |
| | (SEQ ID NO: 21) | (SEQ ID NO: 22) |
| miR-221 | TCGATGTAACAGACGACC | CTTTGGGTCGTCTGTTACA |
| | CAAAG | TCGA |
| | (SEQ ID NO: 23) | (SEQ ID NO: 24) |
| miR-222 | TCGATGTAGACCGATGAC | TGGGTCATCGGTCTACATC |
| | CCA | GA |
| | (SEQ ID NO: 25) | (SEQ ID NO: 26) |
| miR-223 | ACAGTCAAACAGTTTATG | ACCCCATAAACTGTTTGA |
| | GGGT | CTGT |
| | (SEQ ID NO: 27) | (SEQ ID NO: 28) |
| mIR-29b | ATCGTGGTAAACTTTAGTC | TTGTGACTAAAGTTTACCA |
| | ACAA | CGAT |
| | (SEQ ID NO: 29) | (SEQ ID NO: 30) |

TABLE 3
Sequence of F3 and B3 primers used for
DNA extension amplification with PCR

| DNA Extension Gene | Primer | Sequence |
|---|---|---|
| Salmonella | F3 | CAGGCGATTGCTAACCGTT |
| enterica fliC | | (SEQ ID NO: 31) |
| | B3 | CAGACTGGGAGTTGGTGC |
| | | (SEQ ID NO: 32) |
| Leptospira | F3 | ACTGCCTGAGTCTATGGTT |
| interrogans secY | | (SEQ ID NO: 33) |
| | B3 | GCCGTTTACTTTGAAAGGAAT |
| | | (SEQ ID NO: 34) |
| Streptococcus | F3 | CACAAGGCATTGACCCTG |
| agalactiae lmb | | (SEQ ID NO: 35) |
| | B3 | GCACCTTTTTAAATTTTTGAGTG |
| | | (SEQ ID NO: 36) |

TABLE 4
FIP and BIP primers used for LAMP reactions
(F3 and B3 primers used were specific to the
ligated microRNA - sequences are listed in
Table 3).

| | | |
|---|---|---|
| Salmonella | FIP | GCGCAATGGAGATACCGTCG- |
| enterica | | TTCCGCGAACATCAAAGGTCT |
| typh. FliC | | (SEQ ID NO: 37) |
| | BIP | CCACTGAAGGCGCGCTGAA- |
| | | CTGTTAGCAGACTGAACCGC |
| | | (SEQ ID NO: 38) |
| Leptospira | FIP | ACACCGTCAAGGAAATGAGAAGAAT- |
| interrogans | | CAACTTTTCTCTACCGATACG |
| sec Y | | (SEQ ID NO: 39) |
| | BIP | TTAACGCAAGGTGTGAGAAAGG- |
| | | TTGACTCTTGGCCTGAAC |
| | | (SEQ ID NO: 40) |
| Streptococcus | FIP | AGCTCTTTAGCGATATTAACAGCTT- |
| agalactiae | | TTTATGACCCACATACCTCC |
| lmb | | (SEQ ID NO: 41) |
| | BIP | AGGACGTTTGGATCCTAAACACAA- |
| | | TCTTCAGTTAGTTGCTCTGC |
| | | (SEQ ID NO: 42) |

TABLE 5
Expression of microRNAs with the potential as biomarkers for various types of cancer

| | | Sample | Expression | Fold | |
|---|---|---|---|---|---|
| microRNA | Cancer | Type | in Cancer | Change | References |
| miR-100 | Esophageal squamous | Serum | Up | 2.1 | Zhang, et al, (2010), |
| | cell carcinoma | | | | Clin Chem. 56: 1871-9 |
| miR-106a | Gastric cancer | CTC^{a} in | Up | 37 | Zhou, et al., (2010), |
| | | blood | | | J Mol Med (Berl). 88: |
| | | | | | 709-17 |
| miR-125b | Breast cancer | Tissue | Down | N/A | Iorio, et al., (2005), |
| | | | | | Cancer Res. 65: 7065-70 |
| miR-126 | Malignant | Tissue | Down | 18 | Santarelli, et al., (2011), |
| | mesothelioma | | | | PLoS One. 6: e18232 |
| miR-141 | Prostate cancer | Serum | Up | 46 | Mitchell, et al., (2008), |
| | | | | | Proc Natl Acad Sci |
| | | | | | USA. 105: 10513-8 |
| miR-143 | Gastric cancer | Tissue | Up | N/A | Li, et al., (2011), |
| | | | | | Oncol Rep. 26: 1431-9 |
| miR-145 | Breast cancer | Tissue | Down | N/A | Iorio, et al., (2005), |
| | | | | | Cancer Res. 65: |
| | | | | | 7065-70 |
| miR-146a | Gastric cancer | Tissue | Up | N/A | |
| miR-155 | Lung cancer diffuse | Plasma | Up | 17 | Lawrie, et al., (2008), |
| | large B cell lymphoma | | | | Br J Haematol. 141: |
| | | | | | 672-5 |
| miR-17 | Gastric cancer | CTC in | Up | 37 | Zhou, et al., (2010), |
| | | blood | | | J Mol Med (Berl). 88: |
| | | | | | 709-17 |
| miR-221 | Melanoma | Serum | Up | 68 | Kanemaru, et al., (2011), |
| | | | | | J Dermatol Sci. 61: |
| | | | | | 187-93 |
| miR-210 | Diffuse large B | Serum | Up | 4.2 | Lawrie, et al., (2008), |
| | cell lymphoma | | | | Br J Haematol. 141: |
| | | | | | 672-5 |
| miR-21 | Breast cancer | Tissue | Up | N/A | Iorio, et al., (2005), |
| | | | | | Cancer Res. 65: 7065-70 |
| miR-222 | Prostate cancer | Tissue | Up | N/A | Galardi, et al., (2007), |
| | | | | | J Biol Chem. 282: |
| | | | | | 23716-24 |
| miR-223 | Lung cancer | Serum | Up | 3.3 | Chen, et al., (2008), |
| | | | | | Mod Pathol. 21: |
| | | | | | 1139-46 |
| miR-29b | Changiocarcinoma | Tissue | Down | 7 | Garzon, et al., (2009), |
| | | | | | Blood. 114: 5331-41 |
| miR-let-7a | Gastric cancer | Plasma | Down | 2 | Tsujiura, et al., (2010), |
| | | | | | Br J Cancer. 102: 1174-9 |

^{a}CTC = Circulating tumor cells

TABLE 6
Tt values obtained with various microRNAs and DNA extensions.

| | | Repli- | Repli- | Repli- |
|---|---|---|---|---|
| DNA Extension | microRNA | cate 1 | cate 2 | cate 3 |
| Salmonella enterica | miR-126 | 7.5 | 7.5 | 7.5 |
| fliC | miR-222 | 8.25 | 8.25 | 8.25 |
| | miR-221 | 6.75 | 6.75 | 6.75 |
| | miR-145 | 7.5 | 7.5 | 7.5 |
| | miR-125b | 6 | 6 | 6 |
| | miR-106a | 6 | 6 | 6 |
| | miR-143 | 5.25 | 6 | 6 |
| | miR-223 | 5.25 | 6 | 6 |
| | miR-21 | 6 | 6 | 6 |
| | miR-155 | 6 | 6.75 | 6.75 |
| | miR-29b | 6.75 | 6.75 | 6.75 |
| | miR-146 | 6 | 6 | 6 |
| | miR-17 | 6 | 5.25 | 6 |
| | miR-100 | 6 | 6 | 6 |
| | miR-210 | 6 | 6 | 6 |
| | miR-let-7a | 8.25 | 9 | 9 |
| Leptospira interrogans | miR-let-7a | 9 | 9 | 8.25 |
| Streptococcus agalactiae | miR-let-7a | 6.75 | 6.75 | 6.75 |

TABLE 7
Comparison of slopes (p values) between regression lines

| | | | | | | Linear |
|---|---|---|---|---|---|---|
| microRNA | 223 | 21 | 155 | 221 | 141 | Equation |
| miR-223 | 1 | 0.93 | 0.97 | 0.99 | 0.89 | y = −4.54 × |
| | | | | | | +57.6 |
| miR-21 | 0.93 | 1 | 0.96 | 0.94 | 0.96 | y = −4.33 × |
| | | | | | | +56.0 |
| miR-155 | 0.97 | 0.96 | 1 | 0.98 | 0.92 | y = −4.00 × |
| | | | | | | +53.7 |
| miR-221 | 0.99 | 0.94 | 0.98 | 1 | 0.90 | y = −4.00 × |
| | | | | | | +55.9 |
| miR-141 | 0.89 | 0.96 | 0.92 | 0.90 | 1 | y = −3.95 × |
| | | | | | | +56.3 |

DNA Extension Amplification. The 180 bp DNA extension was obtained using PCR and genomic DNA of various bacterial targets. The templates that were used for testing three separate DNA extension sequences included: Leptospira interrogans (ATCC BAA-1198), Streptococcus agalactiae (ATCC BAA-1138), and Salmonella enterica typh. (ATCC 700720). Template DNA was re-suspended in sterile, DEPC-treated and nuclease-free water (Fisher Scientific). Primers were designed using Primer Explorer software for LAMP reactions (Eiken Chemical Company) and validated for specificity using BLAST software Altschul, et al., (1990), Journal of molecular biology. 215:403-10. Primers were designed to target: the fliC gene for S. enterica, the lmb gene for S. agalactiae, and the secY gene for L. interrogans. Primers were ordered as 25 nmol DNA oligonucleotides (Integrated DNA Technologies—IDT). The SYBR Green PCR Core Reagents kit (Applied Biosystems) was used for amplification, which included: Amplitaq Gold DNA Polymerase (250 Units, 5 U/μl), 12.5 mM dNTP Mix, 10×SYBR Green PCR Buffer, and 25 mM MgCl₂ solution. The PCR profile included: Taq activation temperature of 95° C. held for 10 min, denaturation phase at 95° C. for 30 sec, annealing phase at 56° C. for 30 sec, and elongation phase was held at 72° C. for 30 sec. The profile was repeated 40 cycles. The PCR product was purified using QIAquick PCR Purification Kit (QIAGEN). DNA concentrations were measured using Qubit fluorometer (Invitrogen).

cDNA Strands. Single stranded, complementary DNA strands representing reverse transcribed microRNA were obtained as 0.25 nmol DNA Oligos from Integrated DNA Technologies (IDT). Strands were then annealed together to form the double-stranded product. Oligos were resuspended to equimolar concentrations (100 μM) and equal volumes were mixed and incubated at 90-90° C. for 3-5 min. The mixture was then allowed to cool to room temperature for 45-60 min.

Phosphorylation of the 5′ Termini. Approximately 10,000 units/ml T4 Polynucleotide Kinase (New England Biolabs) was used to phosphorylate the 5′ termini of the simulated reverse-transcribed microRNA and the DNA extension. T4 Polynucleotide Ligase Buffer (New England Biolabs) was used in place of the kinase buffer because it contains 10 mM ATP and T4 Polynucleotide Kinase exhibits 100% activity in the buffer. The 50 μl reaction contained 300 μmol of 5′ termini and 1×T4 Polynucleotide Kinase. The reagents were incubated at 37° C. for 30 min.

Quick Ligation. Ligation of the microRNA to the DNA extension was completed with Quick Ligation Kit (New England Biolabs). Approximately 50 ng of the DNA extension was combined with a 3 fold molar excess of the insert. The 2× Quick Ligase Buffer was added to the mixture follows by the Quick Ligase. The mixture was incubated at room temperature for 5 min.

LAMP Reactions with Gene-Z™. A 2× reaction was created to include 2× ThermoPol Buffer (New England Biolabs), 0.28 mM dNTPs (Invitrogen), 1.6 mM Betaine solution (Sigma Life Sciences), 12 mM MgSO₄ (New England Biolabs) and sterile water (Fisher Scientific). The master mix for the LAMP reaction contained 1× reaction mix, 16 units BST Polymerase (New England Biolabs), 20 μM SYTO81 orange fluorescent nucleic acid stain (Invitrogen), 1% Pluronic F-68 (Invitrogen), and 10×BSA (New England Biolabs). Primers were designed with the Primer Explorer software and were verified for specificity with BLAST software Altschul, et al., (1990), Journal of molecular biology. 215:403-10. Primers for the LAMP reactions were obtained through Integrated DNA Technologies (Table 2, 3, 4). Thus in one embodiment, reagents for use with BST polymerase included but were not limited to dNTPs, Betaine solution, MgSO₄, and sterile water, orange stain (orange dye), Pluronic F-68, BSA (bovine serum albumen), etc.

Microfluidic Chips.

Shelled microfluidic 64 reaction well chips were fabricated using a novel mechanism for hot embossing to allow for robust fabrication with thin plastics (approximately 100 μm). The length and dimensions of channels (250×250 μm) were designed so that loading with sample would not be hindered by dust. Channel length and dimensions were designed to hinder crossover of amplicons or primers between adjacent wells during amplification. Thus, a valve mechanism for closing individual reaction wells was not required. Chips were fabricated as described herein. Briefly, the chip consisted of the following: 1) a layer of polyester with channel features formed via hot embossing, 2) a hydrophobic membrane placed over evacuation holes for air to escape without sample overflow during channel loading, and 3) a layer of tape to enclose the channels. For dehydration of assays onto the chips, primers were added to each well with a pipette, prior to applying the enclosing tape layer. Chips were then placed on a heat plate at 95° C. for 1 min and visually inspected to ensure primers had dried completely. Approximately 50 μl of the master mixture was loaded into each of the four channels (n=15 reaction wells) and the chips were sealed using a second layer of adhesive tape. LAMP reactions were run at 63° C. for 50 min in a Gene-Z™ nucleic acid amplification device.

A nucleic acid amplification device of the present inventions included an optical setup for detecting fluorescence, a controlled heater, an internal rechargeable battery, and an iPod user interface, as described herein. Briefly, the optical setup had one LED and optical fiber for each well, emitted fluorescence signal from reactions was transmitted to a single photodiode. Advantageous characteristics of the optical setup include: i). obtaining raw fluorescent signals without the need to process images, ii). no moving parts, iii). small size for placing in a hand-held cartridge, and iv). inexpensive, reliable and low power consumption. Further advantages of this setup include the use of physical sensors (photodiodes and thermocouples) that are generally favored over more complex sensors due to low cost and reliability. For alignment with the optical components, an anodized aluminum holder was machined with negative chip features. Resistive strip heaters are embedded beneath the aluminum holder along with a rapid response thermocouple for temperature sensing. Precise control of Gene-Z™ components was obtained using an ARM7 microcontroller, which has become an industry standard, used in approximately 98% of mobile phones sold (see Krazit, (2006), CNET News), due to low power consumption. Code for the microcontroller was generated using the National Instruments Lab View module for reliable performance and generates extra code to prevent common coding mistakes that would cause an embedded application to crash or function incorrectly.

### Example VIII

This example presents data related to amplification device of the present inventions, for example, Gene-™, performance comparison with commercial real time thermocycler.

A dilution series of miR-100 was prepared with concentrations representing the useful range of detection described for microRNA (10²-10⁹ copies). In detail, dilutions of the microRNA were spiked into a concentration of the DNA extension to represent expected microRNA ratios. Each channel (n=15) was loaded with a ten-fold dilution of the miR-100 mixture, and one channel was loaded without template to serve as the negative control. Reactions in a Gene-Z™ nucleic acid amplification device showed amplification from approximately 10²-10⁹ copies (FIG. 14B). With the dilution of 100 copies per reaction, amplification was observed in 3 out of 15 reaction wells in the microfluidic chip. When tested on a commercial real time cycler (used isothermally), the dynamic range was 10³ to 10⁹ copies per μl of serum. A 10-fold superior lower limit of detection observed with Gene-Z™ was attributed to 15 replicates that were possible due to miniaturization. triplicates of each dilution were run on the commercial thermocycler. Standard deviation of Tₜ was also comparable between a Gene-Z™ and the commercial thermocycler further demonstrating potential for reproducible quantification. Lower dilutions and the negative control did not show amplification in either platform.

### Example IX

This example describes some embodiments of experiments performed to: 1) concentrate cells from water samples, 2) demonstrate an exemplary Gene-Z™ device used with a disposable microfluidic chip developed for use in the present inventions for “sample in-result out” quantification of Dehalococcoides spp.

Based on their importance as potential biomarkers for remediation of chlorinated solvents He, et al., (2003), Appl. and Environ. Microb. 69:996-1003; Müller, et al., (2004), Appl. Environ. Microb. 70:4880-4888, 16S rRNA and vcrA gene sequences of DHC (SDC-9™, Shaw Environmental, Vainberg, et al., (2009), J. Indust. Microbial. Biotechnol. 36:1189-1197 were selected. LAMP primers were designed using Primer Explorer V4, synthesized by Integrated DNA Technologies (IDT, Coralville, Iowa), and dispensed into the card during assembly. Four μL of samples were mixed with 36 μL of LAMP master mix and then loaded in the card. Reagent concentration, conditions for LAMP, and calculation of time to threshold (Tt) have been described previously Stedtfeld, et al., (2012), Lab on a Chip. DOI: 10.1039/C2LC21226A. For comparison, samples were also tested on the commercially available Chromo4™ Real-time PCR detector (BioRad Laboratories, Hercules, Calif.) using 1 μL of sample and 9 μL of LAMP master mix. Based on the tested cell concentrations, three different processing schemes were adopted (FIG. 21A).

Range 1: Greater than 10⁷ cells L⁻¹: A dilution series of DHC SDC-9™ cells (originally 8.0±1.8×10¹¹ copies L⁻¹ as described by suppliers) was subjected directly to LAMP using both primer sets in a Gene-Z™ and Chromo4™. The detection limit, based on three out of three replicates showing amplification on the Chromo4™ and three or more wells showing amplification in the microfluidic card in a Gene-Z™, was 10⁷ cells L⁻¹ with the 16S rRNA gene and 10⁸ cells L⁻¹ for the vcrA gene (FIGS. 21B,C) on both devices.

Acceptable rates of in situ chlorinated solvent degradation have been observed when DHC concentrations are greater than 10⁷ cells L⁻¹. As such, the method proposed here approaches the simplicity of “sample in-results out” because there is no sample concentration or DNA extraction. The sample was added to LAMP reagents and loaded on the card for direct cell-based amplification. The card is then placed in a Gene-Z™ device and the reaction proceeds in less than 50 minutes. The difference in sensitivity between the 16S rRNA and vcrA gene assays is common and highly dependent on primer sets and number of genes per cell.

Range 2: 10⁶-10⁷ cells L⁻¹: For a lower range of cells, a concentration protocol was tested by filtering 100 mL of varying cell dilutions (10⁵ to 10¹⁰ cells L⁻¹) through Sterivex filters (SVGPL10RC, Millipore, Billerica, Mass.). After filtration, concentrated cells were released from the filter by adding 0.9 mL of elution buffer (14600-50-NF-1A and 14600-50-NF-1B, PowerWater® Sterivex™ DNA Isolation Kit, MoBio), vortexing the filters at minimum speed for 10 min, and eluting into a syringe. Both filtered and non-filtered solutions were tested in the microfluidic cards (FIG. 21A). The vcrA gene target was tested using the Range 2 filtration protocol. For non-filtered samples, amplification was observed in each well (16/16) for dilutions from 10¹² and 10⁹ cells L⁻¹. For the non-filtered dilution of 10⁸ cells L⁻¹, six reaction wells showed amplification. However, using the filtration protocol, amplification was observed in each well down to 10⁶ cells L⁻¹.

Other studies on chlorinated solvent contaminated sites showed that Sterivex filters are efficient for concentrating biomass Ritalahti, et al., (2010), Environ. Sci. Technol. 44:5127-5133. However, cells were previously collected from Sterivex cartridges by either removing the membrane from the housing and washing, or using lysate mixtures directly added to the filter and subsequent incubation at 37° C. for 1-3 hours Ritalahti, et al., (2010), Environ. Sci. Technol. 44:5127-5133; Riemann, et al., (2000), Appl. Environ. Microb. 66:578-587. In this study, a cell elution solution was tested as a simple method to remove cells from the filter with minimal intervention. Furthermore, the cell elution solution did not appear to inhibit LAMP directly from cells.

Range 3: Less than 10⁶ cells L⁻¹: For concentrations less than 10⁶ cells L⁻¹, a bench-top sample filtration system may be necessary. An additional experiment was performed by filtering 1 L and 4 L of a 10⁵ cells L⁻¹. Each of the reaction wells displayed amplification with 4 L of filtered solution, while two of the 16 reaction wells displayed amplification with 1 L. Thus, the filtration of the larger volume was able to improve the limit of detection to the range of 10⁵ cells L⁻¹.

Therefore, in some embodiments, a device of the present inventions is used in methods of detecting cells in samples wherein target cells have a concentration of less than 10⁷ cells L⁻¹. In other embodiments, target cells have a concentration of less than 10⁶ cells L⁻¹. In yet further embodiments, target cells have a concentration of less than 10⁶ cells L-1. In additional embodiments, cells undergo filtration prior to testing. Thus, the inventors contemplate the use of devices and methods of the present inventions for direct amplification of nucleic acids from mildly permeabilized cells. While the mechanism for allowing direct amplification from damaged cells is unclear, in situ LAMP was shown successful in nucleic acid amplification with mild permeabilization conditions due to the use of the smaller 67 kDa Bst polymerase compared to 94 kDa Taq DNA polymerase Maruyama, et al., (2003), Appl. Environ. Microb. 69:5023-5028.

In other embodiments, the inventors contemplate the use of devices and methods of the present inventions in bioremediation. Thus in one embodiment, instead of identifying pathogens methods of the present inventions find use in detecting desired organisms related to bioremediation.

### Example X

This Example describes some embodiments of experiments performed to demonstrate an exemplary Gene-Z™ device used with a disposable microfluidic chip developed for use in the present inventions for early detection and quantification of invasive species from lake waters with minimal sample preparation.

This example describes using a low cost environmental DNA-based monitoring system based on microfluidic chips and a hand-held gene analyzer to screen for five high-risk invasive species in lake waters. Markers for target species if present in the e-DNA are amplified using isothermal technique. Enumeration of copy number of target species was carried out using the real time hand-held gene analyzer named Gene-Z™. Developing an early warning system based on cDNA of multiple high priority species requires measuring the cDNA with the best possible limit of detection at the lowest cost in the simplest manner. Existing capabilities to develop and implement this capability include: i) a hand-held gene analyzer, ii) isothermal approach that is less inhibited by extraneous materials present in the sample, iii) a microfluidic chip that costs less than $5 and yet is able to measure 64 assays in parallel, iv) preliminary data demonstrating the usefulness of the complete system, and v) skillset available with the team for multiplexed low cost detection system. As described earlier, cDNA has a higher likelihood of detection compared to traditional methods Darling and Mahon, (2007), Biological Invasions 9:751-765 and has been shown for golden mussel under field conditions. Using the complete 18S ribosomal RNA gene sequence of Zebra mussel (D. polymorphs, Genbank ID:AF120552), LAMP primers were designed for isothermal amplification of target DNA in Lake Lansing water which is infested with Zebra mussel. Using the described microfluidic chip and the device, positive amplification was detected within 15 min. in 1 μl of lake water sample without sample processing. For samples collected 60 feet from the shore, positive amplification was observed in less than 20 min with the modification of recovering DNA in the sample by ethanol precipitation using a larger volume of sample (approximately 100× concentration).

Concerning direct cell amplification for quantitative detection, samples were tested as i) isolates alone (Escherichia coli), ii) a consortium of Dehalococcoides, i.e. more than one species, and iii) fungal spores obtained directly from leaves, using the amplification cards and a Gene-Z™ device.

### Example XI

This example describes some embodiments of experiments performed to demonstrate an exemplary Digital DX device used with a disposable microfluidic chip developed for use in the present inventions for detection and quantification of most probable number by digital endpoint microLAMP assay.

Digital endpoint microLAMP assays targeting the gadA gene and the gelE gene were performed with 10-fold serial dilutions of E. coli and E. faecalis respectively from 10⁵ cells to 0.01 cell. For each dilution, 5 replicates were performed to calculate the MPN concentrations of the assays by using the 10-fold dilution of 5-tube MPN analysis. As LAMP primers for gadA gene of E. coli were not tested earlier. Therefore, RT_{f}-LAMP assay from single E. coli cell was performed on a commercial PCR instrument at 63° C. to confirm the single-cell level sensitivity of the designed assay. The designed RT_{f}-LAMP assay of E. coli (gadA gene) was sensitive to single cell (FIG. 35). This RT_{f}-LAMP assay showed slower amplification (Tt: 27 min) than the single cell assay designed for uidA gene. Therefore, for the MPN-based endpoint microLAMP assays, microchips were incubated for 40 min before imaging.

The applied assumptions were that bacteria were distributed in the sample without any clustering and wells containing even a single viable bacterium would produce the growth/amplification. We have also assumed that the MPN values at the microscale volume would be consistent with the milliliter volume as used in the developed method. The result rejection method is based on that if the dilutions provide the positive results, the calculation would include the most diluted samples. If the dilutions provide the negative results, calculation would include the most concentrated samples.

Endpoint microLAMP assay of gadA gene of E. coli showed amplification from 10⁵ cells to single cell (FIG. 35A). However, 2 out of 5 positive controls wells containing single cell showed amplification. Amplification was not observed at the highest dilutions of 0.1 and 0.01 cell. Based on the 5-well MPN analysis [5 2 0], average MPN concentration of single cell dilution was 0.49 cell (p=0.05) per 2 μL of reaction volume. Endpoint microLAMP assay of gelE gene of E. faecalis showed amplification from 10⁵ cells to single cell (FIG. 35B). However, 3 out of 5 positive controls wells containing single cell showed amplification.

No amplification was observed with the highest dilutions of 0.1 and 0.01 cell. Based on the 5-well MPN analysis [5 3 0], average MPN of single cell dilution was 0.79 cell (p=0.05) per 2 μL of reaction volume. These results showed that the endpoint LAMP assays had a large dynamic range and single cell-level sensitivity. This approach of digital LAMP would be highly useful for the detection of extremely low concentration of target cells in higher reaction volume. Digital PCR and digital recombinase polymerase amplification assays based on DNA amplification have already been reported, which relies on the readout of high throughput reaction wells (positive/negative) at the end of reaction, for example, see, Pohl and Shih, (2004), Expert Review of Molecular Diagnostics. 4:41-47; Shen, et al., (2011), Analytical Chemistry. 83:3533-3540. Applicability of digital LAMP is contemplated to be further increased by performing higher number of single cell dilutions in the presence of clinical samples.

### Example XII

This example describes cutting channels and wells to make an Airlock design in the microfluidic chip using a laser cutter.

The material used in the fabrication of microfluidic chips were PMMA sheets (Poly(methyl methacrylate)) (McMaster, Chicago, Ill., USA) with the thickness of 1.6 mm. A commercially available desktop CO₂ laser system (Full Spectrum Laser LLC, Las Vegas, Nev., USA) was used in the micromachining. The maximum output power of the laser is 40 W, and the cutting power and speed can be varied from 0% to 100% by RetinaEngrave USB, a controlling software developed by the laser supplier.

The laser supports two machining modes: vector cutting and raster engraving. In vector mode, the laser traces vector drawing data such as lines, polylines, and curves which allows cutting or carving thin channels on PMMA. In raster engraving mode, the laser sweep left to right like a jet printer which allows the engraving of an area in a bitmap image.

In this work, the reaction wells are fabricated by engrave mode with 45% power and 20% speed; and the microchannels are cut by vector mode with 30% current, 20% speed and a various power (5%-65%) for different channel depth.

### Example XIII

This example describes using a Gene-Z™ device and isothermal amplification for direct detection of organisms related to corrosion and souring in upstream collection and processing of oil.

Approximately $300 billion is lost due to corrosion in the U.S. each year, Kane and Briegel, (2007), see website at www.isa.org. Solely considering the petroleum industry, microbial activity is responsible for biofouling, microbiologically influenced corrosion (MIC), emulsion problems, reservoir souring, and the degradation of petroleum in reservoirs, with conservative estimate costs of $82 billion. Environmental and societal impacts are even greater as microbial corrosion leads to oil spills such as the well-publicized oil spill in Prudhoe Bay, Ak. pipeline in 2006. The petroleum industry utilizes a combination of microbial monitoring, physical cleaning (i.e. “pigs”), and chemical biocide to combat these problems. In the United States alone, millions of gallons of toxic chemical biocides are applied yearly to pipelines, fracking waters and storage tanks, at costs in excess of $1 billion. Bacterial monitoring is typically rolled into the price of the overall biocidal treatment program at a 1-3% cost to the supplier. Therefore, the industry spends approximately $10-$30 million in the United States alone on biocide monitoring supplies.

Anaerobic sulfate-reducing prokaryotes (SRBs) pose a particular threat to the industry due to their ability to reduce sulfates to sulfides, releasing sulfuric acid and hydrogen sulfide (H₂S) as byproducts. The most widely used standards for monitoring SRBs in the oilfield industry include antiquated techniques such as microscopy and culture-based most probable number (MPN) enumeration. To perform MPN analysis, serial dilutions of samples are placed into microbiological media, an approach referred to as “bug bottles”. Bug bottles are particularly attractive because they are eminently adaptable to field conditions and are easy to prepare and interpret. However, culture-based bug bottles suffer from biases caused by un-culturable organisms, provide minimal information on the identity of SRBs, and require up to 28 days for growth to occur. With this in mind, multi-million dollar decisions on the amount and types of chemical biocides to apply are made based on MPN analysis results. The petroleum industry recognizes these limitations and desires an improved, commercially available alternative. A genetic diagnostics platform that is also inexpensive and field orientated has even greater potential to replace current methodologies. As such, a Gene-Z™ device has been tested for detection of sulfate reducing bacteria. In detail, four primers have been designed targeting Desulfovibrio vulgaris Hildenborough strain. Based on initial results, one of the primers was selected for further validation including an experiment testing various dilutions of genomic DNA.

### Example XIV

This example describes using the Gene-Z™ device and isothermal amplification for direct detection of pathogens on infected plant substrates

Towards demonstrating a field-able tool used for genetic diagnostics of plant pathogen. Experiments have been performed testing fungal spores of Pseudoperonospora cubensis, which is responsible for down mildew in cucumber plants, with loop-mediated isothermal amplification. Studies have included testing a dilution series of both genomic DNA and spores per amplification reaction, and direct amplification of spores from infected cucumber leafs. Results have demonstrated direct amplification from fungal spore, amplification from leaf with minimal sample preparation, and detection limit of 1 spore per reaction allows potential for digital LAMP.

### Example XV

This example describes using the Gene-Z™ device and isothermal amplification for direct detection of single nucleotide polymorphisms and mutations in genetic targets to identify antibiotic resistance.

Genomic DNA from wild type M. tuberculosis (ATCC 25177), was obtained from the American Type Culture Collection (ATCC, Manassas, Va.) and re-suspended in diethylpyrocarbonate-treated, nuclease-free sterile water (Fischer Scientific, Pittsburgh, Pa.). The wild type katG DNA contain the codon S315, which has the sequence AGC and code for a serine amino acid. For the mutant DNA, the 200 bp sequence that was used for the primer design was synthesized and incorporated industrially piDTSMART:ampicilin:blunt plasmid (IDT, Coralville, Iowa). This sequence contained the mutated codon S315T, which has the sequence AGG (instead of AGC) and code for a threonine (T) rather than a serine (S). Both targets (the wild type DNA and the synthetic mutated DNA) were diluted to a concentration of 104 copies/microliter using the conversion factor of 670 g/mole of base pairs.

A set of six specific LAMP primers was designed (FIP, BIP, F3, B3, LF and LB) targeting the wild type codon 5315 of the katG gene. The F3, B3, LF, LB and FIP primers were designed using Primer Explorer version 4 (Eiken Chemical Co., LTD, Tokyo, Japan, see website at primerexplorer.jp/e) and the BIP primer was designed manually. FIP and BIP were designed so that both they contains the polymorphism in the penultimate position of their respective 3′ ends. The specificity of the primer sets was checked against the GenBank database using NCBI BLAST.

LAMP reactions were performed in a volume of 20 microliter consisting of 1.6 μM each of FIP and BIP primers, 0.2 μM each of F3 and B3 primers, 0.8 μM each of LF and LB primers, 0.8 M betaine (Sigma, St Louis, Mo.), 1.4 mM of each dNTP (Invitrogen Corporation, Carlsbad, Calif.), 20 mM Tris-HCl (pH 8.8), 10 mM (NH₄)2SO4, 10 mM KCl, 8 mM Mg504, 8 mM Triton X-100, 0.2 to 2.4 units/microliter of Bst DNA polymerase, large fragment (New England Biolabs Inc., Ipswich, Mass.), 0.04 μg/μL of mismatch repair initiation protein Taq mutS (Affymetrix, Santa Clara, Calif.) and 2 μM SYTO-81. Samples were loaded in 200-microL PCR tubes (VWR International, West Chester, Pa.) and incubated at 64° C. for 40-60 min

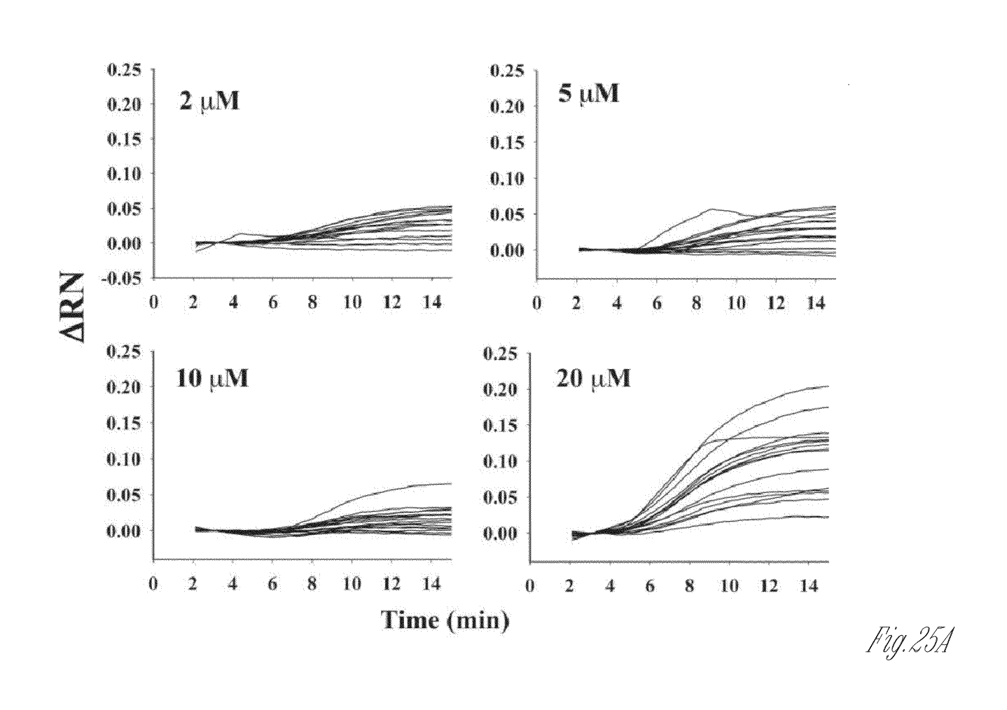

The possibility to detect isoniazid-resistance in M. tuberculosis was evaluated on the 5315 polymorphism of the katG gene. This polymorphism was chosen because it counts for 40-60% of the mutations associated to isoniazid resistance. A primer set was designed to detect the wild type genotype and was evaluated using the wild type target sequence (purified genomic DNA,) and a mutation-containing synthetic sequence (G->C on the codon 315). This experience was based on the hypothesis that an imperfect match would result in a delayed or absent amplification. Alternatively, the same experience was performed in the presence of Taq mutS, a mismatch repair initiation protein that is known to increase the discrimination of mismatch hybridized primers (FIG. 27). LAMP amplification profile of the wild type primers for katG. In the presence of Taq mutS (right panel) the wild type DNA triggers an amplification. In the absence of Taq mutS, both targets result in amplifications, but the mutant amplification time is about 10 min longer than for the wild type.

In the absence of mutS, it was possible to observe an amplification signal for the wild type target after roughly 20 min. An amplification signal was also observed using the mutated target, but after a period of about 30 min.

### Example XVI

This example describes an alternative embodiment for making microfluidic chips including exemplary layout and operation of the microfluidic chips.

In one embodiment, a microfluidic chip is 6.5 cm×8.5 cm in size and consisted of four arrays each with 16 interconnected reaction wells (FIG. 6). Microchannels were 250×250 μm and the reaction wells were 750 μm deep, with a volume of roughly 1 microliter each (FIG. 6). The volume of sample loaded per array was 30 microliter, of which roughly half remained in the microchannels. To prevent cross-contamination between the connected reaction wells, the microfluidic chip was designed such that the distance between neighboring reaction wells was approximately 15 mm in channel length.

The chip was loaded using a conventional pipetter through an access port that fitted snugly around the pointed end of 200 μL pipette tip, resulting in filling of the reaction wells within a few seconds. In the process, air inside the microchannels was purged out through the air vents placed downstream of each reaction well (FIG. 6). The assembled chip contained hydrophobic membranes that prevented liquid from exiting the chip during sample dispensing. After loading, the inlet port and air vents were sealed with tape to prevent contamination. In a contemplated embodiment, the sample-dispensing process will be further simplified to eliminate the use of a pipetter.

Chip Fabrication:

In one embodiment, a chip was fabricated out of 127 μm polyester film (8567K52, McMaster Carr) and biocompatible optical film with pressure-sensitive adhesive (MicroAmp Optical Adhesive Film; Applied Biosystems). Fabrication consisted of four steps: i) micro-structuring of the polyester film, ii) dispensing and dehydrating of LAMP primers in the reaction wells, iii) patterning the adhesive films and hydrophobic membrane using a commercial-grade knife plotter, and iv) assembly and bonding of the chip.

Micro-structuring of the polyester films was performed in a heated press (model 4386; Carver, Wabash, Ind.) by rubber-assisted hot embossing. The embossing mold was fabricated by stereolithography out of high resolution Somos NanoTool (FineLine Prototyping; Raleigh, N.C.). The mold was subsequently thermally cured to increase its glass transition temperature and coated with a thin layer of nickel (SLArmor) to facilitate de-embossing. A landing shoulder was placed around the length of the mold to improve pressure build up around the chip features by preventing excessive lateral squeeze-out flow of the rubber tool during embossing. The embossing process consisted of sandwiching the polyester film between the mold and high temperature resistant rubber (60 A, silicon rubber, 86045K463, McMaster Carr, Aurore, Ohio), followed by heating to 218° C., applying a pressure of 6,300 kg for 1 min, cooling to 93° C. while maintaining the embossing pressure, and de-embossing after further cooling to room temperature. An appropriate amount of LAMP primers was subsequently dispensed in the chips and dehydrated for 15 min at 45° C. The adhesive film for bonding of the chips was patterned using a commercial-grade knife plotter (CraftROBO Pro CE5000-40-CRP; Graphtec, Irvine, Calif.), equipped with a 0.9 mm 45° cutting blade. Finally, the chip was visually aligned with adhesive film and pre-cut gas-permeable hydrophobic membrane (GVHP 09050, Millipore). The hydrophobic membrane was placed over the air vents, between the micro-structured polymer layer and the patterned adhesive film. Subsequently, the chip was firmly bonded in the Carver press at 1600 kg, with a layer of 60 A rubber placed below the chip to obtain an uniform seal. A manually drilled plastic inlet port was attached using double-sided adhesive tape.

In other embodiments a chip was made using the following procedure. Material: One Carver Hydraulic Press (with water cooling system): Model 3851, Carver, Inc, Wabash, Ind.; One 6″×6″×0.25″ FDA-compliant Silicon Rubber (Durometer of 60 A), McMaster Carr, Elmhurst Ill.; Two 6″×6″×0.035″ Economy-grade Stainless Steel Sheet (type 430), McMaster Can; One 5″×5″×0.005″ Clear Polyester Film, McMaster Carr; One Craft Robot Pro plotter, Graphtec America, Inc., Irvine, Calif.; One Craft Robot Pro Carrier sheet A3, Graphtec America, Inc., Irvine, Calif.; Two Optical films: MicroAmp optical adhesive Film (PN: 4311971), Life Technologies, Carlsbad, Calif.; One Durapore Membrane Filter, Millipore Corporation, Billerica, Mass.; Double sided tape JVCC DC-1114, Findtape.com, Skillman, N.J.; One Aluminum mold, Proto Labs, Mapple Plain, Minn.; and Scissors.

Step 1: Press.

Cut a piece of polyester (about 5″×5″) using the scissors Turn-on the carver press and set the temperature at 425° F. for each heated platen During heating: place the mold at the center of a steel plate; place the polyester sheet on top of the mold; place the rubber on top of the polyester sheet; place another steel plate on top of the rubber; place the whole “sandwich” between the two platen of the press; Apply 500 pounds of pressure and wait for temperature to rise. Once at temperature (425° F.): apply 12,000 pounds of pressure; turn the cooling system on (e.g., turn the water on). Wait for system to cool down to about 200° F. Release pressure (turn the release pressure valve to anti-clockwise). Remove the “sandwich” from the press, remove the steel plates, the rubber and detach the chip from the mold manually. Make sure the integrity of the chip is ok (no visible breakpoints or holes).

Step 2: Preparation of Patterned Hydrophobic Membrane:

Turn the plotter on; Place the membrane on the carrier sheet (at the spot that is indicated on the carrier sheet); Place a protective blue disc (furnished with the membranes) on top of the membrane; Fix the preparation by using a layer of adhesive film; Place the carrier sheet in the plotter with the membrane facing up; Lock the carrier sheet (pull “levier” in the back) and press “enter” on the plotter. Turn the software on and load the membrane pattern file named Membrane.GSD; Press “cut”, a little confirmation window will open; Press “enter” and another conformation window will open; Press “enter” and the plotter will begin to cut. Once the plotter has completed its task: pull “levier” down on the plotter and remove the carrier sheet; detach the optical tape and the blue disc from the carrier sheet; remove the parts of membrane that are not wanted using a sharp blade; remove the membranes one by one using a sharp blade, and place them in a petri dish for later use.

Step 3. Preparation of the Patterned Adhesive Film:

Turn the plotter on; Place the optical film, liner facing up, on the carrier sheet (at the indicated spot); Place the carrier sheet in the plotter; Lock the carrier sheet (pull “levier” in the back) and press “enter” on the plotter. Turn the software on and load the adhesive pattern file named Film.GSD. Press “cut”, a little confirmation window will open; Press “enter” and another conformation window will open; Press “enter” and the plotter will begin to cut. Once the plotter has completed its task: pull the “levier” down on the plotter and remove the carrier sheet; using a double-side tape, remove the cutoff parts; and detach the adhesive film from the carrier sheet. Using an air duster, remove any cutoff parts that stayed trapped on the blade

Step 4: Preparation of the Chip:

Place the patterned hydrophobic membranes at the appropriate spots on the chip. Tape the patterned adhesive on the chip. Make sure it is well aligned with the membrane and the chip.

Step 5: Finalization of the Chip:

Place the chip, structure facing up, on a steel plate; Place the rubber on top of it; Place another steep plate on top of the rubber; Place in the hydraulic press (at room temperature) and apply 5,000 pounds of pressure for ten seconds; Release pressure and remove the chip. Using a photo-cutter, cut the edges of the chip; and Seal the four edges of the chip using a plastic bag sealer (line sealer).

The following is an exemplary method for chip fabrication. Exemplary materials include:
One Carver Hydraulic Press (with water cooling system): Model 3851, Carver, Inc, Wabash, Ind.
One 6″×6″×0.25″ FDA-compliant Silicon Rubber (Durometer of 60 A), McMaster Can, Elmhurst Ill.
Two 6″×6″×0.035″ Economy-grade Stainless Steel Sheet (type 430), McMaster Can
One 5″×5″×0.005″ Clear Polyester Film, McMaster Can
One Craft Robot Pro plotter, Graphtec America, Inc., Irvine, Calif.
One Craft Robot Pro Carrier sheet A3, Graphtec America, Inc., Irvine, Calif.
Two Optical films: MicroAmp optical adhesive Film (PN: 4311971), Life Technologies, Carlsbad, Calif.
One Durapore Membrane Filter, Millipore Corporation, Billerica, Mass.
Double sided tape JVCC DC-1114, Findtape.com, Skillman, N.J.
One Aluminum mold, Proto Labs, Mapple Plain, Minn.
Scissors

Step 1:

Use a hydraulic press to mold a chip base into a sheet of plastic and polyester film. i) Cut a piece of polyester (about 5″×5″) using the scissors. ii) Turn-on the carver press and set the temperature at 425° F. for each heated platen. During heating: i) place the mold at the center of a steel plate, ii) place the polyester sheet on top of the mold, iii) place the rubber on top of the polyester sheet, iv) place another steel plate on top of the rubber, v) place the whole “sandwich” between the two platen of the press, vi) Apply 500 pounds of pressure and wait for temperature to rise. Once at temperature (425° F.): i) apply 12,000 pounds of pressure, ii) turn the cooling system on (e.g., turn the water on), iii) Wait for system to cool down to about 200° F. iv) Release pressure (turn the release pressure valve to anti-clockwise). V) Remove the “sandwich” from the press, remove the steel plates, the rubber and detach the chip from the mold manually. vi) Make sure the integrity of the chip is ok (no visible breakpoints or holes).

Step 2: Preparation of Patterned Hydrophobic Membrane.

i) Turn the plotter one. ii) Place the membrane on the carrier sheet (at the spot that is indicated on the carrier sheet). iii) Place a protective blue disc (furnished with the membranes) on top of the membrane. iv) Fix the preparation by using a layer of adhesive film. v) Place the carrier sheet in the plotter with the membrane facing up. Lock the carrier sheet (pull “levier” in the back) and press “enter” on the plotter. vi) Turn the software on and load the membrane pattern file named Membrane.GSD, vii) Press “cut”, a little confirmation window will open., viii) Press “enter” and another conformation window will open, ix) Press “enter” and the plotter will begin to cut. Once the plotter has completed its task: i) pull “levier” down on the plotter and remove the carrier sheet, ii) detach the optical tape and the blue disc from the carrier sheet, iii) remove the parts of membrane that are not wanted using a sharp blade, iv) remove the membranes one by one using a sharp blade, and place them in a Petri dish for later use.

Step 3. Preparation of the Patterned Adhesive Film:

i) Turn the plotter on. ii) Place the optical film, liner facing up, on the carrier sheet (at the indicated spot). iii)

Place the carrier sheet in the plotter. iv) Lock the carrier sheet (pull “levier” in the back) and press “enter” on the plotter. v) Turn the software on and load the adhesive pattern file named Film.GSD. vi) Press “cut”, a little confirmation window will open. vii) Press “enter” and another conformation window will open. viii) Press “enter” and the plotter will begin to cut. Once the plotter has completed its task: i) pull the “levier” down on the plotter and remove the carrier sheet, ii) using a double-side tape, remove the cutoff parts, iii) detach the adhesive film from the carrier sheet. iv) using an air duster, remove any cutoff parts that stayed trapped on the blade.

Step 4: Preparation of the Chip:

i) Place the patterned hydrophobic membranes at the appropriate spots on the chip. ii) Tape the patterned adhesive on the chip. iii) Make sure it is well aligned with the membrane and the chip.

Step 5: Finalization of the Chip:

i) Place the chip, structure facing up, on a steel plate, ii) Place the rubber on top of it, iii) Place another steep plate on top of the rubber, iv) Place in the hydraulic press (at room temperature) and apply 5,000 pounds of pressure for ten seconds, v) Release pressure and remove the chip, vi) Using a photo-cutter, cut the edges of the chip, vii) Seal the four edges of the chip using a plastic bag sealer (line sealer).

In one embodiment, a chip was fabricated out of 1.650 mm PMMA and biocompatible optical film with pressure-sensitive adhesive (MicroAmp Optical Adhesive Film; Applied Biosystems). Fabrication consisted of four steps: i) micro-structuring of the PMMA film using a laser (Full Spectrum Laser LLC, ii) dispensing and dehydrating of LAMP primers in the reaction wells, iii) assembly and enclosing of the channels and wells of the chip with pressure sensitive adhesive, iv) placing a cap on the top of the chip to allow the user to seal the reaction inside the chip with the cap, i.e. a user sealable cap. In some embodiments, the cap is a screw cap.

### Example XVII

This example describes stability of freeze dried Tag polymerase and BST polymerase and optimization of Trehalose concentrations for use in compositions and methods of the present inventions.

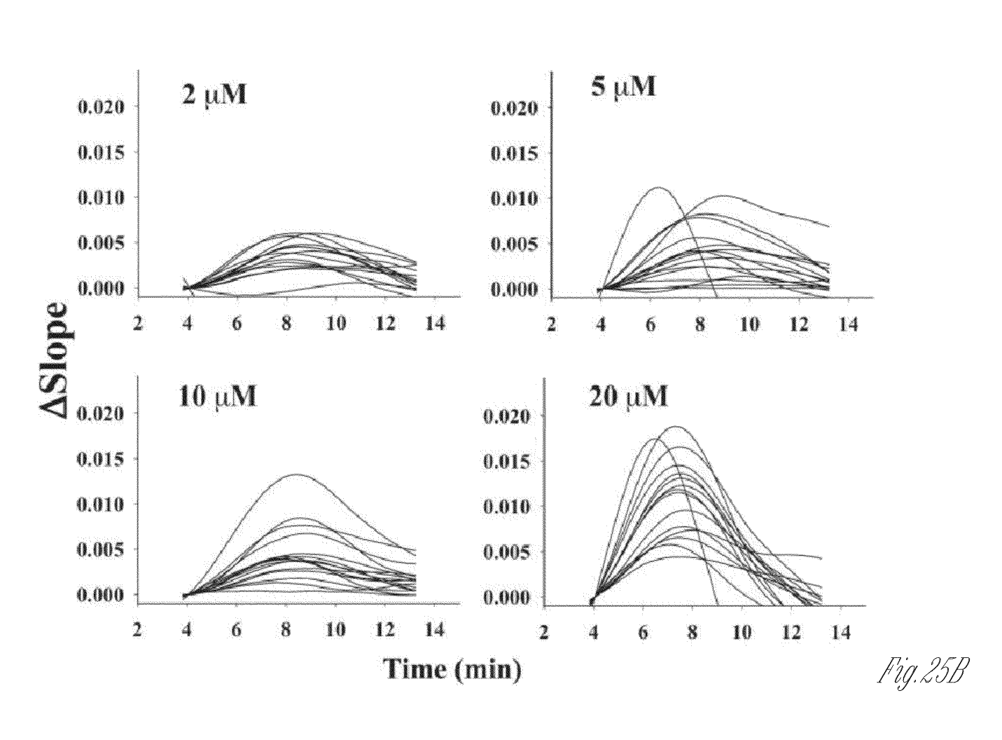

For field applications of an amplification chip comprising primers and probes of the present inventions, the inventors contemplate chips with primers and reagents already dispensed in them. However, this implies that the primers/polymerase/reagents must be made stable at room temperature or even under hot climates. A common practice to obtain freeze-dried reagents is to add sugar (e.g., Trehalose) at the time of freeze-drying. Optimization of the trehalose concentration and stability of the freeze-dried reagents for long periods (6 to 12 months) are two key aspects. A trehalose concentration of 15% has generally been reported as optimal in literature and confirmed by the inventors, although lower concentrations seem to work as well. The reagents were stable for at least one month (FIG. 28).

### Example XVIII

This example describes Real-Time Loop-Mediated Isothermal Amplification-based Rapid and Sensitive Detection of Waterborne Pathogens on Microchips with the optics of the Digital DX system. A CCD with exposure control is used to significantly reduce the time of the amplification reaction.

The effect of CCD exposure time on the fluorescence signals from 10 ng, 1 ng, 0.1 ng, 0.01 ng, and 0 ng dsDNA standard stained with 2 μM SYTO-82 were evaluated by imaging the microchip with increasing exposure times from 1 ms to 60 s. Images of dsDNA standard dilution series on microchip with increasing exposure times are shown in the supporting information. The fluorescence signals from the DNA concentrations and the negative controls increased with increasing exposure times and finally reached to saturation. From an exposure time between 1 ms to 0.1 s, fluorescence signals varied between 4029 a. u. to 4395 a. u. (background) and showed an exponential rise from exposure time between 0.1s to 10s. After 10 s of exposure time, the fluorescence signals reached the saturation value of 65535 a. u. However, the fluorescence signals from 10 ng and 1 ng DNA showed an increase from 0.01s exposure time. Also the fluorescence signals from 10 ng and 1 ng DNA were relatively higher than the signals from the negative control for the exposure time between 0.5s to 5s. For example, fluorescence signals from 10 ng and 1 ng DNA were approximately 8-fold and 3-fold higher than negative control at 0.5s of CCD exposure time and 6.5-fold and 5-fold higher than the negative control at 5s of CCD exposure time, respectively. The lower fluorescence signals from the negative control in comparison to 10 ng and 1 ng DNA standard were due to the low autofluorescence of SYTO-82 dye. SYTO-82 has a substituted unsymmetrical cyanine structure, providing very low autofluorescence in unbound state due to flexibility of its structure in aqueous environment. This cyanine structure becomes rigid in the presence of nucleic acids, providing high fluorescence signals. A 50-fold lower detection limit with 2 μM SYTO-82 in real-time PCR assay, when compared with 14 other DNA intercalating dyes. Fluorescence signals from 0.1 ng and 0.01 ng DNA were nearly similar to the fluorescence signals from the negative control for the applied CCD exposure times. This effect might be due to the lower amount of dsDNA standard available to bind with SYTO-82 dye, producing the fluorescence signals similar to the negative control. The inventors tested to see if by applying the exposure time effect to microRT_{f}-LAMP might lead to faster increment in SNR due to the collection of relatively higher fluorescence signals from the positive controls than the background, reducing the Tt of assay.

Effect of CCD exposure time on SNR and Tt values of microRT_{f}-LAMP assays: The effect of CCD exposure time on the SNR and Tt were evaluated for two different LAMP assays for V. cholerae toxR gene and C. parvum gp60 gene (10⁵ gene copies) for the exposure time of 1 s, 3 s, and 5 s. CCD exposure time was limited to 5 s, as applying an exposure time higher than 5 s either saturated the signal in the positive wells or provided a high background. The SNR and Tt values of microRT_{f}-LAMP assays at these exposure times were also compared with a real-time PCR instrument. A systematic increment in the SNR and reduction in the Tt values of microRT_{f}-LAMP assays were obtained with increasing exposure time as compared to the real-time PCR instrument (Tab. 1). Negative controls did not show any increase in the fluorescence signal.

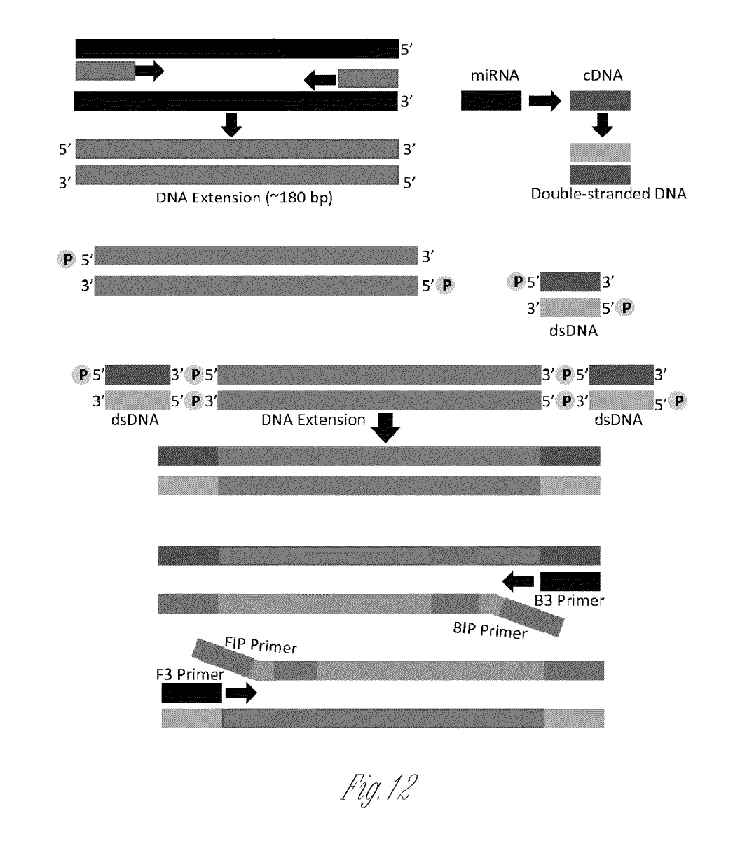

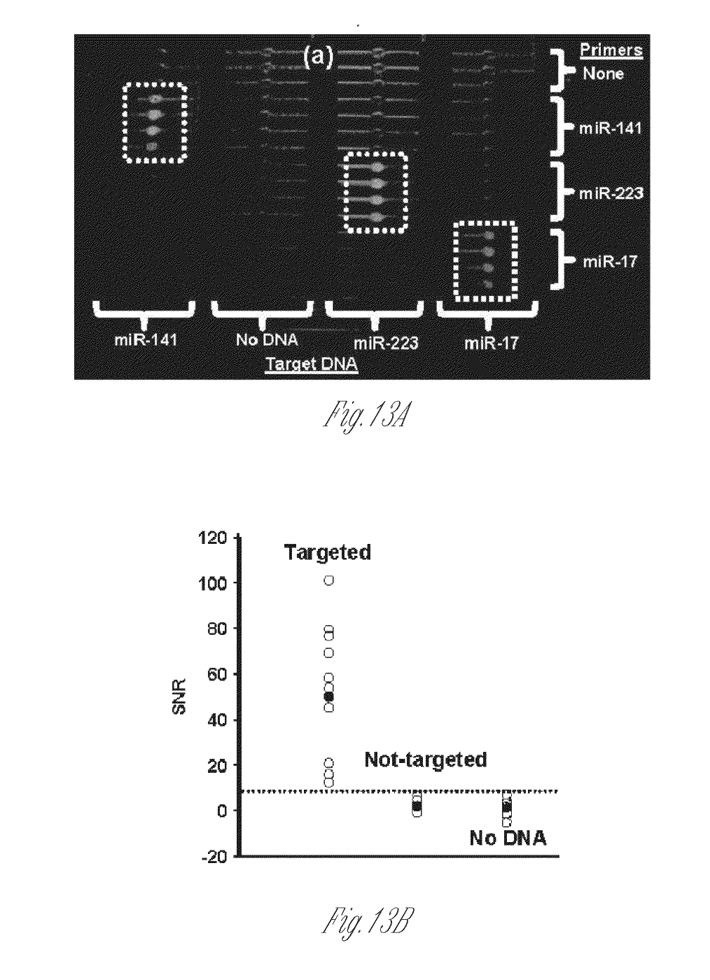

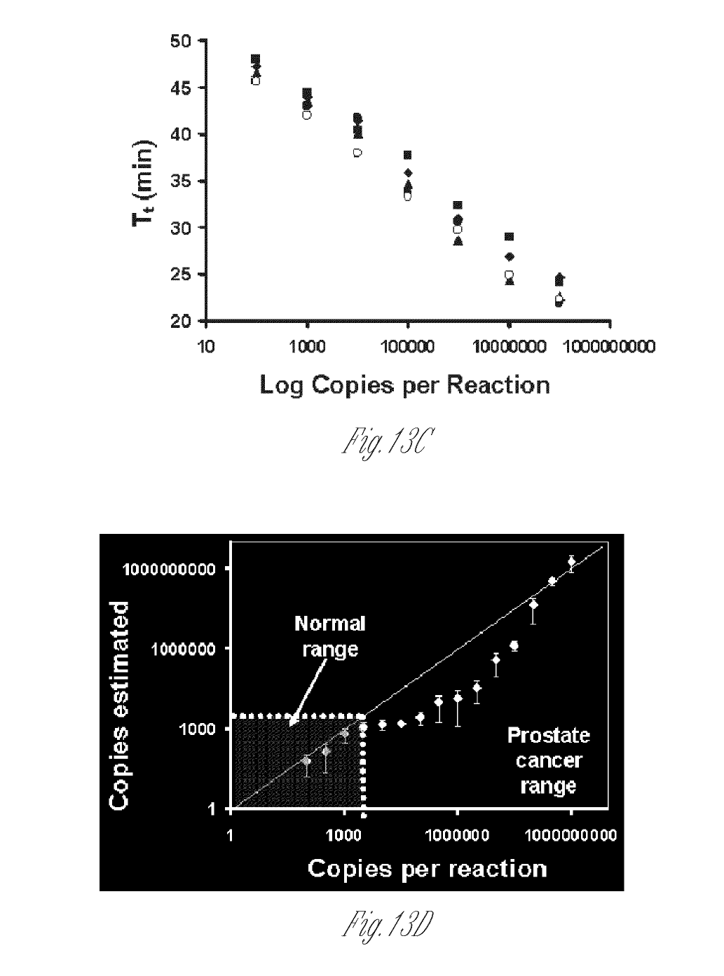

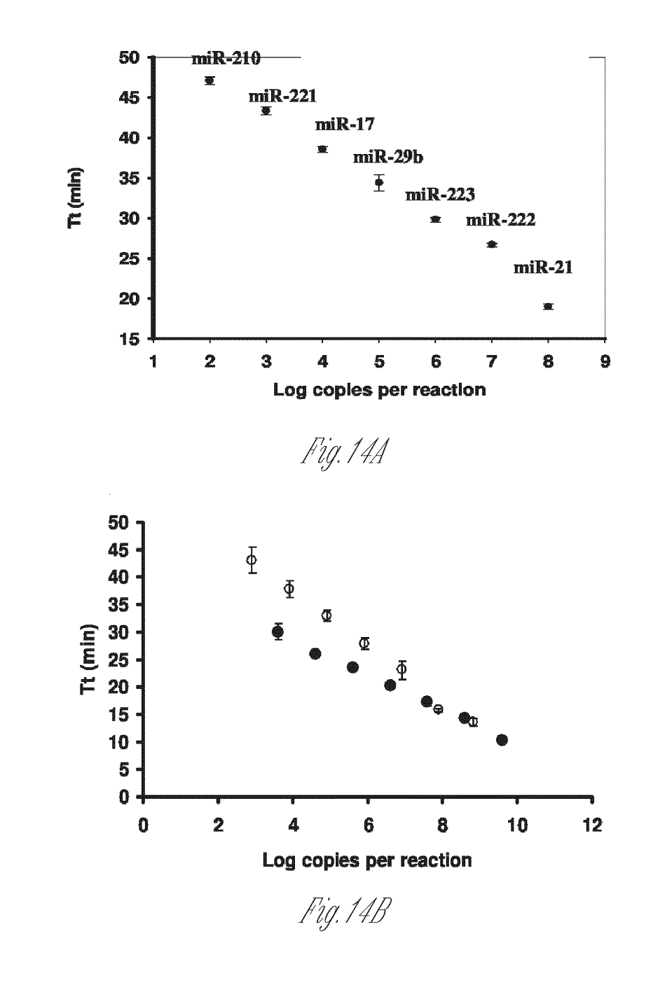

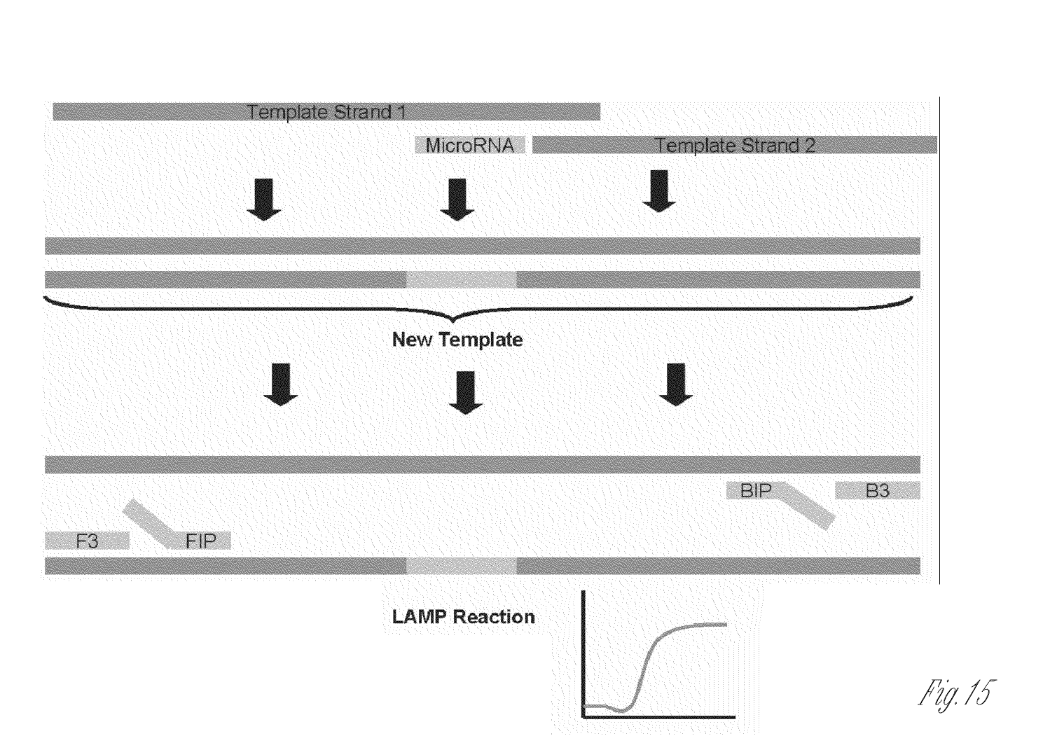

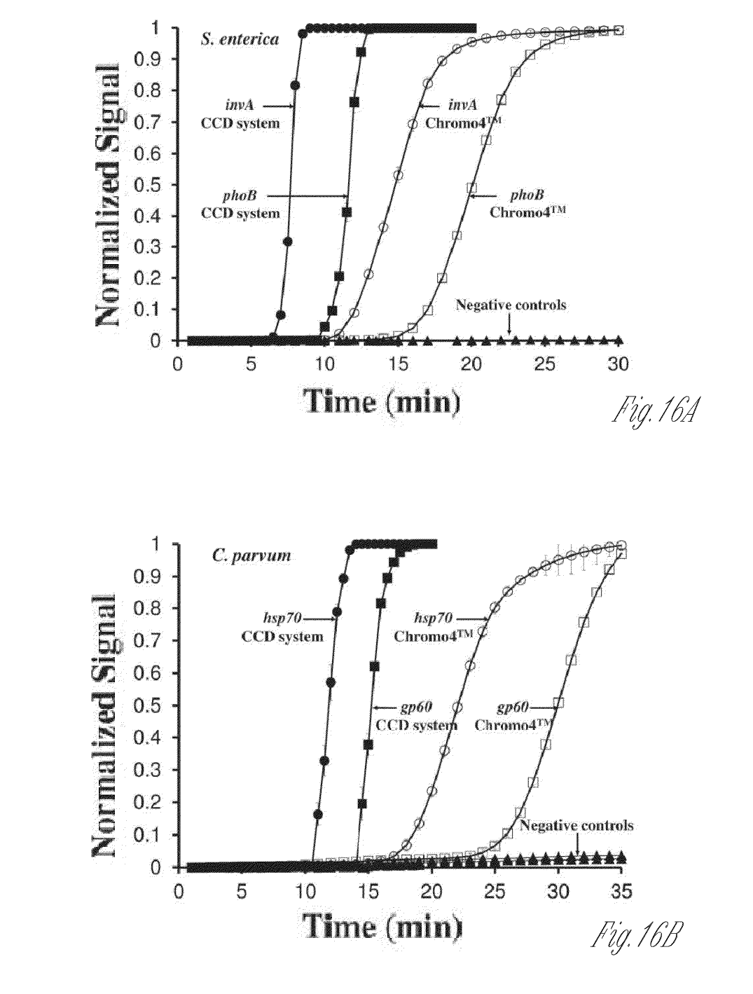

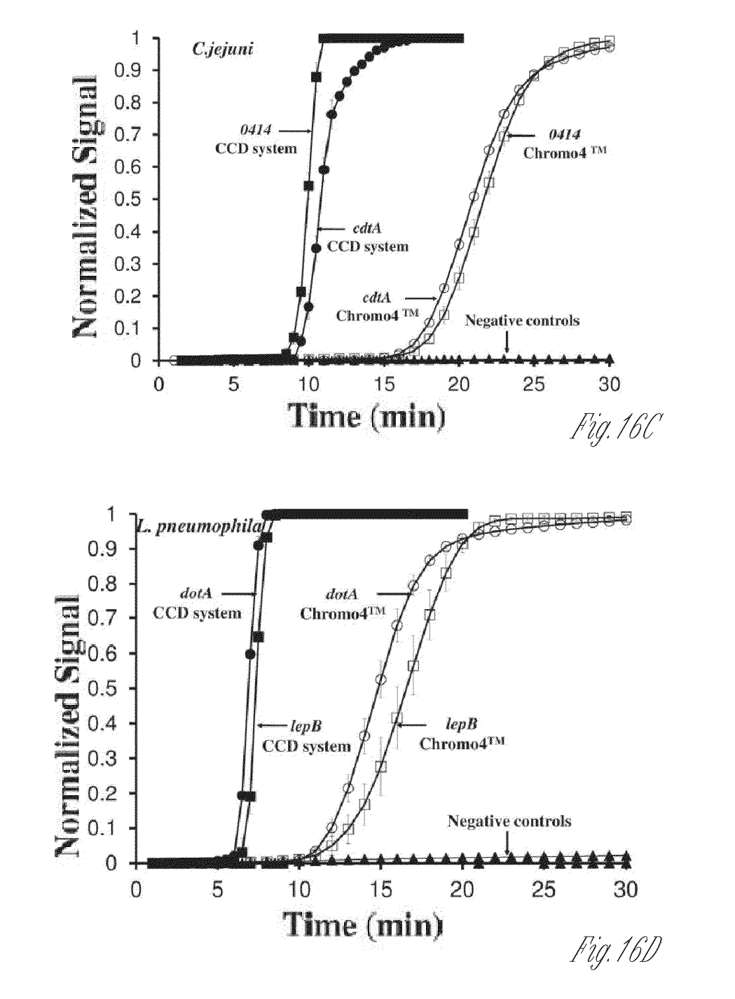

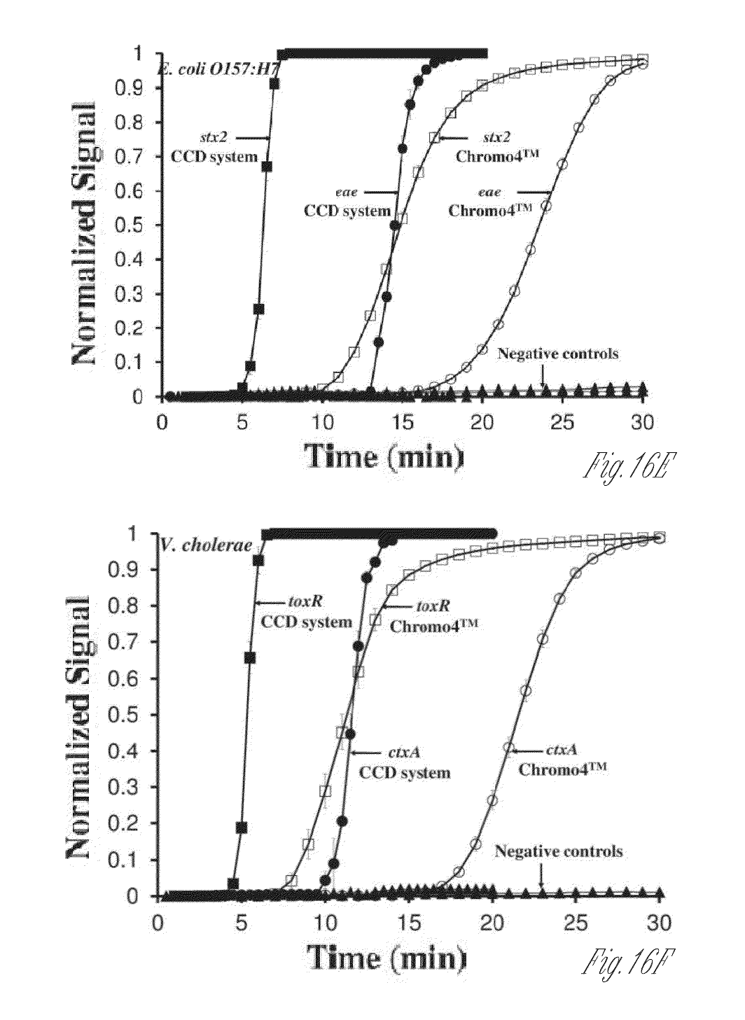

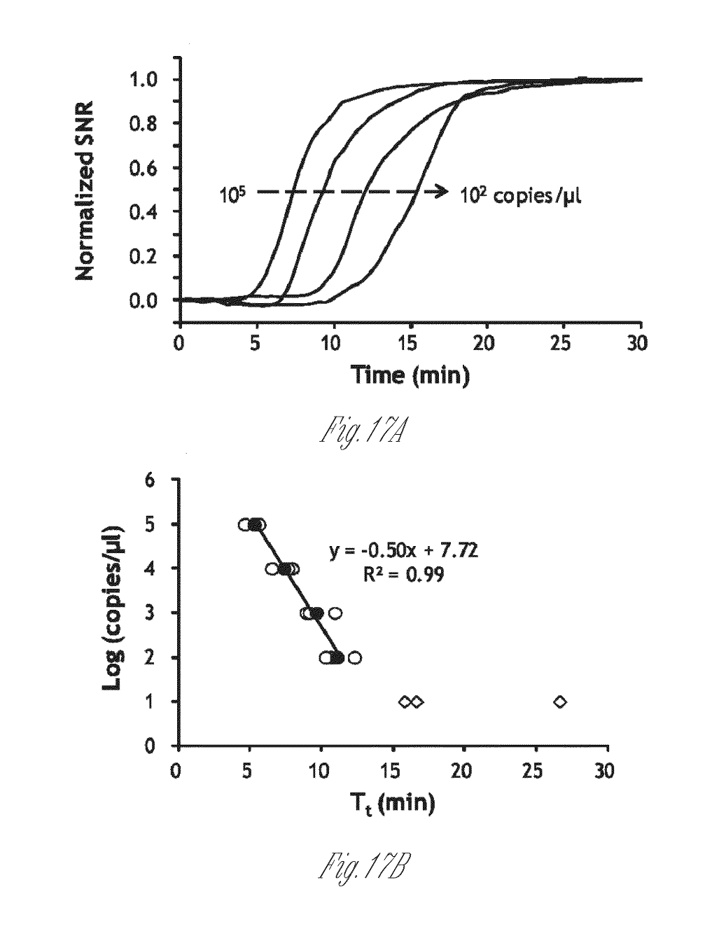

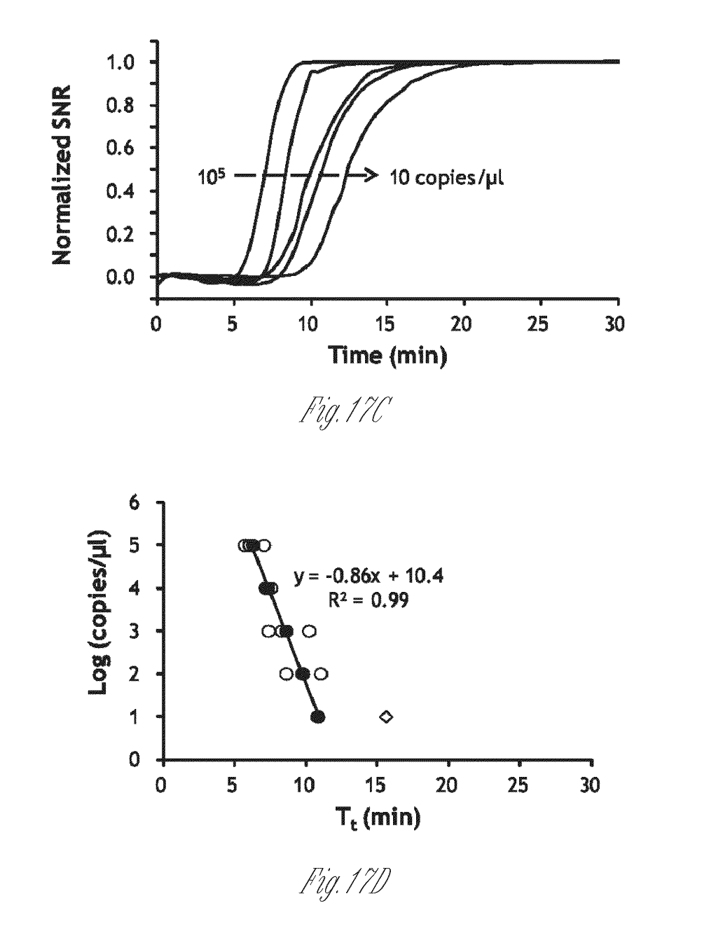

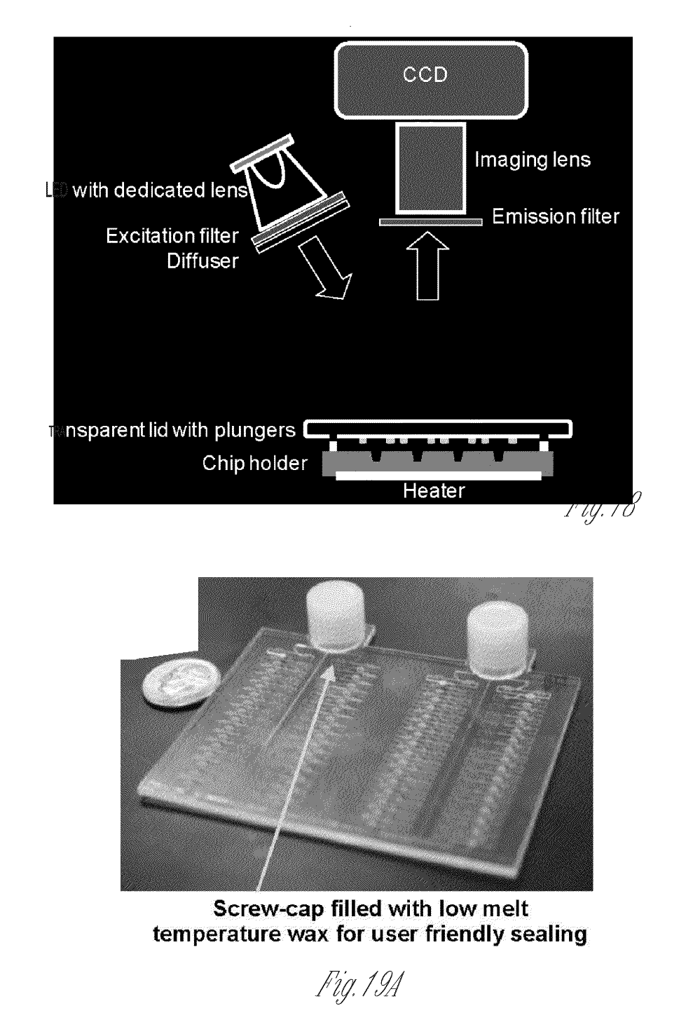

For microRT_{f}-LAMP assay of V. cholerae toxR gene, SNR and Tt values for 1 s, 3 s, and 5 s CCD exposure times were 21.8 and 5.8 min, 14.8 and 5 min, and 70.8 and 5 min respectively. Tt at 3s and 5s of CCD exposure time was same as 5 min. However, SNR at 5s of exposure time was approximately 5-fold higher than SNR at 3 s of exposure time. SNR and Tt for the same assay on the real-time PCR instrument were 28.3 and 7.7, respectively. Moreover, Tt values for the microRT_{f}-LAMP assay with the applied CCD exposure times were lower than the Tt obtained on the real-time PCR instrument (FIG. 16). Time lapse images of microchips during the amplification of V. cholerae toxR gene at 1 s, 3 s, and 5 s of exposure time showed that higher fluorescence signals were achieved faster at higher exposure time. For microRT_{f}-LAMP assay of C. parvum gp60 gene, SNR and Tt values for 1 s, 3 s, and 5 s CCD exposure time were 12.1 and 18.7 min, 12.6 and 15 min, 206 and 14.5 min, respectively. A difference in Tt value of 0.5 min was observed for microRT_{f}-LAMP assay with 3 s and 5 s of CCD exposure time. However, SNR at 5 of CCD exposure time was 16-fold higher than the SNR at 3 s of CCD exposure time. SNR and Tt values for the same assay on the real-time PCR instrument were 16.3 and 24.3 min, respectively. A 9.8 min difference in Tt value of microRT_{f}-LAMP with 5 s of CCD exposure time and real-time PCR instrument was observed. Kimura, et al., (2007), J Biochem Biophys Methods. 70:499-501 demonstrated that the reaction time is highly dependent on the physical properties of LAMP primers such as GC content, melting temperature, and free energy of hybridization. As the same LAMP reaction conditions had been applied, the difference in Tt values of these two LAMP assays (V. cholera toxR gene and C. parvum gp60 gene) was due to the difference in the characteristics of LAMP primers and target DNA.

Mori, et al., (2001), Biochem. Biophys. Res. Commun. 289:150-154 showed that for a 60 min turbidity-based LAMP with 6000 starting DNA copies, the amplicon yield was approximately 400 ng/μl. MicroRT_{f}-LAMP assays used during development of the present inventions had 10⁵ starting DNA copies, reaction volume of 2 μl, and total amplification time of 20 min for 5 s CCD exposure time. Estimated reaction kinetics for microRT_{f}-LAMP of the present inventions indicate yields of more than 267 ng amplicons in 2 μl reaction volume in 20 min. Further, this would produce approximately 70 ng amplicons in 5 min (minimum Tt value of microRT_{f}-LAMP), which should provide higher fluorescence from positive microRT_{f}-LAMP relative to the background at higher exposure times. This effect was similar to the increase in the fluorescence signals from 10 ng and 1 ng dsDNA standard in comparison to the negative control by increasing the CCD exposure times. Yang, et al., ((2008), 80:8532-8537) reportedly observed an increment in signal-to-background ratio from chemiluminescence immunoassay with increasing CCD exposure times. Similarly, SNR values of positive microRT_{f}-LAMP assays showed consistent increment (relative to the background) with increasing exposure times, reducing the Tt values of these assays. However, this effect was not expected to be present from the fluorescence LAMP measured on a real-time bench top PCR instrument, which used a photodiode detector.

MicroRT_{f}-LAMP assays of waterborne pathogens. CCD-based imaging system was validated for 12 virulent genes of 6 waterborne pathogens using SYTO-82 dye and real time fluorescence LAMP on V-shaped microchips. Major waterborne pathogenic bacteria including, S. enterica (invA and phoB gene), C. jejuni (0414 and cdtA gene), L. pneumophila (dotA and lepB gene), E. coli O157:H7 (stx2 and eae genes), and V. cholerae (toxR and ctxA genes), and a protozoan, C. parvum (hsp70 and gp60 genes) were selected from the list of Centers for Disease Control and Prevention Lee, et al., (2002), Morb Mortal Wkly Rep. 51:1-28. MicroRT_{f}-LAMP assays for 12 virulent genes of waterborne pathogens (10⁵ gene copies) were performed at 5 s of CCD exposure time and compared with the real-time fluorescence LAMP on a real-time PCR instrument. A reduction in Tt values ranging from 2.7 min to 9.8 min was achieved for microRT_{f}-LAMP assays in comparison to real-time PCR instrument (Table 9). LAMP primer sets, which were slower (higher Tt) on real-time PCR instrument showed higher reduction in the Tt values on microchip than the LAMP primers which were relatively faster (lower Tt) on the real-time PCR instrument. For example, LAMP primer set for C. parvum gp60 gene showed the slowest amplification on the real-time PCR instrument with Tt of 24.3 min, which was reduced by 9.8 min on the microchip assay. LAMP primer set for V. cholerae toxR gene was the fastest on the real-time PCR instrument with an amplification time of 7.7 min, which was reduced by 2.7 min on microchip assay. Moreover, standard deviations in the Tt values of microRT_{f}-LAMP assays were either same or lower than the real-time PCR instrument.

A LAMP primer set for C. jejuni 0414 gene was evaluated for the dilution series of 14, 1.4, and 0.14 DNA copies, by a real-time turbidometer, for example, see, Yamazaki, et al., (2008), J. Med. Microbial. 57:444-51. Average Tt values for real-time fluorescence LAMP assays measured during the development of the present inventions were similar to their reported average values of Tt for real-time turbidity Yamazaki, et al., (2008), J. Med. Microbial. 57:444-51. However, there was a high deviation in their Tt values between the replicates. Similarly, Chen and Ge, (2010), BMC Microbial. 10: reported observations on the variations in the Tt values of the replicates of real-time turbidity-based LAMP, when compared with real-time fluorescence-based LAMP for the same target of V. parahaemolyticus toxR gene. Other studies reported the real-time fluorescence LAMP assays as faster, more sensitive, and more reproducible than real-time turbidity-based LAMP, for examples, Chen and Ge, (2010), BMC Microbial. 10:; Aoi, et al., (2006), J Biotechnol. 125:484-91. Very low standard deviations was measured in the Tt values of real-time fluorescence LAMP assays on microchips and a real-time PCR instrument. Lee et al. (2008) reported an optical system equipped with a photodiode for monitoring real-time turbidity-based μLAMP assay. A slight variation in the intensity of excitation light or its alignment to the detector was able to affect the turbidity value due to the additional scattering of photons Lee, et al., (2008), Sens. Actuators, B Chem. 133:493-501. However, fluorescence signals from CCD-based microchip assays such as μPCR Dahl, et al., (2007), Biomed Microdevices. 9:307-314 or microRT_{f}-LAMP (used herein) were not affected by slight sample misalignment.

MicroRT_{f}-LAMP assay for quantitative analysis of C. jejuni. To establish standard curves for quantitative analysis, real-time fluorescence LAMP assays targeting 0414 gene were performed on microchips with 5 s CCD exposure time and on a real-time PCR instrument with 10-fold serial dilutions of C. jejuni DNA ranging from 10⁵ to 1 copy. The standard curves were established by plotting the Tt values versus log of the number of genomic DNA copy used in RT_{f}-LAMP assays. Both the microRT_{f}-LAMP and RT_{f}-LAMP assay on commercial real-time PCR instrument were sensitive to a single DNA copy.

Yamazaki et al. Yamazaki, et al., (2008), J. Med. Microbial. 57:444-51 had also reported a single copy level sensitivity for this primer set. The correlation coefficients of the log linear regression plots between Tt values and DNA copy numbers for microRT_{f}-LAMP and real-time PCR instrument were the same, 0.99. However, microRT_{f}-LAMP assay was approximately twice faster than the RT_{f}-LAMP assay on the real-time PCR instrument. The result indicates that microRT_{f}-LAMP enables the reproducible and rapid quantification of DNA.

TABLE 8
Comparison of average SNR and Tt values of RT_{f}-LAMP for
10⁵ DNA copies of V. cholera toxR gene and C. parvum gp60
gene on microchips (1 s, 3 s, and 5 s CCD exposure time) and
the real-time PCR instrument (Chromo4 ™). Standard
deviations are the mean of Tt values from triplicates.

| Microorganism | SNR, Tt | SNR, Tt | SNR, Tt | SNR, Tt |
|---|---|---|---|---|
| gene | (min) | (min) | (min) | (min) |
| | CCD system | CCD system | CCD system | Chromo4 ™ |
| | 1 s exposure | 3 s exposure | 5 s exposure | — |
| V. cholera toxR | 21.8, 5.8 ± 0.4 | 14.8, 5 ± 0.0 | 70.8, 5 ± 0.0 | 28.3, 7.7 ± 0.6 |
| C. parvum gp60 | 12.1, 18.7 ± 0.3 | 12.6, 15 ± 0.0 | 206, 14.5 ± 0.0 | 16.3, 24.3 ± 1.2 |

TABLE 9
Comparison of average Tt values of RT_{f}-LAMP for 10⁵ DNA
copies of 6 waterborne pathogens (2 genes for each) on
the microchips with 5 s CCD exposure and the real-time
PCR instrument (Chromo4 ™). Standard deviations
are the mean of Tt values from triplicates.

| | | Tt | Tt | |
|---|---|---|---|---|
| | | (Chromo4 ™) | (CCD System) | Ä t |
| Microorganism | Gene | (min) | (min) | (min) |
| S. enterica | invA | 11 ± 0.0 | 6.5 ± 0.0 | 4.5 |
| S. enterica | phoB | 14.7 ± 0.6 | 10 ± 0.0 | 4.7 |
| C. parvum | hsp70 | 15.3 ± 0.6 | 11 ± 0.0 | 4.3 |
| C. parvum | gp60 | 24.3 ± 1.2 | 14.5 ± 0.0 | 9.8 |
| C. jejuni | 0414 | 16.7 ± 0.6 | 7.8 ± 0.6 | 8.9 |
| C. jejuni | cdtA | 16 ± 0.0 | 9.3 ± 0.3 | 6.7 |
| L. pneumophila | dotA | 10 ± 0.0 | 5.5 ± 0.5 | 4.5 |
| L. pneumophila | lebB | 11.6 ± 0.6 | 6.5 ± 0.0 | 5.5 |
| E. coli O157: H7 | stx2 | 11 ± 0.0 | 4.8 ± 0.3 | 6.2 |
| E. coli O157: H7 | eae | 18.3 ± 0.6 | 13.3 ± 0.3 | 5.0 |
| V. cholera | toxR | 7.7 ± 0.6 | 5 ± 0.0 | 2.7 |
| V. cholera | ctxA | 17.3 ± 0.6 | 10 ± 0.0 | 7.3 |

To observe the effect of offset and gain on the fluorescence signal collected by CCD, COP microchip containing 10 ng dsDNA standard stained with 2 μM SYTO-82 was imaged by the CCD camera (FIG. 18) with increasing offset and gain at a fixed exposure time of 1 s. An increase in the fluorescence signals was observed with increasing gain and offset values. Initially the gain and exposure time was fixed to 100 and 1 s respectively and the offset was varied from 0 to 100 then the offset and exposure time was fixed to 60 and 1 s respectively and the gain was varied from 0 to 100. For the first condition, fluorescence signal was saturated to 65535 a. u. at a gain of 100 and an offset of 80. For the second condition, maximum fluorescence signal of 58283 a. u. was observed at a gain of 100 and an offset of 60. However, for the same gain and offset of 100 and 60, the fluorescence signal was 62208 a. u. in the first condition. As the circular well microchip used for DNA imaging was not sealed, solution evaporation might have increased the solution concentration, resulting in higher fluorescence signal in the first condition. A gain of 100 and an offset of 60 were selected for further CCD imaging, as this combination provided the most optimum contrast in the images.

TABLE 10
Nucleotide sequences of designed LAMP primers.

| Target | Primer | Sequence (5′-3′) |
|---|---|---|
| C. parvum | F3 | ACAACTCCATCTGTTGTGG |
| hsp70 gene | | (SEQ ID NO: 43) |
| | B3 | GCATCCCCATTATCAGCC |
| | | (SEQ ID NO: 44) |
| | FIP | CAGTGTTTTCTGGGTTTGTGATTG |
| | | CTTTTTC TGAAGATGGGCAG |
| | | (SEQ ID NO: 45) |
| | BIP | TTACGCAACAAAGAGGCTAATTG |
| | | GTTATATGGTAAAATTCCCT |
| | | GTTCC |
| | | (SEQ ID NO: 46) |
| | LF | TTGCAACTTCACCAACCAATCT |
| | | (SEQ ID NO: 47) |
| | LB | AGAAGGTACGAAGAAGAAGCAA |
| | | TC (SEQ ID NO: 48) |
| C. parvum | F3 | ACGCAGAAGGCAGTCAAGA |
| gp60 gene | | (SEQ ID NO: 49) |
| | B3 | ACCACACTTCAATGTCGCAG |
| | | (SEQ ID NO: 50) |
| | FIP | GGAAGCAGCACTAGTTTGGCCAA |
| | | CTGAAG CTTCTGGTAGCCA |
| | | (SEQ ID NO: 51) |
| | BIP | TCCAGCTCAAAGTGAAGGCGCGG |
| | | GGTACCTTCTCCGAACC |
| | | (SEQ ID NO: 52) |
| | LF | TCACTACCTTCCTCTTCAGAACC |
| | | (SEQ ID NO: 53) |
| | LB | TGCGGCACTTCATTTGTAATGT |
| | | (SEQ ID NO: 54) |
| S. enterica | F3 | GAAGCGTACTGGAAAGGGAA |
| invA gene | | (SEQ ID NO: 55) |
| | B3 | TCAACAATGCGGGGATCTG |
| | | (SEQ ID NO: 56) |
| | FIP | ATGATGCCGGCAATAGCGTCACA |
| | | GCCAGCTTTACGGTTCCT |
| | | (SEQ ID NO: 57) |
| | BIP | GATGACCCGCCATGGTATGGATA |
| | | CCATCACCAATGGTCAGC |
| | | (SEQ ID NO: 58) |
| | LF | TGATAAACTTCATCGCACCGTC |
| | | (SEQ ID NO: 59) |
| | LB | TTRTCCTCCGCTCTGTCTAC |
| | | (SEQ ID NO: 60) |
| S. enterica | F3 | GCCATTCCACATCGAAGAGGT |
| phoB gene | | (SEQ ID NO: 61) |
| | B3 | ATGAGAACATCAATGGTATGGC |
| | | (SEQ ID NO: 62) |
| | FIP | GGCGTGAGAGATCCACCTGGAAT |
| | | GCGCCGTAATAGCGGTC |
| | | (SEQ ID NO: 63) |
| | BIP | CACCATTATGGAAACGCTTATCC |
| | | GCCGGATACAGCTGAAGCATC |
| | | (SEQ ID NO: 64) |
| | LF | CAGGTGATCAACATCCCGCC |
| | | (SEQ ID NO: 65) |
| | LB | CGGTAAAGTGGTCAGCAAAGAT |
| | | (SEQ ID NO: 66) |
| C. jejuni | F3 | CCCCACCTTTAACTAGAACAA |
| cdtA gene | | (SEQ ID NO: 67) |
| | B3 | GCCAAATCCTTTGCTATCGA |
| | | (SEQ ID NO: 68) |
| | FIP | CGCAGGGCGATTTTCAAAAATTA |
| | | AACAATAATGCAGYAAATGGGAT |
| | | (SEQ ID NO: 69) |
| | BIP | TTAACCATTTTAGGCCCTAGCGGC |
| | | AAATCCAATTTCCTTGTGCT |
| | | (SEQ ID NO: 70) |
| | LF | GCTTCGTCTTTAAAGYGAGGATT |
| | | G (SEQ ID NO: 71) |
| | LB | AGCAGCTTTAACGGTTTGGG |
| | | (SEQ ID NO: 72) |
| C. jejuni 0414 | F3 | GCAAGACAATATTATTGATCGC |
| gene Yamazaki, | | (SEQ ID NO: 73) |
| et al., J. Med. | | |
| Microbial. 57: | | |
| 444-451, (2008) | | |
| | B3 | CTTTCACAGGCTGCACTT |
| | | (SEQ ID NO: 74) |
| | FIP | ACAGCACCGCCACCTATAGTAGA |
| | | AGCTTTTTTAAACTAGGGC |
| | | (SEQ ID NO: 75) |
| | BIP | AGGCAGCAGAACTTACGCATTGA |
| | | GTTTGAAAAAACATTCTACCTCT |
| | | (SEQ ID NO: 76) |
| | LF | CTAGCTGCTACTACAGAACCAC |
| | | (SEQ ID NO: 77) |
| | LB | CATCAAGCTTCACAAGGAAA |
| | | (SEQ ID NO: 78) |
| E. coli O157:H7 | F3 | AGCTCTAACAATGTACAGCT |
| eaeA gene | | (SEQ ID NO: 79) |
| | B3 | AGTTGCAGTTCCTGAAACA |
| | | (SEQ ID NO: 80) |
| | FIP | GTCTTATCCGCCGTAAAGTCCGCC |
| | | GTTCTGTCGAATGGTC |
| | | (SEQ ID NO: 81) |
| | BIP | CTAAAGCGGATAACGCCGATACC |
| | | CAGGGACATTAGCCTGAG |
| | | (SEQ ID NO: 82) |
| | LF | CCCAACCTGGTCGACAACTT |
| | | (SEQ ID NO: 83) |
| | LB | ATTACTTATACCGCGACGGTGAA |
| | | (SEQ ID NO: 84) |
| E. coli O157:H7 | F3 | GAGATATCGACCCCTCTTG |
| stx2 gene | | (SEQ ID NO: 85) |
| | B3 | AATCTGAAAAACGGTAGAAAGT |
| | | (SEQ ID NO: 86) |
| | FIP | TCCACAGCAAAATAACTGCCCAA |
| | | CATATATCTCAGGGGACCA |
| | | (SEQ ID NO: 87) |
| | BIP | GATGTCTATCAGGCGCGTTTTGCC |
| | | GTATTAACGAACCCGG |
| | | (SEQ ID NO: 88) |
| | LF | TGTGGTTAATAACAGACACCGAT |
| | | G (SEQ ID NO: 89) |
| | LB | ACCATCTTCGTCTGATTATTGAGC |
| | | (SEQ ID NO: 90) |
| V. cholerae | F3 | TCGGGCAGATTCTAGACC |
| ctxA gene | | (SEQ ID NO: 91) |
| | B3 | GTGGGCACTTCTCAAACT |
| | | (SEQ ID NO: 92) |
| | FIP | TTGAGTACCTCGGTCAAAGTACTT |
| | | CCTGATGAAATAAAGCAGTCA |
| | | (SEQ ID NO: 93) |
| | BIP | TCAACCTTTATGATCATGCAAGA |
| | | GGGGAAACATATCCATCATCGTG |
| | | (SEQ ID NO: 94) |
| | LF | CCTCTTGGCATAAGACCACC |
| | | (SEQ ID NO: 95) |
| | LB | AACTCAGACGGGATTTGTTAGG |
| | | (SEQ ID NO: 96) |
| V. cholerae | F3 | CGAGTGGAAACGGTTGAAGA |
| toxR gene | | (SEQ ID NO: 97) |
| | B3 | AGGGGAAGTAAGACCGCTAT |
| | | (SEQ ID NO: 98) |
| | FIP | GCACACTGCTTGAYTCTGCGTAC |
| | | GAAAGCGAAGCTGCTCAT |
| | | (SEQ ID NO: 99) |
| | BIP | AGCCACTGTAGTGAACACACCGT |
| | | CGATTCCCCAAGTTTGGAG |
| | | (SEQ ID NO: 100) |
| | LF | ACAGATTCTGGCTGAGAGATGTC |
| | | (SEQ ID NO: 101) |
| | LB | CAGCCAGCCAATGTTGTGAC |
| | | (SEQ ID NO: 102) |
| L. pneumophila | F3 | GTCAAGCAACCTGATCT |
| dotA gene | | (SEQ ID NO: 103) |
| | B3 | TGCCGCAATCAAAATCCT |
| | | (SEQ ID NO: 104) |
| | FIP | CCATCATGGAATTGTTGACAAAT |
| | | CCTAATCCTCAACGACAGTCTG |
| | | (SEQ ID NO: 105) |
| | BIP | GCCAGGTCAACCAGGAATAAAAC |
| | | GCTTCATATAATAAAGCGACGT |
| | | (SEQ ID NO: 106) |
| | LF | GAGGACAATGGCCCACTCA |
| | | (SEQ ID NO: 107) |
| | LB | CGTTGACCTTTGCCAATCTGA |
| | | (SEQ ID NO: 108) |
| L. pneumophila | F3 | TCTTTACGTTGATGAACTAGC |
| lepB gene | | (SEQ ID NO: 109) |
| | B3 | AAGTTGAAAGTATTAGGGTCTAC |
| | | (SEQ ID NO: 110) |
| | FIP | AGAGCAAACAGATTAGGGGTGCC |
| | | ATCACGTGTGAAGCCAA |
| | | (SEQ ID NO: 111) |
| | BIP | ATAGCGGTGGTGAAGCGATTGTA |
| | | AATAGGCGGCGCAAT |
| | | (SEQ ID NO: 112) |
| | LF | TGTCTATTCTTTCTTTTGCCCAGA |
| | | C (SEQ ID NO: 113) |
| | LB | CACGGACATGCCTTTGTTCC |
| | | (SEQ ID NO: 114) |

DNA Targets:

Genomic DNA of S. enterica (700702D), C. parvum (PRA67D), C. jejuni (700819D), L. pneumophila (33152D), E. coli O157:H7 (BAA460D), and V. cholerae (39315) was obtained from the American Type Culture Collection (ATCC, Manassas, Va.). Before use, dried genomic DNA was resuspended in nuclease-free sterile water (Fischer Scientific, Pittsburgh, Pa.). Double stranded DNA standard (1 kb, 1 μg/μL) was obtained from Invitrogen (Invitrogen Corporation, Carlsbad, Calif.).

LAMP primer design: LAMP primers were designed for 11 virulence genes specific to 6 waterborne pathogens. For C. jejuni 0414 gene, primers from the literature were used Yamazaki, et al., (2008), J. Med. Microbial. 57:444-51. Sequences of primers are provided in the Table 10. Prior to primer design, consensus sequences were generated by aligning multiple gene sequences with Bioedit Sequence Alignment Editor (Ibis Biosciences, Carlsbad, Calif.). A set of six specific LAMP primers (F3, B3, FIP, BIP, LF and LB) were designed for each target by using Primer Explorer V4 (Eiken Chemicals Co., Tokyo, Japan). Primers were synthesized by Integrated DNA Technologies (IDT, Coralville, Iowa).

Microchip fabrication: Microchips with two different designs were fabricated for dsDNA standard dilution series imaging and monitoring RT_{f}-LAMP assays. Microchips used for dsDNA standard dilution series imaging consisted of 16 circular wells with 1 mm diameter and 2 μL volume per well. Microchips for RT-LAMP had seven V-shaped reaction wells with a volume of 2 μL per well. V-shaped reaction wells provided easy solution dispensing and effective sealing of microchip. Both types of microchips were fabricated with 100 μm thick ZeonorFilm® (ZF14-100; Zeon Chemicals, Louisville, Ky.) by hot embossing using a sacrificial thermoplastic counter tool (acrylonitrile butadiene styrene, ABS from K-mac Plastics). Embossing molds were fabricated via stereo lithography (FineLine Prototyping; Raleigh, N.C.) with the circular and V-shaped features. A sheet of ZeonorFilm® was sandwiched between the ABS plastic and embossing mold, and preheated to 150° C. in a press (Carver press model 4386; Carver, Wabash, Ind.). An embossing pressure of 1000 lbs was applied for 3 min. The system was subsequently cooled to 105° C. while maintaining the embossing pressure. Sample dispensing ports with 750 μm diameter were patterned into the PCR tape (MicroAmp® Optical Adhesive Film; Applied Biosystems; Foster City, Calif.) using a commercial-grade knife plotter (CraftROBO model CC330L-20; Graphtec). The patterned PCR tape was manually aligned onto the chip, and pressed at 2000 lbs. with a piece of silicon rubber (70 A, McMaster-Carr, Los Angeles, Calif.) to seal the chip. Microchips used for dsDNA standard dilution series imaging were not sealed from the top.

CCD with exposure control as an alternative to a PD: Gene amplification and detection system was built by integrating light source, optical filters, thin film heater, and a CCD camera (FIG. 18). A 530 nm green LED (05027-PM12, LED Supply) was used as the excitation light source. The LED was attached to a black anodized aluminum heat sink (HS13137, LED Supply), optic holder (L2-OH-S35, LED Supply), collimating lens (L2-OP-025, LED Supply), and an engineered glass diffuser (ED1-050, Thorlabs, Newton, N.J.) to achieve widely distributed homogenous light. The LED was driven at 700 mA with a power supply (HY5003, Power Supply Depot, Lake Park, Fla.). The excitation light was filtered through a 534±20 nm bandpass filter (FF01-534/20-25, Semrock, Rochester, N.Y.). The emission light was filtered through a 572±20 nm bandpass filter (FF01-572/28-25, Semrock) connected to the CCD camera. Imaging of microchips for dsDNA standard dilution series and RT_{f}-LAMP assays was done by a 16 bit, 0.25 megapixel monochrome CCD camera (MEADE DSI Pro, Irvine, Calif.) equipped with a 16 mm relay lens (15774, Deal Extreme). DSI Pro CCD is an interline-scan monochromatic camera commonly applied for astronomical imaging Gottscheber and Dech, (2012), 61st International Astronautical Congress. 1-5. It is equipped with AutoStar Envisage imaging software with manual control over the gain (0-100), offset (0-100), and exposure time (0.1 ms⁻¹ h). A gain of 100 and an offset of 60 were selected for imaging, as this combination provided the most optimum contrast in the images. The temperature control system consisted of a thermocouple (5RTC-TT-T-40-36, Omega), a pulse width modulator IC (DRV102T, Texas Instruments), a USB DAQs (USB-DAQ 6009, National Instruments), a thin film heater (Electro-Flex Heat Inc.), and a LabVIEW VI developed in-house. To control the temperature of the microchip at 63° C., a feedback mechanism involving (PID) and pulse width modulation (PWM) was implemented. Signals from the thermocouple were amplified and conditioned using a LabView thermocouple input module. The analog output generated from the PID controller was used to adjust the duty cycle of the PWM driver. The component cost of this experimental setup was approximately $1000.

DNA dilution series and real-time LAMP: Serial dilutions (10-fold) of dsDNA standards ranging from 5 ng/μL to 0.005 ng/μL were prepared in sterile water. dsDNA standard dilutions were mixed with 2 μM SYTO-82. Negative control had water and 2 μM of SYTO-82 (Invitrogen Corporation, Carlsbad, Calif.). Approximately, 2 μL of dsDNA standard dilution series with 10 ng, 1 ng, 0.1 ng, 0.01 ng, and water were placed on the microchip with circular wells. experiments were performed in triplicate. Reaction mixtures for LAMP contained 1.6 μM each of FIP and BIP primer, 0.200 μM each of F3 and B3 primer, 0.8 μM each of LF and LB primer, 0.8 M betaine (Sigma, St Louis, Mo.), 1.4 mM of each dNTP (Invitrogen Corporation, Carlsbad, Calif.), 20 mM Tris-HCl (pH 8.8), 10 mM (NH₄)₂SO₄, 10 mM KCl, 8 mM MgSO₄, 8 mM Triton X-100, 0.64 units/4 of large fragment of Bst DNA polymerase (New England Biolabs Inc., Ipswich, Mass.), 2 μM of SYTO-82, and 10⁵ genomic copies of target DNA. To evaluate the dynamics of RT_{f}-LAMP and establish standard curves for quantitative analysis, 10-fold serially diluted genomic DNA of C. jejuni ranging from 10⁵ to 1 copy was prepared. LAMP reaction mixtures without any DNA template were also prepared to serve as negative controls. Positive and negative LAMP controls with the volume of 25 μL were loaded in 0.2 mL PCR tubes (VWR International, West Chester, Pa.) and incubated at 63° C. for 45 min on a commercial real-time PCR instrument (Chromo4™, Bio-Rad Laboratories, Hercules, Calif.). Fluorescence signals of the RT_{f}-LAMP assays were measured every minute in channel 2 (excitation wavelength range from 500-535 nm and emission wavelength range from 560-580 nm). For RT_{f}-LAMP on microchip, 2 μL of LAMP solutions was dispensed in each of the 6 wells using a pipetter, manually sealed with a PCR tape, and placed on the experimental setup for incubation at 63° C.

Experiments were Performed in Triplicate.

Fluorescence measurement, extraction, and analysis: Opticon™ software (Bio-Rad Laboratories, Hercules, Calif.) was used to measure and extract raw fluorescence signals of RT_{f}-LAMP assays on the real-time PCR instrument. For the florescence imagining system, CCD camera imaged the microchips and saved the images in flexible image transport system format. For dsDNA standard dilution series, images of the microchip (with circular wells) were recorded for increasing exposure times from 1 ms to 60s. For microRT_{f}-LAMP assay, time-lapse images of microchip (with V-shaped wells) were recorded every 30 s at fixed exposure time. Imaging was stopped when the signals from the positive wells reached to saturation value of 65,535 a.u. CCD images were opened in Image J (National Institutes of Health, Bethesda, Md.) and a microarray profile plug-in (see website at www.optinay.com/imagej.html) was applied to extract fluorescence signals from the wells. For dsDNA standard dilution series, average fluorescence signals from the triplicates were plotted with respected to exposure time. To calculate SNR values of RT_{f}-LAMP assays on real-time PCR instrument and microchip, raw signal intensities were baseline corrected by subtracting the average fluorescence signals obtained in the first 3 min and dividing by their standard deviation. Tt was then defined as the time at which the SNR reached an arbitrary cut-off of 10 or higher. SNR and the corresponding Tt values were calculated for individual LAMP reaction of triplicates and an average value of Tt is reported here. Fluorescence signals were normalized by dividing the signals with the maximum signal value. Average of the normalized fluorescence signals from the triplicates was plotted with respect to amplification time. Data analysis and plotting was done with Microsoft Excel (Microsoft, Redmond, Wash.).

### Example XIX

This example describes integration of solar panel in Gene-Z™ to charge the battery in places where no electricity is available

In one of the embodiments Gene-Z™ has a custom solar panel of approximately 180 mm×158 mm solar panels (FIG. 36). These panels are made by custom order and integration of four panels of part number SLMD481H12L, IXOLAR modules that have 22-23% efficiency. The integrated panel is designed to provide about 15 volts, with 400 mA charging current.

### Example XX

This example describes an embodiment of Gene-Z™ that uses only 8-wells and allows the use of PCR vials as well.

This embodiment is named iDx but it includes the Gene-Z™ features and capabilities described above. The iDx has a cellphone attachment and is adapted for isothermal amplification in 8-well 1-μL self-digitizing microfluidic chips or eight separate 200-μl PCR vials (FIG. 37-38). It is smaller and more light-weight version of the Gene-Z™ device that uses the same optics with LEDs and a single photodiode, and can be operated by smart devices (e.g., Android/iPhone) based platforms using Bluetooth™ connectivity. Capable technologies of the iDx are derived from the Gene-Z™. As already established with the Gene-Z™ device, a rapid response thermocouple, thermocouple conditioner integrated circuit, resistive heater placed beneath the chip, and pulse-width-modulation integrated circuit can be used for feedback temperature control of microfluidic chip. Eight compact and bright surface mountable LEDs (available from Kingbright) were used to excite fluorescence. One difference is that the iDX uses a heater that can accommodate an 8-well chip or 8 PCR tubes (FIG. 39). This heater is made of aluminum to aid in equal temperature displacement along the length of the chip. The heater has 2 mm holes to allow excitation light from each of the 8 LEDs to pass through, and 1 mm holes placed at 45 degree angle on the back for optical fibers. A low power consumption ARM7 microcontroller is used for precise embedded control of components in the iDx-PD and iDx-CCD (described in next example). ARM microcontrollers have become an industry standard and are used in approximately 98% of mobile phones. Code for the microcontroller was generated using the National Instruments LabView Embedded module, as used previously with the Gene-Z device (Stedtfeld et al., 2012). This module ensures reliable performance of generated code, preventing common errors that could cause an embedded application to crash or function incorrectly. Connectivity will be obtained using a USB port for serial string commands between the phone and iDx-CCD.

Additional differences compared to the Gene-Z include a custom printed circuit board for all components. Since only eight LEDs are needed (one for each well), a single printed circuit board can be used (FIG. 40). A smaller cartridge is also used because the sizes of many other components are reduced. The smaller heater uses less power, and therefore a smaller battery is required compared to the Gene-Z. The resistive heater requires the largest amount of power, with approximately 16 ohms of resistance used to heat the 8-well microfluidic chip to temperatures of 63° C. within 120 seconds using 5 volts (0.31 A). Including power from the microcontroller, LEDs, PD, and the heater, a total current of approximately 580 mA is needed from a rechargeable battery. Overall, the iDx device is only slightly larger than the size of a typical smartphone, and has a lower component cost compared to the Gene-Z.

Considering the results from testing low dilutions in environmental samples, when the limit of detection is an important issue to solve, the multiplexing can be adapted for use with 200-μL vials so up to 100 μL sample can be used for direct amplification, increasing the limit of detection by 100-fold. The smaller iDx device was designed to accommodate both one 8-well chip with 1 μL samples and eight 200 μL vials with 100 μL samples. Use of the 200 μl vial is advantageous for highly dilute samples. It is known that when detection targets are of particle nature (e.g., low target numbers or low target copy concentration), then reducing the reaction volume comes at the cost of detection limit. For example, if there are only 10 particles of target DNA or 10 cells in a 100 microliter sample, then only 10% of the wells have a likelihood of actually exhibiting amplification when the amplification assays are carried out on 1 microliter samples (assuming particle separation and 1 particle amplification efficiency). However, if the same sample is tested in a 200 μL vial, then there should be about 10 particles per sample vial, the amplification efficiency should be about 10 particles per reaction, and the probability of amplification is 100%. A device that utilizes real time isothermal amplification in eight PCR vials and that is operated by a laptop is currently in the market for $7,000 (ESI Quant, Qiagen). The devices described herein (e.g., the iDx device with many of the same features as the Gene-Z device but where the heater is shaped differently to allow either the microfluidic card to be inserted into the top of the device, or the use of 200 microliter PCR tubes) can provide better results more cheaply.

### Example XXI

This example describes another embodiment of Gene-Z that uses the CCD camera of the smartphone, tablet, or other portable device for detection of nucleic acids amplification.

A smaller embodiment of Gene-Z device, named iDx-CCD has dimensions of approximately 125×45×13 mm (FIG. 41), however, the photodiode (PD) is replaced with a Charge-Coupled Device (CCD) for fluorescent detection. As with the iDx-PD, this embodiment will allow users to use either conventional Eppendorf tubes or microfluidic chips for 8 different samples or 8 different assays to be run in parallel (FIG. 42). The selection of components allows the iDx-CCD to be used for chemiluminescence or fluorescent based assays, with the only difference being the type of chip added to the iDx and the time required for the reaction to proceed. For monitoring fluorescence, an optical setup similar to Gene-Z is implemented. However, to reduce the cost and size of the iDx, the camera of the cellphone is used for time lapse imaging of the reaction, instead of a photodiode (FIG. 43). As described herein (see, e.g., Section F), we have shown that exposure control can enhance the signal to noise ratio many fold and make the test more rapid (Ahmad et al., 2011). Since the camera placement varies among cellphones, optical fibers can be placed above the chip to capture emission wavelengths and direct light to the camera of the cellphone. A macro lens is placed between optical fibers and the camera, and both the optical assembly and main body of the iDx-CCD are held to the phone/tablet with magnets. We have tested our novel optical setup (originally used in the Gene-Z device) for absorbance and fluorescence measurements with the CCD of tablets and cell-phones.

A cellphone application (developed also for the Android OS), is used to interface with the iDx-CCD. The application is used to scan barcodes on the chip, aiding in the identity of the assay to be run (automatically setting reaction conditions such as time and temperature). Once the chip is placed into the iDx-CCD and the heater set point temperature is reached, the microcontroller directs the phone to begin image acquisition. The application automatically captures and processes time lapse images, performs data analysis, and stores encrypted data for later use.

### Example XXII

This example describes the embodiment of Gene-Z that is capable of multiple samples (termed Gene-Z HT).

Gene-Z HT uses the same principles described for Gene-Z but it will allow up to 100 samples to be run in parallel. The same 64 well chip used with the Gene-Z device will also be used with the Gene-Z HT device or the number of wells may be increased, for example, up to 1536 (the maximal number wells currently tested). Using a different material (e.g., glass) and additional manufacturing technologies (e.g., dry etching) it is possible to incorporate a much higher density of wells for Gene-Z HT. Compared to the Gene-Z, modifications to the optics included using a single source for reaction excitation, and a CCD instead of optical fibers and a single photodiode. These optical components have already been validated and demonstrated to have far greater analytical sensitivity compared to commercial real time thermocyclers by the inventors and are described earlier in this application.

A fluorescence imaging setup is built with a white or green LED as the excitation light source, an optic holder (L2-OH—S35, LED Supply), collimating lens (L2-OP-025, LED Supply), a glass diffuser (e.g., ED1-050, Thorlabs, Newton, N.J.) to achieve widely distributed homogenous light, a bandpass filter for excitation and emission, and a 16 bit, 0.25 megapixel monochrome CCD camera (MEADE DSI Pro, Irvine, Calif.) equipped with a 16 mm relay lens (15774, Deal Extreme). This optical setup is integrated with a rotating carousal that allows multiple chips to be loaded/unloaded/run/imaged as needed. Compared to the Gene-Z, the circuit for the Gene-Z HT includes use of integrated circuits to provide uniform heating by heated air. The ARM7 microcontroller is used to provide digital inputs/outputs for controlling the heater. The software for automated image acquisition, overlaying spots, and processing signals is developed and consists of a wireless Bluetooth interface with a Samsung Tablet (Android OS: FIG. 44). The device has dimensions of less than 30.0 cm (depth)×60.0 cm (width)×60.0 cm (height) and less than 10 lbs, and has conventional power requirements.

### Example XXIII

This example describes self-digitization of samples using an airlock mechanism on a chip with 64 wells used in Gene-Z device.

Simple self-digitization without any peripherals or complex combinations of valves and fluids can greatly enhance the utility of microfluidic-based multiplex assays. Applications include multiplex detection of pathogens under field conditions using multiple genetic targets, combinations of assays (DNA, RNA, microRNA, and/or a comprehensive panel of antibody-based assays, and drug discovery where a single sample must be screened for activity with multiple drugs, among others.

Several mechanisms for loading multiple assays and sealing microfluidic chips have been described and reviewed previously, including:
i) manual dispensing of sample in a small number of individual wells,
ii) peripheral equipment such as arrayers, pumps, centrifuges, 8 multiple layer chips with slip, air, thermal, or physical valve control, or vacuum assistance,
iii) treatment of chip for primer immobilization/and mobilization during filling, and
iv) propagation of sample through a parallel network of interconnecting channels using an air vent for each reaction well.
   However, assembly of multiple layer chips, which typically require fine alignment and functionalization for surface testability, or the use of peripherals is not well suited for point of contact assays and applications. Furthermore, the mechanisms required to reliably seal multiple points in a disposable chip can limit throughput, increase the probability of contamination, and decrease robustness for POC applications. Self-digitization into multiple wells without the use of peripherals or complex multiple layer chips has been described for chips primed with immiscible fluids and chips stored under vacuum pressure. While these strategies may be useful, they have not been described for sample distribution into wells without carryover of predisposed analytes. As such, they may be limited to diagnostics of a single assay.

The goal of this study was to develop a simple mechanism for self-digitization of samples that does not require any peripherals or complex systems of valves and fluid handling. Key characteristics to be achieved included:
i) simplified dispensing of sample into multiple wells without carryover of dried, already existing reaction components in those wells,
ii) single entry point for sample and exit point for displaced air, and
iii) effortless sealing in the hands of the user via a cap at the time of running the test.

Towards these goals, a novel means of self-digitizing samples into a two-layer, laser etched, multi-well chip was developed and validated. This chip is referred to herein as an ‘airlock’ chip. The chip contains a single loading port to distribute the dispensed sample into reaction wells (e.g., 16 to 64 wells, depending on the throughput chosen by the user).

A critical element of the self-digitization is the design of the microfluidic network that allows part of the air trapped in a section of the microfluidic network to remain in place forming an airlock while in another section of the microfluidic network, the air moves forward with the liquid and vents at a single point. This unique airlock forming design prevents primer (and reagent) carryover into subsequent wells during sample distribution. The single air vent for all wells also permitted sealing of the chip by a cap at a solitary point.

An airlock chip designed to distribute the sample into multiple wells without any peripherals is shown in FIG. 45 (64 to 1536 wells) and FIG. 46 (8 wells). Results of LAMP reaction tested with amplicon from the toxR gene of V. cholerea in all samples plus templates of gDNA from C. jejuni (column 2), Salmonella (column 3), and V. cholera (column 4) added to each of the four sample columns. FIG. 47 shows a map identifying where primers were dried into wells (FIG. 47A), with a CCD image of chip after the 60 min LAMP reaction (FIG. 47B). FIG. 47 i, iii, and iv shows signal to noise ratio (SNR) curves versus reaction time for the reactions occurring in all wells in columns i, iii, and iv as monitored with the Gene-Z device.

### Example XXIV

This example describes elimination of DNA extraction step—a particularly useful capability for genetic analyses in the field.

Isothermal amplification was used to detect target species within certain sample matrices without DNA extraction. The Bst polymerase was employed because it is less influenced by inhibitors compared to conventional PCR primers. A newer polymerase, titled Bst 2.0, was not inhibited at all by the inhibitory substrates tested. Although both PCR and isothermal techniques are known to allow direct amplification of bacteria in selected dilute matrices (e.g., 1% blood, urine), an extensive evaluation of direct amplification for many targets has been carried out using the devices described herein. Use of the Bst combined with the devices described herein (e., GeneX or iDx) and the simplified sample preparation (e.g. filtration) protocols provided herein eliminates significant delay in carrying out genetic testing under field conditions. FIG. 48 provides schematic diagrams showing that the devices and methods described herein eliminate tedious sample preparation steps, reducing the cost and time required to obtain results.

Although this is an ongoing work, the results so far indicate that veligers/eggs/juveniles are directly amplifiable in the following matrices with little or no inhibitory effects: i) Cyanobacterial cells (Lyngbya wollei) in lake water, ii) zebra mussel (Dreissena polymorphs) and quagga mussel present in concentrated lake samples, iii) plant pathogen fungal spores (Pseudoperonospora cubensis), iv) Ascaris eggs present in50-fold diluted sludge, v) gut microbiota in 5-fold diluted fecal matter, and vi) bacterial cells in 4000-fold concentrated groundwater (some shown in FIG. 49). We have also tested serum, blood, and urine as matrices for blood borne pathogens and found very little or manageable inhibition on isothermal amplification. This development which we are writing into a manuscript allows “direct amplification without DNA extraction” which is much simpler and therefore doable under field conditions compared to genetic analysis that requires DNA extraction. For invasive species, it is the simplicity and no recovery losses during extraction that are important rather than speed. Occasionally, especially for Gram positive bacterial cells, 10-min heating at 95° C. was employed. However, because this step is easily carried out in the device itself, it is not an extra burden.

When dealing with environmental matrices, inhibition of PCR is common. Because sample concentration is unavoidable for detection of species at low abundance, issues with inhibitory substances must be addressed for DNA-extraction based approaches but not for direct amplification. Taxa based PCR primers used to detect invasive species present in ballast water in total extracted DNA suggests that inhibitory substrate were a challenge for PCR-based detection at low target concentrations. Recently it was shown that 56% of spiked environmental water samples failed to show amplification for PCR, but all samples amplified with loop mediated isothermal amplification of the same DNA. Because of inhibition or sampling issues, contradictory observations have been reported i.e., genetic assays giving lower sensitivity than traditional approaches. Seasonal variations, DNA extraction protocols, and sample volume were all important in determining the presence/absence PCR success rate.

### Example XXV

This example describes another embodiment of Gene-Z or iDX devices that include a secure wireless messaging system and database:

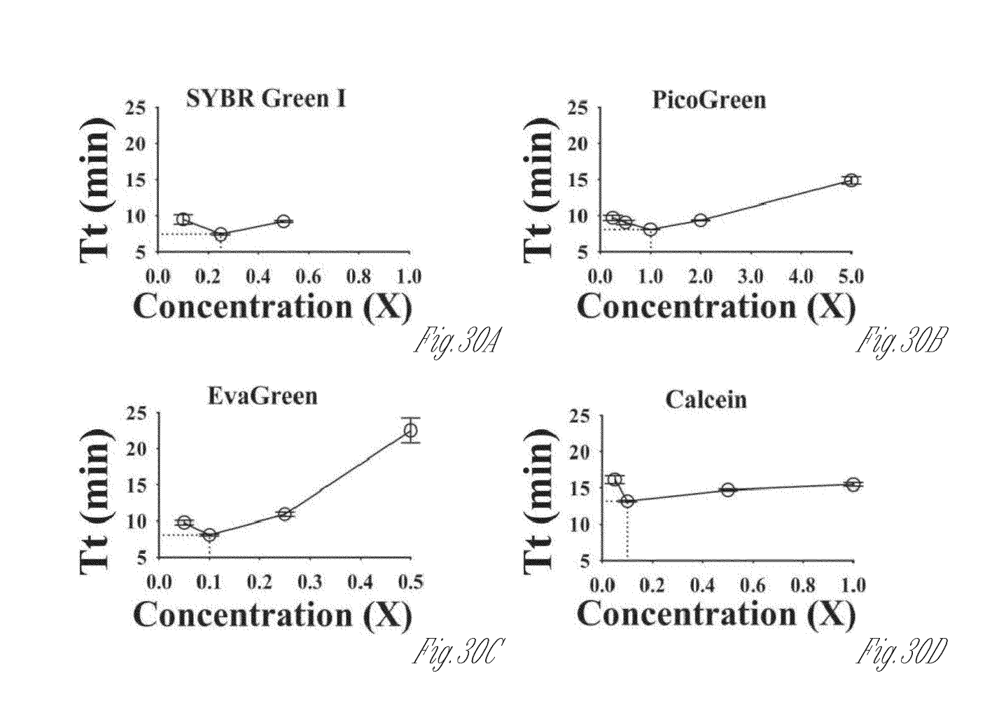

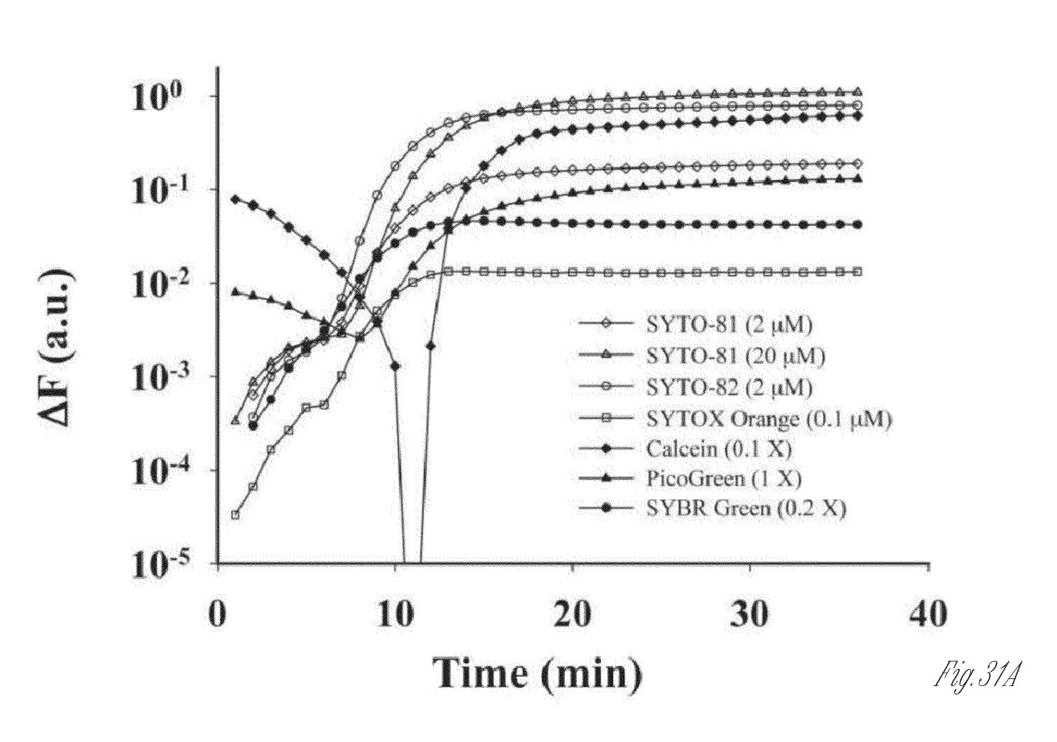

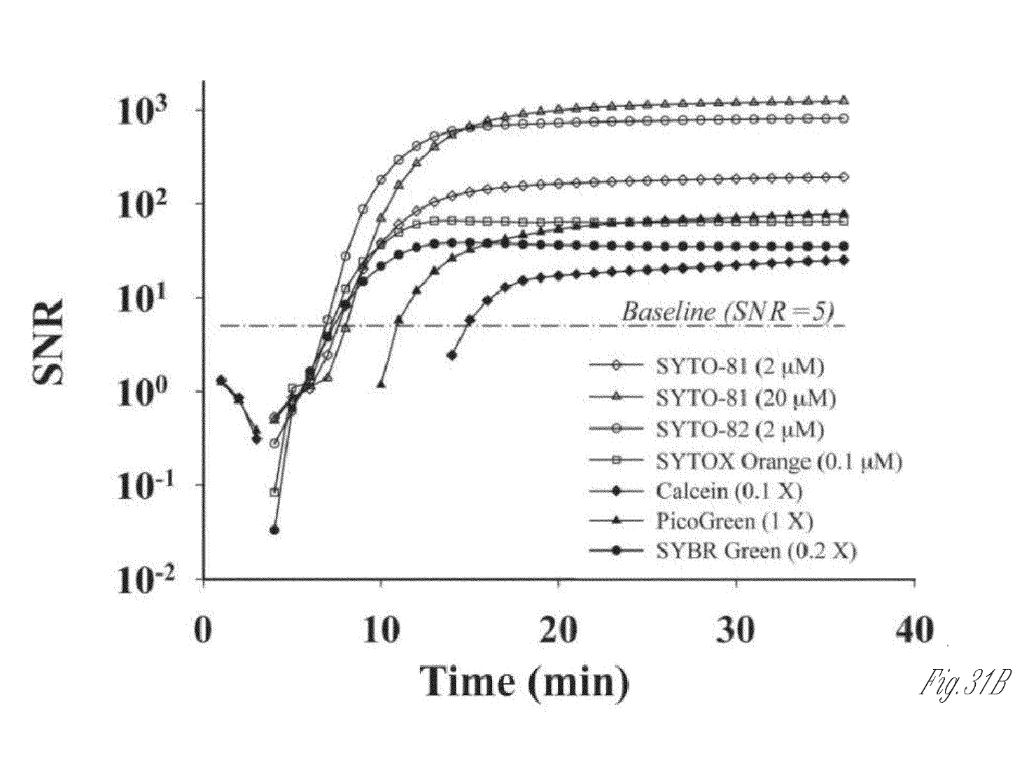

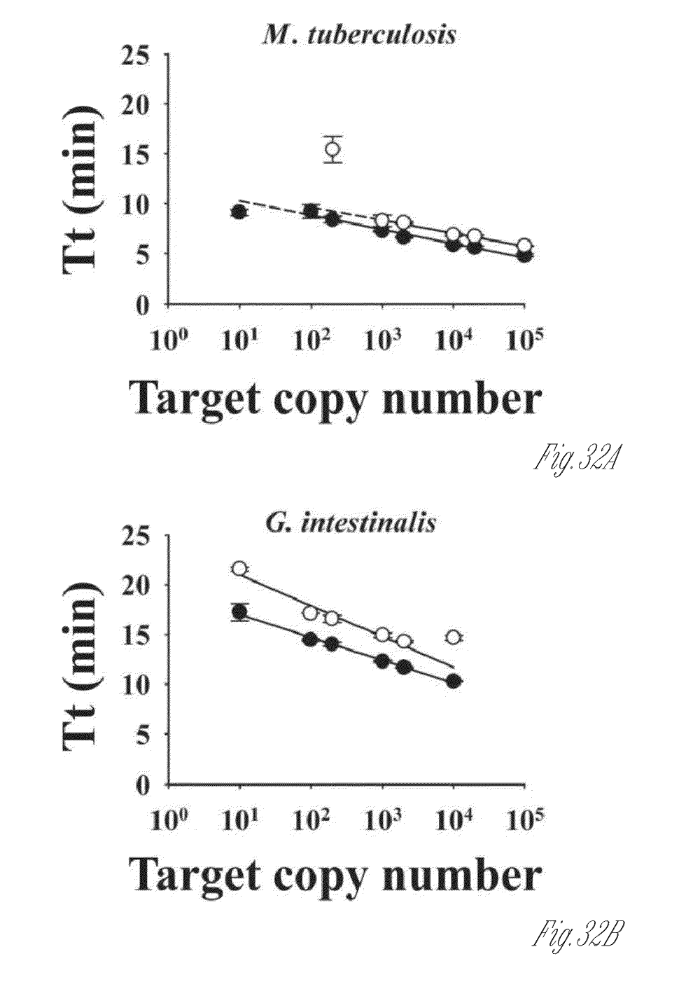

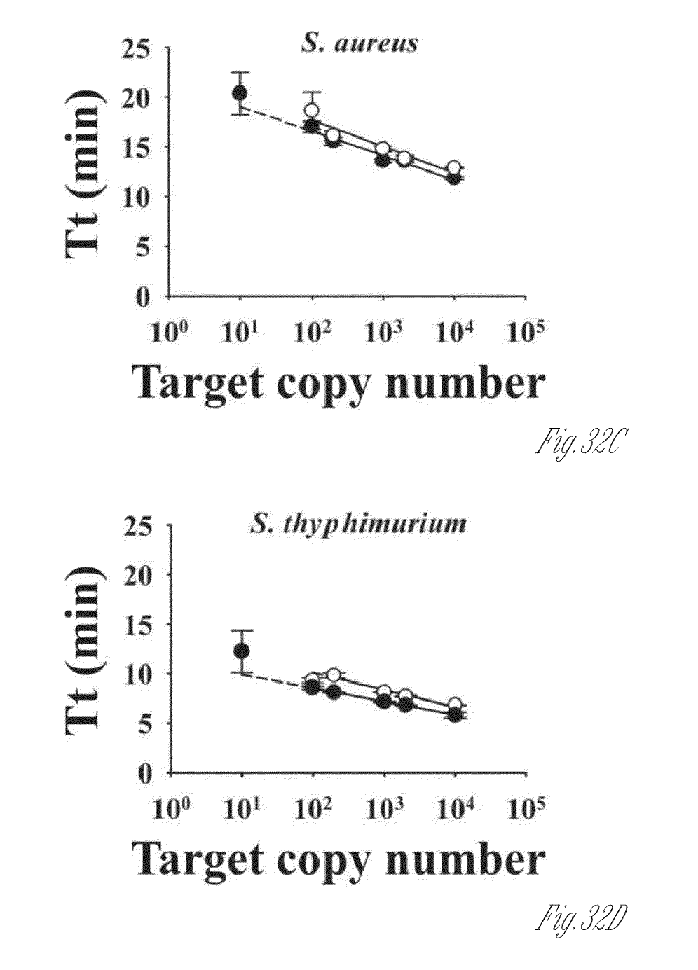

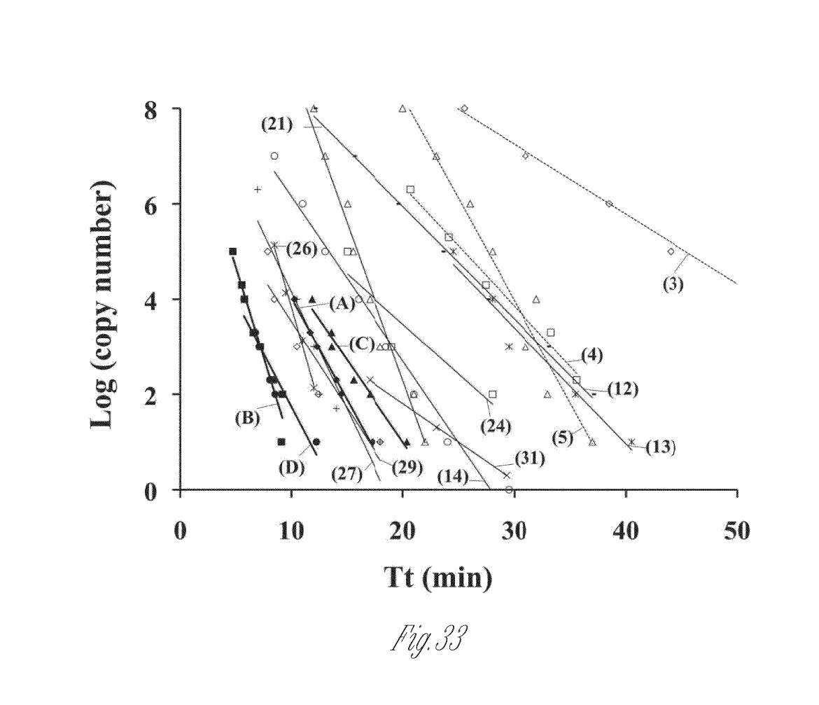

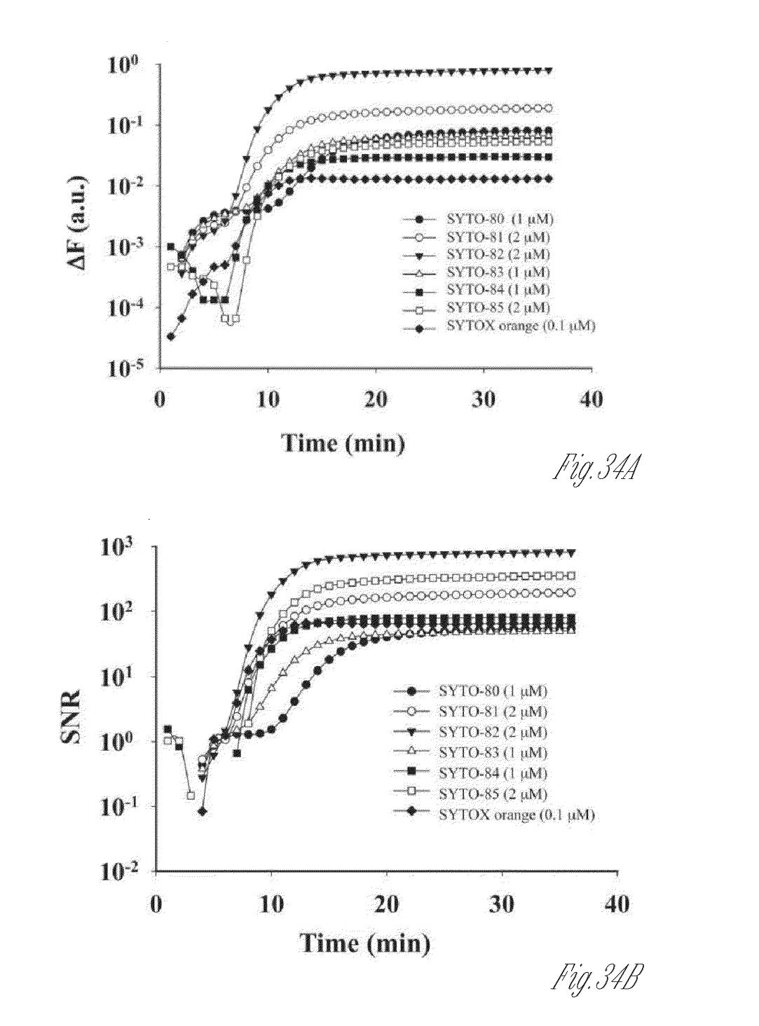

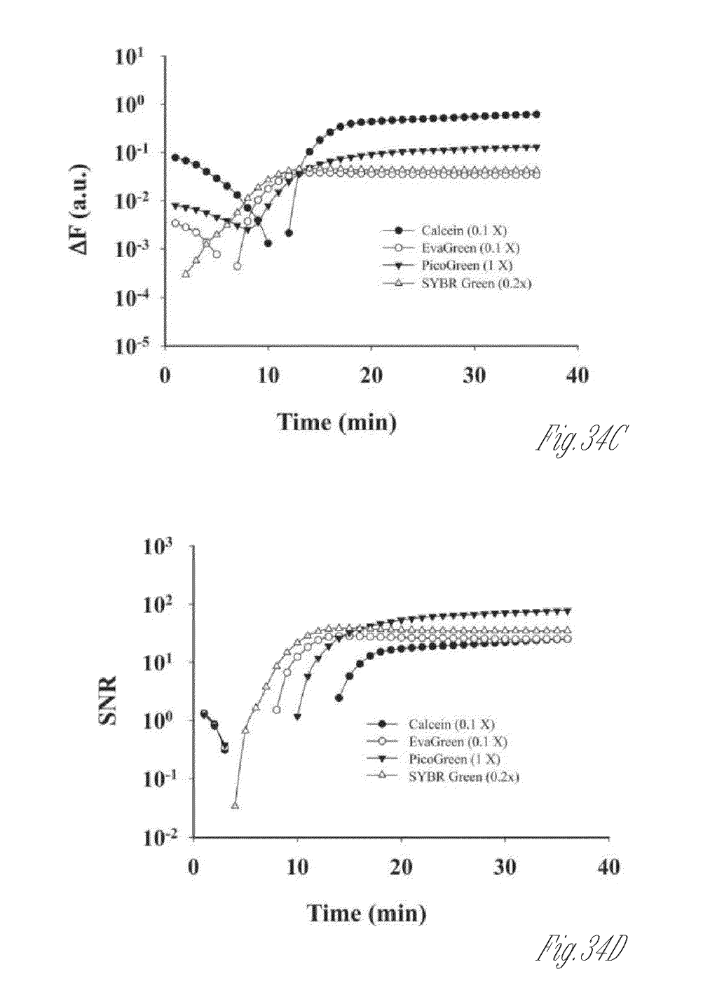

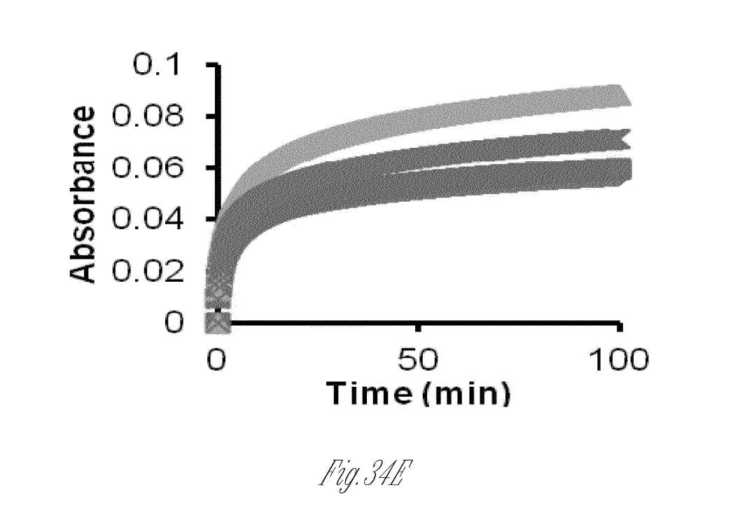

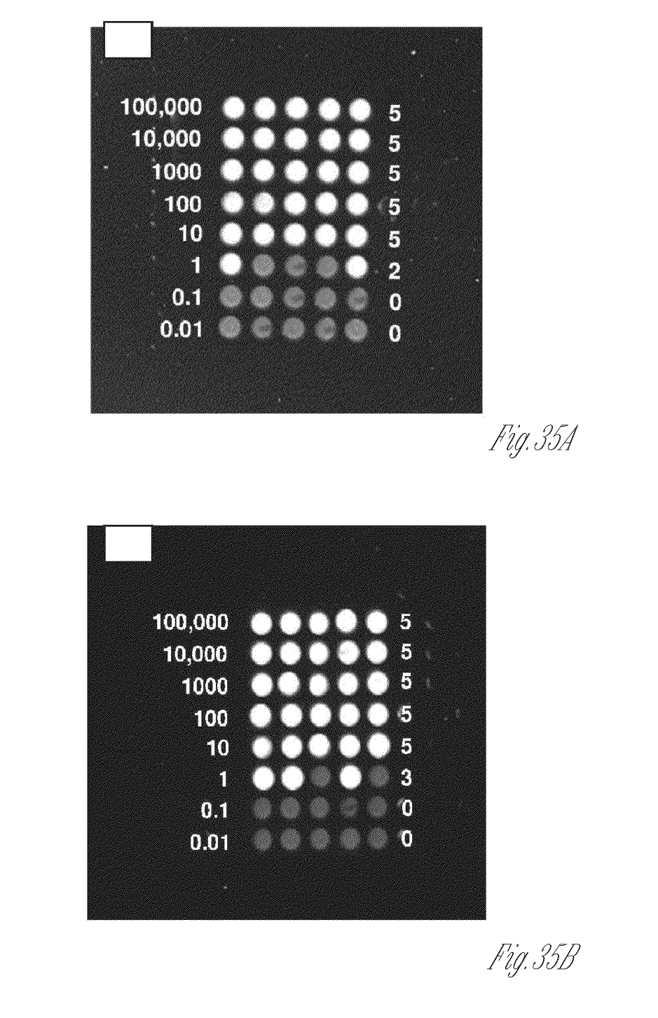

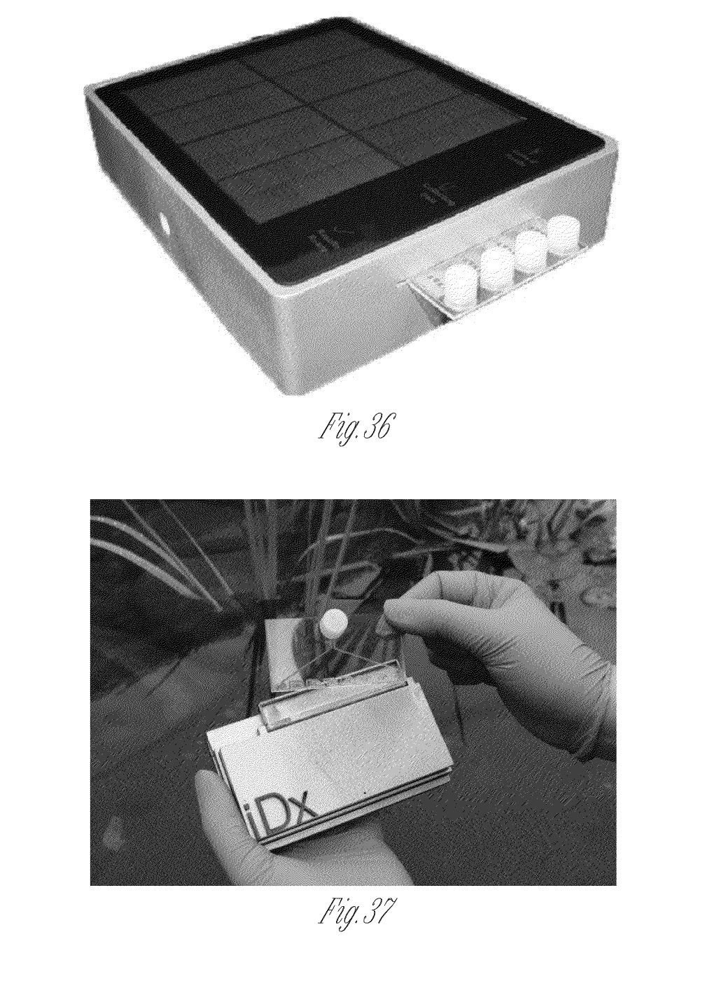

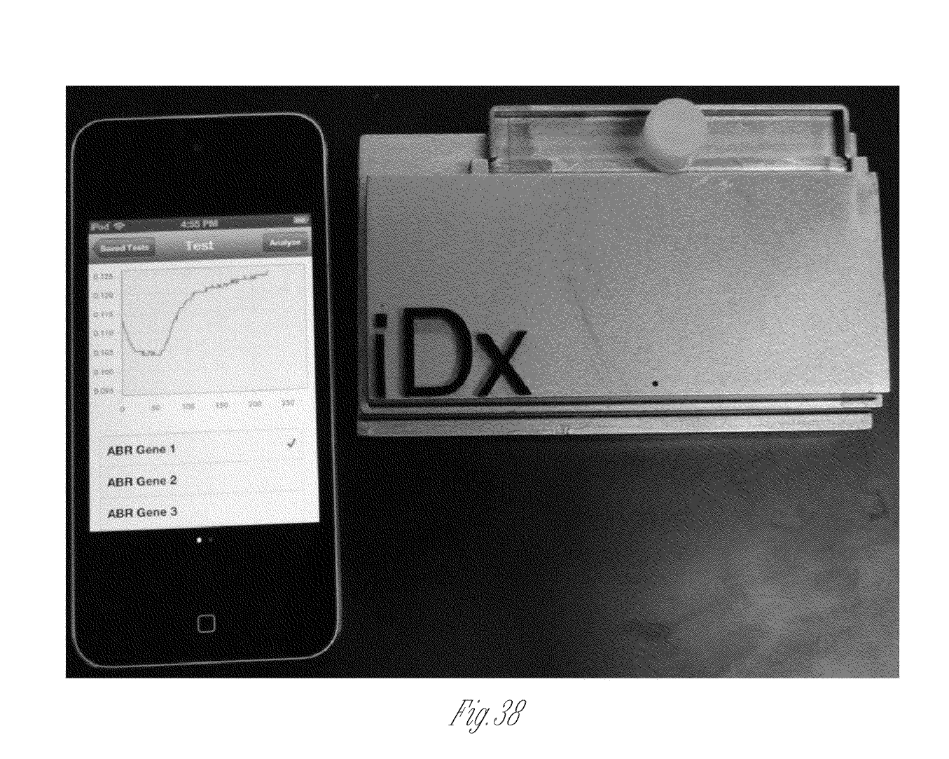

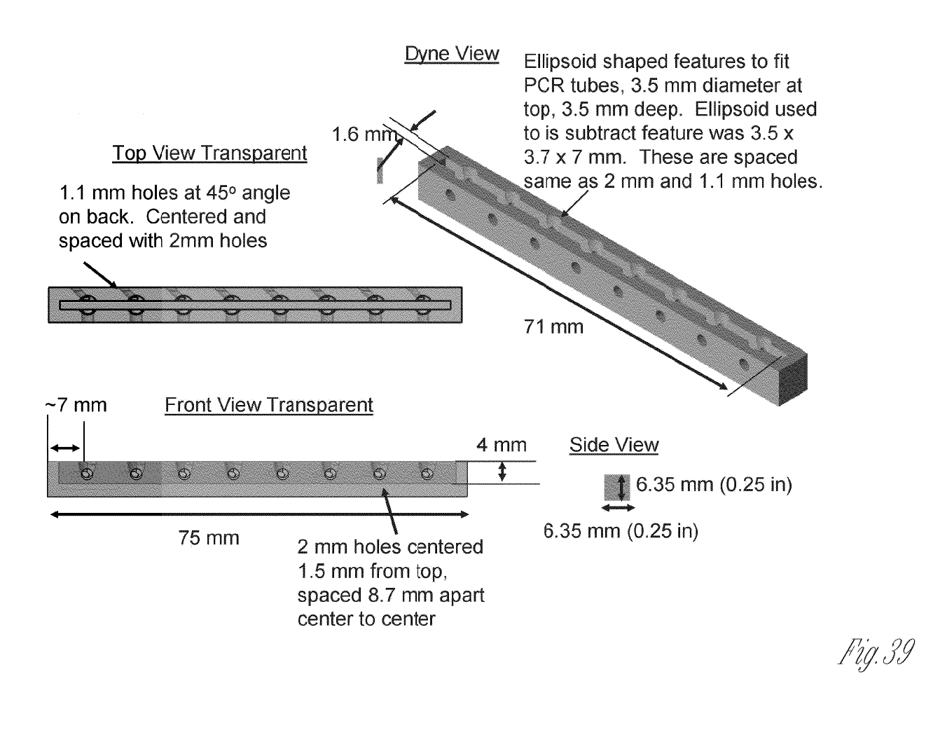

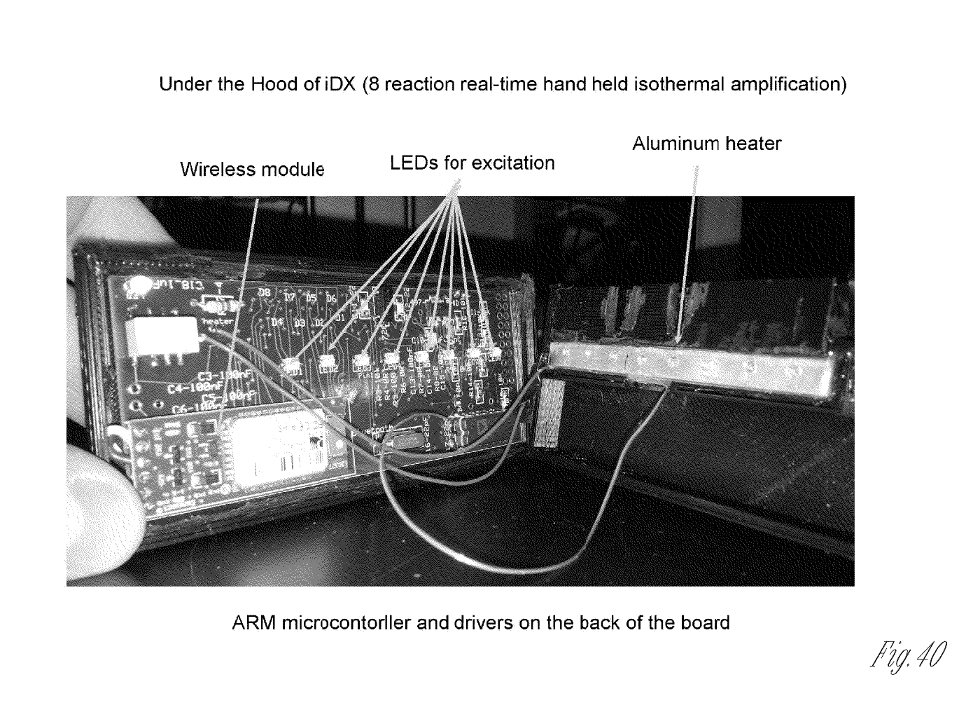

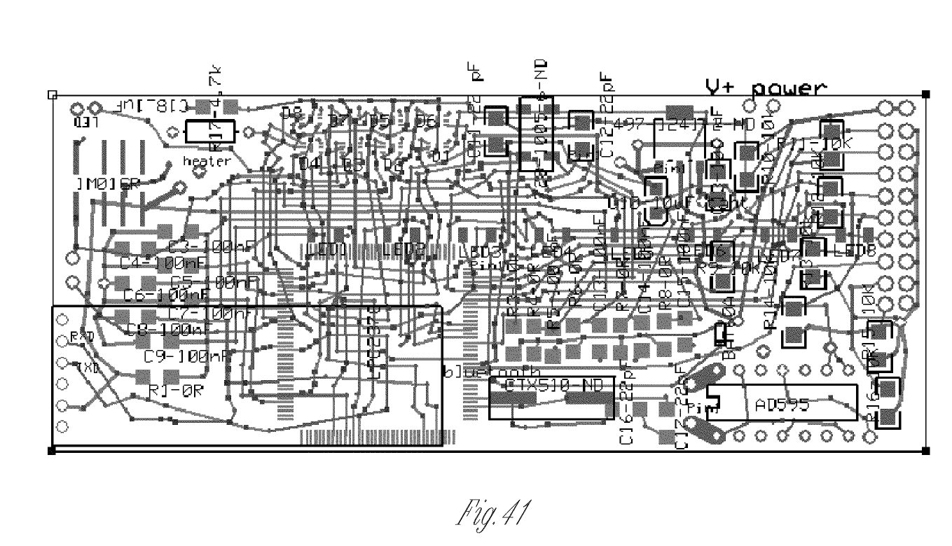

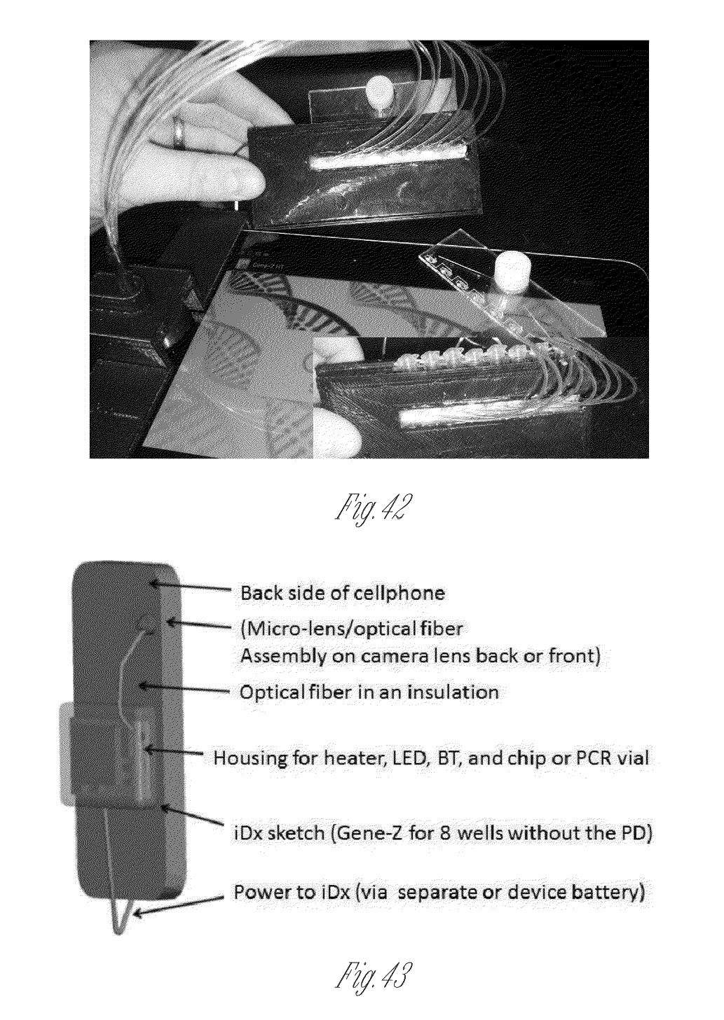

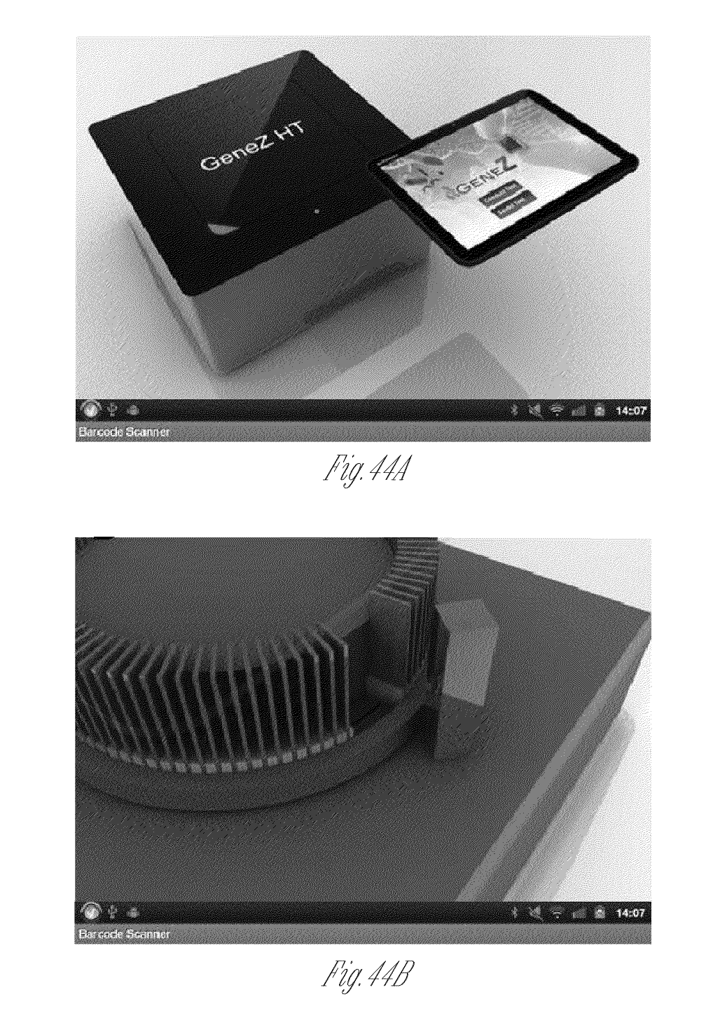

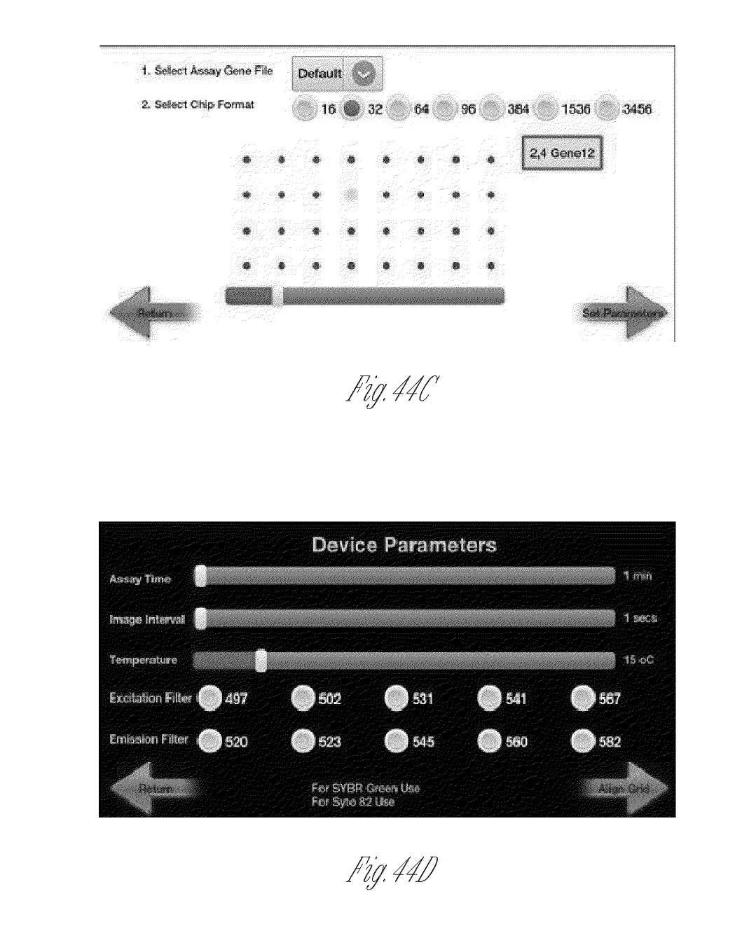

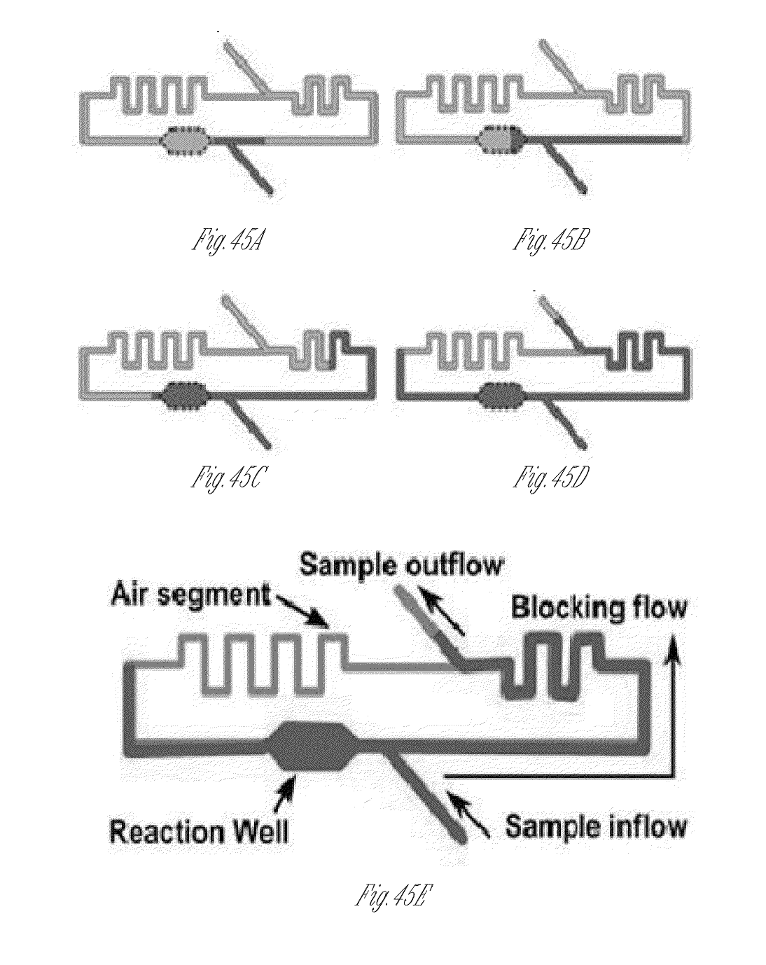

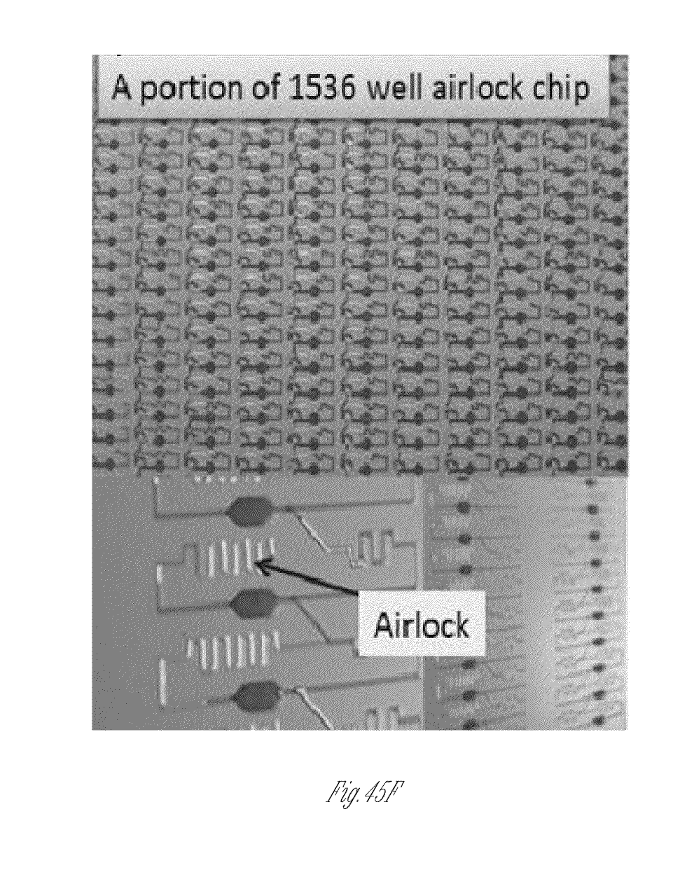

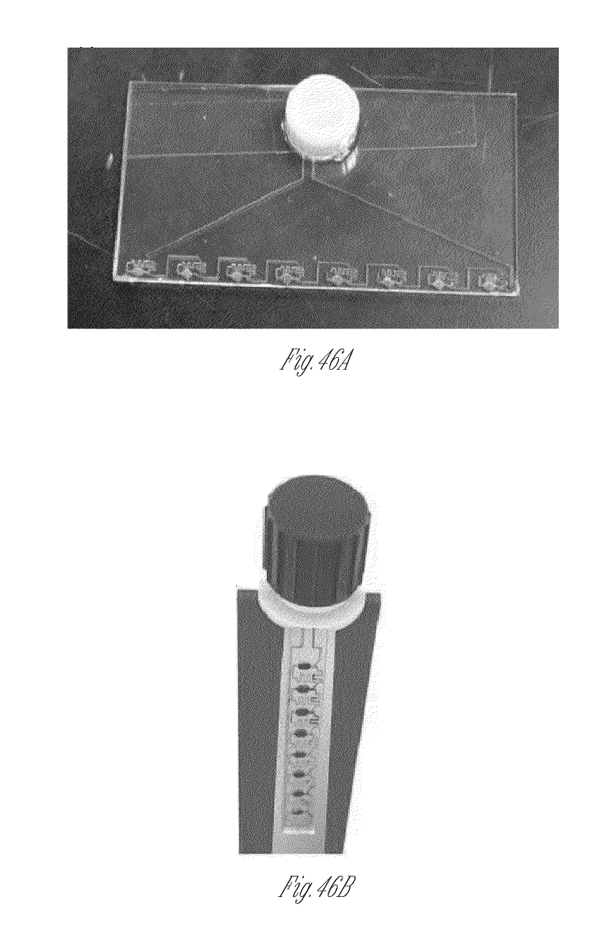

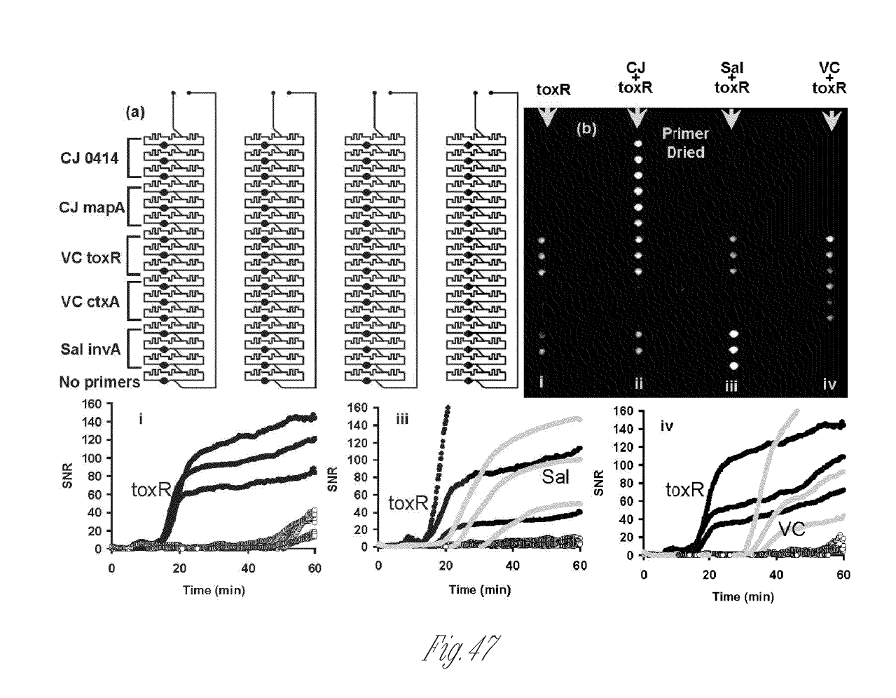

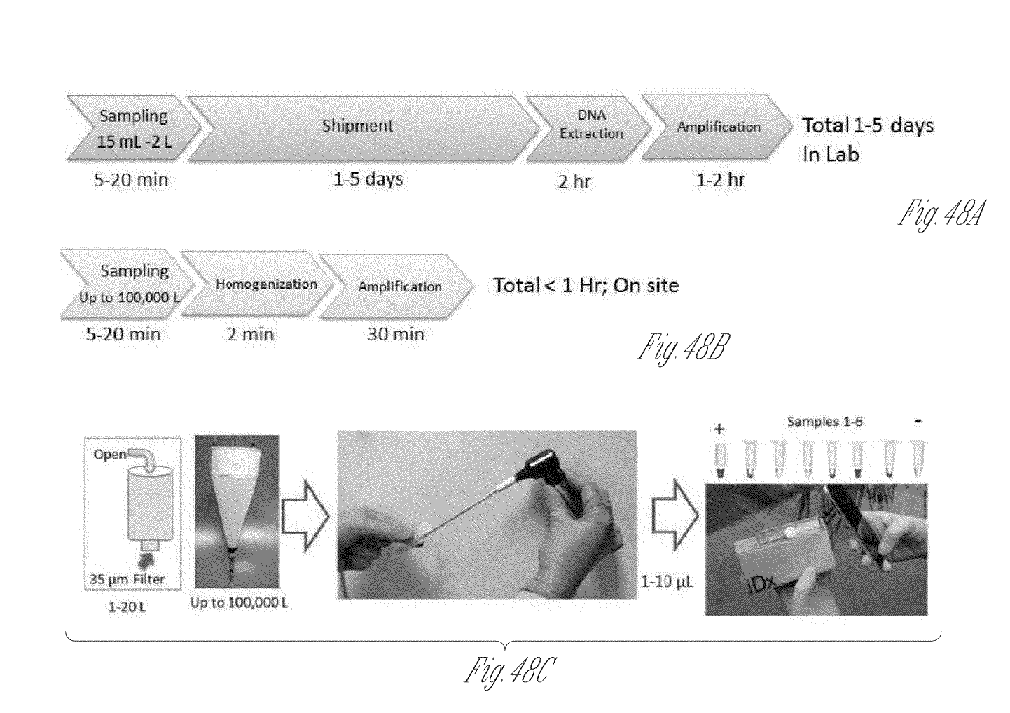

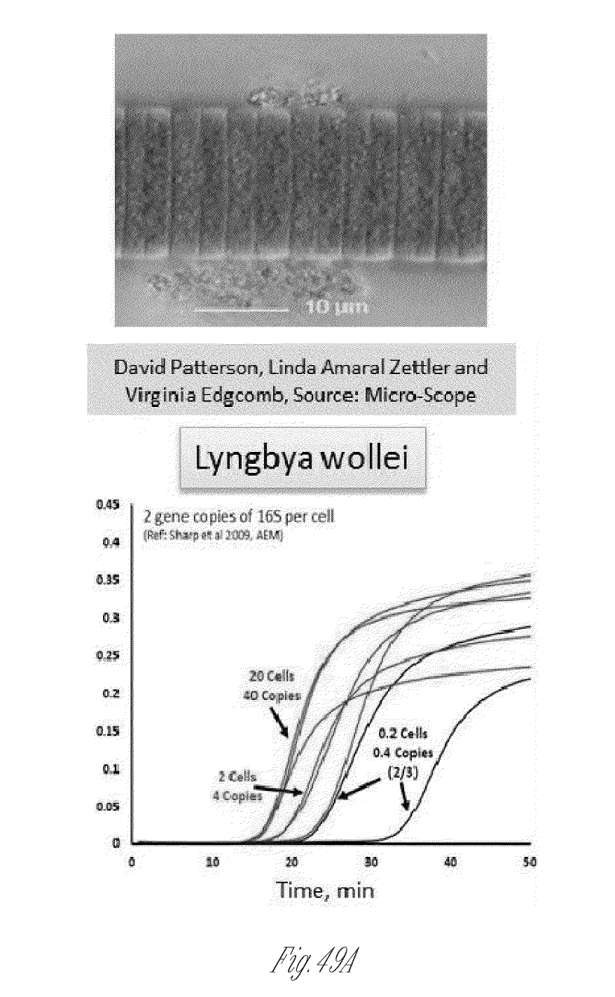

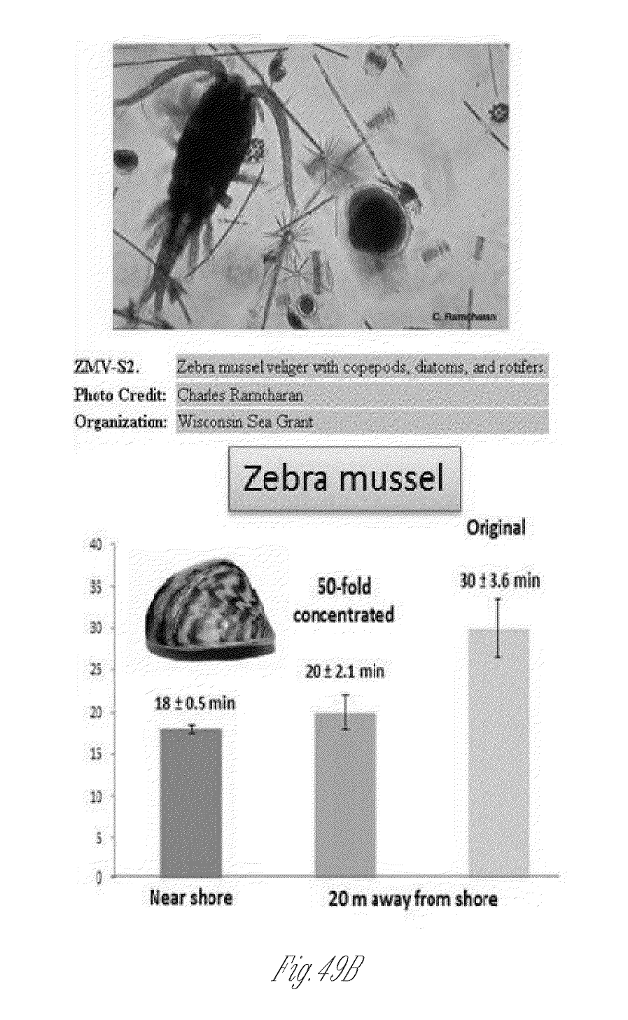

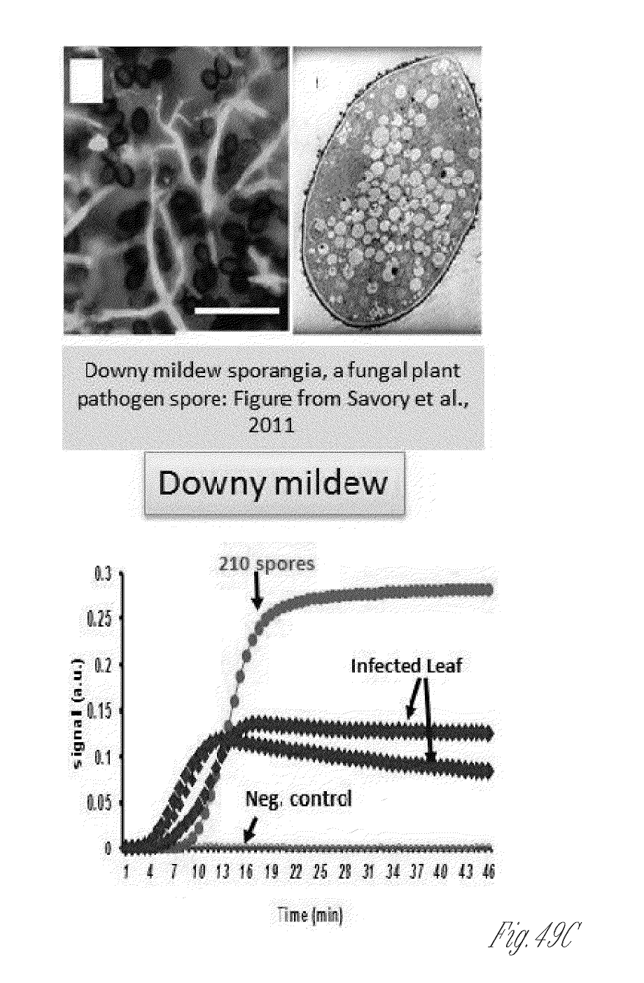

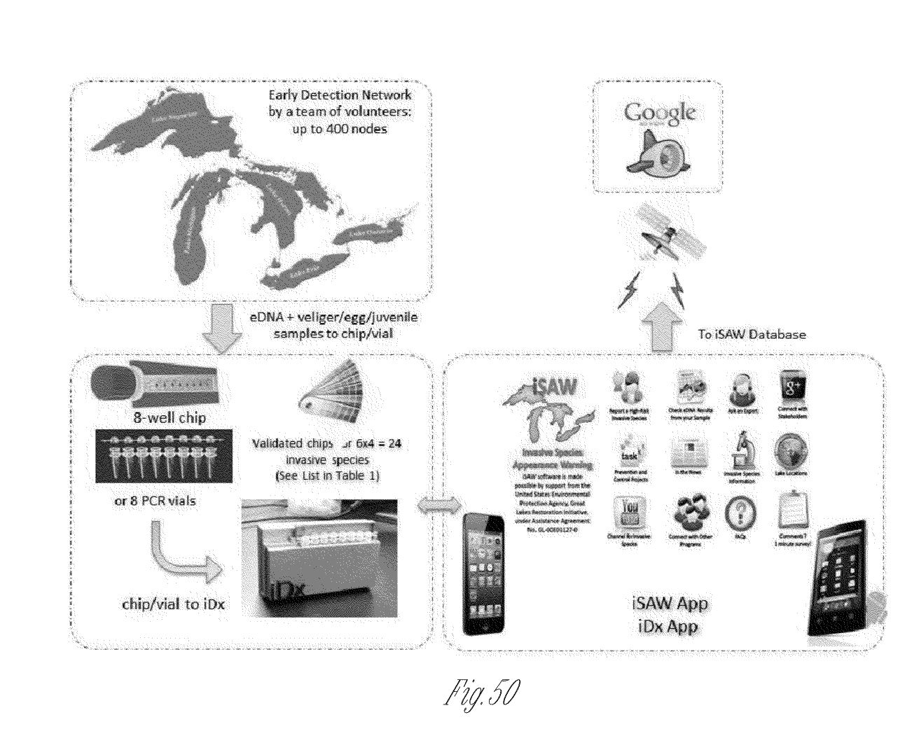

A secure data transfer and database system that complies with the Health Information Portability and Accountability Act (HIPAA) (Health Insurance Portability and Accountability Act, 1996) is required to support home health monitoring. These two components are necessary to ensure that test results are interpreted correctly and to allow consultation with a physician if necessary. Data management will be very crucial for the success of the system for supporting continuous monitoring and to keep a history of the findings overtime. An embodiment of the overall system integrated to a database for lake monitoring using iDx is shown in FIG. 50. Although a vast number of database management infrastructures and techniques are available, they are primarily focused on the communication from clients in the form of personal computers to servers by using the internet as the media. The proposed solution of using mobile technologies, like smart phones, for diagnosing will enable patients to take on the responsibility for important aspects of their self-care and monitoring. The long-term goal of our project is to develop and implement an effective informatics solution that will improve the integration of patient's health information and to test feasibility, acceptability, and satisfaction with secure data collection through secure channels of communication from a smart phone, especially for patients impacted by the presence of co-morbid conditions that also require ongoing management. This secure database management system can be integrated into the smartphone applications used with the iDx and Gene-Z devices.

### Example XXVI

This example describes some embodiments of experiments performed to demonstrate an exemplary Gene-Z™ device used with a disposable microfluidic chip developed for use in the present inventions for early detection and quantification of invasive species from lake waters with minimal sample preparation.

This example describes use of a low cost environmental DNA-based monitoring system based on microfluidic chips and a hand-held gene analyzer to screen for five high-risk invasive species in lake waters. Markers for target species if present in the environment are termed environmental DNA (cDNA). These cDNA are amplified using isothermal technique. Enumeration of copy number of target species was carried out using the real time hand-held gene analyzer named Gene-Z™

Developing an early warning system based on cDNA of multiple high priority species requires measuring the cDNA with the best possible limit of detection at the lowest cost in the simplest manner. Existing capabilities to develop and implement this capability include: i) a hand-held gene analyzer, ii) isothermal approach that is less inhibited by extraneous materials present in the sample, iii) a microfluidic chip that costs less than $5 and yet is able to measure 64 assays in parallel, iv) preliminary data demonstrating the usefulness of the complete system, and v) skillset available with the team for multiplexed low cost detection system. As described earlier, use of the devise described herein has a higher likelihood of detection of cDNA compared to traditional methods such as those by Darling and Mahon, (2007), Biological Invasions 9:751-765 and has been shown for golden mussel under field conditions.

Using the complete 18S ribosomal RNA gene sequence of Zebra mussel (D. polymorpha, Genbank ID:AF120552), LAMP primers were designed for isothermal amplification of target DNA in Lake Lansing water which is infested with Zebra mussel. Using the described microfluidic chip and the device, we were able to detect positive amplification within 15 min with no sample processing in 1 μl of lake water samples. For samples collected 60 feet from the shore, positive amplification was observed in less than 20 min but only after recovering the DNA by ethanol precipitation using a larger volume of sample (˜100× concentration). Michigan area lakes were screened for zebra mussel (D. polymorpha), quagga mussel (Dreissena bugensis) and golden mussel (Limnoperna fortunei). Positive results were obtained for quagga mussel only at Lake Michigan sites, while positive results were obtained for zebra mussel at inland lakes. These results were consistent with known infestation records available in Michigan. In all cases, filtered water samples (from plankton tows and test-scale bottles) were directly amplified. See FIG. 49-50.

Concerning direct cell amplification for quantitative detection, we have tested i) isolates alone (Escherichia coli), ii) a consortium of Dehalococcoides, iii) fungal spores directly from leaves, iv) bacterial cells directly in fecal samples, v) veligers/cells of mussels from filtered water using the amplification cards and the Gene-Z™ device.

In addition to these direct amplification means, the amplification of mRNA or RNA targets has the potential to enhance the limit of detection even further. For example, there can be ˜1000 copies/cell of 16S rRNA per cell. Because Gene-Z™ can detect as low as ˜1 copy per reaction, having multiple gene copies per cell can greatly increase the likelihood of a positive reaction. A ratio of RNA:DNA of approximately 10:1 was also reported for a variety of organisms in environmental samples. This suggests that other RNA targets likely would enhance this limit of detection as well. Reverse transcription LAMP (RT-LAMP) was developed as a method for amplifying RNA and mRNA targets in as little as 0.1 PFU/reaction of virus. The method works by combining the effects of the reverse transcriptase to convert the RNA target to the complementary DNA strand (cDNA). The polymerase then amplifies the target cDNA region normally. An enzyme was developed by Lucigen Corp. that can perform the simultaneous reverse transcription and PCR amplification in under 30 minutes at high temperatures. These methods/enzymes in conjunction with the devices described herein (e.g., Gene-Z™ or iDx) has the potential to greatly enhance the detection limit of pathogens and other targets.

The following statements summarize features of the invention.
1. A device, comprising:
   a) a plurality of sample wells, at least one of the wells containing one or more light emitting molecules;
   b) a plurality of Light Emitting Diodes (LEDs) for emitting optical energy capable of activating the one or more of the light emitting molecules, wherein each of the LEDs has a vertical plane;
   c) a plurality of optical fibers, each of the optical fibers having first and second ends, each of the first ends separately linked to a sample well for capturing emitted optical energy from the light emitting molecule(s), the second end configured for emitting the captured optical energy, wherein the first end is at an angle of greater than 1° and less than 90° from the vertical plane of the LED;
   wherein each LED source emits optical energy to one associated sample well and one first end of an optical fiber can capture optical energy from the one associated sample well.
2. The device of statement 1, wherein each sample well is linked to a separate LED.
3. The device of statement 1 or 2, wherein the vertical plane is along the light path of a LED to a sample well.
4. The device of any of statements 1-3, wherein the angle is about 30° to 60°.
5. The device of any of statements 1-4, wherein the angle is 45°.
6. The device of any of statements 1-5, wherein the LEDs are separately activated to emit optical energy capable of activating the light emitting molecule.
7. The device of any of statements 1-6, wherein the LEDs are sequentially activated to emit optical energy capable of activating the light emitting molecule.
8. The device of any of statements 1-7, further comprising at least one emission filter positioned for filtering optical energy emitted from the second end(s) of the plurality of optical fibers.
9. The device of any of statements 1-8, further comprising a light capturing unit operably linked to each of the second end(s) of the plurality of optical fibers.
10. The device of any of statements 1-9, further comprising a light capturing unit operably linked to each of the second end(s) of the plurality of optical fibers, wherein the light capturing unit is a photodiode, photomultiplier, fluorescence detector, charge-coupled device, or a combination thereof.
11. The device of any of statements 1-10, wherein the plurality of sample wells are contained within a biochip.
12. The device of any of statements 1-11, wherein the plurality of sample wells is contained within a biochip and the biochip further comprises microchannels.
13. The device of any of statements 1-12, wherein the plurality of sample wells is contained within a biochip, and each sample well is connected to a first branch of a bifurcated input microchannel and to an airlock microchannel, wherein the combination of a sample well, a connected input microchannel and a connected airlock microchannel forms a unit within the biochip.
14. The device of any of statements 1-13, wherein the plurality of sample wells is contained within a biochip, and each sample well is connected to a first branch of a bifurcated input microchannel and to an airlock microchannel, wherein the combination of a sample well, a connected input microchannel and a connected airlock microchannel forms a unit within the biochip, and the biochip comprises about 2 to about 100,000 units, or about 2 to about 50,000 units, or about 2 to about 2000 units, or about 2 to about 100 units, or about 2 to about 64 units, or about 2 to about 8 units.
15. The device of any of statements 1-14, wherein the plurality of sample wells is contained within a biochip, and each sample well is connected to a first branch of a bifurcated input microchannel and to an airlock microchannel, wherein the combination of a sample well, a connected input microchannel and a connected airlock microchannel forms a unit within the biochip, and wherein each airlock microchannel allows sample to enter a sample well but does not allow components in the sample well to leave the sample well.
16. The device of any of statements 13-15, wherein a segment of each airlock microchannel is filled with air.
17. The device of any of statement 13-16, wherein each airlock microchannel is connected to a microchannel sample outflow port, and sample not flowing into a sample well can exit the microchannel sample outflow port by passage through a second branch of the bifurcated input microchannel to the microchannel sample outflow port.
18. The device of any of statements 1-17, wherein the sample wells are contained within a biochip and the biochip further comprises microchannels allowing sample to self-digitize and flow into multiple sample wells.
19. The device of any of statements 1-18, wherein the sample wells are contained within a disposable biochip.
20. The device of any of statements 1-19, wherein the sample wells are contained within a biochip and the biochip comprises acrylic, glass, silica, silicon, polycarbonate, poly(methyl methacrylate), polyester, or a combination thereof.
21. The device of any of statements 1-20, wherein the sample wells are contained within a biochip and the biochip is manufactured by cutting, etching, printing, injection molding, or a combination thereof.
22. The device of any of statements 1-21, wherein the sample wells are separately adapted to accommodate the same or different sample volumes.
23. The device of any of statements 1-22, wherein each sample well separately has a volume that is selected from the group consisting of about 10 nanoliters to about 1 milliliter, or about 20 nanoliters to about 0.5 milliliters, or about 50 nanoliters to about 1 milliliter, or about 0.05 microliters to about 200 microliters, about 0.1 microliter to about 100 microliters, about 1 microliter to about 50 microliters, about 0.25 microliters to about 10 microliters, and about 0.25 microliters to about 5 microliters.
24. The device of any of statements 1-23, comprising about 2 to about 100,000 sample wells, or about 2 to about 50,000 sample wells, or about 2 to about 2000 sample wells, or about 2 to about 100 sample wells, or about 2 to about 64 sample wells, or about 2 to about 8 sample wells.
25. The device of any of statements 1-24, further comprising a cap or plug configured to seal at least one sample inflow port, at least one sample outflow port, or a combination thereof.
26. The device of any of statements 1-25, further comprising a biochip holder in contact with the sample wells wherein the holder has indented openings for guiding placement of the sample wells into the biochip holder.
27. The device of any of statements 1-26, further comprising a heater capable of heating the sample wells in contact with the heater.
28. The device of any of statements 1-27, further comprising a heater configured to heat the sample wells by circulation of heated air.
29. The device of any of statements 1-28, further comprising a heater configured to heat the sample wells to a temperature of about 50° C. to about 95° C., or about 55° C. to about 80° C., or about 58° C. to about 72° C.
30. The device of any of statements 1-29, wherein at least one of the sample wells contains an amplification nucleic acid molecule selected from the group consisting of a primer for nucleic acid amplification, a primer for microRNA nucleic acid amplification, an oligonucleotide probe, a DNA extension sequence, a template strand for hybridization and base stacking
31. The device of any of statements 1-30, wherein at least one of the sample wells comprises one or more primers that can hybridize to a target nucleic acid.
32. The device of any of statements 1-31, wherein at least one of the sample wells comprises one or more primers that can hybridize to a target nucleic acid, and the target nucleic acid is provided (or has been provided) to the sample wells as a sample to be tested (or amplified) via a first branch of a bifurcated input microchannel.
33. The device of any of statements 1-32, wherein at least one of the sample wells comprises one or more primers that can specifically hybridize to a target nucleic acid at about 50° C. to about 80° C., or at about 55° C. to about 75° C., or at about 58° C. to about 72° C.
34. The device of any of statements 1-33, wherein at least one of the wells comprises one or more primers comprising a sequence selected from the group consisting of any of SEQ ID NO:1-114 or a combination thereof.
35. The device of any of statements 1-34, further comprising DNA polymerase in one or more sample wells.
36. The device of any of statements 1-35, further comprising DNA polymerase in substantially all of the sample wells.
37. The device of any of statements 1-36, further comprising Bst polymerase in one or more sample wells.
38. The device of any of statements 1-37, further comprising Bst polymerase in substantially all of the sample wells.
39. The device of any of statements 1-38, wherein one or more of the samples wells contains two or more types of light emitting molecules.
40. The device of any of statements 1-39, wherein one or more of the light emitting molecule is a fluorescent or chemiluminescent molecule.
41. The device of any of statements 1-40, wherein one or more of the light emitting molecules is orange SYTO®-81, SYTO®-82, a cyanine dye, an asymmetrical cyanine dye, a green fluorescent dye, SYBR® Green I, SYBR® Green II, green SYTO®, SYBR™ Brilliant Green, SYBR™ Green I, SYBR™ Green II, SYBR™ gold, SYBR™ safe, EvaGreen™, fluorescein, ethidium bromide (EtBr), thiazole orange (TO), oxazole yellow (YO), thiarole orange (TOTO), oxazole yellow homodimer (YOYO), oxazole yellow homodimer (YOYO-1), SYPRO® Ruby, SYPRO® Orange, Coomassie Fluor™ Orange stains, or a derivative thereof.
42. The device of any of statements 1-41, wherein the light emitting molecule is orange SYTO®-81 or SYTO®-82.
43. The device of any of statements 1-42, wherein the light emitting molecule is one or more of the following compounds:

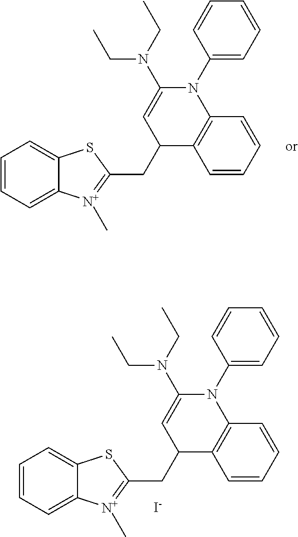 [SMILES: CCN(CC)C1=CC(Cc2sc3ccccc3[n+]2C)c2ccccc2N1c1ccccc1 ; CCN(CC)C1=CC(Cc2sc3ccccc3[n+]2C)c2ccccc2N1c1ccccc1 ; [I-]]

44. The device of any of statements 1-43, further comprising an untreated sample.
45. The device of any of statements 1-43, further comprising a heat treated sample.
46. The device of any of statements 1-43 or 45, further comprising a chemically or physically disrupted sample.
47. The device of any of statements 1-46, further comprising a sample with one to 100 cells, or with one to 10 cells, or with one to 5 cells, or with one to two cells, in one or more sample wells.
48. The device of any of statements 1-47, further comprising a sample with a concentration of one to 10¹⁰ cells per litter, or 10 to 10¹⁰ cells per liter, or 100 to 10⁹ cells per liter, or 10³ to 10⁹ cells per liter, or 10⁴ to 10⁹ cells per liter, or 10⁵ to 10⁸ cells per liter, or 10⁶ to 10⁸ cells per liter, or 10⁷ to 10⁹ cells per liter, or 10⁷ to 10⁸ cells per liter.
49. The device of any of statements 1-48, further comprising a sample selected from the group consisting of a single cell, whole cells, genomic DNA, heat-treated cells, one or more cells that have undergone chemical lysis, a food sample, an environmental sample, an unprocessed sample, a purified sample and an unpurified sample.
50. The device of any of statements 1-49, further comprising a processor, computer, microprocessor, touch screen computational phone, tablet, PDA, music player with wireless capabilities, or smart device operably linked to the device.
51. The device of any of statements 1-50, further comprising a processor, computer, microprocessor, touch screen computational phone, tablet, PDA, music player with wireless capabilities, or smart device that can receive optical energy from the second end of an optical fiber via a light detector, a microcontroller, wireless transmission, or a combination thereof.
52. The device of any of statements 1-51, further comprising a processor, computer, microprocessor, touch screen computational phone, tablet, PDA, music player with wireless capabilities, or smart device that can automatically analyze data, store data, transmit data, report data, or a combination thereof.
53. The device of any of statements 1-52, further comprising a charge-coupled device as a light capturing unit.
54. The device of statement 53, wherein the charge-coupled device receives and/or records light from any of the second end(s) of the plurality of optical fibers.
55. The device of any of statements 1-54, further comprising a wireless interface module.
56. The device of any of statements 1-55, further comprising a wireless interface module for wireless transmission of data from the device.
57. The device of any of statements 1-56, further comprising a wireless interface module for wireless transmission of data from the device to a central database repository, a private database or a commercially available database.
58. The device of any of statements 1-57, wherein each sample well is a reaction well configured for amplification of one or more nucleic acids provided as a sample to the reaction well.
59. The device of any of statements 1-58, wherein each LED can be above or below an associated sample well.
60. The device of any of statements 1-59, further comprising a battery to provide power to the device, a solar charger for the battery, or a combination thereof.
61. The device of any of statements 1-60, comprising
   a detachable, disposable biochip comprising a plurality of sample wells, each sample well configured (i) to receive light from a Light Emitting Diode (LED) and (ii) to emit light from one or more light emitting molecules residing within each of the plurality of reaction wells;
   a biochip holder that can be joined to the biochip and placed in contact with the sample wells, wherein the biochip holder has (i) a series of indentions, each indentation configured to guide alignment and placement of each of the plurality of sample wells onto the biochip holder, (ii) holes for alignment and passage of light from each LED to an aligned sample well, and (iii) attachment channels, each attachment channel configured for attachment of a first end of a separate optical fiber that can capture emitted optical energy from one or more of the light emitting molecules in an associated sample well;
   wherein each of the attachment channels is at an angle of greater than 1° and less than 90° from the path of light from the LED to the sample well;
   wherein a second end of each of the optical fibers can emit light to a light capturing unit.
62. The device of statement 61, further comprising a heater integrated into the biochip holder.
63. The device of statement 62, further comprising a detachable heater configured to heat each of the sample wells.
64. A device, comprising:
   a) a plurality of sample wells, at least one of said wells containing a fluorescent molecule;
   b) a plurality of Light Emitting Diodes (LEDs) for emitting optical energy capable of activating said fluorescent molecule, wherein each of said LEDs has a vertical plane;
   c) a plurality of optical fibers, wherein each said optical fiber has first and second ends, said first end positioned for capturing emitted optical energy from said fluorescent molecule, said second end configured for emitting said captured optical energy, wherein said first end is at an angle of greater than 1° and less than 90° from said vertical plane of said LED; wherein each LED source is associated with one sample well and one said optical fiber in optical communication such that optical energy emitted by said LED illuminates said one sample well in a manner capable of causing said fluorescent molecules to emit optical energy captured by said first end of said optical fiber.
65. The device of statement 64, wherein said angle is 45°.
66. The device of statement 64, further comprising one emission filter positioned for filtering optical energy emitted from said second end of said plurality of fiber optics.
67. The device of statement 64, wherein said sample wells are contained within a biochip.
68. The device of statement 67, further comprising a biochip holder in contact with said sample wells wherein said holder has indented openings for guiding placement of said sample wells into said biochip holder.
69. The device of statement 68, wherein said holder further comprises a heater capable of heating said sample wells in contact with said heater.
70. The device of statement 69, wherein at least one of said sample wells contains an amplification nucleic acid molecule selected from the group consisting of a primer for nucleic acid amplification, a primer for microRNA nucleic acid amplification, an oligonucleotide probe, a DNA extension sequence, a template strand for hybridization and base stacking
71. The device of statement 64, wherein at least one of said sample wells further comprises a sample selected from the group consisting of a single cell, a whole cells, genomic DNA, a cell that has undergone chemical lyses, a purified sample and an unpurified sample.
72. A device, comprising
   a) a plurality of sample wells in a biochip, at least one of said wells containing a fluorescent molecule;
   b) a plurality of Light Emitting Diodes (LEDs) for emitting optical energy capable of activating said fluorescent molecule, wherein each of said LEDs has a vertical plane;
   c) a plurality of optical fibers wherein each optical fiber has first and second ends, said first end positioned for capturing emitted optical energy from said fluorescent molecule, said second end configured for emitting said captured optical energy, wherein said first end is at an angle of greater than 1° and less than 90° from said vertical plane of said LED; wherein each LED source is associated with one sample well and one said optical fiber in optical communication such that optical energy emitted by said LED illuminates said one sample well in a manner capable of causing said fluorescent molecules to emit optical energy captured by said first end of said optical fiber, and
   d) a biochip holder in contact with said sample wells, wherein said holder comprises indented openings for guiding placement of said sample wells into said biochip holder.
73. The device of statement 72, wherein said holder further comprises a heater capable of heating said sample wells in contact with said heater.
74. The device of statement 73, further comprising a user interface for operating said device.
75. The device of statement 74, wherein said user interface is a wireless user interface module.
76. The device of statement 75, further comprising a microcontroller in electrical communication with said heater and said wireless user interface module.
77. The device of statement 75, wherein said wireless user interface is selected from the group consisting a touch screen computational phone, tablet, PDA, and a music player with wireless capabilities.
78. The device of statement 72, further comprising one photodiode for capturing and measuring optical energy emitted from said second end of said plurality of fiber optics.
79. The device of statement 78, further comprising one emission filter positioned for filtering optical energy emitted from said second end of said plurality of fiber optics before capture by said photodiode.
80. A method for detecting fluorescence, comprising,
   a) applying a sample to the device of any of statements 1-79;
   b) illuminating one or more of sample wells in the device via one or more LEDs;
   c) capturing light or light energy emitted by fluorescent light emitting molecules with the one or more optical fibers to thereby detect fluorescence.
81. A method of detecting the amount of nucleic acid present in a sample, the method comprising:
   separately amplifying one or more nucleic acids within a plurality of reaction wells, each reaction well operably linked to a Light Emitting Diode (LED);
   separately detecting the period of time for a specified amount of amplified nucleic acid to be made within each reaction well by recording the time for a specified level of optical energy to be emitted from light emitting molecules that are present within each of the sample wells, the light emitting molecules capable of emitting light upon incorporation into the nucleic acid, and the period of time being dependent on the amount of nucleic acid present in the sample;
   wherein detecting the period of time further comprises:
   separately emitting optical energy from each LED into its operably linked reaction well, wherein the optical energy is capable of activating the light emitting molecules in each of the plurality of sample wells;
   capturing optical energy from activated light emitting molecules incorporated into the nucleic acid(s) with a first end of an optical fiber operably linked to a reaction well, wherein the first end is positioned at an angle of greater than 1° and less than 90° from the light path of the LED;
   receiving optical energy from a second end of the optical fiber;
   intermittently recording the amount of optical energy received from the second end of the optical fiber until at least the specified level of optical energy is emitted from light emitting molecules, to thereby detect the period of time for a specified amount of amplified nucleic acid to be made.
82. A method for detecting fluorescence, comprising,
   a) providing, a device, comprising:
      i) a plurality of sample wells, at least one of said wells containing a fluorescent molecule;
      ii) a plurality of Light Emitting Diodes (LEDs) for emitting optical energy capable of activating said fluorescence molecule, wherein each of said LEDs has a vertical plane;
      iii) a plurality of optical fibers wherein each optical fiber has first and second ends, said first end positioned for capturing emitted optical energy from said fluorescence molecule, said second end configured for emitting said captured optical energy, wherein said first end is at a 45 degree angle in relation to said vertical plane of said LED; wherein each LED source is associated with one sample well and one said optical fiber, and
   b) illuminating one or more of said sample wells with said LEDs;
   c) capturing the energy emitted by said fluorescent molecules with said optical fibers thereby detecting fluorescence.
83. The method of statement 82, wherein at least one of said sample wells further comprises a sample selected from the group consisting of a single cell, a whole cells, genomic DNA, a cell that has undergone chemical lyses, a purified sample and an unpurified sample.
84. The method of statement 82, wherein at least one of said sample wells further comprises a sample selected from the group consisting of water, a bodily fluid, and a blood sample.
85. The method of statement 82, wherein said sample wells has a concentration of cells between one and 10⁶ L⁻¹ cells.
86. A microfluidic biochip, comprising:
   a plurality of units, each unit comprising a sample well,
   each sample well connected to a first branch of a bifurcated input microchannel and to an airlock microchannel,
   wherein each airlock microchannel allows sample to enter a sample well but does not allow components in the sample well to leave the sample well; and
   wherein each sample well comprises walls that allow passage of light radiating from with the sample well.
87. The microfluidic biochip of statement 86, wherein the biochip comprises about 2 to about 100,000 units, or about 2 to about 50,000 units, or about 2 to about 2000 units, or about 2 to about 100 units, or about 2 to about 64 units, or about 2 to about 8 units.
88. The microfluidic biochip of statement 86 or 87, wherein a segment of each airlock microchannel is filled with air.
89. The microfluidic biochip of any of statement 86-88, wherein a proximal end of each airlock microchannel is joined to a sample well and a distal end of each airlock microchannel is joined to microchannel leading to the sample outflow port.
90. The microfluidic biochip of any of statement 86-89, wherein each airlock microchannel is connected to a microchannel sample outflow port, and sample not flowing into a sample well can exit the microchannel sample outflow port by passage through a second branch of the bifurcated input microchannel to the microchannel sample outflow port.
91. The microfluidic biochip of any of statement 86-90, wherein liquid sample can to self-digitize and flow into multiple sample wells via input microchannel leading into each sample well.
92. The microfluidic biochip of any of statement 86-91, further comprising a sample entry port for the biochip.
93. The microfluidic biochip of any of statement 86-92, wherein the biochip is a disposable biochip.
94. The microfluidic biochip of any of statement 86-93, wherein the biochip comprises acrylic, glass, silica, silicon, polycarbonate, poly(methyl methacrylate), polyester, or a combination thereof.
95. The microfluidic biochip of any of statement 86-94, wherein the sample wells comprises acrylic, glass, silica, silicon, polycarbonate, poly(methyl methacrylate), polyester, or a combination thereof.
96. The microfluidic biochip of any of statement 86-96, wherein the sample wells and/or the microchannels are manufactured by cutting, etching, printing, injection molding, or a combination thereof.
97. The microfluidic biochip of any of statement 86-96, wherein the sample wells are separately adapted to accommodate the same or different sample volumes.
98. The microfluidic biochip of any of statement 86-97, wherein each sample well separately has a volume that is selected from the group consisting of about 10 nanoliters to about 1 milliliter, or about 20 nanoliters to about 0.5 milliliters, or about 50 nanoliters to about 1 milliliter, or about 0.05 microliters to about 200 microliters, about 0.1 microliter to about 100 microliters, about 1 microliter to about 50 microliters, about 0.25 microliters to about 10 microliters, and about 0.25 microliters to about 5 microliters.
99. The microfluidic biochip of any of statement 86-98, wherein each sample well configured (i) to receive light from a Light Emitting Diode (LED) and (ii) to emit light from one or more light emitting molecules residing within each of the plurality of sample wells.
100. A device comprising the microfluidic biochip of any of statements 86-99, further comprising:
   a) a plurality of Light Emitting Diodes (LEDs), each LED capable of emitting optical energy into one operably linked sample well of the biochip, wherein the optical energy can activate one or more light emitting molecules in the operably linked sample well;
   b) a biochip holder comprising indented openings for guiding placement of the sample wells into the holder, the biochip holder further comprising a plurality of optical fibers, each of the optical fibers having first and second ends, each of the first ends separately be linked to a sample well for capturing light emitted from one or more light emitting molecule(s) in the sample well, the second end configured for emitting the captured optical energy;
   wherein the first end of each optical fiber is configured to capture light from an associated sample well at an angle of greater than 1° and less than 90° from the LED light path.
101. A kit comprising:
   (a) at least one microfluidic biochip, each biochip comprising a plurality of units, each unit comprising a sample well,
      each sample well connected to a first branch of a bifurcated input microchannel and to an airlock microchannel;
      wherein each airlock microchannel allows sample to enter a sample well but does not allow components in the sample well to leave the sample well; and
      wherein each sample well configured (i) to receive light from a Light Emitting Diode (LED) and (ii) to emit light from one or more light emitting molecules residing within each of the plurality of reaction wells;
   (b) a biochip holder that can be joined to the biochip and placed in contact with the sample wells, wherein the biochip holder has (i) a series of indentions, each indentation configured to guide alignment and placement of each of the plurality of sample wells onto the biochip holder, (ii) holes for alignment and passage of light from each LED to an aligned sample well, and (iii) attachment channels, each attachment channel configured for attachment of a first end of a separate optical fiber that can capture emitted optical energy from one or more of the light emitting molecules in an associated sample well;
   wherein each of the attachment channels is at an angle of greater than 1° and less than 90° from the path of light from the LED to the sample well;
   wherein a second end of each of the optical fibers can emit light to a light capturing unit.
102. The kit of statement 101, further comprising a heater integrated into the biochip holder.
103. The kit of statement 101, further comprising a detachable heater configured to heat each of the sample wells.
104. The kit of any of statements 101-103, further comprising a light capturing unit.
105. The kit of any of statements 101-104, further comprising a battery, a solar charging unit or a combination thereof.
106. The kit of any of statements 101-105, comprising any of the features of the device of any of statements 1-79 or 100.

All publications and patents mentioned in the above specification are herein incorporated by reference. Various modifications and variations of the described compositions and methods of the invention will be apparent to those skilled in the art without departing from the scope and spirit of the invention. Although the invention has been described in connection with specific preferred embodiments, it should be understood that the invention should not be unduly limited to such specific embodiments. Indeed, various modifications of the described modes for carrying out the invention which are obvious to those skilled in electronics, physics, medicine, microbiology, diagnostics, evolutionary biology, molecular biology or related fields are intended to be within the scope of the present invention and the following Claims.

1. A device, comprising:
a) a plurality of sample wells, at least one of the wells containing one or more light emitting molecules;
b) a plurality of Light Emitting Diodes (LEDs), each LED capable of emitting optical energy for activating the one or more of the light emitting molecules in an associated sample, wherein each of the LEDs has a vertical plane;
c) a plurality of optical fibers, each of the optical fibers having first and second ends, each of the first ends separately and operably linked to an associated sample well for capturing emitted optical energy from the light emitting molecule(s), the second end configured for emitting the captured optical energy;
wherein the first end is at an angle of greater than 1° and less than 90° from the vertical plane of the LED.

2. The device of claim 1, wherein each sample well receives optical energy from a separate LED.

3. The device of claim 1, wherein the vertical plane of each LED is parallel to an LED's light path to the associated sample well.

4. The device of claim 1, wherein the angle is about 30° to 60°.

5. The device of claim 1, wherein the LEDs are sequentially activated to emit optical energy capable of activating the light emitting molecule(s) in associated sample wells.

6. The device of claim 1, further comprising a series of light capturing units operably linked to each of the second end(s) of the plurality of optical fibers.

7. The device of claim 6, wherein the light capturing units are selected from a photodiodes, photomultipliers, fluorescence detectors, charge-coupled devices, and a combination thereof.

8. The device of claim 1, further comprising a holder in contact with said sample wells, wherein said holder comprises indented openings for guiding placement of the sample wells into the holder.

9. The device of claim 8, wherein the holder further comprises a heater capable of heating the sample wells in contact with the heater.

10. The device of claim 8, wherein the holder further comprises a series of attachment channels, each attachment channel configured for attachment of a first end of an optical fiber to an associated sample well.

11. The device of claim 1, wherein the plurality of sample wells is contained within a biochip, and each sample well is connected to a first branch of a bifurcated input microchannel and to an airlock microchannel, wherein the combination of a sample well, a connected input microchannel and a connected airlock microchannel forms a unit within the biochip, and wherein each airlock microchannel allows sample to enter a sample well but does not allow components in that sample well to leave the sample well.

12. The device of claim 1, wherein the sample wells are contained within a biochip and the biochip comprises acrylic, glass, silica, silicon, polycarbonate, poly(methyl methacrylate), polyester, or a combination thereof.

13. The device of claim 1, further comprising a user interface for operating said device.

14. The device of claim 13, wherein the user interface has wireless capabilities.

15. The device of claim 14, wherein the user interface is a processor, computer, microprocessor, microcontroller, touch screen computational phone, tablet, PDA, music player with wireless capabilities, a touch screen computational phone, charge-coupled device, or smart device that can automatically analyze data, store data, transmit data, report data, or a combination thereof.

16. The device of claim 1, further comprising a wireless interface module for wireless transmission of data from the device to a central database repository, a private database or a commercially available database.

17. A method for detecting light or optical energy emitted by a sample, comprising,
a) applying a sample to at least one of the sample wells of the device of claim 1;
b) illuminating one or more of sample wells in the device via one or more LEDs;
c) observing light or light energy emitted by light emitting molecules within one or more of the sample wells to thereby detect light or optical energy emitted by the sample.

18. A microfluidic biochip, comprising:
a plurality of units, each unit comprising a sample well,
each sample well connected to a first branch of a bifurcated input microchannel and to an airlock microchannel,
wherein each airlock microchannel allows sample to enter a sample well but does not allow components in the sample well to leave the sample well; and
wherein each sample well comprises walls that allow passage of light radiating from with the sample well.

19. A kit comprising the microfluidic biochip of claim 18 and instructions for using the microfluidic biochip.

20. The kit of claim 19, comprising:
(a) at least one microfluidic biochip, each biochip comprising a plurality of units, each unit comprising a sample well,
each sample well connected to a first branch of a bifurcated input microchannel and to an airlock microchannel;
wherein each airlock microchannel allows sample to enter a sample well but does not allow components in the sample well to leave the sample well; and
wherein each sample well is configured (i) to receive light from a Light Emitting Diode (LED) and (ii) to emit light from one or more light emitting molecules residing within each of the plurality of reaction wells;
(b) a biochip holder that can be joined to the biochip so that the sample wells are in contact with the holder, wherein the biochip holder has (i) a series of indentions, each indentation configured to guide alignment and placement of each of the plurality of sample wells onto the biochip holder, (ii) holes for alignment and passage of light from each LED to an aligned sample well, and (iii) attachment channels, each attachment channel configured for attachment of a first end of a separate optical fiber that can capture emitted optical energy from one or more of the light emitting molecules in an associated sample well;
wherein each of the attachment channels is at an angle of greater than 1° and less than 90° from the path of light from the LED to the sample well; and
wherein a second end of each of the optical fibers can emit light to a light capturing unit.
